SEQUENCE LISTING (12 sequences)

SEQ ID NO: 1 - protein, 831 aa, Homo sapiens
  SIGNAL (1)..(33): Sortilin signal peptide
MERPWGAADGLSRWPHGLGLLLLLQLLPPSTLSQDRLDAPPPPAAPLPRWSGPIGVSWGLRAAAAGGAFPRGGRWRRSAPGEDEECGRVRDFVAKLANNTHQHVFDDLRGSVSLSWVGDSTGVILVLTTFHVPLVIMTFGQSKLYRSEDYGKNFKDITDLINNTFIRTEFGMAIGPENSGKVVLTAEVSGGSRGGRIFRSSDFAKNFVQTDLPFHPLTQMMYSPQNSDYLLALSTENGLWVSKNFGGKWEEIHKAVCLAKWGSDNTIFFTTYANGSCKADLGALELWRTSDLGKSFKTIGVKIYSFGLGGRFLFASVMADKDTTRRIHVSTDQGDTWSMAQLPSVGQEQFYSILAANDDMVFMHVDEPGDTGFGTIFTSDDRGIVYSKSLDRHLYTTTGGETDFTNVTSLRGVYITSVLSEDNSIQTMITFDQGGRWTHLRKPENSECDATAKNKNECSLHIHASYSISQKLNVPMAPLSEPNAVGIVIAHGSVGDAISVMVPDVYISDDGGYSWTKMLEGPHYYTILDSGGIIVAIEHSSRPINVIKFSTDEGQCWQTYTFTRDPIYFTGLASEPGARSMNISIWGFTESFLTSQWVSYTIDFKDILERNCEEKDYTIWLAHSTDPEDYEDGCILGYKEQFLRLRKSSVCQNGRDYVVTKQPSICLCSLEDFLCDFGYYRPENDSKCVEQPELKGHDLEFCLYGREEHLTTNGYRKIPGDKCQGGVNPVREVKDLKKKCTSNFLSPEKQNSKSNSVPIILAIVGLMLVTVVAGVLIVKKYVCGGRFLVHRYSVLQQHAEANGVDGVDALDTASHTNKSGYHDDSDEDLLE

SEQ ID NO: 2 - protein, 2214 aa, Homo sapiens
  SIGNAL (1)..(28): Signal peptide of SorLA
MATRSSRRESRLPFLFTLVALLPPGALCEVWTQRLHGGSAPLPQDRGFLVVQGDPRELRLWARGDARGASRADEKPLRRKRSAALQPEPIKVYGQVSLNDSHNQMVVHWAGEKSNVIVALARDSLALARPKSSDVYVSYDYGKSFKKISDKLNFGLGNRSEAVIAQFYHSPADNKRYIFADAYAQYLWITFDFCNTLQGFSIPFRAADLLLHSKASNLLLGFDRSHPNKQLWKSDDFGQTWIMIQEHVKSFSWGIDPYDKPNTIYIERHEPSGYSTVFRSTDFFQSRENQEVILEEVRDFQLRDKYMFATKVVHLLGSEQQSSVQLWVSFGRKPMRAAQFVTRHPINEYYIADASEDQVFVCVSHSNNRTNLYISEAEGLKFSLSLENVLYYSPGGAGSDTLVRYFANEPFADFHRVEGLQGVYIATLINGSMNEENMRSVITFDKGGTWEFLQAPAFTGYGEKINCELSQGCSLHLAQRLSQLLNLQLRRMPILSKESAPGLIIATGSVGKNLASKTNVYISSSAGARWREALPGPHYYTWGDHGGIITAIAQGMETNELKYSTNEGETWKTFIFSEKPVFVYGLLTEPGEKSTVFTIFGSNKENVHSWLILQVNATDALGVPCTENDYKLWSPSDERGNECLLGHKTVFKRRTPHATCFNGEDFDRPVVVSNCSCTREDYECDFGFKMSEDLSLEVCVPDPEFSGKSYSPPVPCPVGSTYRRTRGYRKISGDTCSGGDVEARLEGELVPCPLAEENEFILYAVRKSIYRYDLASGATEQLPLTGLRAAVALDFDYEHNCLYWSDLALDVIQRLCLNGSTGQEVIINSGLETVEALAFEPLSQLLYWVDAGFKKIEVANPDGDFRLTIVNSSVLDRPRALVLVPQEGVMFWTDWGDLKPGIYRSNMDGSAAYHLVSEDVKWPNGISVDDQWIYWTDAYLECIERITFSGQQRSVILDNLPHPYAIAVFKNEIYWDDWSQLSIFRASKYSGSQMEILANQLTGLMDMKIFYKGKNTGSNACVPRPCSLLCLPKANNSRSCRCPEDVSSSVLPSGDLMCDCPQGYQLKNNTCVKEENTCLRNQYRCSNGNCINSIWWCDFDNDCGDMSDERNCPTTICDLDTQFRCQESGTCIPLSYKCDLEDDCGDNSDESHCEMHQCRSDEYNCSSGMCIRSSWVCDGDNDCRDWSDEANCTAIYHTCEASNFQCRNGHCIPQRWACDGDTDCQDGSDEDPVNCEKKCNGFRCPNGTCIPSSKHCDGLRDCSDGSDEQHCEPLCTHFMDFVCKNRQQCLFHSMVCDGIIQCRDGSDEDAAFAGCSQDPEFHKVCDEFGFQCQNGVCISLIWKCDGMDDCGDYSDEANCENPTEAPNCSRYFQFRCENGHCIPNRWKCDRENDCGDWSDEKDCGDSHILPFSTPGPSTCLPNYYRCSSGTCVMDTWVCDGYRDCADGSDEEACPLLANVTAASTPTQLGRCDRFEFECHQPKTCIPNWKRCDGHQDCQDGRDEANCPTHSTLTCMSREFQCEDGEACIVLSERCDGFLDCSDESDEKACSDELTVYKVQNLQWTADFSGDVTLTWMRPKKMPSASCVYNVYYRVVGESIWKTLETHSNKTNTVLKVLKPDTTYQVKVQVQCLSKAHNTNDFVTLRTPEGLPDAPRNLQLSLPREAEGVIVGHWAPPIHTHGLIREYIVEYSRSGSKMWASQRAASNFTEIKNLLVNTLYTVRVAAVTSRGIGNWSDSKSITTIKGKVIPPPDIHIDSYGENYLSFTLTMESDIKVNGYVVNLFWAFDTHKQERRTLNFRGSILSHKVGNLTAHTSYEISAWAKTDLGDSPLAFEHVMTRGVRPPAPSLKAKAINQTAVECTWTGPRNVVYGIFYATSFLDLYRNPKSLTTSLHNKTVIVSKDEQYLFLVRVVVPYQGPSSDYVVVKMIPDSRLPPRHLHVVHTGKTSVVIKWESPYDSPDQDLLYAIAVKDLIRKTDRSYKVKSRNSTVEYTLNKLEPGGKYHIIVQLGNMSKDSSIKITTVSLSAPDALKIITENDHVLLFWKSLALKEKHFNESRGYEIHMFDSAMNITAYLGNTTDNFFKISNLKMGHNYTFTVQARCLFGNQICGEPAILLYDELGSGADASATQAARSTDVAAVVVPILFLILLSLGVGFAILYTKHRRLQSSFTAFANSHYSSRLGSAIFSSGDDLGEDDEDAPMITGFSDDVPMVIA

SEQ ID NO: 3 - protein, 1168 aa, Homo Sapiens [sequence omitted]

SEQ ID NO: 4 - protein, 907 aa, Homo Sapiens
LIFHPKEEDKVLAYTKESKLYVSSDLGKKWTLLQERVTKDHVFWSVSGVDADPDLVHVEAQDLGGDFRYVTCAIHNCSEKMLTAPFAGPIDHGSLTVQDDYIFFKATSANQTKYYVSYRRNEFVLMKLPKYALPKDLQIISTDESQVFVAVQEWYQMDTYNLYQSDPRGVRYALVLQDVRSSRQAEESVLIDILEVRGVKGVFLANQKIDGKVMTLITYNKGRDWDYLRPPSMDMNGKPTNCKPPDCHLHLHLRWADNPYVSGTVHTKDTAPGLIMGAGNLGSQLVEYKEEMYITSDCGHTWRQVFEEEHHILYLDHGGVIVAIKDTSIPLKILKFSVDEGLTWSTHNFTSTSVFVDGLLSEPGDETLVMTVFGHISFRSDWELVKVDFRPSFSRQCGEEDYSSWELSNLQGDRCIMGQQRSFRKRKSTSWCIKGRSFTSALTSRVCECRDSDFLCDYGFERSPSSESSTNKCSANFWFNPLSPPDDCALGQTYTSSLGYRKVVSNVCEGGVDMQQSQVQLQCPLTPPRGLQVSIQGEAVAVRPGEDVLFVVRQEQGDVLTTKYQVDLGDGFKAMYVNLTLTGEPIRHRYESPGIYRVSVRAENTAGHDEAVLFVQVNSPLQALYLEVVPVIGLNQEVNLTAVLLPLNPNLTVFYWWIGHSLQPLLSLDNSVTTRFSDTGDVRVTVQAACGNSVLQDSRVLRVLDQFQVMPLQFSKELDAYNPNTPEWREDVGLVVTRLLSKETSVPQELLVTVVKPGLPTLADLYVLLPPPRPTRKRSLSSDKRLAAIQQVLNAQKISFLLRGGVRVLVALRDTGTGAEQLGGGGGYWAVVVLFVIGLFAAGAFILYKFKRKRPGRTVYAQMHNEKEQEMTSPVSHSEDVQGAVQGNHSGVVLSINSREMHSYLVS

SEQ ID NO: 5 - protein, 1222 aa, Homo Sapiens
MEAARTERPAGRPGAPLVRTGLLLLSTWVLAGAEITWDATGGPGRPAAPASRPPALSPLSPRAVASQWPEELASARRAAVLGRRAGPELLPQQGGGRGGEMQVEAGGTSPAGERRGRGIPAPAKLGGARRSRRAQPPITQERGDAWATAPADGSRGSRPLAKGSREEVKAPRAGGSAAEDLRLPSTSFALTGDSAHNQAMVHWSGHNSSVILILTKLYDFNLGSVTESSLWRSTDYGTTYEKLNDKVGLKTVLSYLYVNPTNKRKIMLLSDPEMESSILISSDEGATYQKYRLTFYIQSLLFHPKQEDWVLAYSLDQKLYSSMDFGRRWQLMHERITPNRFYWSVAGLDKEADLVHMEVRTTDGYAHYLTCRIQECAETTRSGPFARSIDISSLVVQDEYIFIQVTTSGRASYYVSYRREAFAQIKLPKYSLPKDMHIISTDENQVFAAVQEWNQNDTYNLYISDTRGIYFTLAMENIKSSRGLMGNIIIELYEVAGIKGIFLANKKVDDQVKTYITYNKGRDWRLLQAPDVDLRGSPVHCLLPFCSLHLHLQLSENPYSSGRISSKETAPGLVVATGNIGPELSYTDIGVFISSDGGNTWRQIFDEEYNVWFLDWGGALVAMKHTPLPVRHLWVSFDEGHSWDKYGFTSVPLFVDGALVEAGMETHIMTVFGHFSLRSEWQLVKVDYKSIFSRHCTKEDYQTWHLLNQGEPCVMGERKIFKKRKPGAQCALGRDHSGSVVSEPCVCANWDFECDYGYERHGESQCVPAFWYNPASPSKDCSLGQSYLNSTGYRRIVSNNCTDGLREKYTAKAQMCPGKAPRGLHVVTTDGRLVAEQGHNATFIILMEEGDLQRTNIQLDFGDGIAVSYANFSPIEDGIKHVYKSAGIFQVTAYAENNLGSDTAVLFLHVVCPVEHVHLRVPFVAIRNKEVNISAVVWPSQLGTLTYFWWFGNSTKPLITLDSSISFTFLAEGTDTITVQVAAGNALIQDTKEIAVHEYFQSQLLSFSPNLDYHNPDIPEWRKDIGNVIKRALVKVTSVPEDQILIAVFPGLPTSAELFILPPKNLTERRKGNEGDLEQIVETLFNALNQNLVQFELKPGVQVIVYVTQLTLAPLVDSSAGHSSSAMLMLLSVVFVGLAVFLIYKFKRKIPWINIYAQVQHDKEQEMIGSVSQSENAPKITLSDFTEPEELLDKELDTRVIGGIATIANSESTKEIPNCTSV

SEQ ID NO: 6 - protein, 241 aa, Homo sapiens
  SIGNAL (1)..(18): Signal peptide of NGF
MSMLFYTLITAFLIGIQAEPHSESNVPAGHTIPQVHWTKLQHSLDTALRRARSAPAAAIAARVAGQTRNITVDPRLFKKRRLRSPRVLFSTQPPREAADTQDLDFEVGGAAPFNRTHRSKRSSSHPIFHRGEFSVCDSVSVWVGDKTTATDIKGKEVMVLGEVNINNSVFKQYFFETKCRDPNPVDSGCRGIDSKHWNSYCTTTHTFVKALTMDGKQAAWRFIRIDTACVCVLSRKAVRRA

SEQ ID NO: 7 - protein, 246 aa, Homo sapiens
  SIGNAL (1)..(18): Signal peptide of BDNF
MTILFLTMVISYFGCMKAAPMKEANIRGQGGLAYPGVRTHGTLESVNGPKAGSGLTSLADTFEHVIEELLDEDQKVRPNEENNKDADLYTSRVMLSSQVPLEPPLLFLLEEYKNYLDAANMSMRVRRHSDPARRGELSVCDSISEWVTAADKKTAVDMSGGTVTVLEKVPVSKGQLKQYFYETKCNPMGYTKEGCRGIDKRHWNSQCRTTQSYVRALTMDSKKRIGWRFIRIDTSCVCTLTIKRGR

SEQ ID NO: 8 - protein, 257 aa, Homo sapiens
  SIGNAL (1)..(16): Signal peptide of NT3
MSILFYVIFLAYLRGIQGNNMDQRSLPEDSLNSLIIKLIQADILKNKLSKQMVDVKENYQSTLPKAEAPREPERGGPAKSAFQPVIAMDTELLRQQRRYNSPRVLLSDSTPLEPPPLYLMEDYVGSPVVANRTSRRKRYAEHKSHRGEYSVCDSESLWVTDKSSAIDIRGHQVTVLGEIKTGNSPVKQYFYETRCKEARPVKNGCRGIDDKHWNSQCKTSQTYVRALTSENNKLVGWRWIRIDTSCVCALSRKIGRT

SEQ ID NO: 9 - protein, 210 aa, Homo sapiens
  SIGNAL (1)..(24): Signal peptide of NT4/5
MLPLPSCSLPILLLFLLPSVPIESQPPPSTLPPFLAPEWDLLSPRVVLSRGAPAGPPLLFLLEAGAFRESAGAPANRSRRGVSETAPASRRGELAVCDAVSGWVTDRRTAVDLRGREVEVLGEVPAAGGSPLRQYFFETRCKADNAEEGGPGAGGGGCRGVDRRHWVSECKAKQSYVRALTADAQGRVGWRWIRIDTACVCTLLSRTGRA

SEQ ID NO: 10 - protein, 13 aa, Homo Sapiens
  MISC_FEATURE (1)..(13): Neurotensin
XLYENKPRRPYIL

SEQ ID NO: 11 - protein, 4 aa, Homo Sapiens
  MISC_FEATURE (1)..(4): Four C-terminal amino acids of Neurotensin
PYIL

SEQ ID NO: 12 - protein, 6 aa, Artificial Sequence
  Synthetically generated peptide
XKPXXL

(19) United States
(12) Patent Application Publication
(10) Pub. No.: US 2011/0166032 A1
(43) Pub. Date: Jul. 7, 2011

(54) Design and Use of Sortilin Specific Molecular Imaging Ligands

(75) Inventor: Jens Claus Munck Petersen, Arhus C (DK)

(73) Assignee: H. LUNDBECK A/S, Valby-Copenhagen (DK)

(21) Appl. No.: 12/990,289

(22) PCT Filed: Apr. 27, 2009
(86) PCT No.: PCT/DK09/50098

§ 371 Date: Mar. 9, 2011

(30) Foreign Application Priority Data
Apr. 27, 2008 (DK) PA 2008 00593

(51) Int. Cl. C40B 30/02; G06F 19/00; G06G 7/58

(52) U.S. Cl. 506/8; 702/19; 703/11

(57) ABSTRACT

The present invention provides methods for design and identification of Vps10p domain receptor specific molecular imaging ligands based on the atomic coordinates of said Vps10p-domain. The present invention also relates to the preparation and use of such ligands for the preparation of a target specific imaging reagent or molecular imaging probe useful in detection of said Vps10p-domain receptor involved in disease.

All patent and non-patent references cited in the application, or in the present application, are hereby incorporated by reference in their entirety.

### FIELD OF INVENTION

The present invention relates to design of specific molecular imaging ligands capable of binding to the Vps10p-domain receptor Sortilin. The invention further relates to methods for screening, identification and/or design of specific molecular imaging ligands of Vps10p-domain receptors. In particular the invention relates to design of molecular imaging probes binding specifically to one or more binding sites of Sortilin. The molecular imaging probe may be utilized as a diagnostic in a diagnostic assay. A contrast or signal emitting source may be incorporated into the reagent, to generate a target-specific imaging reagent.

### BACKGROUND OF INVENTION

Medical diagnosis and monitoring utilize a variety of imaging techniques. Standard radiography, fluoroscopy, Magnetic Resonance Imaging (MRI), Computed Tomography (CT), Positron Emission Tomography (PET), Single Photon Emission Computed Tomography (SPECT) and Ultrasound are all useful methods in clinical practice. These techniques all have their unique advantages and drawbacks. The clinical utility of all of these techniques could be greatly enhanced by using contrast or signal emitting reagents which are targeted to disease specific molecules. This approach (molecular imaging) could provide added sensitivity for detection of disease or anatomical extent of disease and specificity to help differentiate anatomical findings due to disease from normal or non-diseased tissue. The potential applications of this approach are clear in every medical discipline and disease category.

The present inventors have developed methods for design of ligands binding specifically to Vps10p-domain receptors including SorLA, SorCS1, SorCS2, SorCS3 and in particular Sortilin.

Sortilin, sometimes also referred to as Neurotensin receptor 3 (NTR3), Glycoprotein 95 (Gp95) or 100 kDa NT receptor of Swiss Prot ID No. Q99523, is the archetypical member of this mammalian family of neuronal receptors (1-3) defined by the unique Vps10p-domain (Vps10p-D) that binds neurotrophic factors and neuropeptides (4-8). This domain constitutes the entire luminal part of Sortilin (sSortilin) and is activated for ligand binding by enzymatic propeptide cleavage (4, 5). Sortilin is a multifunctional type-1 receptor capable of endocytosis as well as intracellular sorting (9-11), and as shown recently, it also engages in signaling by triggering proneurotrophin-induction of p75^{NTR}-mediated neuronal apoptosis (6, 7, 12, 13). Sortilin is synthesized as a proprotein, which is converted to mature Sortilin by enzymatic cleavage and removal of a short N-terminal propeptide. Only the mature receptor binds ligands and interestingly, all its known ligands, e.g. Neurotensin (NT), lipoprotein lipase, the proforms of nerve growth factor-β (proNGF) and brain derived neurotrophic factor (proBDNF), receptor associated protein (RAP), and its own propeptide, compete for binding (5-7, 10), indicating that the diverse ligands target a shared or partially shared binding site. NT is a tridecapeptide, which binds to Sortilin, SorLA (another Vps10p-D receptor) and the two G-protein coupled receptors NTR1 and NTR2 (4, 14-16).

### SUMMARY OF THE INVENTION

In one aspect the present invention relates to a method of identifying a target specific molecular imaging ligand capable of binding to binding site 1 and/or binding site 2 and/or binding site 3 of SEQ ID NO. 1 (Sortilin), or a fragment or variant thereof (i.e. of SEQ ID NO. 1) said method comprising the steps of:
a. generating the spatial structure of the binding site on a computer screen using atomic coordinates as presented in any of FIGS. 17 to 20 or atomic coordinates selected from a three-dimensional structure that deviates from the three-dimensional structure presented in any of FIGS. 17 to 20 by a root mean square deviation over protein backbone atoms of not more than 3 Å,
b. generating potential ligands with their spatial structure on the computer screen, and
c. selecting ligands that can bind to at least 1 amino acid residue of the set of binding interaction sites without steric interference.

In another aspect the present invention relate to a computer-assisted method for identifying a target specific molecular imaging ligand of sortilin capable of binding to binding site 1 and/or binding site 2 and/or binding site 3 of SEQ ID NO. 1 (Sortilin), or a fragment or variant thereof, using a programmed computer comprising a processor, a data storage system, a data input device and a data output device, comprising the following steps:
a. inputting into the programmed computer through said input device data comprising:
   atomic coordinates of a subset of the atoms of said sortilin, thereby generating a criteria data set;
   wherein said atomic coordinates are selected from the three-dimensional structure presented in any of FIGS. 17 to 20 or atomic coordinates selected from a three-dimensional structure that deviates from the three-dimensional structure presented in any of FIGS. 17 to 20 by a root mean square deviation over protein backbone atoms of not more than 3 Å,
b. comparing, using said processor, the criteria data set to a computer data base of low-molecular weight organic chemical structures and peptide fragments stored in the data storage system; and
c. selecting from said data base, using computer methods, a chemical structure having a portion that is structurally complementary to the criteria data set and being free of steric interference with the receptor sortilin.

In a further aspect the present invention relates to a method for identifying a target specific molecular imaging ligand, said method comprising the steps of:
a. selecting a potential ligand using atomic coordinates in conjunction with computer modelling, wherein said atomic coordinates are the atomic coordinates presented in any of FIGS. 17 to 20 or wherein the atomic coordinates are selected from a three-dimensional structure that deviates from the three-dimensional structure presented in any of FIGS. 17 to 20 by a root mean square deviation over protein backbone atoms of not more than 3 Å, by docking potential ligands into a set of binding interaction sites in binding site 1 and/or binding site 2 and/or binding site 3 of SEQ ID NO. 1 (Sortilin), or a fragment or variant thereof, said binding interaction generated by computer modelling and selecting a potential ligand capable of binding to at least one amino acid in said set of binding interaction sites of sortilin,
b. providing said potential ligand and said receptor sortilin
c. contacting the potential ligand with said receptor sortilin and detecting binding of said receptor sortilin by the potential ligand.

In yet another aspect the present invention relates to a method of identifying a potential target specific molecular imaging ligand of binding site 1, binding site 2 or binding site 3 of sortilin, or a fragment or variant thereof said method comprising the steps of
a. introducing into a computer, information derived from atomic coordinates defining a conformation of binding site 1 and/or binding site 2 and/or binding site 3 of SEQ ID NO. 1 (Sortilin), or a fragment or variant thereof, based on three-dimensional structure determination, whereby a computer program utilizes or displays on the computer screen the structure of said conformation;
   wherein said atomic coordinates are selected from the three-dimensional structure as presented in any of FIGS. 17 to 20 or atomic coordinates selected from a three-dimensional structure that deviates from any one of the tree-dimensional structure represented by any of FIGS. 17 to 20 by a root mean square deviation over protein backbone atoms of not more than 3 Å;
b. generating a three-dimensional representation of binding site 1, binding site 2 or binding site 3 of Sortilin, or a fragment or variant thereof, by said computer program on a computer screen;
c. superimposing a model of a potential ligand on the representation of said binding site 1, binding site 2 or binding site 3,
d. assessing the possibility of bonding and the absence of steric interference of the potential ligand with binding site 1, binding site 2 or binding site 3 of Sortilin or a fragment or variant thereof;
e. incorporating said potential ligand compound in a binding assay of said receptor sortilin and determining whether said potential ligand is capable of binding to binding site 1 and/or binding site 2 and/or binding site 3 of SEQ ID NO. 1 by performing a biochemical or biophysical competitive binding assay wherein the competing ligand is selected from the group consisting of amino acid residues 19 to 241 of SEQ ID NO 6 (proNGF), amino acid residues 19 to 121 of SEQ ID NO 6 (NGF pro domain), amino acid residues 19 to 246 of SEQ ID NO 7 (proBDNF), amino acid residues 19 to 127 of SEQ ID NO 7 (BDNF pro domain), amino acid residues 17 to 257 of SEQ ID NO 8 (proNT3), amino acid residues 17 to 140 of SEQ ID NO 8 (NT3 pro domain), amino acid residues 25 to 210 of SEQ ID NO. 9.
f. (proNT4/5), amino acid residues 25 to 80 of SEQ ID NO 9 (NT4/5 pro domain), SEQ ID NO. 10 (Neurotensin), SEQ ID NO. 11 (PYIL), amino acid residues 11 to 13 of SEQ ID NO. 10 (YIL) and SEQ ID NO. 12 (NT69L) or a fragment or variant of said competing ligand.

In a further aspect the present invention relates to a ligand identified as described herein above, said ligand capable of binding to at least one interaction point of said binding site 1, said interaction points comprising X₁, X₂, X₃, X₄, R₁, R₂, J₁, J₂ and J₃ as presented in FIG. 14 wherein

X₁ comprises the amino acid residues R325, S316 and Y351 of SEQ ID NO. 1, and wherein
X₂ comprises the backbone carbonyl of Y351 and wherein
X₃ comprises the backbone of 1353 and wherein
X₄ comprises the amino group of K260 and wherein
R₁ comprises amino acid residues I327, F314, Y351, I353 and M363 and wherein
R₂ comprises F350 and at least one amino acid from the loop comprising amino acid residues T397 to E401 and wherein
J₁ comprises S305 and wherein
J₂ comprises the backbone amide of F306 and wherein
J₃ comprises the backbone carbonyl of F306.

In one aspect, the present invention relates to use of a ligand identified as described herein, said ligand igand having the general structure of formula (I):

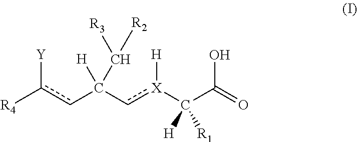

wherein X is an atom acting as hydrogen donor said atom selected from the group consisting of N, O, S, P and wherein
Y is an electronegative atom acting as hydrogen bond acceptor selected from the group consisting of O, N, S, F, Cl, Br, I, and wherein
R₁ is C3-6 alkyl, C4-6 cyclyl, a heterocyclic or a heteroaromatic structure having one ring, 4 to 6 ring members in each and 1 to 3 heteroatoms, or a heteroalkyl comprising 1 to 3 heteroatoms selected from the group consisting of N, O, S(O)₀₋₂, and wherein
R₂ is a hydrogen, a C1-12 alkyl or an aromatic, a carbocyclic, a heterocyclic or a heteroaromatic structure having 1-3 rings, 3-8 ring members in each and 0 to 4 heteroatoms, or a heteroalkyl comprising 1 to 8 heteroatoms selected from the group consisting of N, O, S(O)₀₋₂, and wherein
R₃ is hydrogen, SH, imidazole, C1-12 alkyl or an aromatic, a carbocyclic, a heterocyclic or a heteroaromatic structure having 1-3 rings, 3-8 ring members in each and 0 to 4 heteroatoms, or a heteroalkyl comprising 1 to 8 heteroatoms selected from the group consisting of N, O, S, and wherein
R₄ is selected from the functional groups C1-100 linear or branched alkyl, linear or branched alkenyl, linear or branched alkynyl, phenyl, benzyl, haloalkane, chloroalkane, bromoalkane, iodoalkane, haloformyl, hydroxyl, carbonyl, aldehyde, carbonate ester, carboxylate, carboxyl, ether, ester, hydroperoxy, peroxy, carboxamide, primary amine, secondary amine, tertiary amine, ammonium, primary ketimine, secondary ketimine, primary aldimine, secondary aldimine, imide, azide, azo (diimide), cyanate, isocyanide, isothiocyanate, nitrate, nitrile, nitrosooxy, nitro, nitroso, priidyl, phosphino, phosphate, phosphono, sulfonyl, sulfinyl, sulfhydryl (SH), thiocyanate, disulfide, a linker L2 or L3, and an amino acid sequence being at least 50% identical to SEQ ID NO: 10 or a fragment thereof.

In one aspect, the present invention relates to use of a ligand identified as described herein, for the preparation of a target specific molecular imaging ligand having the general structure of structure of formula (II):

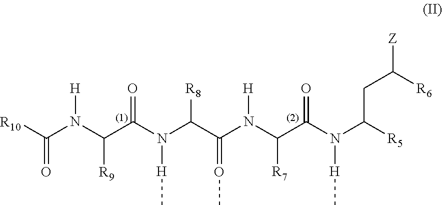

wherein Z is a hydrogen bond donor or acceptor selected from the group consisting of carbonyl, hydroxyl, amino, imino, amide, sulfhydryl, chloro, fluoro, and wherein
R₅ is selected from the group consisting of H, CH₃, and a linker L2, and wherein
R₆ is selected from the group consisting of H, —CH₃, —CH₂CH₃ and —OCH₃, and wherein
R₇ is selected from the group consisting of side chains of glutamate, glutamine, lysine, arginine, histidine, tyrosine, methionine, cysteine, aliphatic C4-6 groups, and wherein
R₈ is selected from the group consisting of side chains of tyrosine, histidine, serine, threonine, aspartate, asparagine, cysteine, phenylalanine, iodo-tyrosine and —CH₂—NH₂, and wherein
R₉ is selected from the group consisting of side chain of lysine, arginine, glutamine, C3-8 aliphatic and heteroaliphatic groups, carbocyclic and heterocyclic groups comprising 5 or 6 membered rings, and wherein
R₁₀ is selected from the group consisting of a pyroglutamate, poly-carbohydrates and a polypeptide of length greater than equal to 10, wherein said polypeptide may be, but is not limited to, Green Fluorescent Protein (GFP), and wherein
R₁₁ and R₁₂ individually are selected from the group consisting of H, C1-12 linear or branched alkyl, linear or branched alkenyl, linear or branched alkynyl, phenyl, benzyl, haloalkane, chloroalkane, bromoalkane, iodoalkane, haloformyl, hydroxyl, carbonyl, aldehyde, carbonate ester, carboxylate, carboxyl, ether, ester, hydroperoxy, peroxy, carboxamide, primary amine, secondary amine, tertiary amine, ammonium, primary ketimine, secondary ketimine, primary aldimine, secondary aldimine, imide, azide, azo (diimide), cyanate, isocyanide, isothiocyanate, nitrate, nitrile, nitrosooxy, nitro, nitroso, priidyl, phosphino, phosphate, phosphono, sulfonyl, sulfinyl, sulfhydryl (SH), and wherein
the covalent bonds (1) and (2) individually are selected from the group consisting of single bonds and double bonds.

In one aspect, the present invention relates to use of a ligand identified as described herein, for the preparation of a target specific molecular imaging ligand having the general structure of structure of formula (III):

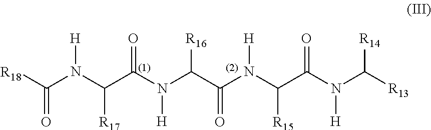

wherein R₁₃ is selected from the group consisting of H, C1-12 alkyl, alkenyl, alkynyl and a linker L3, and wherein
R₁₄, R₁₅, R₁₇, R₁₉, R₂₀ individually are selected from the group consisting of H, C1-12 alkyl, alkenyl and alkynyl, and wherein
R₁₆ is selected from the group consisting of sidechains of phenylalanine, leucine, isoleucine, valine, methionine, histidine, cysteine, lysine and aliphatic C3-7, and wherein
R₁₈ is selected from the group consisting of H, —CH₃ and —CH₂OH, and wherein
the covalent bonds (1) and (2) individually are selected from the group consisting of single bonds and double bonds.

In a further aspect the present invention relates to a target specific imaging reagent, comprising an affinity agent coupled to an imaging agent, wherein said affinity agent specifically binds to a Vps10p-domain receptor.

In a further aspect the present invention relates to a method of diagnosing or monitoring a disease or disease state comprising:
a. administering to a mammal the target-specific imaging reagent specified herein above,
b. imaging said mammal, and diagnosing or monitoring said disease or disease state.

In a further aspect the present invention relates to a diagnostic assay comprising the target specific imaging reagent specified herein above.

In a further aspect the present invention relates to use of the target specific molecular imaging ligand as defined herein above, for the preparation of a diagnostic composition for the diagnosis of a disease, disorder or damage of the central or peripheral nervous system in an individual, wherein said disease, disorder or damage is associated with the biological activity of a Vps10p-domain receptor.

In a further aspect the present invention relates to a method for building an atomic model of a Vps10p-domain receptor protein molecule comprising the steps of:
a) identifying a Vps10p-domain receptor, or a fragment or variant thereof, having at least 20% sequence identity to SEQ ID NO. 1, and
b) utilizing the atomic coordinates as presented in any of FIGS. 17 to 20 or atomic coordinates selected from a three-dimensional structure that deviates from the three-dimensional structure presented in any of FIGS. 17 to 20 by a root mean square deviation over protein backbone atoms of not more than 3 Å,
   to obtain an atomic model of the identified Vps10p-domain receptor by homology modelling.

In a further aspect the present invention relates to a method of identifying a potential target specific molecular imaging ligand of a Vps10p-domain receptor, or a fragment or variant thereof said method comprising the steps of
a) introducing into a computer, information derived from atomic coordinates defining a conformation of a binding site having at least 20% sequence identity to 1 and/or binding site 2 and/or binding site 3 of SEQ ID NO. 1 (Sortilin), or a fragment or variant thereof, based on three-dimensional structure determination, whereby a computer program utilizes or displays on the computer screen the structure of said conformation; wherein said atomic coordinates are selected from the three-dimensional structure as presented in any of FIGS. 17 to 20 or atomic coordinates selected from a three-dimensional structure that deviates from any one of the tree-dimensional structure represented by any of FIGS. 17 to 20 by a root mean square deviation over protein backbone atoms of not more than 3 Å;
b) generating a three-dimensional representation of a binding site having at least 20% sequence identity to binding site 1, binding site 2 or binding site 3 of Sortilin, or a fragment or variant thereof, by said computer program on a computer screen;
c) superimposing a model of a potential ligand on the representation of said binding site having at least 20% sequence identity to site 1, binding site 2 or binding site 3 of Sortilin,
d) assessing the possibility of bonding and the absence of steric interference of the potential ligand with the binding site having at least 20% sequence identity to binding site 1, binding site 2 or binding site 3 of Sortilin or a fragment or variant thereof;
e) incorporating said potential ligand compound in a binding assay of said Vps10p-domain receptor and
f) determining whether said potential ligand is capable of binding to said binding site having at least 20% sequence identity to binding site 1 and/or binding site 2 and/or binding site 3 of SEQ ID NO. 1 by performing a biochemical or biophysical competitive binding assay wherein the competing ligand is selected from the group consisting of amino acid residues 19 to 241 of SEQ ID NO 6 (proNGF), amino acid residues 19 to 121 of SEQ ID NO 6 (NGF pro domain), amino acid residues 19 to 246 of SEQ ID NO 7 (proBDNF), amino acid residues 19 to 127 of SEQ ID NO 7 (BDNF pro domain), amino acid residues 17 to 257 of SEQ ID NO 8 (proNT3), amino acid residues 17 to 140 of SEQ ID NO 8 (NT3 pro domain), amino acid residues 25 to 210 of SEQ ID NO 9 (proNT4/5), amino acid residues 25 to 80 of SEQ ID NO 9 (NT4/5 pro domain), SEQ ID NO. 10 (Neurotensin), SEQ ID NO. 11 (PYIL), amino acid residues 11 to 13 of SEQ ID NO. 10 (YIL) and SEQ ID NO. 12 (NT69L) or a fragment or variant of said competing ligand.

### DETAILED DESCRIPTION ON THE INVENTION

### Definitions

Affinity: The interaction of most ligands with their binding sites can be characterized in terms of a binding affinity. In general, high affinity ligand binding results from greater intermolecular force between the ligand and its receptor while low affinity ligand binding involves less intermolecular force between the ligand and its receptor. In general, high affinity binding involves a longer residence time for the ligand at its receptor binding site than is the case for low affinity binding. High affinity binding of ligands to receptors is often physiologically important when some of the binding energy can be used to cause a conformational change in the receptor, resulting in altered behavior of an associated ion channel or enzyme.

A ligand that can bind to a receptor, alter the function of the receptor and trigger a physiological response is called an agonist for that receptor. Agonist binding to a receptor can be characterized both in terms of how much physiological response can be triggered and the concentration of the agonist that is required to produce the physiological response. High affinity ligand binding implies that a relatively low concentration of a ligand is adequate to maximally occupy a ligand binding site and trigger a physiological response. Low affinity binding implies that a relatively high concentration of a ligand is required before the binding site is maximally occupied and the maximum physiological response to the ligand is achieved. Ligand binding is often characterized in terms of the concentration of ligand at which half of the receptor binding sites are occupied, known as the dissociation constant (k_{d}).

Alcohol: A class of organic compounds containing one or more hydroxyl groups (OH). In this context a saturated or unsaturated, branched or unbranched hydrocarbon group sitting as a substituent on a larger molecule.

Alicyclic group: the term “alicyclic group” means a cyclic hydrocarbon group having properties resembling those of aliphatic groups.

Aliphatic group: in the context of the present invention, the term “aliphatic group” means a saturated or unsaturated linear or branched hydrocarbon group. This term is used to encompass alkyl, alkenyl, and alkynyl groups, for example.

Alkyl group: the term “alkyl group” means a saturated linear or branched hydrocarbon group including, for example, methyl, ethyl, isopropyl, t-butyl, heptyl, dodecyl, octadecyl, amyl, 2-ethylhexyl, and the like.

Alkenyl group: the term “alkenyl group” means an unsaturated, linear or branched hydrocarbon group with one or more carbon-carbon double bonds, such as a vinyl group.

Alkynyl group: the term “alkynyl group” means an unsaturated, linear or branched hydrocarbon group with one or more carbon-carbon triple bonds.

Amphiphil: substance containing both polar, water-soluble and nonpolar, water-insoluble groups.

Apoptosis: Apoptosis is a process of suicide by a cell in a multi-cellular organism. It is one of the main types of programmed cell death (PCD), and involves an orchestrated series of biochemical events leading to a characteristic cell morphology and death.

Aromatic group: the term “aromatic group” or “aryl group” means a mono- or polycyclic aromatic hydrocarbon group.

Binding: The term “binding” or “associated with” refers to a condition of proximity between chemical entities or compounds, or portions thereof. The association may be non-covalent—wherein the juxtaposition is energetically favoured by hydrogen bonding or van der Waals or electrostatic interactions—or it may be covalent.

Binding site: The term “binding site” or “binding pocket”, as used herein, refers to a region of a molecule or molecular complex that, as a result of its shape, favourably associates with another molecule, molecular complex, chemical entity or compound. As used herein, the pocket comprises at least a deep cavity and, optionally a shallow cavity.

Binding site 1: A high affinity binding site of neurotensin or synonymously binding site 1 is a binding site of sortilin (SEQ ID NO. 1) having high affinity for neurotensin or a fragment or variant of neurotensin, and having affinity for the sortilin propeptide or a fragment thereof (Amino acid residues 34-77 of SEQ ID NO. 1) said binding site comprising amino acid residues R325, S316, Y351, I353, K260, I327, F314, F350 to M363, S305, F306, T398 to G400, I303-G309, Q349-A356, Y395 and T402 of SEQ ID NO. 1. More preferably, binding site 1 comprises amino acids R325, S316, Y351, I353, K260, I327, F314, F350 to M363, S305, F306 and T398 to G400 of SEQ ID NO. 1. Most preferably binding site 1 of sortilin comprises amino acids R325, S316, Y351, I353, K260, I327, F314 and F350 to M363 of SEQ ID NO. 1.

Binding site 1 is a promiscuous binding site.

Binding site 2: A binding site of sortilin having low affinity for neurotensin or a fragment or variant of neurotensin, said binding site comprising amino acid residues L572, L114, V112, R109 to S111, S115 to G118, T570, G571, W586, W597, T168-I174, L572, A573 and S584 to F588 of SEQ ID NO. 1. More preferably the sortilin low affinity binding site of neurotensin comprises amino acids L572, L114, V112, R109 to S111, S115 to G118, T570, G571, W586 and W597 of SEQ ID NO. 1. Most preferably the sortilin low affinity binding site of neurotensin comprises amino acids L572, L114 and V112. Binding site 2 is promiscuous and may bind the propeptide of Sortilin (amino acid residues 34-77 of SEQ ID NO. 1).

Binding site 3: A promiscuous binding site of sortilin comprising amino acid residues D403, S420, D422, N423, S424, I425, Q426, T451, Y466, Q470, I498, S499 and V500 of SEQ ID NO. 1, more preferably comprising amino acid residues D403, N423, S424, I425, T451, Y466, I498 and V500 of SEQ ID NO. 1, most preferably comprising amino acid residues T451, Y466, I498 and V500 of SEQ ID NO. 1.

Bioreactive agent: The term “bioactive agent” as used herein refers to any substance which may be used in connection with an application that is therapeutic or diagnostic, such as, for example, in methods for diagnosing the presence or absence of a disease in a patient and/or methods for the treatment of a disease in a patient. “Bioactive agent” refers to substances, which are capable of exerting a biological effect in vitro and/or in vivo. The bioactive agents may be neutral, positively or negatively charged. Suitable bioactive agents include, for example, prodrugs, diagnostic agents, therapeutic agents, pharmaceutical agents, drugs, oxygen delivery agents, blood substitutes, synthetic organic molecules, polypeptides, peptides, vitamins, steroids, steroid analogues and genetic determinants, including nucleosides, nucleotides and polynucleotides.

Cationic group: A chemical group capable of functioning as a proton donor when a compound comprising the chemical group is dissolved in a solvent, preferably when dissolved in water.

Complex: As used herein the term “complex” refers to the combination of a molecule or a protein, conservative analogues or truncations thereof associated with a chemical entity.

Coordinate: The term “coordinate” as use herein, refers to the information of the three dimensional organization of the atoms contributing to a protein structure. The final map containing the atomic coordinates of the constituents of the crystal may be stored on a data carrier; typically the data is stored in PDB format or in x-plor format, both of which are known to the person skilled in the art. However, crystal coordinates may as well be stored in simple tables or text formats. The PDB format is organized according to the instructions and guidelines given by the Research Collaboratory for structural Bioinformatics.

Crystal: The term “crystal” refers to an ordered state of matter. Proteins, by their nature are difficult to purify to homogeneity. Even highly purified proteins may be chronically heterogeneous due to modifications, the binding of ligands or a host of other effects. In addition, proteins are crystallized from generally complex solutions that may include not only the target molecule but also buffers, salts, precipitating agents, water and any number of small binding proteins. It is important to note that protein crystals are composed not only of protein, but also of a large percentage of solvents molecules, in particular water. These may vary from 30 to even 90%. Protein crystals may accumulate greater quantities and a diverse range of impurities which cannot be listed here or anticipated in detail. Frequently, heterogeneous masses serve as nucleation centers and the crystals simply grow around them. The skilled person knows that some crystals diffract better than others. Crystals vary in size from a barely observable 20 micron to 1 or more millimetres. Crystals useful for X-ray analysis are typically single, 0.05 mm or larger, and free of cracks and defects.

Cyclic group: the term “cyclic group” means a closed ring hydrocarbon group that is classified as an alicyclic group, aromatic group, or heterocyclic group.

Cycloalkenyl: means a monovalent unsaturated carbocyclic radical consisting of one, two or three rings, of three to eight carbons per ring, which can optionally be substituted with one or two substituents selected from the group consisting of hydroxy, cyano, lower alkenyl, lower alkoxy, lower haloalkoxy, alkenylthio, halo, haloalkenyl, hydroxyalkenyl, nitro, alkoxycarbonenyl, amino, alkenylamino, alkenylsulfonyl, arylsulfonyl, alkenylaminosulfonyl, arylaminosulfonyl, alkylsulfonylamino, arylsulfonylamino, alkenylaminocarbonyl, arylaminocarbonyl, alkenylcarbonylamino and arylcarbonylamino.

Cycloalkyl: means a monovalent saturated carbocyclic radical consisting of one, two or three rings, of three to eight carbons per ring, which can optionally be substituted with one or two substituents selected from the group consisting of hydroxy, cyano, lower alkyl, lower alkoxy, lower haloalkoxy, alkylthio, halo, haloalkyl, hydroxyalkyl, nitro, alkoxycarbonyl, amino, alkylamino, alkylsulfonyl, arylsulfonyl, alkylaminosulfonyl, arylaminosulfonyl, alkylsulfonylamino, arylsulfonylamino, alkylaminocarbonyl, arylaminocarbonyl, alkylcarbonylamino and arylcarbonylamino.

Dipole-dipole interaction: The term “dipole-dipole interaction” as used herein refers to the attraction which can occur among two or more polar molecules. Thus, “dipole-dipole interaction” refers to the attraction of the uncharged, partial positive end of a first polar molecule to the uncharged, partial negative end of a second polar molecule. “Dipole-dipole interaction” also refers to intermolecular hydrogen bonding.

Electrostatic interaction: The term “electrostatic interaction” as used herein refers to any interaction occurring between charged components, molecules or ions, due to attractive forces when components of opposite electric charge are attracted to each other. Examples include, but are not limited to: ionic interactions, covalent interactions, interactions between a ion and a dipole (ion and polar molecule), interactions between two dipoles (partial charges of polar molecules), hydrogen bonds and London dispersion bonds (induced dipoles of polarizable molecules). Thus, for example, “ionic interaction” or “electrostatic interaction” refers to the attraction between a first, positively charged molecule and a second, negatively charged molecule. Ionic or electrostatic interactions include, for example, the attraction between a negatively charged bioactive agent (input examples relevant to this invention).

Form a ring: means that the atoms mentioned are connected through a bond when the ring structure is formed.

Fragments: The polypeptide fragments according to the present invention, including any functional equivalents thereof, may in one embodiment comprise less than 500 amino acid residues, such as less than 450 amino acid residues, for example less than 400 amino acid residues, such as less than 350 amino acid residues, for example less than 300 amino acid residues, for example less than 250 amino acid residues, such as less than 240 amino acid residues, for example less than 225 amino acid residues, such as less than 200 amino acid residues, for example less than 180 amino acid residues, such as less than 160 amino acid residues, for example less than 150 amino acid residues, such as less than 140 amino acid residues, for example less than 130 amino acid residues, such as less than 120 amino acid residues, for example less than 110 amino acid residues, such as less than 100 amino acid residues, for example less than 90 amino acid residues, such as less than 85 amino acid residues, for example less than 80 amino acid residues, such as less than 75 amino acid residues, for example less than 70 amino acid residues, such as less than 65 amino acid residues, for example less than 60 amino acid residues, such as less than 55 amino acid residues, for example less than 50 amino acid residues. Fragments of neurotensin include but is not limited to the C-terminal amino acids of neurotensin PYIL and YIL.

Functional equivalency: “Functional equivalency” as used in the present invention is, according to one preferred embodiment, established by means of reference to the corresponding functionality of a predetermined fragment of the sequence.

Functional equivalents or variants of a proneurotrophin activity modulator will be understood to exhibit amino acid sequences gradually differing from the preferred predetermined proneurotrophin activity modulator sequence, as the number and scope of insertions, deletions and substitutions including conservative substitutions increase. This difference is measured as a reduction in homology between the preferred predetermined sequence and the fragment or functional equivalent.

All fragments or functional equivalents of SEQ ID NO: proneurotrophin activity modulator are included within the scope of this invention, regardless of the degree of homology that they show to the respective, predetermined proneurotrophin activity modulator sequences disclosed herein. The reason for this is that some regions of the proneurotrophin activity modulator are most likely readily mutatable, or capable of being completely deleted, without any significant effect on the binding activity of the resulting fragment.

A functional variant obtained by substitution may well exhibit some form or degree of native proneurotrophin activity modulator activity, and yet be less homologous, if residues containing functionally similar amino acid side chains are substituted. Functionally similar in this respect refers to dominant characteristics of the side chains such as hydrophobic, basic, neutral or acidic, or the presence or absence of steric bulk. Accordingly, in one embodiment of the invention, the degree of identity is not a principal measure of a fragment being a variant or functional equivalent of a preferred predetermined fragment according to the present invention.

Global ischemia: Anoxia resultant from ceased blood supply to the entire body resulting in tissue damage through a variety of mechanisms including apoptosis.

Global cerebral ischemia: Anoxia resultant from ceased blood supply to the entire brain resulting in tissue damage through a variety of mechanisms including apoptosis. Global cerebral ischemia is ischemia of the whole brain, as opposed to e.g. stroke which causes ischemia in parts of the brain only.

Group: (Moiety/substitution) as is well understood in this technical area, a large degree of substitution is not only tolerated, but is often advisable. Substitution is anticipated on the materials of the present invention. As a means of simplifying the discussion and recitation of certain terminology used throughout this application, the terms “group” and “moiety” are used to differentiate between chemical species that allow for substitution or that may be substituted and those that do not allow or may not be so substituted. Thus, when the term “group” is used to describe a chemical substituent, the described chemical material includes the unsubstituted group and that group with O, N, or S atoms, for example, in the chain as well as carbonyl groups or other conventional substitution. Where the term “moiety” is used to describe a chemical compound or substituent, only an unsubstituted chemical material is intended to be included. For example, the phrase “alkyl group” is intended to include not only pure open chain saturated hydrocarbon alkyl substituents, such as methyl, ethyl, propyl, t-butyl, and the like, but also alkyl substituents bearing further substituents known in the art, such as hydroxy, alkoxy, alkylsulfonyl, halogen atoms, cyano, nitro, amino, carboxyl, etc. Thus, “alkyl group” includes ether groups, haloalkyls, nitroalkyls, carboxyalkyls, hydroxyalkyls, sulfoalkyls, etc. On the other hand, the phrase “alkyl moiety” is limited to the inclusion of only pure open chain saturated hydrocarbon alkyl substituents, such as methyl, ethyl, propyl, t-butyl, and the like. The same definitions apply to “alkenyl group” and “alkenyl moiety”; to “alkynyl group” and “alkynyl moiety”; to “cyclic group” and “cyclic moiety; to “alicyclic group” and “alicyclic moiety”; to “aromatic group” or “aryl group” and to “aromatic moiety” or “aryl moiety”; as well as to “heterocyclic group” and “heterocyclic moiety”.

Heterocyclic group: the term “heterocyclic group” means a closed ring hydrocarbon in which one or more of the atoms in the ring is an element other than carbon (e.g., nitrogen, oxygen, sulphur, etc.).

Heterocyclyl means a monovalent saturated cyclic radical, consisting of one to two rings, of three to eight atoms per ring, incorporating one or two ring heteroatoms (chosen from N, O or S(O)₀₋₂, and which can optionally be substituted with one or two substituents selected from the group consisting of hydroxyl, oxo, cyano, lower alkyl, lower alkoxy, lower haloalkoxy, alkylthio, halo, haloalkyl, hydroxyalkyl, nitro, alkoxycarbonyl, amino, alkylamino, alkylsulfonyl, arylsulfonyl, alkylaminosulfonyl, arylaminosulfonyl, alkylsulfonylamino, arylsulfonylamino, alkylaminofarbonyl, arylaminocarbonyl, alkylcarbonylamino, or arylcarbonylamino.

Heteroaryl means a monovalent aromatic cyclic radical having one to three rings, of four to eight atoms per ring, incorporating one or two heteroatoms (chosen from nitrogen, oxygen, or sulphur) within the ring which can optionally be substituted with one or two substituents selected from the group consisting of hydroxy, cyano, lower alkyl, lower alkoxy, lower haloalkoxy, alkylthio, halo, haloalkyl, hydroxyalkyl, nitro, alkoxycarbonyl, amino, alkylamino, alkylsulfonyl, arylsulfonyl, alkylaminosulfonyl, arylaminosulfonyl, alkylsulfonylamino, arylsulfonylamino, alkylaminocarbonyl, arylaminocarbonyl, alkylcarbonlamino and arylcarbonylamino.

Homology: The homology between amino acid sequences may be calculated using well known scoring matrices such as any one of BLOSUM 30, BLOSUM 40, BLOSUM 45, BLOSUM 50, BLOSUM 55, BLOSUM 60, BLOSUM 62, BLOSUM 65, BLOSUM 70, BLOSUM 75, BLOSUM 80, BLOSUM 85, and BLOSUM 90.

Fragments sharing homology with fragments of SEQ ID NO:1 to 13, respectively, are to be considered as falling within the scope of the present invention when they are preferably at least about 60 percent homologous, for example at least 65 percent homologous, for example at least 70 percent homologous, for example at least 75 percent homologous, for example at least 80 percent homologous, for example at least 85 percent homologous, for example at least 90 percent homologous, for example at least 92 percent homologous, such as at least 94 percent homologous, for example at least 95 percent homologous, such as at least 96 percent homologous, for example at least 97 percent homologous, such as at least 98 percent homologous, for example at least 99 percent homologous with said predetermined fragment sequences, respectively. According to one embodiment of the invention, the homology percentages refer to identity percentages.

A further suitably adaptable method for determining structure and function relationships of peptide fragments is described in U.S. Pat. No. 6,013,478, which is herein incorporated by reference. Also, methods of assaying the binding of an amino acid sequence to a receptor moiety are known to the skilled artisan.

In addition to conservative substitutions introduced into any position of a preferred predetermined proneurotrophin activity modulator, or a fragment thereof, it may also be desirable to introduce non-conservative substitutions in any one or more positions of such a proneurotrophin activity modulator.

A non-conservative substitution leading to the formation of a functionally equivalent fragment of proneurotrophin activity modulator would for example i) differ substantially in polarity, for example a residue with a non-polar side chain (Ala, Leu, Pro, Trp, Val, Ile, Leu, Phe or Met) substituted for a residue with a polar side chain such as Gly, Ser, Thr, Cys, Tyr, Asn, or Gln or a charged amino acid such as Asp, Glu, Arg, or Lys, or substituting a charged or a polar residue for a non-polar one; and/or ii) differ substantially in its effect on polypeptide backbone orientation such as substitution of or for Pro or Gly by another residue; and/or iii) differ substantially in electric charge, for example substitution of a negatively charged residue such as Glu or Asp for a positively charged residue such as Lys, His or Arg (and vice versa); and/or iv) differ substantially in steric bulk, for example substitution of a bulky residue such as His, Trp, Phe or Tyr for one having a minor side chain, e.g. Ala, Gly or Ser (and vice versa).

Variants obtained by substitution of amino acids may in one preferred embodiment be made based upon the hydrophobicity and hydrophilicity values and the relative similarity of the amino acid side-chain substituents, including charge, size, and the like. Exemplary amino acid substitutions which take various of the foregoing characteristics into consideration are well known to those of skill in the art and include: arginine and lysine; glutamate and aspartate; serine and threonine; glutamine and asparagine; and valine, leucine and isoleucine.

In addition to the variants described herein, sterically similar variants may be formulated to mimic the key portions of the variant structure and that such compounds may also be used in the same manner as the variants of the invention. This may be achieved by techniques of modelling and chemical designing known to those of skill in the art. It will be understood that all such sterically similar constructs fall within the scope of the present invention.

In a further embodiment the present invention relates to functional variants comprising substituted amino acids having hydrophilic values or hydropathic indices that are within +/−4.9, for example within +/−4.7, such as within +/−4.5, for example within +/−4.3, such as within +/−4.1, for example within +/−3.9, such as within +/−3.7, for example within +/−3.5, such as within +/−3.3, for example within +/−3.1, such as within +/−2.9, for example within +/−2.7, such as within +/−2.5, for example within +/−2.3, such as within +/−2.1, for example within +/−2.0, such as within +/−1.8, for example within +/−1.6, such as within +/−1.5, for example within +/−1.4, such as within +/−1.3 for example within +/−1.2, such as within +/−1.1, for example within +/−1.0, such as within +/−0.9, for example within +/−0.8, such as within +/−0.7, for example within +/−0.6, such as within +/−0.5, for example within +/−0.4, such as within +/−0.3, for example within +/−0.25, such as within +/−0.2 of the value of the amino acid it has substituted.

The importance of the hydrophilic and hydropathic amino acid indices in conferring interactive biologic function on a protein is well understood in the art (Kyte & Doolittle, 1982 and Hopp, U.S. Pat. No. 4,554,101, each incorporated herein by reference).

The amino acid hydropathic index values as used herein are: isoleucine (+4.5); valine (+4.2); leucine (+3.8); phenylalanine (+2.8); cysteine/cystine (+2.5); methionine (+1.9); alanine (+1.8); glycine (−0.4); threonine (−0.7); serine (−0.8); tryptophan (−0.9); tyrosine (−1.3); proline (−1.6); histidine (−3.2); glutamate (−3.5); glutamine (−3.5); aspartate (−3.5); asparagine (−3.5); lysine (−3.9); and arginine (−4.5) (Kyte & Doolittle, 1982).

The amino acid hydrophilicity values are: arginine (+3.0); lysine (+3.0); aspartate (+3.0.+−0.1); glutamate (+3.0.+−0.1); serine (+0.3); asparagine (+0.2); glutamine (+0.2); glycine (0); threonine (−0.4); proline (−0.5.+−0.1); alanine (−0.5); histidine (−0.5); cysteine (−1.0); methionine (−1.3); valine (−1.5); leucine (−1.8); isoleucine (−1.8); tyrosine (−2.3); phenylalanine (−2.5); tryptophan (−3.4) (U.S. Pat. No. 4,554,101).

In addition to the peptidyl compounds described herein, sterically similar compounds may be formulated to mimic the key portions of the peptide structure and that such compounds may also be used in the same manner as the peptides of the invention. This may be achieved by techniques of modelling and chemical designing known to those of skill in the art. For example, esterification and other alkylations may be employed to modify the amino terminus of, e.g., a di-arginine peptide backbone, to mimic a tetra peptide structure. It will be understood that all such sterically similar constructs fall within the scope of the present invention.

Peptides with N-terminal alkylations and C-terminal esterifications are also encompassed within the present invention. Functional equivalents also comprise glycosylated and covalent or aggregative conjugates formed with the same or other proneurotrophin activity modulator fragments and/or proneurotrophin activity modulator molecules, including dimers or unrelated chemical moieties. Such functional equivalents are prepared by linkage of functionalities to groups which are found in fragment including at any one or both of the N- and C-termini, by means known in the art.

Functional equivalents may thus comprise fragments conjugated to aliphatic or acyl esters or amides of the carboxyl terminus, alkylamines or residues containing carboxyl side chains, e.g., conjugates to alkylamines at aspartic acid residues; O-acyl derivatives of hydroxyl group-containing residues and N-acyl derivatives of the amino terminal amino acid or amino-group containing residues, e.g. conjugates with fMet-Leu-Phe or immunogenic proteins. Derivatives of the acyl groups are selected from the group of alkyl-moieties (including C3 to C10 normal alkyl), thereby forming alkanoyl species, and carbocyclic or heterocyclic compounds, thereby forming aroyl species. The reactive groups preferably are difunctional compounds known per se for use in cross-linking proteins to insoluble matrices through reactive side groups.

Covalent or aggregative functional equivalents and derivatives thereof are useful as reagents in immunoassays or for affinity purification procedures. For example, a fragment of proneurotrophin activity modulator according to the present invention may be insolubilized by covalent bonding to cyanogen bromide-activated Sepharose by methods known per se or adsorbed to polyolefin surfaces, either with or without glutaraldehyde cross-linking, for use in an assay or purification of anti-neurotrophin activity modulator antibodies or cell surface receptors. Fragments may also be labelled with a detectable group, e.g., radioiodinated by the chloramine T procedure, covalently bound to rare earth chelates or conjugated to another fluorescent moiety for use in e.g. diagnostic assays.

Mutagenesis of a preferred predetermined fragment of proneurotrophin activity modulator can be conducted by making amino acid insertions, usually on the order of about from 1 to 10 amino acid residues, preferably from about 1 to 5 amino acid residues, or deletions of from about from 1 to 10 residues, such as from about 2 to 5 residues.

In one embodiment the ligand of binding site 1, 2 or 3 is an oligopeptide synthesised by automated synthesis. Any of the commercially available solid-phase techniques may be employed, such as the Merrifield solid phase synthesis method, in which amino acids are sequentially added to a growing amino acid chain (see Merrifield, J. Am. Chem. Soc. 85:2149-2146, 1963).

Equipment for automated synthesis of polypeptides is commercially available from suppliers such as Applied Biosystems, Inc. of Foster City, Calif., and may generally be operated according to the manufacturers instructions. Solid phase synthesis will enable the incorporation of desirable amino acid substitutions into any fragment of proneurotrophin activity modulator according to the present invention. It will be understood that substitutions, deletions, insertions or any subcombination thereof may be combined to arrive at a final sequence of a functional equivalent. Insertions shall be understood to include amino-terminal and/or carboxyl-terminal fusions, e.g. with a hydrophobic or immunogenic protein or a carrier such as any polypeptide or scaffold structure capable as serving as a carrier.

Oligomers including dimers including homodimers and heterodimers of fragments of sortilin ligands according to the invention are also provided and fall under the scope of the invention.

Sortilin binding peptide fragments may be synthesised both in vitro and in vivo. Method for in vitro synthesis are well known, and methods being suitable or suitably adaptable to the synthesis in vivo of sortilin ligands are also described in the prior art. When synthesized in vivo, a host cell is transformed with vectors containing DNA encoding a sortilin peptide ligand or a fragment thereof. A vector is defined as a replicable nucleic acid construct. Vectors are used to mediate expression of proneurotrophin activity modulator. An expression vector is a replicable DNA construct in which a nucleic acid sequence encoding the predetermined sortilin binding fragment, or any functional equivalent thereof that can be expressed in vivo, is operably linked to suitable control sequences capable of effecting the expression of the fragment or equivalent in a suitable host. Such control sequences are well known in the art. Both prokaryotic and eukaryotic cells may be used for synthesising ligands. Cultures of cells derived from multicellular organisms however represent preferred host cells. In principle, any higher eukaryotic cell culture is workable, whether from vertebrate or invertebrate culture. Examples of useful host cell lines are VERO and HeLa cells, Chinese hamster ovary (CHO) cell lines, and WI38, BHK, COS-7, 293 and MDCK cell lines. Preferred host cells are eukaryotic cells known to synthesize endogenous sortilin ligands. Cultures of such host cells may be isolated and used as a source of the fragment, or used in therapeutic methods of treatment, including therapeutic methods aimed at promoting or inhibiting a growth state, or diagnostic methods carried out on the human or animal body.

The word homology, as used herein shall be understood as interchangeable with the word identity, and vice versa.

Hydrophobic bond: The term “hydrogen bond” as used herein refers to an attractive force, or bridge, which may occur between a hydrogen atom which is bonded covalently to an electronegative atom, for example, oxygen, sulphur, or nitrogen, and another electronegative atom. The hydrogen bond may occur between a hydrogen atom in a first molecule and an electronegative atom in a second molecule (intermolecular hydrogen bonding). Also, the hydrogen bond may occur between a hydrogen atom and an electronegative atom which are both contained in a single molecule (intramolecular hydrogen bonding).

Hydrophobic interaction: The term “hydrophobic interaction” as used herein refers to any interaction occurring between essentially non-polar (hydrophobic) components located within attraction range of one another in a polar environment (e.g. water). As used herein, attraction range is on the scale of from 0.1 up to 2 nm. A particular type of hydrophobic interaction is exerted by “Van der Waal's forces”, i.e. the attractive forces between non-polar molecules that are accounted for by quantum mechanics. Van der Waal's forces are generally associated with momentary dipole moments which are induced by neighbouring molecules and which involve changes in electron distribution.

In vitro/in vivo: the terms are used in their normal meaning.

In silico: a method of performing an in vitro or in vivo operation by computer simulation.

Ischemia: Restriction in blood supply with resultant dysfunction or damage of tissue.

Ischemic tissue damage: Tissue damage due to ischemia.

Lactic acidosis: Lactic acidosis is a condition caused by the buildup of lactic acid in the body. An important cause of lactic acidosis is inadequate oxygen supply to tissues. Lactic acidosis leads to acidification of the blood (acidosis), and is considered a distinct form of metabolic acidosis.

Ligand: a substance or compound that is able to bind to and form a complex with a biomolecule to serve a biological purpose. In a narrower sense, it is a signal triggering molecule binding to a site on a target protein, by intermolecular forces such as ionic bonds, hydrogen bonds and Van der Waals forces. The docking (association) is usually reversible (dissociation). Actual irreversible covalent binding between a ligand and its target molecule is rare in biological systems. As opposed to the meaning in metalorganic and inorganic chemistry, it is irrelevant, whether or not the ligand actually binds at a metal site, as it is the case in hemoglobin. Ligand binding to receptors may alter the chemical conformation, i.e. the three dimensional shape of the receptor protein. The conformational state of a receptor protein determines the functional state of a receptor. The tendency or strength of binding is called affinity. Ligands include substrates, activators, and neurotransmitters. Radioligands are radioisotope labeled compounds and used in vivo as tracers in PET studies and for in vitro binding studies.

Moieties of a particular compound cover group(s) or part(s) of said particular compound.

Pharmaceutical agent: The terms “pharmaceutical agent” or “drug” or “medicament” refer to any therapeutic or prophylactic agent which may be used in the treatment (including the prevention, diagnosis, alleviation, or cure) of a malady, affliction, condition, disease or injury in a patient. Therapeutically useful genetic determinants, peptides, polypeptides and polynucleotides may be included within the meaning of the term pharmaceutical or drug. As defined herein, a “therapeutic agent,” “pharmaceutical agent” or “drug” or “medicament” is a type of bioactive agent.

Pharmaceutical composition: or drug, medicament or agent refers to any chemical or biological material, compound, or composition capable of inducing a desired therapeutic effect when properly administered to a patient. Some drugs are sold in an inactive form that is converted in vivo into a metabolite with pharmaceutical activity. For purposes of the present invention, the terms “pharmaceutical composition” and “medicament” encompass both the inactive drug and the active metabolite.

Polypeptide: The term “polypeptide” as used herein refers to a molecule comprising at least two amino acids. The amino acids may be natural or synthetic. “Oligopeptides” are defined herein as being polypeptides of length not more than 100 amino acids. The term “polypeptide” is also intended to include proteins, i.e. functional biomolecules comprising at least one polypeptide; when comprising at least two polypeptides, these may form complexes, be covalently linked or may be non-covalently linked. The polypeptides in a protein can be glycosylated and/or lipidated and/or comprise prosthetic groups.

Polynucleotide: “Polynucleotide” as used herein refers to a molecule comprising at least two nucleic acids. The nucleic acids may be naturally occurring or modified, such as locked nucleic acids (LNA), or peptide nucleic acids (PNA). Polynucleotide as used herein generally pertains to
i) a polynucleotide comprising a predetermined coding sequence, or
ii) a polynucleotide encoding a predetermined amino acid sequence, or
iii) a polynucleotide encoding a fragment of a polypeptide encoded by polynucleotides (i) or (ii), wherein said fragment has at least one predetermined activity as specified herein; and
iv) a polynucleotide the complementary strand of which hybridizes under stringent conditions with a polynucleotide as defined in any one of (i), (ii) and (iii), and encodes a polypeptide, or a fragment thereof, having at least one predetermined activity as specified herein; and
v) a polynucleotide comprising a nucleotide sequence which is degenerate to the nucleotide sequence of polynucleotides (iii) or (iv);
or the complementary strand of such a polynucleotide.

Purified antibody: The term a “purified antibody” is an antibody at least 60 weight percent of which is free from the polypeptides and naturally-occurring organic molecules with which it is naturally associated. Preferably, the preparation comprises antibody in an amount of at least 75 weight percent, more preferably at least 90 weight percent, and most preferably at least 99 weight percent.

Root mean square deviation: The term “root mean square deviation” (rmsd) is used as a mean of comparing two closely related structures and relates to a deviation in the distance between related atoms of the two structures after structurally minimizing this distance in an alignment. Related proteins with closely related structures will be characterized by relatively low RMSD values whereas larger differences will result in an increase of the RMSD value.

Sequence identity: Sequence identity is determined in one embodiment by utilising fragments of proneurotrophin activity modulator peptides comprising at least 25 contiguous amino acids and having an amino acid sequence which is at least 80%, such as 85%, for example 90%, such as 91%, for example 92%, such as 93%, for example 94%, such as 95%, for example 96%, such as 97%, for example 99%, preferably 100% identical to the amino acid sequence of any of SEQ ID NO: 1, SEQ ID NO: 2, SEQ ID NO: 3, SEQ ID NO: 4, SEQ ID NO: 5, SEQ ID NO: 25, SEQ ID NO: 26, SEQ ID NO: 27 AND SEQ ID NO: 28 respectively, wherein the percent identity is determined with the algorithm GAP, BESTFIT, or FASTA in the Wisconsin Genetics Software Package Release 7.0, using default gap weights.

The following terms are used to describe the sequence relationships between two or more polynucleotides: “predetermined sequence”, “comparison window”, “sequence identity”, “percentage of sequence identity”, and “substantial identity”.

A “predetermined sequence” is a defined sequence used as a basis for a sequence comparison; a predetermined sequence may be a subset of a larger sequence, for example, as a segment of a full-length DNA or gene sequence given in a sequence listing, such as a polynucleotide sequence of SEQ ID NO:1, or may comprise a complete DNA or gene sequence. Generally, a predetermined sequence is at least 20 nucleotides in length, frequently at least 25 nucleotides in length, and often at least 50 nucleotides in length.

Since two polynucleotides may each (1) comprise a sequence (i.e., a portion of the complete polynucleotide sequence) that is similar between the two polynucleotides, and (2) may further comprise a sequence that is divergent between the two polynucleotides, sequence comparisons between two (or more) polynucleotides are typically performed by comparing sequences of the two polynucleotides over a “comparison window” to identify and compare local regions of sequence similarity. A “comparison window”, as used herein, refers to a conceptual segment of at least 20 contiguous nucleotide positions wherein a polynucleotide sequence may be compared to a predetermined sequence of at least 20 contiguous nucleotides and wherein the portion of the polynucleotide sequence in the comparison window may comprise additions or deletions (i.e., gaps) of 20 percent or less as compared to the predetermined sequence (which does not comprise additions or deletions) for optimal alignment of the two sequences.

Optimal alignment of sequences for aligning a comparison window may be conducted by the local homology algorithm of Smith and Waterman (1981) Adv. Appl. Math. 2: 482, by the homology alignment algorithm of Needleman and Wunsch (1970) J. Mol. Biol. 48: 443, by the search for similarity method of Pearson and Lipman (1988) Proc. Natl. Acad. Sci. (U.S.A.) 85: 2444, by computerized implementations of these algorithms (GAP, BESTFIT, FASTA, and TFASTA in the Wisconsin Genetics Software Package Release 7.0, Genetics Computer Group, 575 Science Dr., Madison, Wis.), or by inspection, and the best alignment (i.e., resulting in the highest percentage of homology over the comparison window) generated by the various methods is selected.

The term “sequence identity” means that two polynucleotide sequences are identical (i.e., on a nucleotide-by-nucleotide basis) over the window of comparison. The term “percentage of sequence identity” is calculated by comparing two optimally aligned sequences over the window of comparison, determining the number of positions at which the identical nucleic acid base (e.g., A, T, C, G, U, or I) occurs in both sequences to yield the number of matched positions, dividing the number of matched positions by the total number of positions in the window of comparison (i.e., the window size), and multiplying the result by 100 to yield the percentage of sequence identity. The terms “substantial identity” as used herein denotes a characteristic of a polynucleotide sequence, wherein the polynucleotide comprises a sequence that has at least 85 percent sequence identity, preferably at least 90 to 95 percent sequence identity, more usually at least 99 percent sequence identity as compared to a predetermined sequence over a comparison window of at least 20 nucleotide positions, frequently over a window of at least 25-50 nucleotides, wherein the percentage of sequence identity is calculated by comparing the predetermined sequence to the polynucleotide sequence which may include deletions or additions which total 20 percent or less of the predetermined sequence over the window of comparison. The predetermined sequence may be a subset of a larger sequence, for example, as a segment of the full-length SEQ ID NO:1 polynucleotide sequence illustrated herein.

As applied to polypeptides, a degree of identity of amino acid sequences is a function of the number of identical amino acids at positions shared by the amino acid sequences. A degree of homology or similarity of amino acid sequences is a function of the number of amino acids, i.e. structurally related, at positions shared by the amino acid sequences.

An “unrelated” or “non-homologous” sequence shares less than 40% identity, though preferably less than 25% identity, with one of the proneurotrophin activity modulator polypeptide sequences of the present invention. The term “substantial identity” means that two peptide sequences, when optimally aligned, such as by the programs GAP or BESTFIT using default gap weights, share at least 80 percent sequence identity, preferably at least 90 percent sequence identity, more preferably at least 95 percent sequence identity or more (e.g., 99 percent sequence identity). Preferably, residue positions which are not identical differ by conservative amino acid substitutions.

Conservative amino acid substitutions refer to the interchangeability of residues having similar side chains. For example, a group of amino acids having aliphatic side chains is glycine, alanine, valine, leucine, and isoleucine; a group of amino acids having aliphatic-hydroxyl side chains is serine and threonine, a group of amino acids having amide-containing side chains is asparagine and glutamine; a group of amino acids having aromatic side chains is phenylalanine, tyrosine, and tryptophan; a group of amino acids having basic side chains is lysine, arginine, and histidine; and a group of amino acids having sulphur-containing side chains is cysteine and methionine. Preferred conservative amino acids substitution groups are: valine-leucine-isoleucine, phenylalanine-tyrosine, lysine-arginine, alanine-valine, and asparagine-glutamine.

Additionally, variants are also determined based on a predetermined number of conservative amino acid substitutions as defined herein below. Conservative amino acid substitution as used herein relates to the substitution of one amino acid (within a predetermined group of amino acids) for another amino acid (within the same group), wherein the amino acids exhibit similar or substantially similar characteristics.

Within the meaning of the term “conservative amino acid substitution” as applied herein, one amino acid may be substituted for another within the groups of amino acids indicated herein below:
i) Amino acids having polar side chains (Asp, Glu, Lys, Arg, His, Asn, Gln, Ser, Thr, Tyr, and Cys,)
ii) Amino acids having non-polar side chains (Gly, Ala, Val, Leu, Ile, Phe, Trp, Pro, and Met)
iii) Amino acids having aliphatic side chains (Gly, Ala Val, Leu, Ile)
iv) Amino acids having cyclic side chains (Phe, Tyr, Trp, His, Pro)
v) Amino acids having aromatic side chains (Phe, Tyr, Trp)
vi) Amino acids having acidic side chains (Asp, Glu)
vii) Amino acids having basic side chains (Lys, Arg, His)
viii) Amino acids having amide side chains (Asn, Gln)
ix) Amino acids having hydroxy side chains (Ser, Thr)
x) Amino acids having sulphur-containing side chains (Cys, Met),
xi) Neutral, weakly hydrophobic amino acids (Pro, Ala, Gly, Ser, Thr)
xii) Hydrophilic, acidic amino acids (Gln, Asn, Glu, Asp), and
xiii) Hydrophobic amino acids (Leu, Ile, Val)

Accordingly, a variant or a fragment thereof according to the invention may comprise, within the same variant of the sequence or fragments thereof, or among different variants of the sequence or fragments thereof, at least one substitution, such as a plurality of substitutions introduced independently of one another.

It is clear from the above outline that the same variant or fragment thereof may comprise more than one conservative amino acid substitution from more than one group of conservative amino acids as defined herein above.

The addition or deletion of at least one amino acid may be an addition or deletion of from preferably 2 to 250 amino acids, such as from 10 to 20 amino acids, for example from 20 to 30 amino acids, such as from 40 to 50 amino acids. However, additions or deletions of more than 50 amino acids, such as additions from 50 to 100 amino acids, addition of 100 to 150 amino acids, addition of 150-250 amino acids, are also comprised within the present invention. The deletion and/or the addition may—independently of one another—be a deletion and/or an addition within a sequence and/or at the end of a sequence.

Substituted lower alkyl means a lower alkyl having one to three substituents selected from the group consisting of hydroxyl, alkoxy, amino, amido, carboxyl, acyl, halogen, cyano, nitro and thiol.

Variants: The term “variants” as used herein refers to amino acid sequence variants said variants preferably having at least 60% identity, for example at least 63% identity, such as at least 66% identity, for example at least 70% sequence identity, for example at least 72% sequence identity, for example at least 75% sequence identity, for example at least 80% sequence identity, such as at least 85% sequence identity, for example at least 90% sequence identity, such as at least 91% sequence identity, for example at least 91% sequence identity, such as at least 92% sequence identity, for example at least 93% sequence identity, such as at least 94% sequence identity, for example at least 95% sequence identity, such as at least 96% sequence identity, for example at least 97% sequence identity, such as at least 98% sequence identity, for example 99% sequence identity with any of the predetermined sequences.

### Sortilin Crystal

To clarify the structural organization and ligand binding of the Vps10p-domain and of human Sortilin in particular, the present inventors have determined the crystal structures of sSortilin in complex with NT and with residues 4-29 of its own propeptide (at resolutions of 2.0 and 3.2 Å respectively). Data on the sSortilin:NT complex was obtained from crystals grown with a slight (molar ratio 1:1.5) as well as with a large (molar ratio 1:15) excess of NT. (See Example 5) The inventors have furthermore determined the structure of sSortilin in complex with the pro-domain of Nerve Growth Factor (NGF).

Accordingly, in one embodiment the present invention relates to a crystal comprising
a) a polypeptide of SEQ ID NO. 1;
b) a sequence variant of said polypeptide wherein the variant has at least 60% sequence identity to said SEQ ID NO. 1;
c) a fragment comprising at least 500 contiguous amino acids of any of a) through b), wherein the fragment exhibits sortilin activity,
d) any of a) through c) in complex with at least one ligand.

In a preferred embodiment of the present invention the at least one ligand is present in binding site 1 (high affinity neurotensin binding site and sortilin propeptide binding site) comprising amino acid residues R325, S316, Y351, I353, K260, I327, F314, F350 to M363, S305, F306 and T398 to G400 of SEQ ID NO. 1.

In a more preferred embodiment of the present invention the at least one ligand is present in binding site 1 (high affinity neurotensin binding site and sortilin propeptide binding site) comprising amino acid residues R325, S316, Y351, I353, K260, I327, F314 and F350 to M363 of SEQ ID NO. 1.

In a highly preferred embodiment of the present invention the at least one ligand is present in binding site 1 (high affinity neurotensin binding site and sortilin propeptide binding site) comprising amino acid residues R325, S316, Y351, I353, K260, I327, F314 and F350 to M363 of SEQ ID NO. 1.

In another embodiment of the present invention the at least one ligand is present in binding site 2 (low affinity neurotensin binding site and sortilin propeptide binding site) comprising amino acid residues L572, L114, V112, R109 to S111, S115 to G118, T570, G571, W586, W597, T168-I174, L572, A573 and S584 to F588 of SEQ ID NO. 1.

In yet another embodiment of the present invention the at least one ligand is present in binding site 2 (low affinity neurotensin binding site and sortilin propeptide binding site) comprising amino acid residues L572, L114, V112, R109 to S111, S115 to G118, T570, G571, W586 and W597 of SEQ ID NO. 1.

In a preferred embodiment the at least one ligand of the present invention is present in binding site 2 (low affinity neurotensin binding site and sortilin propeptide binding site) comprising amino acid residues L572, L114 and V112 of SEQ ID NO. 1.

In another preferred embodiment of the present invention the at least one ligand is present in binding site 3 (neurotrophin-propeptide binding site) comprising amino acid residues D403, S420, D422, N423, S424, I425, Q426, T451, Y466, Q470, I498, S499 and V500 of SEQ ID NO. 1. As binding site 3 bind the pro-domain of neurotrophins, said binding site 3 may also bind the entire pro-neurotrophin. Accordingly binding site 3 may be referred to as pro-neurotrophin binding site or neurotrophin prodomain binding site or a synonymous expression of identical biochemical meaning.

In a more preferred embodiment the at least one ligand of the present invention is present in binding site 3 (neurotrophin-propeptide binding site) comprising amino acid residues D403, N423, S424, I425, T451, Y466, I498 and V500 of SEQ ID NO. 1

In a highly preferred embodiment of the present invention the at least one ligand is present in binding site 3 (neurotrophin-propeptide binding site) comprising amino acid residues T451, Y466, I498 and V500 of SEQ ID NO. 1.

In another embodiment of the present invention binding site 3 (the pro-neurotrophin binding site) is a proNGF binding site.

In another embodiment of the present invention binding site 3 (the pro-neurotrophin binding site) is a proBDNF binding site.

In another embodiment of the present invention binding site 3 (the pro-neurotrophin binding site) is a proNT3 binding site.

In another embodiment of the present invention binding site 3 (the pro-neurotrophin binding site) is a proNT4/5 binding site.

The crystal according to claim 1 wherein the polypeptide comprises amino acid residue no. 78 to 755 of SEQ ID NO. 1.

In another embodiment the crystal defined herein above is of a triclinic space group.

In one embodiment the crystal of the triclinic space group belong to space group P1.

In another embodiment the crystal defined herein above is of a monoclinic space group.

In one embodiment the crystal of the monoclinic space group belong to space group C2.

In another embodiment the crystal defined herein above is of an orthorhombic space group.

In one embodiment the crystal of the orthorhombic space group is P2₁2₁2₁.

In another embodiment of the present invention the crystal as defined herein above comprises a polypeptide variant comprising amino acid residues 78 to 755 (sSortilin) of SEQ ID NO. 1, or a fragment or variant thereof.

In one embodiment of the present invention the crystal as defined herein above comprises a sortilin polypeptide wherein one or more or all methionine(s) have been replaced by Se-methionine (seleno-methionine).

In another embodiment of the present invention the crystal as defined herein above comprises a polypeptide ligand selected from the group consisting of amino acid residues 19 to 241 of SEQ ID NO 6 (proNGF), amino acid residues 19 to 121 of SEQ ID NO 6 (NGF pro domain), amino acid residues 19 to 246 of SEQ ID NO 7 (proBDNF), amino acid residues 19 to 127 of SEQ ID NO 7 (BDNF pro domain), amino acid residues 17 to 257 of SEQ ID NO 8 (proNT3), amino acid residues 17 to 140 of SEQ ID NO 8 (NT3 pro domain), amino acid residues 25 to 210 of SEQ ID NO 9 (proNT4/5), amino acid residues 25 to 80 of SEQ ID NO 9 (NT4/5 pro domain), SEQ ID NO. 10 (Neurotensin), SEQ ID NO. 11 (PYIL), amino acid residues 11 to 13 of SEQ ID NO. 10 (YIL) and SEQ ID NO. 12 (NT69L), or a fragment or variant thereof.

### Method of Growing a Sortilin Crystal

In a further aspect, the present invention furthermore relates to a method of growing a sortilin crystal comprising the steps of:
a. obtaining a composition comprising 4.5 to 5.5 mg/mL of a polypeptide of SEQ ID NO. 1 or a fragment or variant thereof, in a buffer containing 50 mM Tris-HCl pH 7.9 and 150 mM NaCl,
b. mixing said composition with Neurotensin at a molar ratio of:
   i. 1:1.5 to 1:15 (sSortilin:NT) or,
   ii. 1:4 (sSortilin:propeptide),
c. subjecting equal volumes of said composition and a crystallization solution respectively, said crystallization solution containing
   iii. 18-21% w/v PEG 6000, and
   iv. 0-15% Glycerol, and
   v. Tris-HEPES pH 7.2-7.8 (40-93 mM Tris and 100 mM HEPES) or 100 mM Tris-HCl pH 7.9, 3-6% glycerol and
   vi. 300-900 mM NaCl or 150-400 mM C₃H₂Na₂O₄ wherein said C₃H₂Na₂O₄ is adjusted to pH 6-7.5 by malonic acid, or 300-500 mM LiSO₄ or 500-700 mM KCl and,
d. obtaining crystals comprising SEQ ID NO. 1 or a fragment or variant thereof.

In a further embodiment of the present invention the cystein residues of SEQ ID NO. 1 are replaced by seleno-cystein.

In another embodiment of the present invention the method of obtaining crystals as defined herein above further comprises the steps of:
a. isolating an initial precipitate and
b. growing these by vapour diffusion from hanging drops.

In yet another embodiment of the present invention the crystal as defined herein above further comprises a ligand bound to Sortilin for determination of the three dimensional structure of Sortilin or a fragment or variant thereof in complex with said ligand.

### Sortilin Structure

The inventors have found that residues 78-609 of Sortilin (SEQ ID NO. 1) constitute the first example of a 10-bladed β-propeller. Long extensions are found both between the four-stranded up-and-down blades and between individual β-strands of the blades (FIG. 1A). The smaller 10 cysteine containing C-terminal part (10CC), residues 610-758, presents itself as two similar structural domains with an overall shape and architecture reminiscent of the cysteine-rich domains found in p75NTR (18) (FIG. 1B). The interface between the two 10CC domains and the propeller domain comprises extensive hydrophobic and electrostatic interactions and covers approximately 180° of one face of the propeller.

Overall the propeller domain is oval-shaped and forms a wide slightly conical tunnel narrowing towards the side of the 10CC-interacting face. In the equatorial plane the cross section of the tunnel is approximately 25 by 40 Å (FIG. 1C+D). Access to the tunnel from the narrow 10CC-interacting side is furthermore partially blocked by an Asn406-linked glycosylation located on the inner rim at the end of strand one of blade 7 (FIG. 1C+D). Two more glycosylations are found at Asn162 and Asn582, both on the outer rim and both on the 10CC interacting side of the propeller. Notably, two protruding hydrophobic loops connecting strand two and three of blades 1 and 10 emerge from the opposite face (FIG. 1B), suggesting that this face, and the loops in particular, might mediate contact with the cell membrane or serve in interactions with other proteins.

In both structures of sSortilin in complex with NT, the inventors have found that the four C-terminal residues (Pro10-Tyr11-Ile12-Leu13) of NT form a short β-strand to strand one of blade 6 (referred to herein as the high affinity NT binding site). The hydroxyl group of Tyr11 forms a hydrogen bond to Lys260 of Sortilin, and the C-terminal leucine fits into a hydrophobic pocket formed by Phe314, Ile327 and Ile353. However, the major contribution to binding is clearly the C-terminal carboxylate of NT, which forms a salt bridge with the guanidinium group of Arg325 and hydrogen bonds to the side chain of Ser316 and the main chain amide of Tyr351 (FIG. 2B).

In the structure determined with a large excess of NT two additional binding sites are found. Binding site 2 (FIG. 2A) is found at the inner rim of the propeller. Here the N-terminal half of Neurotensin (residues 2-6) is modelled as a short β-strand interacting with the first strand of blade 1. No specific side chain interactions with the receptor are observed in this site (FIG. 2B). The distance from Cα of Lys6 to Cα of Pro10 is 17.7 Å and no electron density is present in the intervening region. Hence, the inventors conclude that at high concentration of NT two molecules are bound inside the propeller.

The results presented above indicate that Sortilin has a high affinity binding site for the C-terminus of NT, and a secondary low affinity subsite engaging the N-terminal part of the peptide. Accordingly, the inventors examined the ability of NT-derived fragments to inhibit Sortilins binding of its own propeptide (Sort-pro). It has previously been shown (5) that the binding of Sort-pro is completely abolished in the presence of 5 fold excess of NT and the C-terminal peptide Arg9-Pro-Tyr-Ile-Leu13 is equally effective (FIG. 3A). In contrast, the present inventors have found that both the N-terminal peptide NT (1-8) and Arg8-Arg-Pro-Tyr-Ile-Leu13-NH2 i.e. with the terminal carboxylate replaced by amide, fails to inhibit (FIG. 3A+B), whereas the C-terminal tripeptide Tyr11-Ile-Leu13 proves sufficient for full inhibition of Sort-pro binding (FIG. 3B). Tyr11-Ile-Leu13 also hampers binding of the prodomain of NGF (FIG. 3C) and RAP (FIG. 3D) although not as efficiently as full length NT. The latter indicates that proNGF and RAP could be subjects to sterical hindrance and have different or more extended binding sites than Tyr11-Ile-Leu13.

Neurotensin and Sort-pro have no sequence similarity. Yet, the structure of sSortilin in complex with a fragment of Sort-pro (residues 4-29) shows both binding sites inside the propeller to be occupied (FIG. 2C-E). The density for the peptide is strong but not sufficiently defined to allow modelling of the peptide. However, an overlay with the sSortilin:NT structure clearly shows that the Sort-pro density overlaps with that of the C- and N-terminal parts of NT (FIG. 2C+D) and fills the cavity in between (FIG. 2E). Since the propeptide does not contain a Tyr-Ile-Leu motif and its binding does not depend on a free C-terminus (8), it could be speculated that an intrinsic acidic residue in Sort-pro or other ligands, e.g. proNGF, may assume a role in binding similar to that of the C-terminal Leu-carboxylate of NT.

To investigate this, the inventors generated sSortilin-mutant constructs in which either Ser316 or Arg325 were exchanged for Glu and Ala respectively. The S316E mutant was subsequently expressed and purified, whereas the R325A mutant proved unstable and disintegrated during the purification procedure. Interestingly both mutants were seriously delayed in secretion (FIG. 4A), an effect also observed for Sortilin expressed without the propeptide (8). The S316E displayed no binding of Sort-pro but did bind the NGF-prodomain and BDNF with affinities

similar to that of wtSortilin. As expected the presence of NT had no effect on binding of the NGF-prodomain to the S316E mutant. These results strongly support the finding that Sort-pro and NT bind to the same structural site (binding site 1 and 2), and that other ligands, e.g. pro-domains of neurotrophins such as but not limited to NGF-prodomain and the full pro-NGF, bind at a closely situated but independent separate site (binding site 3).

Accordingly, in an embodiment of the present invention, ligands are designed to specifically bind to one or more of the three binding sites of sortilin.

The pairwise sequence identity between Sortilin from eight species is within 60-95%. Sequence alignment (FIG. 5) maps large patches of conserved residues to the inner surface of the propeller cavity and smaller scattered patches to the outer rim and to the 10CC domain (FIG. 1E). The pattern of conservation in the cavity would agree with the presence of additional or supplementary binding sites and suggests that such alternative sites might implicate other propeller blades in formation of β-strand interactions. The existence of alternative sites is evidently an important point as several ligands target Sortilin. It is well known that the full length ligands all compete for binding, but the efficiency of competition varies and not all are effectively antagonized by the Tyr-Ile-Leu tripeptide. Accordingly, it is likely that all ligands must bind inside the propeller cavity in overlapping sites.

In summary, the inventors have determined the first known structure of a member of the Vps10p-D protein family and of an NT-binding receptor. The results disclose that in fact the Vps10p-D consists of two distinct but structurally interdependent domains, i.e. the first example of a 10 bladed n-propeller and the 10CC composed of two similar structural domains. The propeller tunnel comprises the ligand binding region of Sortilin, and we have mapped the specific sites for its interaction with NT and its own propeptide. In addition we have demonstrated that an essential part of the recognition site for the proneurotrophins also are located within this area. The finding that the tripeptide Tyr-Ile-Leu targets Sortilin with high affinity, provides the first NT-derived ligand with a potential to discriminate between Sortilin, SorLA and the G-protein coupled NTRs and it opens for design of specific ligands that may be chemically modified to act as probes to be used in a molecular imaging technique described herein. The person skilled in the art of molecular imaging is familiar with methods available in the art describing chemical modification. Finally, the crystal structure provided in the application and binding analyses may prove useful in future modeling of structures and interactions of the other Vps10p-D receptors, and in the study of their putative roles in diseases like diabetes and Alzheimers disease (19-21).

In another aspect the present invention relates to a computer-readable data storage medium comprising a data storage material encoded with at least a portion of the structure coordinates of Sortilin as set forth in any of FIGS. 17 to 20.

In a further aspect the present invention relate to use of the atomic coordinates as presented in any of FIGS. 17 to 20 or atomic coordinates selected from a three-dimensional structure that deviates from the three-dimensional structure as presented in any of FIGS. 17 to 20 by a root mean square deviation over protein backbone atoms of not more than 3 Å in a method for identifying a ligand capable of binding to one or more of:
a. binding site 1, or
b. binding site 2, or
c. binding site 3,
   or a fragment or variant of a through c.

In yet another aspect the present invention relate to use of the crystal as described herein above for determination of the three dimensional structure of Sortilin or a fragment or variant thereof.

In yet another aspect the present invention relates to use of atomic coordinates as presented in any of FIGS. 17 to 20 or atomic coordinates selected from a three-dimensional structure that deviates from the three-dimensional structure as presented in any of FIGS. 17 to 20 by a root mean square deviation over protein backbone atoms of not more than 3 Å in a method for identifying a ligand capable of binding to one or more of:
a. binding site 1, or
b. binding site 2, or
c. binding site 3,
   or a fragment or variant of a through c.

### Methods of Identification and Design of Target Specific Imaging Reagents

The present invention provide methods for identification and design of ligands capable of binding specifically to any of the three binding sites (1, 2 and 3) of Sortilin as defined herein above, said ligands being target specific imaging reagents.

A potential ligand is at least partially complementary to at least a portion of the binding site 1, binding site 2 or binding site 3 of Sortilin in terms of shape and in terms of hydrophilic or hydrophobic properties.

Databases of chemical structures (e.g. cambridge structural database or from Chemical Abstracts Service; for a review see: Rusinko (1993) Chem. Des. Auto. News 8, 44-47) may be used to varying extents. In a totally automatic embodiment, all structures in a data base may be compared to the active site or to the binding pockets of sortilin for complementarity and lack of steric interference computationally using the processor of the computer and a suitable computer program. In this case, computer modelling which comprises manual user interaction at a computer screen may not be necessary. Alternatively, molecular fragments may be selected from a data base and assembled or constructed on a computer screen e.g. manually. Also, the ratio of automation to manual interaction by a person skilled in the art in the process of selecting may vary a lot. As computer programs for drug design and docking of molecules to each other become better, the need for manual interaction decreases.

Programs usable for computer modelling include Quanta (Molecular Simulations, Inc.) and Sibyl (Tripos Associates). Other useful programs are Autodock (Scripps Research Institute, La Jolla, described in Goodsell and Olsen (1990) Proteins: Structure, Function and Genetics, 8, 195-201), Dock (University of California, San Francisco, described in: Kuntz et al. (1982) J. Mol. Biol. 161, 269-288.

In a further aspect the present invention relates to a method of identifying a ligand capable of binding to binding site 1 and/or binding site 2 and/or binding site 3 of SEQ ID NO. 1 (Sortilin), or a fragment or variant thereof said method comprising the steps of:
a. generating the spatial structure of the binding site on a computer screen using atomic coordinates as presented in any of FIGS. 17 to 20 or atomic coordinates selected from a three-dimensional structure that deviates from the three-dimensional structure presented in any of FIGS. 17 to 20 by a root mean square deviation over protein backbone atoms of not more than 3 Å,
b. generating potential ligands with their spatial structure on the computer screen, and
c. selecting ligands that can bind to at least 1 amino acid residue of the set of binding interaction sites without steric interference.

In another aspect the present invention relates to a computer-assisted method for identifying a ligand of sortilin capable of binding to binding site 1 and/or binding site 2 and/or binding site 3 of SEQ ID NO. 1 (Sortilin), or a fragment or variant thereof, using a programmed computer comprising a processor, a data storage system, a data input device and a data output device, comprising the following steps:
a. inputting into the programmed computer through said input device data comprising: atomic coordinates of a subset of the atoms of said sortilin, thereby generating a criteria data set; wherein said atomic coordinates are selected from the three-dimensional structure presented in any of FIGS. 17 to 20 or atomic coordinates selected from a three-dimensional structure that deviates from the three-dimensional structure presented in any of FIGS. 17 to 20 by a root mean square deviation over protein backbone atoms of not more than 3 Å,
b. comparing, using said processor, the criteria data set to a computer data base of low-molecular weight organic chemical structures and peptide fragments stored in the data storage system; and
c. selecting from said data base, using computer methods, a chemical structure having a portion that is structurally complementary to the criteria data set and being free of steric interference with the receptor sortilin.

In yet another aspect the present invention relates to a method for identifying a ligand, said method comprising the steps of:
a. selecting a potential ligand using atomic coordinates in conjunction with computer modelling, wherein said atomic coordinates are the atomic coordinates presented in any of FIGS. 17 to 20 or wherein the atomic coordinates are selected from a three-dimensional structure that deviates from the three-dimensional structure presented in any of FIGS. 17 to 20 by a root mean square deviation over protein backbone atoms of not more than 3 Å, by docking potential ligands into a set of binding interaction sites in binding site 1 and/or binding site 2 and/or binding site 3 of SEQ ID NO. 1 (Sortilin), or a fragment or variant thereof, said binding interaction generated by computer modelling and selecting a potential ligand capable of binding to at least one amino acid in said set of binding interaction sites of sortilin,
b. providing said potential ligand and said receptor sortilin
c. contacting the potential ligand with said receptor sortilin and
d. detecting binding of said receptor sortilin by the potential ligand.

In one embodiment of the present invention the docking of potential ligand molecules is performed by employing a three-dimensional structure defined by atomic coordinates of the three dimensional structure presented in any of FIGS. 17 to 20 and such that said potential ligand is capable of binding to at least three amino acids in the binding site 1 and/or binding site 2 and/or binding site 3 of SEQ ID NO. 1 (Sortilin), or a fragment or variant thereof.

In a further aspect the present invention relates to a method of identifying a potential ligand of binding site 1, binding site 2 or binding site 3 of sortilin, or a fragment or variant thereof said method comprising the steps of
a. introducing into a computer, information derived from atomic coordinates defining a conformation of binding site 1 and/or binding site 2 and/or binding site 3 of SEQ ID NO. 1 (Sortilin), or a fragment or variant thereof, based on three-dimensional structure determination, whereby a computer program utilizes or displays on the computer screen the structure of said conformation; wherein said atomic coordinates are selected from the three-dimensional structure as presented in any of FIGS. 17 to 20 or atomic coordinates selected from a three-dimensional structure that deviates from any one of the tree-dimensional structure represented by any of FIGS. 17 to 20 by a root mean square deviation over protein backbone atoms of not more than 3 Å;
b. generating a three-dimensional representation of binding site 1, binding site 2 or binding site 3 of sortilin by said computer program on a computer screen;
c. superimposing a model of a potential ligand on the representation of said binding site 1, binding site 2 or binding site 3 or sortilin,
d. assessing the possibility of bonding and the absence of steric interference of the potential ligand with binding site 1 (the high affinity neurotensin binding site), binding site 2 (the low affinity neurotensin binding site), binding site 3 (pro-neurotrophin binding site of Sortilin);
e. incorporating said potential ligand compound in a binding assay of said receptor sortilin and
f. determining whether said potential ligand can compete with an endogenous or exogenous ligand selected from the group consisting of, but not limited to, amino acid residues 19 to 241 of SEQ ID NO 6 (proNGF), amino acid residues 19 to 121 of SEQ ID NO 6 (NGF pro domain), amino acid residues 19 to 246 of SEQ ID NO 7 (proBDNF), amino acid residues 19 to 127 of SEQ ID NO 7 (BDNF pro domain), amino acid residues 17 to 257 of SEQ ID NO 8 (proNT3), amino acid residues 17 to 140 of SEQ ID NO 8 (NT3 pro domain), amino acid residues 25 to 210 of SEQ ID NO 9 (proNT4/5), amino acid residues 25 to 80 of SEQ ID NO 9 (NT4/5 pro domain), SEQ ID NO. 10 (Neurotensin), SEQ ID NO. 11 (PYIL), amino acid residues 11 to 13 of SEQ ID NO. 10 (YIL) and SEQ ID NO. 12 (NT69L).

In a further embodiment of the present invention the information derived from the atomic coordinates of at least one of the following amino acid residues of binding site 1: R325, S316, Y351, I353, K260, I327, F314, F350 to M363, S305, F306, T398 to G400, I303-G309, Q349-A356, Y395 and T402 of SEQ ID NO. 1 are used.

In a further embodiment of the present invention the information derived from the atomic coordinates of at least one of the following amino acid residues of binding site 2: L572, L114, V112, R109 to S111, S115 to G118, T570, G571, W586, W597, T168-I174, L572, A573 and S584 to F588 of SEQ ID NO. 1 are used for ligand prediction and/or design.

In a further embodiment of the present invention information derived from the atomic coordinates of at least one of the following amino acid residues of binding site 3: D403, S420, D422, N423, S424, I425, Q426, T451, Y466, Q470, I498, S499 and V500 of SEQ ID NO. 1 are used.

In a further embodiment of the present invention the data criteria set or binding interaction set comprise at least 3 amino acid residues selected from the identified groups.

In a further embodiment of the present invention the atomic coordinates are determined to a resolution of at least 5 Å.

In a further embodiment of the present invention the atomic coordinates are determined to a resolution of at least 4 Å.

In a further embodiment of the present invention the atomic coordinates are determined to a resolution of at least 3 Å.

In a further embodiment of the present invention the atomic coordinates are determined to a resolution of at least 2 Å.

In a further embodiment of the present invention the atomic coordinates are determined to a resolution of at least 1.5 Å.

In a further embodiment of the present invention the potential ligand molecule interacts with at least amino acids in the high affinity Neurotensin binding site of SEQ ID NO. 1.

In a further embodiment of the present invention the potential ligand molecule interacts with at least amino acids in the low affinity Neurotensin binding site of SEQ ID NO. 1.

In a further embodiment of the present invention the potential ligand molecule interacts with at least amino acids in the Sortilin propeptide binding site of SEQ ID NO. 1.

In a further embodiment of the present invention the potential ligand molecule interacts with at least amino acids in the pro-neurotrophin binding site of SEQ ID NO. 1.

In a further embodiment of the present invention the potential ligand is selected from the group consisting of non-hydrolyzable peptides and peptide analogues, organic compounds and inorganic compounds.

In a further embodiment of the present invention a library of small organic molecules are screened.

In a further embodiment of the present invention a library of potential peptide ligands are screened.

In a further aspect the present invention relates to a ligand identified by the method described herein above, said ligand capable of binding to at least one interaction point of said binding site 1, said interaction points comprising X₁, X₂, X₃, X₄, R₁, R₂, J₁, J₂ and J₃ of FIG. 14 wherein

X₁ comprises the amino acid residues R325, S316 and Y351 of SEQ ID NO. 1, and wherein
X₂ comprises the backbone carbonyl of Y351 and wherein
X₃ comprises the backbone of 1353 and wherein
X₄ comprises the amino group of K260 and wherein
R₁ comprises amino acid residues I327, F314, Y351, I353 and M363 and wherein
R₂ comprises F350 and at least one amino acid from the loop comprising amino acid residues T397 to E401 and wherein
J₁ comprises S305 and wherein
J₂ comprises the backbone amide of F306 and wherein
J₃ comprises the backbone carbonyl of F306.

In a further embodiment of the present invention interaction point X₁ comprises a negative charge and/or hydrogen acceptor properties said negative charge and/or hydrogen acceptor properties selected from the group consisting of carboxylate, sulfonic acid, di-fluoro said difluoro lacking a negative charge to compensate the positive charge of the Arginine, di-chloro said di-chloro lacking a negative charge to compensate the positive charge of the Arginine.

In a further embodiment of the present invention the ligand as defined herein above comprises at interaction point X₂ a hydrogen bond donor selected from the group consisting of hydroxyl, amino and amido.

In a further embodiment of the present invention the ligand as defined herein above comprises at interaction point X₃ comprises a hydrogen bond acceptor selected from the group consisting of carbonyl, chloro and fluoro.

In a further embodiment of the present invention the ligand as defined herein above comprises at interaction point R₁ a bulky hydrophobic group selected from th group consisting of cyclohexyl-alanine, leucine, isoleucine methionine and phenylalanine.

In a further embodiment of the present invention the ligand as defined herein above comprises at interaction point R₂ a hydrophobic amino acid residue selected from the group consisting of isoleucine, leucine, cysteine, or a partially hydrophobic group selected from the group consisting of histidine, glutamine, lysine, arginine and glutamate.

In a further embodiment of the present invention the molecular imaging ligand is selected from the group consisting of RRPYI (chg), iodoYIL, QIL, YCL, dYIL, YHL, RRPYI (acc), RRPYI (nMe)L, YIL depicted in FIG. 26.

In one aspect, the present invention relates to use of a ligand identified as described herein, said ligand igand having the general structure of formula (I):

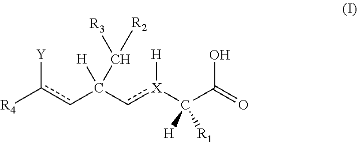

wherein X is an atom acting as hydrogen donor said atom selected from the group consisting of N, O, S, P and wherein
Y is an electronegative atom acting as hydrogen bond acceptor selected from the group consisting of O, N, S, F, Cl, Br, I, and wherein
R₁ is C3-6 alkyl, C4-6 cyclyl, a heterocyclic or a heteroaromatic structure having one ring, 4 to 6 ring members in each and 1 to 3 heteroatoms, or a heteroalkyl comprising 1 to 3 heteroatoms selected from the group consisting of N, O, S(O)₀₋₂, and wherein
R₂ is a hydrogen, a C1-12 alkyl or an aromatic, a carbocyclic, a heterocyclic or a heteroaromatic structure having 1-3 rings, 3-8 ring members in each and 0 to 4 heteroatoms, or a heteroalkyl comprising 1 to 8 heteroatoms selected from the group consisting of N, O, S(O)₀₋₂, and wherein
R₃ is hydrogen, SH, imidazole, C1-12 alkyl or an aromatic, a carbocyclic, a heterocyclic or a heteroaromatic structure having 1-3 rings, 3-8 ring members in each and 0 to 4 heteroatoms, or a heteroalkyl comprising 1 to 8 heteroatoms selected from the group consisting of N, O, S, and wherein
R₄ is selected from the functional groups C1-100 linear or branched alkyl, linear or branched alkenyl, linear or branched alkynyl, phenyl, benzyl, haloalkane, chloroalkane, bromoalkane, iodoalkane, haloformyl, hydroxyl, carbonyl, aldehyde, carbonate ester, carboxylate, carboxyl, ether, ester, hydroperoxy, peroxy, carboxamide, primary amine, secondary amine, tertiary amine, ammonium, primary ketimine, secondary ketimine, primary aldimine, secondary aldimine, imide, azide, azo (diimide), cyanate, isocyanide, isothiocyanate, nitrate, nitrile, nitrosooxy, nitro, nitroso, priidyl, phosphino, phosphate, phosphono, sulfonyl, sulfinyl, sulfhydryl (SH), thiocyanate, disulfide, a linker L2 or L3, and an amino acid sequence being at least 50% identical to SEQ ID NO: 10 or a fragment thereof.

In one aspect, the present invention relates to use of a ligand identified as described herein, for the preparation of a target specific molecular imaging ligand having the general structure of structure of formula (II):

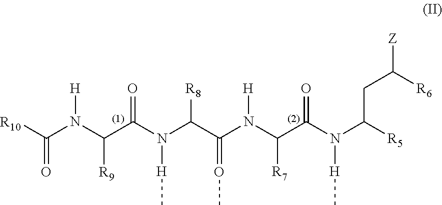

wherein Z is a hydrogen bond donor or acceptor selected from the group consisting of carbonyl, hydroxyl, amino, imino, amide, sulfhydryl, chloro, fluoro, and wherein
R₅ is selected from the group consisting of H, CH₃, and a linker L2, and wherein
R₆ is selected from the group consisting of H, —CH₃, —CH₂CH₃ and —OCH₃, and wherein
R₇ is selected from the group consisting of side chains of glutamate, glutamine, lysine, arginine, histidine, tyrosine, methionine, cysteine, aliphatic C4-6 groups, and wherein
R₈ is selected from the group consisting of side chains of tyrosine, histidine, serine, threonine, aspartate, asparagine, cysteine, phenylalanine, iodo-tyrosine and —CH₂—NH₂, and wherein
R₉ is selected from the group consisting of side chain of lysine, arginine, glutamine, C3-8 aliphatic and heteroaliphatic groups, carbocyclic and heterocyclic groups comprising 5 or 6 membered rings, and wherein
R₁₀ is selected from the group consisting of a pyroglutamate, poly-carbohydrates and a polypeptide of length greater than equal to 10, wherein said polypeptide may be, but is not limited to, Green Fluorescent Protein (GFP), and wherein
R₁₁ and R₁₂ individually are selected from the group consisting of H, C1-12 linear or branched alkyl, linear or branched alkenyl, linear or branched alkynyl, phenyl, benzyl, haloalkane, chloroalkane, bromoalkane, iodoalkane, haloformyl, hydroxyl, carbonyl, aldehyde, carbonate ester, carboxylate, carboxyl, ether, ester, hydroperoxy, peroxy, carboxamide, primary amine, secondary amine, tertiary amine, ammonium, primary ketimine, secondary ketimine, primary aldimine, secondary aldimine, imide, azide, azo (diimide), cyanate, isocyanide, isothiocyanate, nitrate, nitrile, nitrosooxy, nitro, nitroso, priidyl, phosphino, phosphate, phosphono, sulfonyl, sulfinyl, sulfhydryl (SH), and wherein
the covalent bonds (1) and (2) individually are selected from the group consisting of single bonds and double bonds.

In one aspect, the present invention relates to use of a ligand identified as described herein, for the preparation of a target specific molecular imaging ligand having the general structure of structure of formula (III):

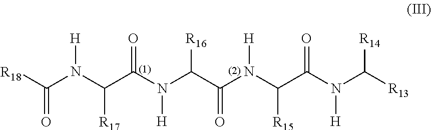

wherein R₁₃ is selected from the group consisting of H, C1-12 alkyl, alkenyl, alkynyl and a linker L3, and wherein
R₁₄, R₁₅, R₁₇, R₁₉, R₂₀ individually are selected from the group consisting of H, C1-12 alkyl, alkenyl and alkynyl, and wherein
R₁₆ is selected from the group consisting of sidechains of phenylalanine, leucine, isoleucine, valine, methionine, histidine, cysteine, lysine and aliphatic C3-7, and wherein
R₁₈ is selected from the group consisting of H, —CH₃ and —CH₂OH, and wherein
the covalent bonds (1) and (2) individually are selected from the group consisting of single bonds and double bonds.

### Antibodies

An antibody binds tightly to a particular target molecule, thereby either inactivating it directly or marking it for destruction. The antibody recognizes its target (antigen) with remarkable specificity and strength dictated by the sum of many chemical forces, including hydrogen bonds, hydrophobic and van der Waal's forces, as well as ionic interactions. In general, the more complex the target is chemically, the more immunogenic it will be. The antigenic determinant may encompass short linear amino acid stretches or a more complicated, three-dimensional protein module.

Conceptually, antibodies directed against a target receptor such as Sortilin may be used as for molecular imaging if linked to a probe suited for the imaging method of choice.

Antibodies are unlikely to be able to access the Neurotensin binding sites 1 and 2, due to their bulky structure of the antibodies and the pocket like nature of these binding sites. However, the major pro-neurotrophin binding site (binding site 3) is readily accessible to antibodies of the invention.

Accordingly, in one important aspect of the present invention an antibody-coupled molecular imaging probe according to the invention is provided, said antibody capable of binding specifically to binding site 3 of SEQ ID NO. 1.

In one embodiment of the present invention the antibody as described herein above is selected from the group consisting of: polyclonal antibodies, monoclonal antibodies, humanised antibodies, single chain antibodies, recombinant antibodies.

In a further aspect the present invention relates to an immunoconjugate comprising an antibody as described herein above and a conjugate selected from the group consisting of: a cytotoxic agent such as a chemotherapeutic agent, a toxin, or a radioactive isotope; a member of a specific binding pair, such as avidin or streptavidin or an antigen; an enzyme capable of producing a detectable product.

### Imaging Technology

Development of molecular imaging targets for specific disease states involving Vps10p-domain receptors can be performed without regards to downstream label or contrast agent for imaging technology. Modalities differ with respect to spatial resolution and sensitivity, which are usually exclusive. Suitability of an imaging modality for molecular imaging is judged oil the criteria of spatial resolution, anatomical coverage, reproducibility, potential for quantification, support of image-guided drug delivery and, finally, the ability to image molecular targets.

Computer Tomography (CT) has good spatial resolution. However, there are limitations in imaging with the use of contrast agents and in assessing molecular information. CT scanning exposes the subject to ionizing radiation. The high spatial resolution maltes x-ray-based imaging important for hybrid systems such as PET-CT (see below).

Ultrasound has a wide range of applications but is restricted to anatomical regions that are closer to a surface which is accessible to the ultrasound probe. Ultrasound does allow the use of microbubbles as a contrast agent and other ultrasound contrast agents have recently been developed that allow imaging of smaller molecular targets.

Magnetic Resonance (MR) can visualize anatomy with good spatial resolution, is applicable to all body regions and will allow reproducible and quantitative imaging. It can also be used for intravascular and needle image-guided drug delivery, but not for a broad range of drugs due to safety aspects. MR call partly assess molecular information, for example through spectroscopy, but is limited by sensitivity. However, highly sensitive contrast agents have recently been used to allow imaging of molecular targets and gene expression. Since MR allows reproducible quantitative imaging without radiation it has significant potential for molecular imaging, Magnetic Resonance Spectroscopy (MRS) is also available as a method of evaluation of molecular content of tissues. This approach has significant advantages in that no target specific reagent needs to be administered in that molecular discrimination is achieved using specific pulse sequences. The potential drawback of this approach is the technical challenge associated with development and implementation of molecular specific pulses and sequences.

Nuclear Imaging, comprising PET and SPECT is a molecular imaging technique with excellent sensitivity and whole-body applications with good reproducibility and quantitation. However, its poor spatial resolution maltes it unsuitable for image-guided drug delivery, and it requires relatively long scan times. Using nuclear imaging with radiopharmaceutical agents enables drug tracing, including the study of pharmacolcinetics in vivo.

PET requires isotopes which are generally short lived and thus a cyclotron needs to be within 2 hours of the scanning site. The advantage of this is a short period of exposure to ionizing radiation. PET is more sensitive than SPECT. SPECT tracers are 99Tc or 201 T1, SPECT is several-fold inferior to PET with respect to sensitivity and special resolution. Mobile PET units are being developed. There are about 200 PET centers in the US. PETICT combinations are replacing PET alone.

PETICT combined scanning allows anatomical and molecular information to be collected on the same piece of equipment which helps combine sensitivity to specific cells or inolecules with anatomical information.

Optical Imaging is a relatively new imaging technique that, because of its lower penetration depth, is currently limited to endoscopic and microscopic applications in humans and animals. Optical imaging may eventually be used to retrieve information from deeper areas. Potential is seen in screening applications where only a yes|no answer is required rather than spatially resolved information. There are a number of specific optical approaches:

DOT—Diffuse Optical Tomography, which can penetrate several centimetres.

### OCT—Optical Coherence Tomography

### CSLM—Confocal Laser Scanning Microscopy

### FCM—Fluorescence Correlation Microscopy

### FRET—Fluorescence Resonance Energy Transfer

### FLIM—Fluorescence Lifetime Imaging

In general, these imaging approaches can be assessed with respect to anatomical resolution, sensitivity, amount of probe needed, difficulty of designing, producing and labelling probe, costs, imaging depth and availability. Some of these features are examined in Table 1. The particular technology selected may differ for specific clinical indications.

### Diagnostic and Monitoring Assays

The affinity reagents|agents of the invention have various utilities, including use as diagnostic and monitoring assays for proteins of the invention, e.g., detecting their expression in specific cells, tissues, or serum.

For example, antibodies may be used in diagnostic and monitoring assays for the proteins of the invention, e.g,, detecting their expression in specific cells, tissues, or serum. Various diagnostic assay techniques known in the art may be used, such as competitive binding assays, direct or indirect sandwich assays and immunoprecipitation assays conducted in either heterogeneous or homogeneous phases (Zola, Monoclonal Antibodies: A Manual of Techniques, CRC Press, Inc. (1987) pp. 147-1583). The antibodies used in the diagnostic and monitoring assays can be labelled with a detectable moiety. The detectable moiety should be capable of producing, either directly or indirectly, a detectable signal. For example, the detectable moiety may be a radioisotope, such as ³H, ¹⁴C, ³²P, ³⁵S or ¹²⁵I, a fluorescent or chemiluminescent compound, such as fluorescein isothiocyanate, rhodamine, or luciferin, or an enzyme, such as alkaline phosphatase, beta-galactosidase or horseradish peroxidase. Any method known in the art for conjugating the antibody to the detectable moiety may be employed, including those methods described by Hunter et al., Nature, 144:945 (1962); David et al., Biochemistry, 13:1014 (1974); Pain et al., J. Immunol. Meth., 40:219 (1981); and Nygren, J. Histochern. and Cytochem., 30:407 (1982).

The diagnostic and monitoring assays can be utilized to diagnose and/or monitor cancer, heart disease, hematopoietic stein cell transplantation, neurologic disease, autoimmune and chronic inflammatory disease, gynecologic disease and infectious disease. “Diagnosing” can include detection of any type of activity or progression of a disease, for example, determination of whether the disease is present, identifying the stage of the disease, monitoring the response of the disease to therapy, etc. The term “monitoring” is used herein to describe the use of an affinity agent to provide useful information about an individual or an individual's health or disease status. Monitoring can include, determination of prognosis, risk-stratification, selection of drug therapy, assessment of ongoing drug therapy, prediction of outcomes, determining response to therapy, diagnosis of a disease or disease complication, following progression of a disease or providing any information relating to a patient's health status over time, selecting patients most likely to benefit from experimental therapies with known molecular mechanisms of action, selecting patients most likely to benefit from approved drugs with known molecular mechanisms where that mechanism may be important in a small subset of a disease for which the medication may not have a label, screening a patient population to help decide on a more invasive/expensive test, for example, a cascade of tests from a non-invasive blood test to a more invasive option such as biopsy, or testing to assess side effects of drugs used to treat another indication.

Such diagnostic and monitoring assays can be in the form of a kit. The kit may include reagents for performing the diagnostic assay.

Development of Imaging Reagent from Target Specific Reagents

Once an sortilin specific affinity reagent (e.g., an antibody or a peptide or a small organic molecule) is available for a molecular imaging target, imaging contrast or signal emitting source is incorporated into the reagent.

For development of imaging reagents for nuclear techniques (PET and SPECT) an isotope which emits particles is incorporated into or attached to the reagent. For PET, isotopes that emit positrons which collide with electrons to produce two gamma rays. These gamma rays are then detected to generate a signal. Positrons are emitted by ¹⁵O, ¹¹C, ¹³N and ¹⁸F which are the most commonly used isotopes. Also of potential use are ¹⁴O, ⁶⁴Cu, ⁶²Cu, ¹²⁴I, ⁷⁶Br, ⁸²Rb and ⁶⁸Ga. These isotopes are produced in a cyclotron and available in radiopharmacies. These isotopes can often be substitute for naturally occurring atoms in affinity reagents. Isotopes that emit gamma rays directly (e.g., ⁹⁹Tc, ¹¹In, ¹²³I, ¹³¹I) are used for SPECT imaging.

Methods for development of signal emitting reagents for nuclear imaging (PET and SPECT) are well established. Radiolabeling can be achieved by direct labeling (incorporation of label materials into molecules) or chelation of a label. Radiopeptides have been used for tumor imaging with some success. Octreotide has also been labeled with techniciuin and is used for tumor imaging (Octreoscan, Mid-South Imaging, Memphis), Introduction of label into a molecule may affect biological or binding properties markedly. These properties must be reassessed after labelling. This may be done in a high throughput manner using cell or tissue preps in 96 or 384 well plates.

Radiolabeled molecules must also be tested in animals before human testing. This will help assess toxicity and tissue distribution and clearance. Clearance of radiopeptides by the kidneys is a key issue which needs improvement. Examples of common methods used to incorporate labels into affinity reagents for PET and SPECT imaging are found in Cumming and Gjedde 1998, Lucignani and Frost 2000, Wagner et al. 1983, Coenen et al. 1987, Kung et al. 1990, Crouzel et al. 1988, Virgolini 2000, Oriuchi and Yang 2001, Lovqvist et al. 2001, Kim 2001.

For MRI scanning, the most common approaches currently in use include the incorporation or labeling of the affinity reagent with Gadolinium or Supermagnetic Iron Oxide containing compounds. These molecules alter local magnetic resonance characteristics which creates a local signal contrast in the area of reagent accumulation. One strategy involves the use of a biotinylated antibody followed by the administration of Gadolinium complexes (e.g., with liopsomes) which are linked to Avidin (Artemov et al. 2003). Another strategy involves the use of enzyme mediated polymerization of paramagnetic substrates into oligomers of higher relaxivity (Weissleder et al. 2002).

One can develop reagents which activate with binding (Bogdanov et al., 2002). Also one can develop high relaxivity contrast agents (Artemov et al., 2003, Weissleder et al., 2001, Bogdanov et al., 2002). Other magnetic resonance signal amplification probe technologies are available which utilize receptor mediated internalization or enzyme mediated signal amplification. Additional methods for conjugation of iron oxide or Gadolinium compounds to affinity probes are found in Remson et al. 1996, Kang et al. 2002 and Zhao et al. 2001, Flacke et al. 2001, Li et al. 2002, Siplcins et al. 1998, Sipltins et al. 2000, Weissleder 1991, Artemov et al. 2003, Storrs et al. 1995.

Scanning using the selected imaging technology using 384 well plates of potential reagent combinations to determine binding characteristics and labeling efficiency may be utilized as a direct approach to evaluation of potential reagents, Tissue or cell arrays can be used to screen reagent combinations. Clonal cell line expressing target on surface in high throughput format could also be used. Animal testing with scanning is used when appropriate models exist. This can be done in vivo or explanted tumor tissue or other explanted tissues may be used to determine binding characteristics. Standard immunohistochemistry or immunofluorescence an be used to test the binding, sensitivity and cell type specificity of the reagent and label omb bin at ion (Brown et al., 1990; Abbondanzo et al., 1990; Allred et al., 1990, and Sambrook et al. 1989). This can be performed using human tissue specimens or animal model tissue specimens in the case of animal reagents.

In any case, the imaging reagent needs to be produced with materials which provide contrast or can be linked with contrast materials after production. Probes should be biocompatible, lack interference with biological function, generate high signal output and signal-to-noise. PET and SPECT tracers are easier to develop because of need for low concentrations and ease of labeling.

“Multiplex imaging” may prove to be clinically useful. Such an approach could be used to image more than one molecule in a single scan. It could be done in such a way that the more than one target both contribute signal, but are not resolvable (“one color”) or may be done using contrast or signal emitting reagents that allow the >I targets to be distinguished in the image (“two color”). Simultaneous imaging of multiple markers may be useful to overcome variability in the population (e.g., some tumors express one marker and others express another marker). This approach could also provide a means to provide additional contrast by specifically imaging both the diseased and control tissues. Perhaps also this approach would add to the information value of an imaging protocol. For example, one could image 2 or 3 marlters of tumor progression and the worst prognosis would be associated with the presence of more marlters or more advanced markers in the process. PET can only measure two targets by injecting and imaging one and then performing a second injection and scan for the second target after the signal from the first has faded. SPECT can image more than one target in a single scan. Other combinations of technologies may be used to measure more than one target simultaneously (combine MRI, CT, Nuclear, Optical).

Accordingly, in one embodiment the present invention relates to a target specific imaging reagent, comprising an affinity agent coupled to an imaging agent, wherein said affinity agent specifically binds to a Vps10p-domain receptor.

In an important embodiment of the present invention the target specific imaging reagent as defined herein above binds to Sortilin.

In another embodiment of the present invention the target specific imaging reagent as defined herein above binds to SorLA.

In another embodiment of the present invention the target specific imaging reagent as defined herein above binds to SorCS1.

In another embodiment of the present invention the target specific imaging reagent as defined herein above binds to SorCS2.

In another embodiment of the present invention the target specific imaging reagent as defined herein above binds to SorCS3.

In another embodiment, the target specific imaging reagent as defined herein above binds to at least one amino acid residue of binding site 1 comprising amino acid residues R325, S316, Y351, I353, K260, I327, F314, F350 to M363, S305, F306, T398 to G400, I303-G309, Q349-A356, Y395 and T402 of SEQ ID NO. 1.

In another embodiment, the target specific imaging reagent as defined herein above binds to at least one amino acid residue of binding site 1 comprising amino acid residues R325, S316, Y351, I353, K260, I327, F314, F350 to M363, S305, F306 and T398 to G400 of SEQ ID NO. 1.

In another embodiment, the target specific imaging reagent as defined herein above binds to at least one amino acid residue of binding site 1 comprising amino acid residues R325, S316, Y351, I353, K260, I327, F314 and F350 to M363 of SEQ ID NO. 1.

In another embodiment, the target specific imaging reagent as defined herein above binds to at least one amino acid residue of binding site 2 comprising amino acid residues L572, L114, V112, R109 to S111, S115 to G118, T570, G571, W586, W597, T168-I174, L572, A573 and S584 to F588 of SEQ ID NO. 1.

In another embodiment, the target specific imaging reagent as defined herein above binds to at least one amino acid residue of The crystal according to claim 1 wherein the at least one ligand is present in binding site 2 (low affinity neurotensin binding site and sortilin propeptide binding site) comprising amino acid residues L572, L114, V112, R109 to S111, S115 to G118, T570, G571, W586 and W597 of SEQ ID NO. 1.

In another embodiment, the target specific imaging reagent as defined herein above binds to at least one amino acid residue of binding site 2 comprising amino acid residues L572, L114 and V112 of SEQ ID NO. 1.

In another embodiment, the target specific imaging reagent as defined herein above binds to at least one amino acid residue of binding site 3 comprising amino acid residues D403, S420, D422, N423, S424, I425, Q426, T451, Y466, Q470, I498, S499 and V500 of SEQ ID NO. 1.

In another embodiment, the target specific imaging reagent as defined herein above binds to at least one amino acid residue of binding site 3 comprising amino acid residues D403, N423, S424, I425, T451, Y466, I498 and V500 of SEQ ID NO. 1.

In another embodiment, the target specific imaging reagent as defined herein above binds to at least one amino acid residue of binding site 3 comprising amino acid residues T451, Y466, I498 and V500 of SEQ ID NO. 1.

In one embodiment of the present invention the target specific imaging reagent is detectable by at least one of the technologies selected from the group consisting of: computer tomography, ultrasound, magnetic resonance, nuclear imaging, and optical imaging.

In one embodiment of the present invention the method for detecting the target specific imaging reagent is selected from the group consisting of diffuse optical tomography, optical coherence tomography, confocal laser scanning, microscopy, electron microscopy, fluorescence correlation microscopy, fluorescence resonance energy transfer, and fluorescence lifetime imaging.

In one embodiment of said nuclear imaging is selected from the group consisting of PET and SPECT.

In one embodiment of the present invention the affinity agent of the target specific imaging reagent as defined herein above is selected from the group consisting of antibodies, small molecules, and peptides.

In one embodiment of the present invention the affinity agent is an antibody coupled to an imaging agent, said antibody being capable of binding to binding site 1 of SEQ ID NO. 1.

In one embodiment of the present invention the affinity agent is an antibody coupled to an imaging agent, said antibody being capable of binding to binding site 2 of SEQ ID NO. 1.

In one embodiment of the present invention the affinity agent is an antibody coupled to an imaging agent, said antibody being capable of binding to binding site 3 of SEQ ID NO. 1.

In one embodiment the antibody as defined herein above is selected from the group consisting of: polyclonal antibodies, monoclonal antibodies, humanised antibodies, single chain antibodies, recombinant antibodies.

In one aspect the present invention relates to an immunoconjugate comprising the antibody as defined herein above and a detectable conjugate comprising a radioactive isotope and/or an enzyme capable of producing a detectable product.

In an important embodiment the present invention relates to a method of diagnosing or monitoring a disease or disease state comprising the steps of:
a) administering to a mammal the target-specific imaging reagent as defined herein above,
b) imaging said mammal, and diagnosing or monitoring said disease or disease state.

In one embodiment of the present invention, the mammal as described herein above is an animal or a human.

In another embodiment of the present invention the imaging is conducted using at least one of the technologies selected from the group consisting of: computer tomography, ultrasound, magnetic resonance, nuclear imaging, and optical imaging.

In a further embodiment of the present invention the optical imaging as defined herein above is selected from the group comprising diffuse optical tomography, optical coherence tomography, confocal laser scanning microscopy, fluorescence correlation microscopy, fluorescence resonance energy transfer, and fluorescence lifetime imaging.

In further embodiment the present invention comprises a diagnostic assay comprising the target specific imaging reagent as defined herein above.

In further embodiment the present invention comprises a kit comprising the diagnostic assay as defined herein above.

### Clinical Validation of Imaging Reagents

For any given molecular imaging reagent, clinical utility and efficacy in humans is demonstrated for specific clinical indications to provide support for the position that the test will have an impact on clinical practice. After appropriate safety studies have been performed in primates and then human subjects, patients with the target disease process (or suspected to have it) are recruited along with appropriate control subjects. The performance of the molecular imaging test with respect to disease diagnosis or prognosis is then assessed. The assessment of performance may be related to a gold standard based on the pathological diagnosis of the disease status or other standards such as endoscopic evaluation, other imaging approaches or diagnostic testing. Alternatively or in addition, the test is assessed with respect to its ability to identify patients at risk for events, complications, outcomes or mortality related to the disease process (prognosis). The test may also be shown to identify patients with an increased or decreased responsiveness to therapy (therapy broadly or specific medications). Alternatively, testing can be shown to monitor response to therapy. Various clinical utilities of molecular imaging approaches are discussed and exemplified below in the section on clinical indications for molecular testing.

### Disease, Disorder or Damage of the Nervous System

The brain and spinal cord are difficult to biopsy to make a tissue diagnosis of disease. This is due to accessibility and risk of complications from damage to the or gan. At the same time, there are a number of neurologic diseases involving specific regions of the brain. In each case, it is extremely difficult to diagnose disease prior to significant neurologic dysfunction. Detection of disease at an earlier stage may allow intervention with medical or other therapies which slows progression of disease prior to significant damage.

Alzheimer's disease is characterized by the formation of amyloid plaques in the brain. There is a characteristic distribution in the frontal lobes. Definitive diagnosis at an early stage is not possible as findings of dementia are not specific and numerous alternative causes must be considered. Even when these have been ruled out, Alzheimer's disease is a diagnosis of exclusion and can only be definitively diagnosed at autopsy. A specific molecular probe would be valuable to make a definitive early diagnosis which would allow early medical therapy. Molecular imaging would also facilitate monitoring of response to therapy. Dojindo Laboratories has developed an MRI reagent for amyloid plaques.

Multiple Sclerosis is an autoimmune disease of the central nervous system characterized by inflammation and demyelination leading to chronic neurologic disability. The disease is often characterized by flares and periods of remission. MRI scanning is used to detect plaques (characteristic lesions). However, once apparent on a standard MRI scan, the disease has already caused irreversible damage to the brain. It would be very useful if one could detect plaque formation at an earlier stage. Molecular imaging contrast or signal emitting reagents specific to features of the plaque could provide additional sensitivity for early disease.

Parkinson's Disease (PD) and Amyotrophic Lateral Sclerosis (ALS) are additional diseases of the nervous system that could benefit from the emergence of specific and sensitive molecular imaging reagents. Earlier diagnosis could facilitate earlier therapy or the validation of new treatments which could slow progression of disease.

Accordingly, in one embodiment the present invention relates to use of the target specific molecular imaging ligand as defined herein above, for the preparation of a diagnostic composition for the diagnosis of a disease, disorder or damage of the central or peripheral nervous system in an individual, wherein said disease, disorder or damage is associated with the biological activity of a Vps10p-domain receptor selected from the group consisting of Sortilin (SEQ ID NO. 1) or a fragment or varaiant thereof, SorLA (SEQ ID NO. 2) or a fragment or varaiant thereof, SorCS1 (SEQ ID NO. 3) or a fragment or varaiant thereof, SorCS2 (SEQ ID NO. 4) or a fragment or varaiant thereof and SorCS3 (SEQ ID NO. 5) or a fragment or varaiant thereof).

In one embodiment the disease or disorder described herein above is selected from the group consisting of a disease, disorder, or damage involving injury to the brain, brain stem, the spinal cord, and/or peripheral nerves.

In a further embodiment of the present invention the injury as defined herein above is due to stroke, traumatic brain injury, spinal cord injury, diffuse axonal injury, and epilepsy.

In a further embodiment of the present invention the nervous system disorder as defined herein above involves degeneration of neurons and their processes in the brain, brain stem, the spinal cord, and/or the peripheral nerves.

In a further embodiment of the present invention the degeneration of neurons as defined herein above is due to Parkinson's Disease, Alzheimer's Disease, senile dementia, Huntington's Disease, amyotrophic lateral sclerosis, and neuronal injury associated with multiple sclerosis.

In a further embodiment of the present invention the neurodegenerative disease as defined herein above is Parkinson' Disease.

In a further embodiment of the present invention the neurodegenerative disease as defined herein above is Huntington's Disease.

In a further embodiment of the present invention the neurodegenerative disease as defined herein above is amyotrophic lateral sclerosis.

In another embodiment of the present invention the nervous system disorder as defined herein above is a disease, disorder, or damage involving dysfunction and/or loss of neurons in the brain, brain stem, the spinal cord, and/or peripheral nerves.

In yet another embodiment of the present invention the disease, disorder, or damage involving dysfunction and/or loss of neurons in the brain, brain stem, the spinal cord, and/or peripheral nerves is selected from the group consisting of conditions caused by metabolic diseases, nutritional deficiency, toxic injury, malignancy, and/or genetic or idiopathic conditions as defined herein above include but is not limited to diabetes, renal dysfunction, alcoholism, chemotherapy, chemical agents, drug abuse, vitamin deficiency, and infection.

In a further embodiment of the present invention the nervous system disorder as defined herein above is a disease, disorder, or damage involving degeneration or sclerosis of glia, wherein said glia is selected from the group consisting of oligodendrocytes, astrocytes and Schwann cells in the brain, brain stem, the spinal cord, and the peripheral nerves.

In a further embodiment of the present invention the disease, disorder, or damage involving degeneration or sclerosis of glia is selected from the group consisting of multiple sclerosis, optic neuritis, cerebral sclerosis, post-infectious encephalomyelitis, and epilepsy.

In a further embodiment of the present invention the disease or disorder is selected from the group consisting of multiple sclerosis, sensory ataxus, neurodegenerative spinocerebellar disorders, hereditary ataxis, cerebellar atrophies, and alcoholism.

In a further embodiment of the present invention the nervous system disorder, disease, or damage involves the retina, photoreceptors, and associated nerves.

In a further embodiment of the present invention the nervous system disorder, disease, or damage involving the retina, photoreceptors, and associated nerves as defined herein above is selected from the group consisting of retinitis pigmentosa, macular degeneration, glaucoma, and diabetic retinopathy.

In a further embodiment of the present invention the nervous system disorder, disease, or damage involves the sensory epithelium and associated ganglia of the vestibuloacoustic complex.

In a further embodiment of the present invention the nervous system disorder, disease, or damage involving the sensory epithelium and associated ganglia of the vestibuloacoustic complex is selected from the group consisting of noise-induced hearing loss, deafness, tinnitus, otitis, labyrintitis, hereditary and cochleovestibular atrophies, and Menieres Disease.

In a further aspect the present invention relates to a method for building an atomic model of a Vps10p-domain receptor protein molecule comprising the steps of:
a. identifying a Vps10p-domain receptor, or a fragment or variant thereof, having at least 20% sequence identity to SEQ ID NO. 1, and
b. utilizing the atomic coordinates as presented in any of FIGS. 17 to 20 or atomic coordinates selected from a three-dimensional structure that deviates from the three-dimensional structure presented in any of FIGS. 17 to 20 by a root mean square deviation over protein backbone atoms of not more than 3 Å,
   to obtain an atomic model of the identified Vps10p-domain receptor by homology modelling.

In one embodiment of the present invention the method for building an atomic model as defined herein above is a method for building an atomic model of a Vps10p-domain receptor selected from the group consisting of SEQ ID NO. 2 (SorLA), SEQ ID NO. 3 (SorCS1), SEQ ID NO. 4 (SorCS2) and SEQ ID NO. 5 (SorCS3) or a fragment or variant thereof.

In a further aspect the present invention relates to a method of identifying a potential target specific molecular imaging ligand of the Vps10p-domain defined herein above, or a fragment or variant thereof said method comprising the steps of
a) introducing into a computer, information derived from atomic coordinates defining a conformation of a binding site having at least 20% sequence identity to 1 and/or binding site 2 and/or binding site 3 of SEQ ID NO. 1 (Sortilin), or a fragment or variant thereof, based on three-dimensional structure determination, whereby a computer program utilizes or displays on the computer screen the structure of said conformation; wherein said atomic coordinates are selected from the three-dimensional structure as presented in any of FIGS. 17 to 20 or atomic coordinates selected from a three-dimensional structure that deviates from any one of the tree-dimensional structure represented by any of FIGS. 17 to 20 by a root mean square deviation over protein backbone atoms of not more than 3 Å;
b) generating a three-dimensional representation of a binding site having at least 20% sequence identity to binding site 1, binding site 2 or binding site 3 of Sortilin, or a fragment or variant thereof, by said computer program on a computer screen;
c) superimposing a model of a potential ligand on the representation of said binding site having at least 20% sequence identity to site 1, binding site 2 or binding site 3 of Sortilin,
d) assessing the possibility of bonding and the absence of steric interference of the potential ligand with the binding site having at least 20% sequence identity to binding site 1, binding site 2 or binding site 3 of Sortilin or a fragment or variant thereof;
e) incorporating said potential ligand compound in a binding assay of said Vps10p-domain receptor and
f) determining whether said potential ligand is capable of binding to said binding site having at least 20% sequence identity to binding site 1 and/or binding site 2 and/or binding site 3 of SEQ ID NO. 1 by performing a biochemical or biophysical competitive binding assay wherein the competing ligand is selected from the group consisting of amino acid residues 19 to 241 of SEQ ID NO 6 (proNGF), amino acid residues 19 to 121 of SEQ ID NO 6 (NGF pro domain), amino acid residues 19 to 246 of SEQ ID NO 7 (proBDNF), amino acid residues 19 to 127 of SEQ ID NO 7 (BDNF pro domain), amino acid residues 17 to 257 of SEQ ID NO 8 (proNT3), amino acid residues 17 to 140 of SEQ ID NO 8 (NT3 pro domain), amino acid residues 25 to 210 of SEQ ID NO 9 (proNT4/5), amino acid residues 25 to 80 of SEQ ID NO 9 (NT4/5 pro domain), SEQ ID NO. 10 (Neurotensin), SEQ ID NO. 11 (PYIL), amino acid residues 11 to 13 of SEQ ID NO. 10 (YIL) and SEQ ID NO. 12 (NT69L) or a fragment or variant of said competing ligand.

### DESCRIPTION OF THE DRAWINGS

FIG. 1: Overview of Sortilin structure

A) Cartoon illustration of sSortilin:NT at 2.6 Å resolution as viewed down the propeller axis from the open side of the tunnel. Individual propeller blades are numbered along the outer rim. NT (Pro10-Tyr-Ile-Leu13) in the high affinity NT binding site (binding site 1) at blade 6 and NT (Leu2-Tyr-Glu-Asn-Lys6) in binding site 2 at blade 1 is shown as stick models. The oligosaccharide moieties of the glycosylation at Asn206, Asn450, and Asn626 are also shown as stick models.

B) View of sSortilin (a) following a 90° rotation around a horizontal axis. The propeller is shown as a surface representation. The hydrophobic loops extending from blades 1 and 10. The 10CC domains is shown as a cartoon representation. 10CC-a is shown at the lower part of the drawing and 10CC-b is shown in the left part of the drawing.

C) Surface representation of the sSortilin:NT complex shown in (a). The dimensions of the tunnel along the dashed lines in the equatorial plane are shown. The dashed line indicates the position of the cross-section shown in d.

D) Cross-section of the propeller with NT shown as sticks. This view is rotated 180° around a vertical axis with respect to the view used in (b).

The dashed line shows the largest dimension in the equatorial plane.

E) Surface representation of sSortilin. All three peptide fragments found in the 2.6 Å Sortilin:NT structure with 15 fold excess of NT as well as glycosylations are shown as sticks. Left: Top view of sSortilin, i.e. same orientation as in C Right: Bottom view of sSortilin i.e. 180° rotation of the top view around a vertical axis.

FIG. 2: Details of Ligand Binding

A) Binding of the N-terminal part of NT to sSortilin as seen in the 2.6 Å structure. Neurotensin residues are overlaid with the 1σ level of the final 2.6 Å 2Fo-Fc electron density map shown as a wire mesh. The dashed lines indicate the positions of hydrogen bonds.

B) Binding of the C-terminal part of NT to sortilin as seen in the 2.0 Å structure. Residues Pro10-Tyr-Ile-Leu13 and the residues of sSortilin forming the binding pocket are shown as sticks. The electron density map contoured at 1σ is the final 3Fo-2Fc map of the 2.0 Å structure.

C) Electron density of the propeptide at propeller binding site 2. The same set of atoms of sSortilin as in panel (a) is superimposed on strand 1 of blade 1 of the sSortilin:propeptide. The 1σ surface of the final 3.2 Å 3Fc-2Fo electron density is shown as a net-representation indicating the position of the bound propeptide.

D) Electron density of the propeptide at propeller the high affinity NT binding site. The same set of atoms of sSortilin as in panel (b) is superimposed on strand 1 of blade 6 of the sSortilin:propeptide. The 1σ surface of the final 3.2 Å 3Fc-2Fo electron density is shown as a net-representation indicating the position of the bound propeptide.

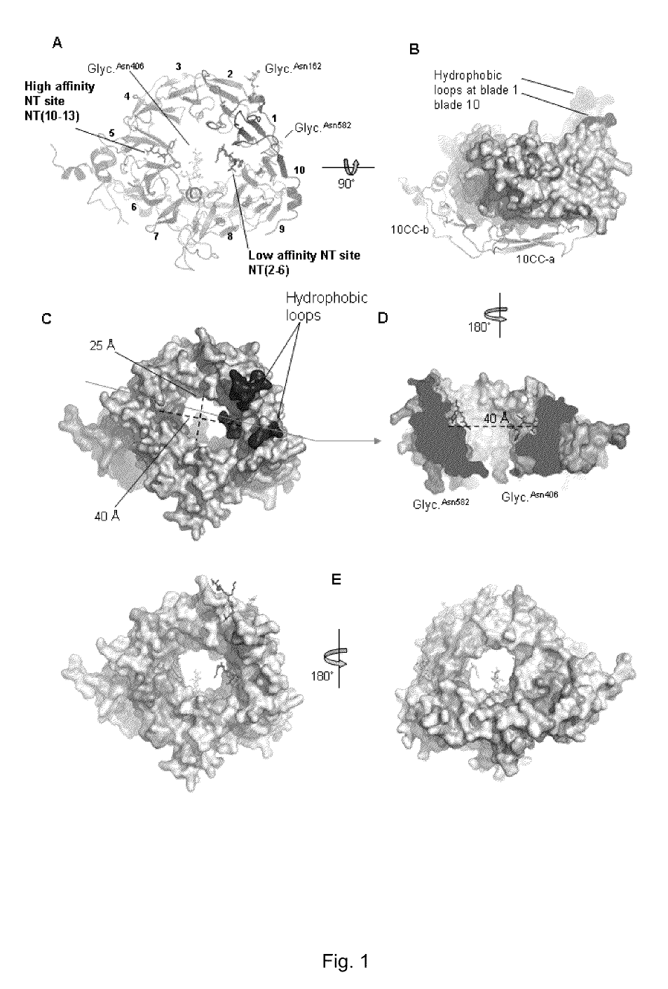

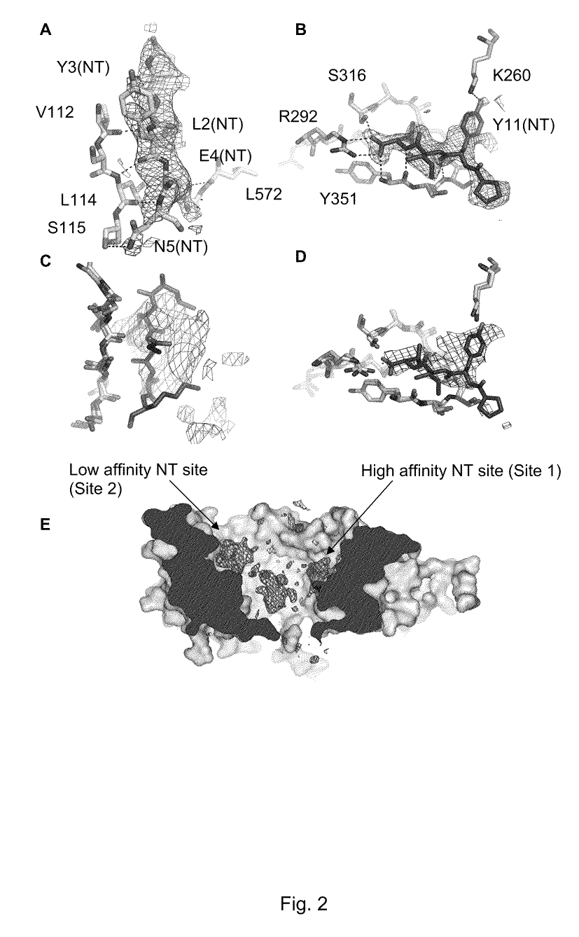

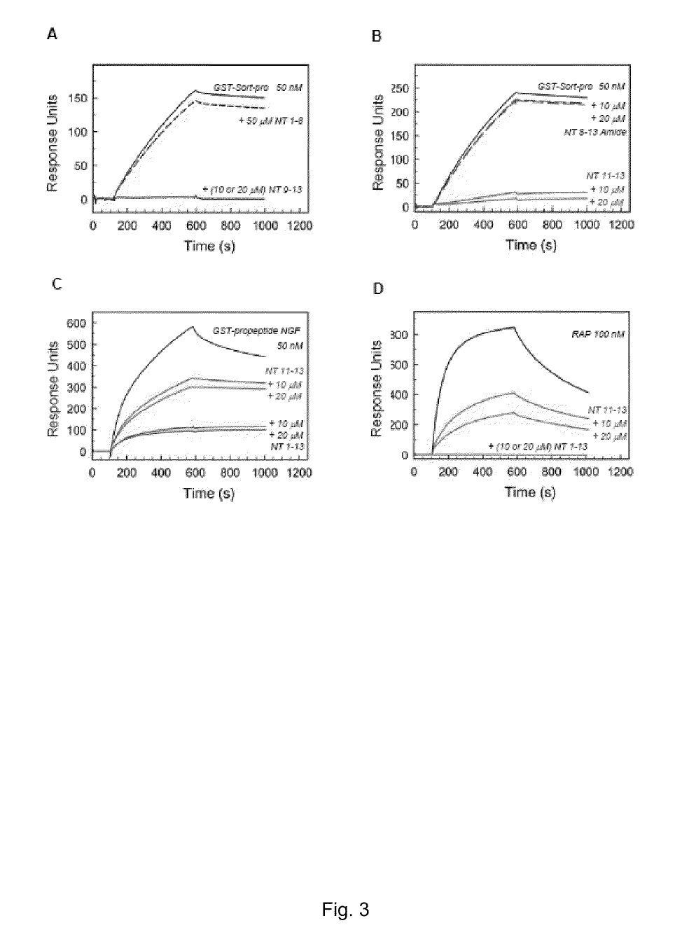

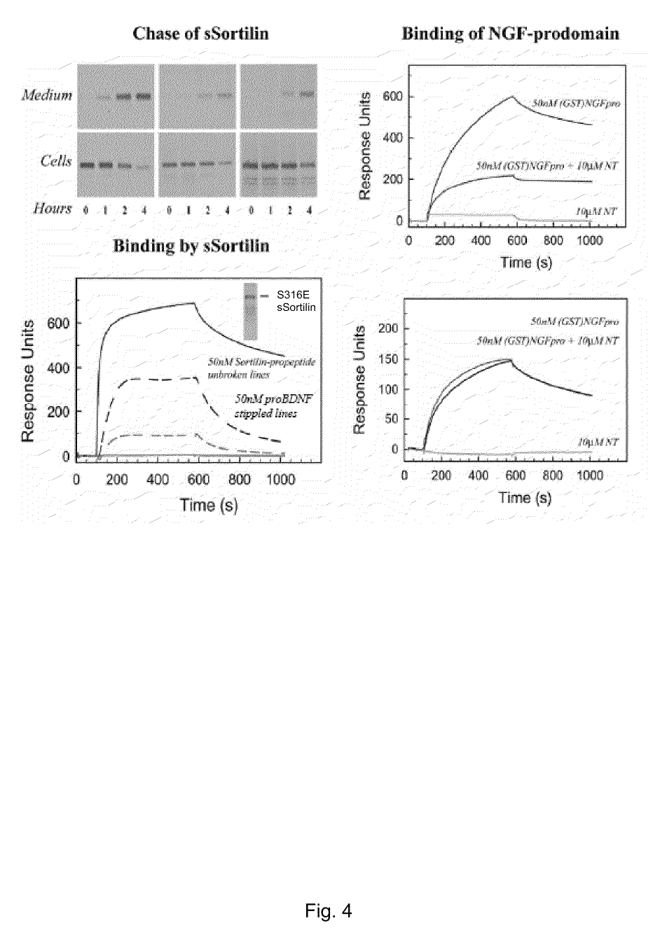

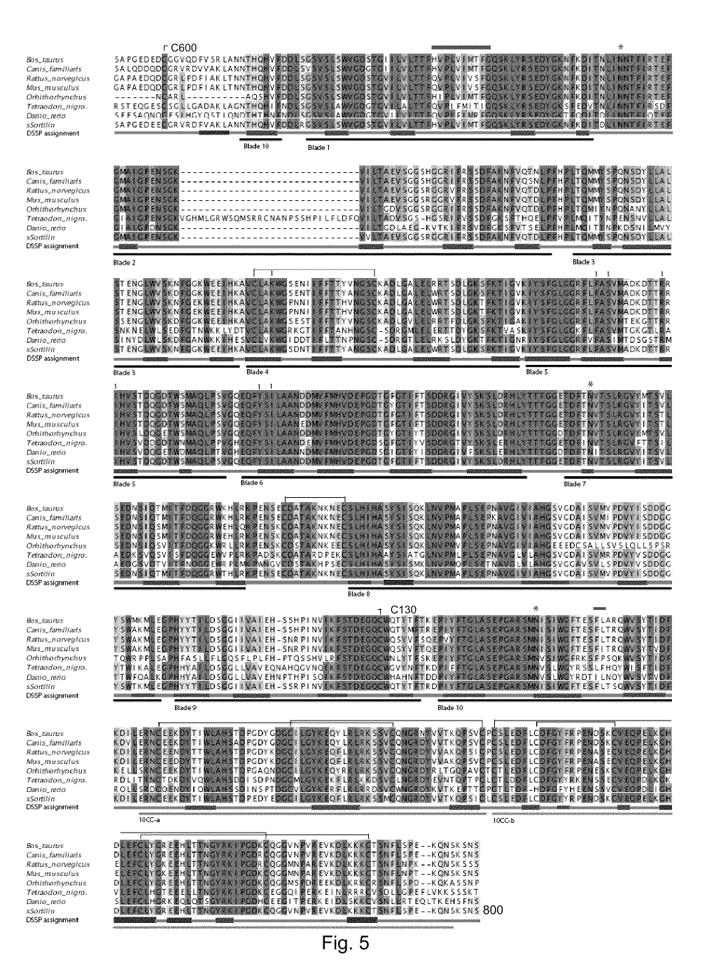

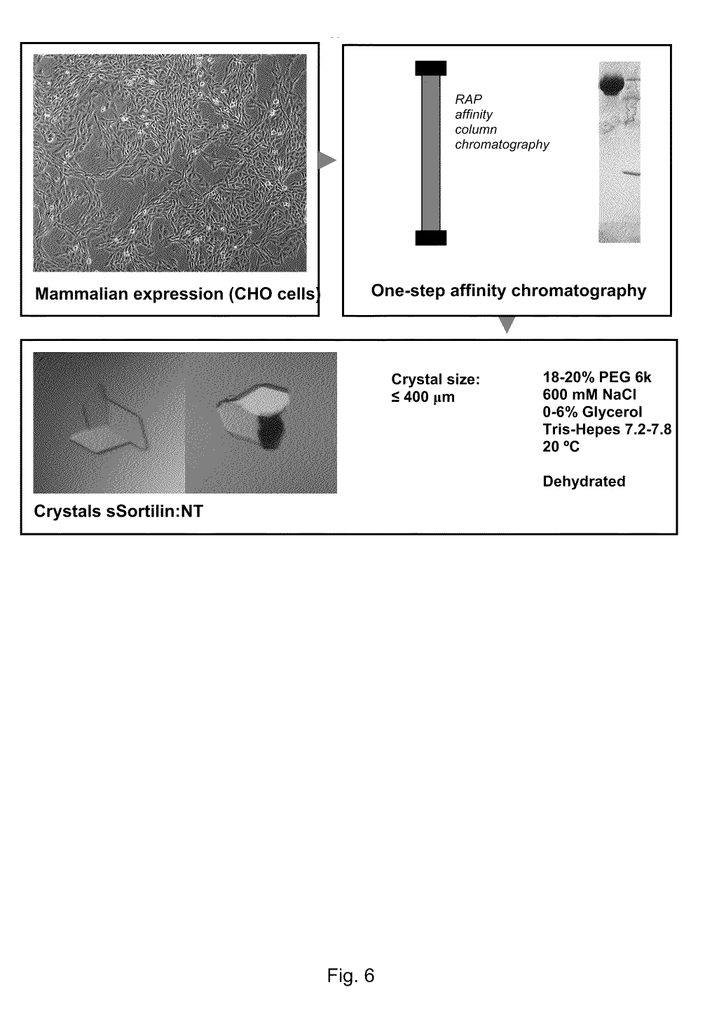

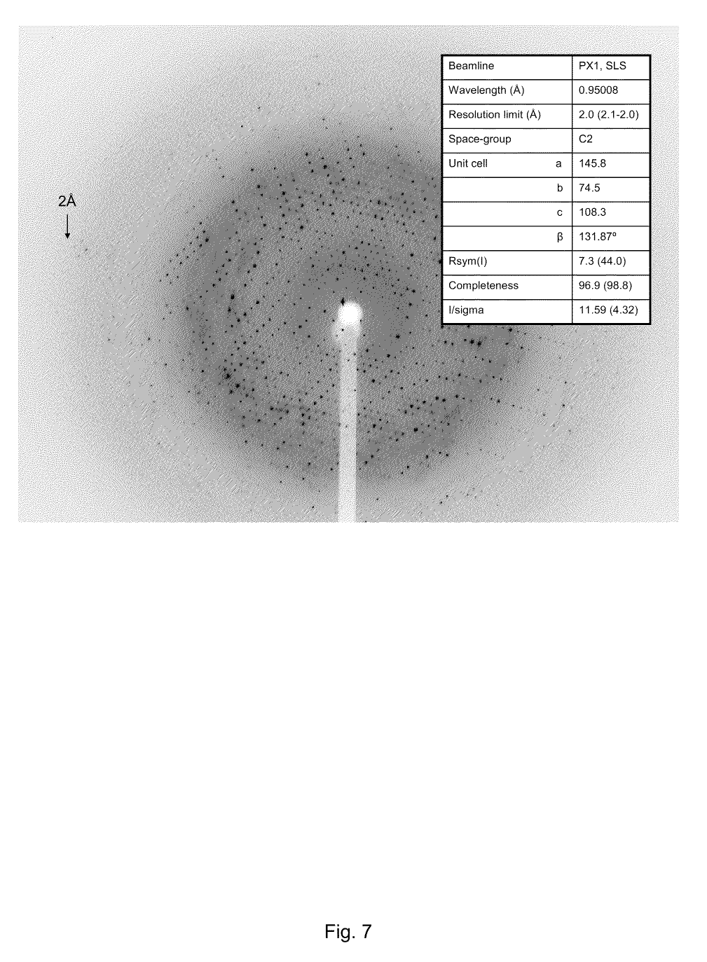

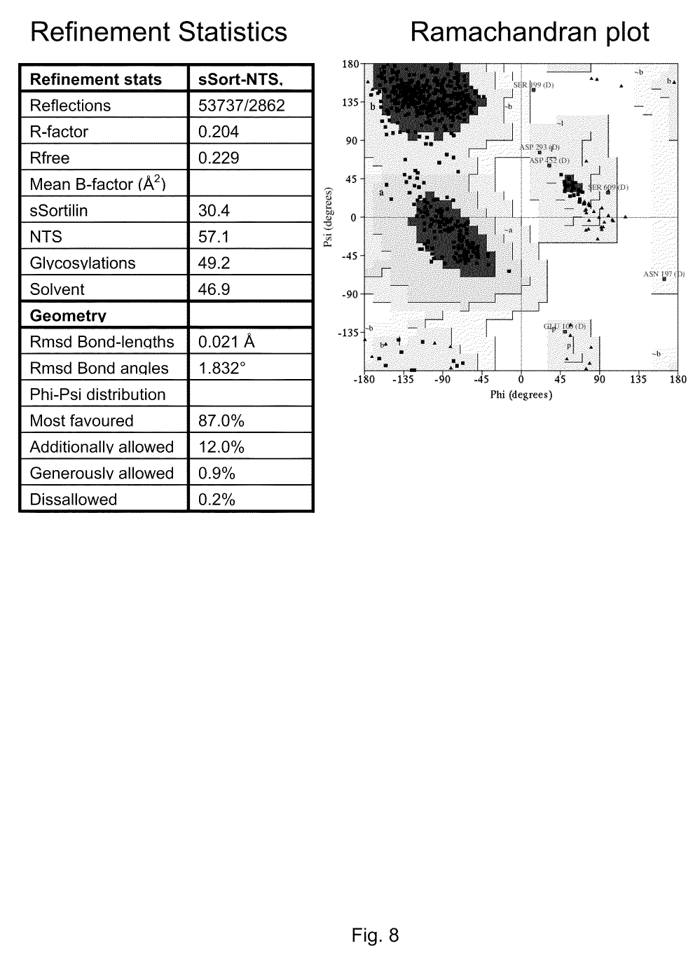

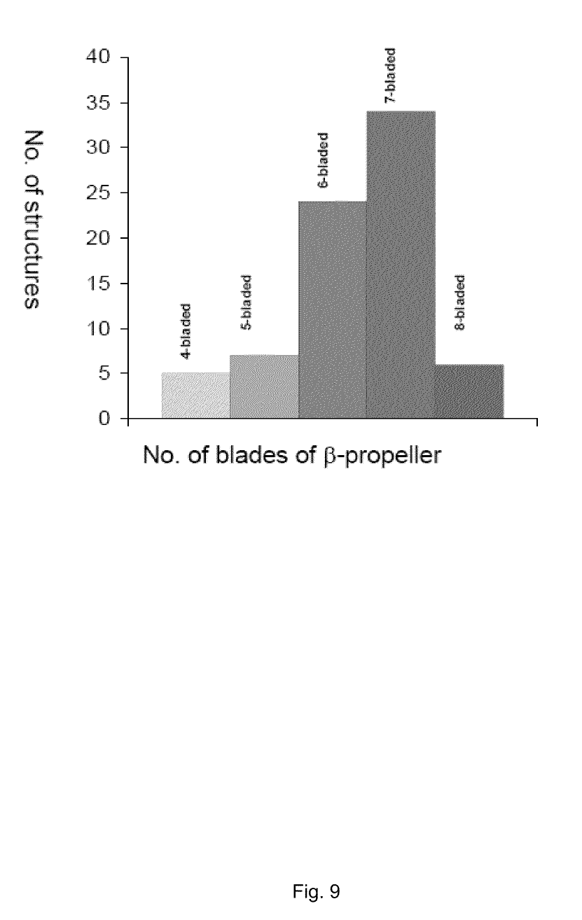

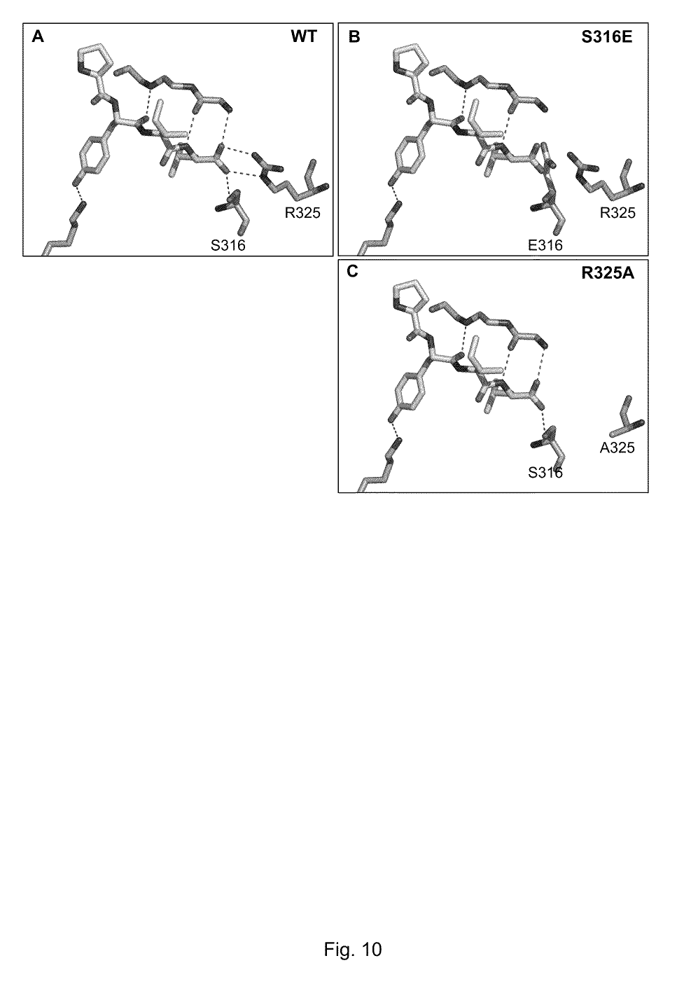

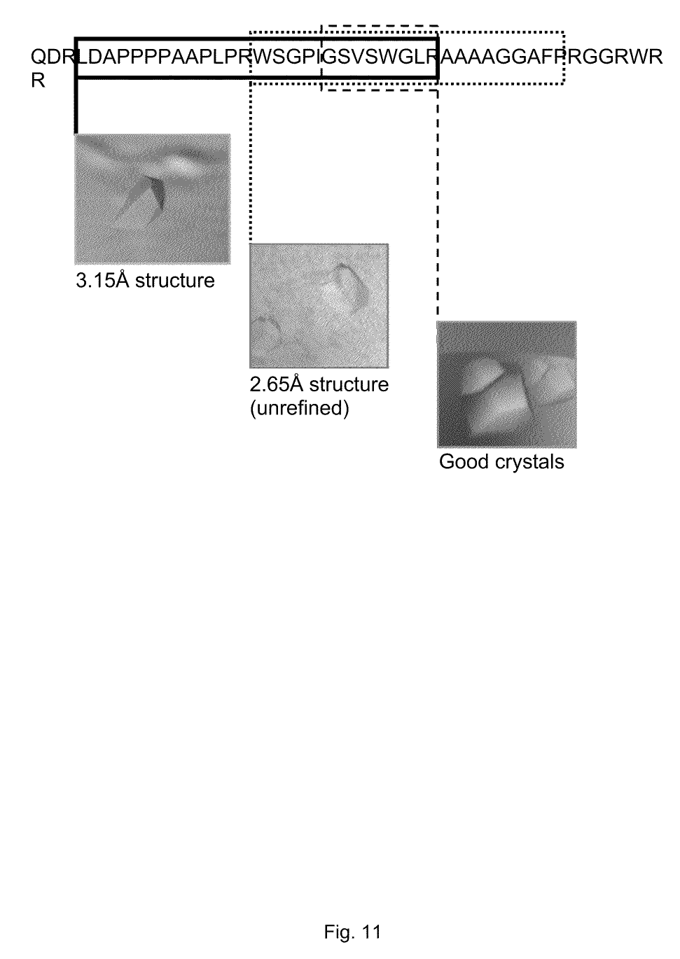

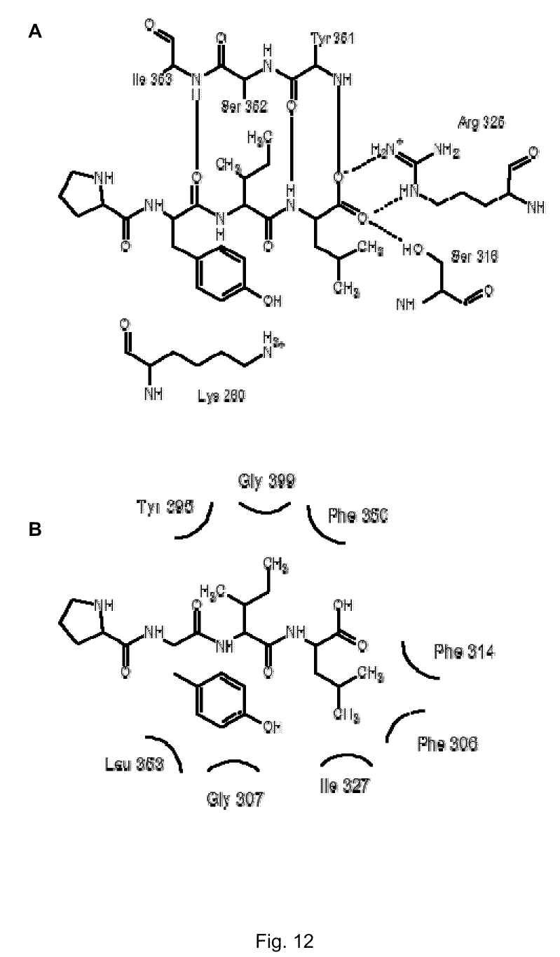

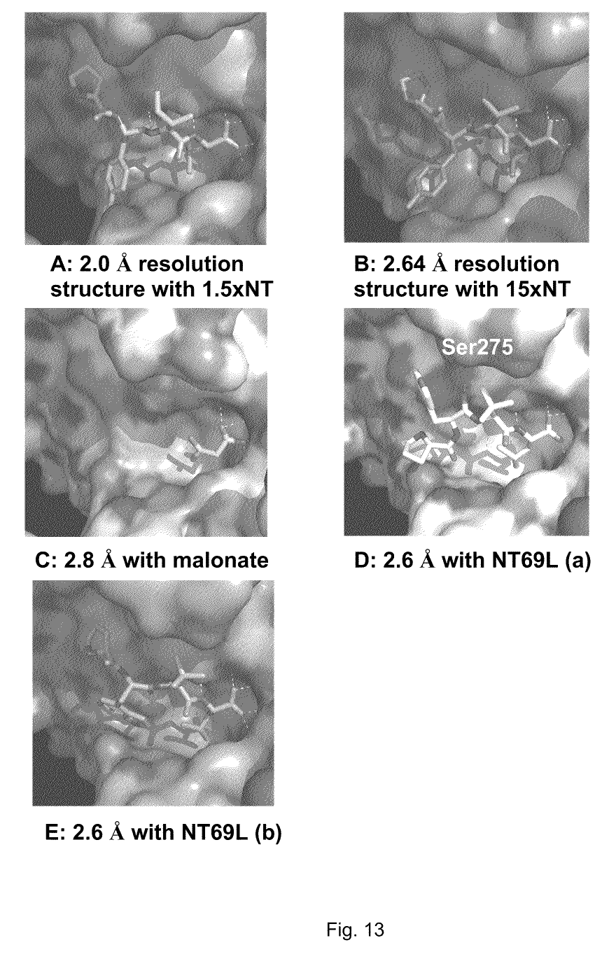

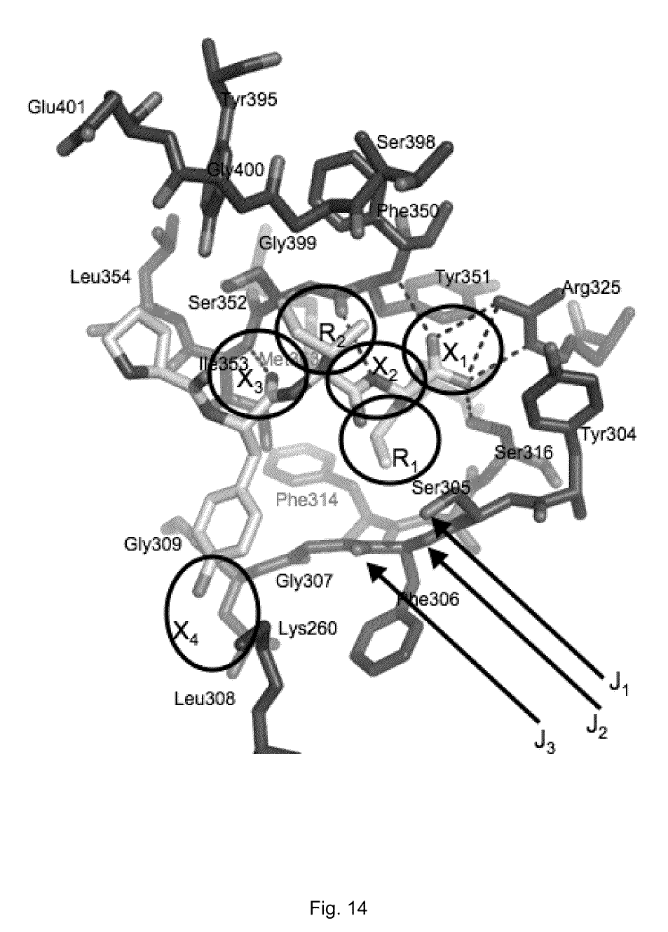

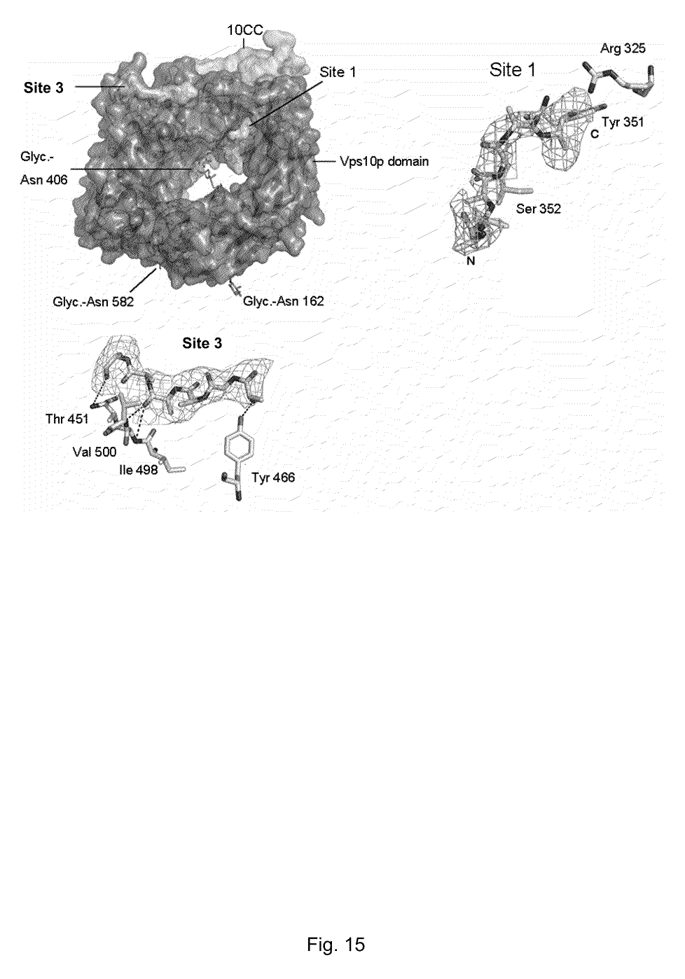

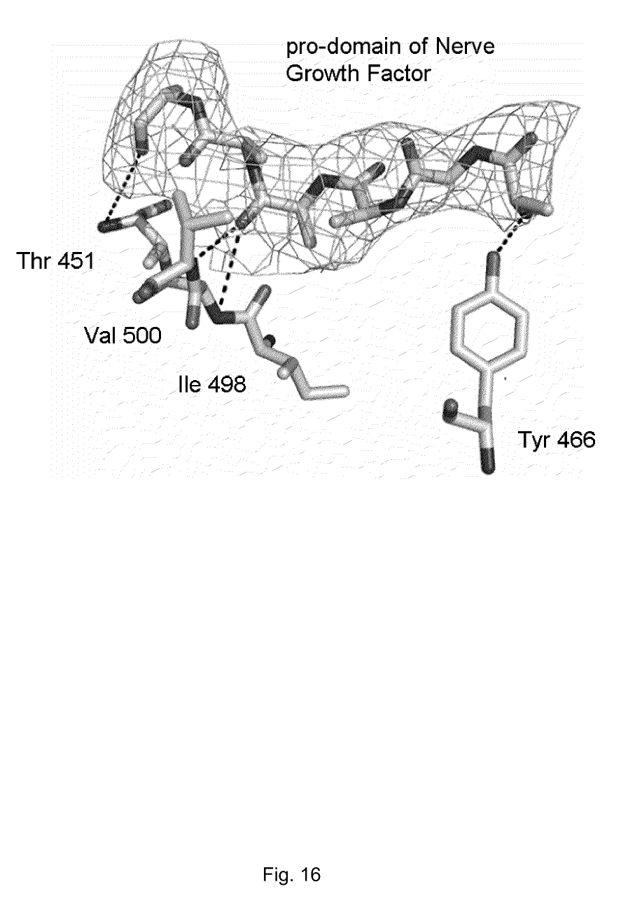

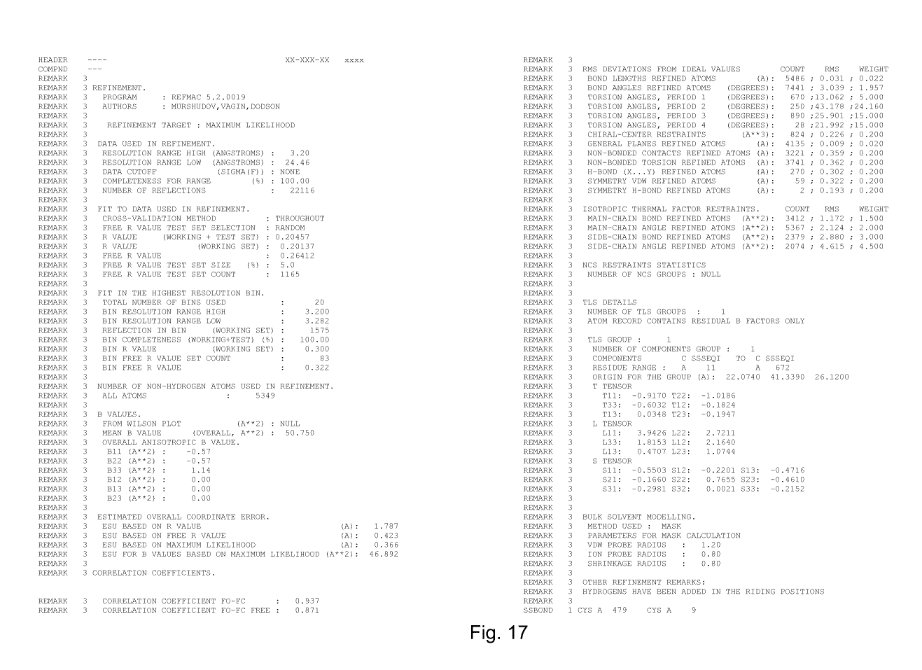

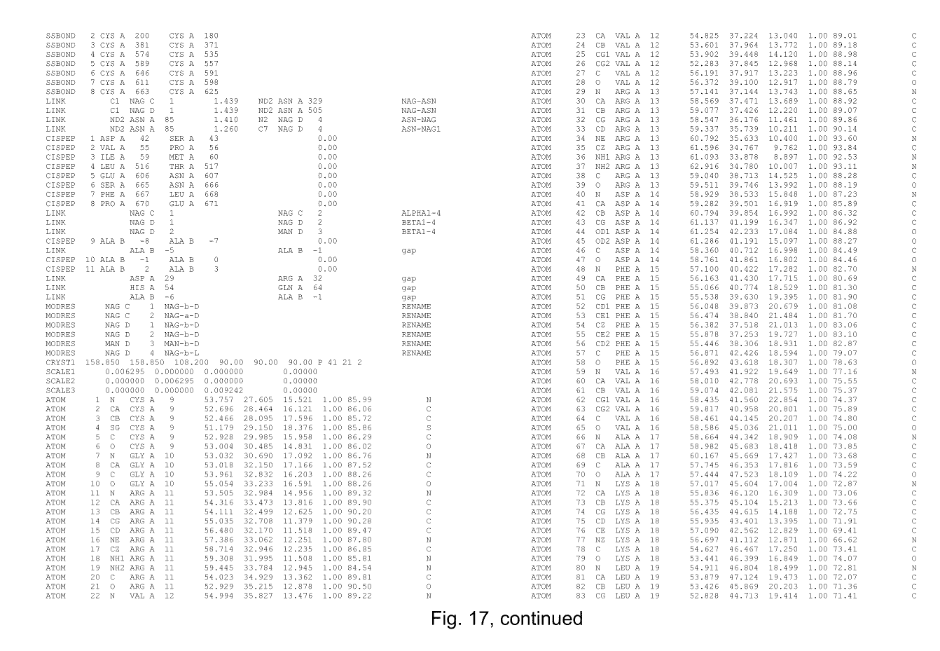

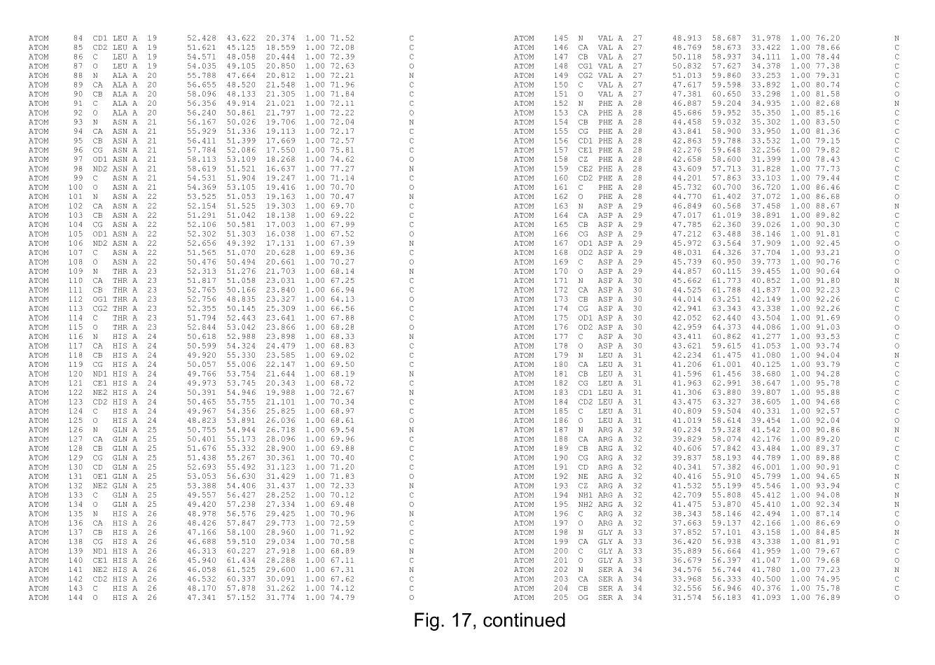

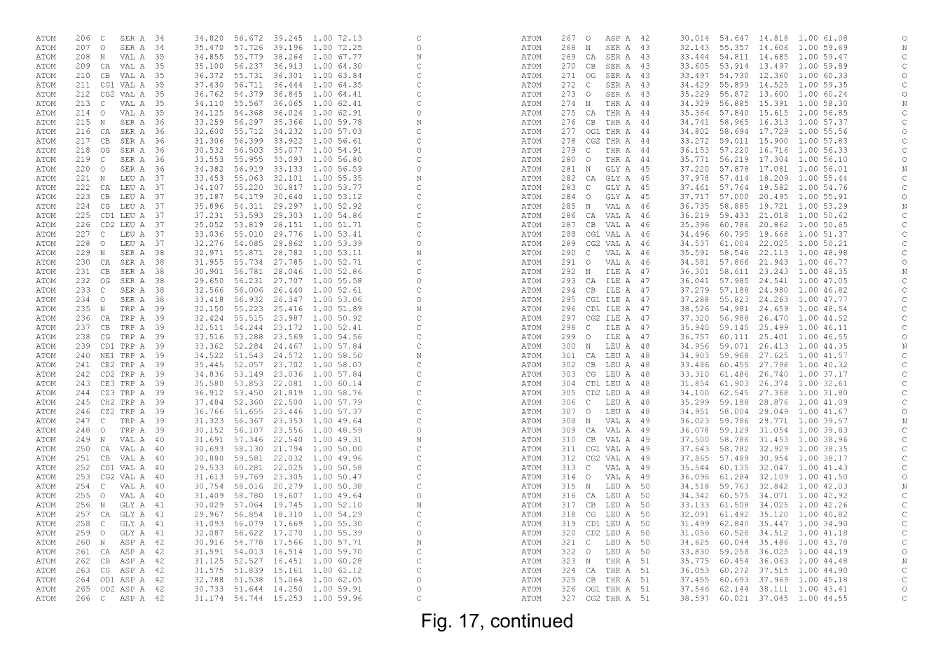

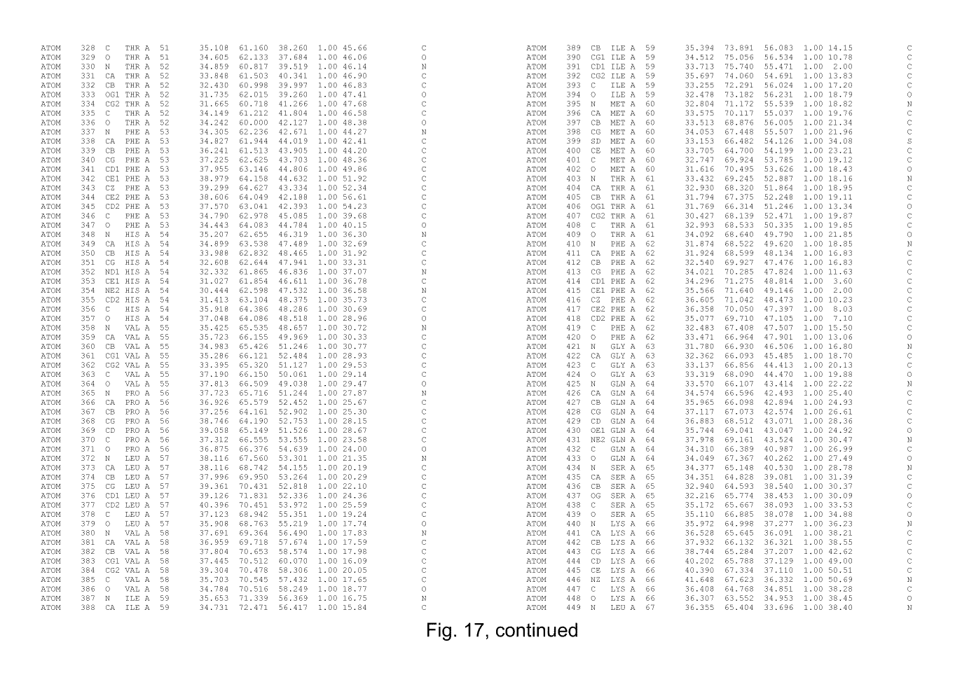

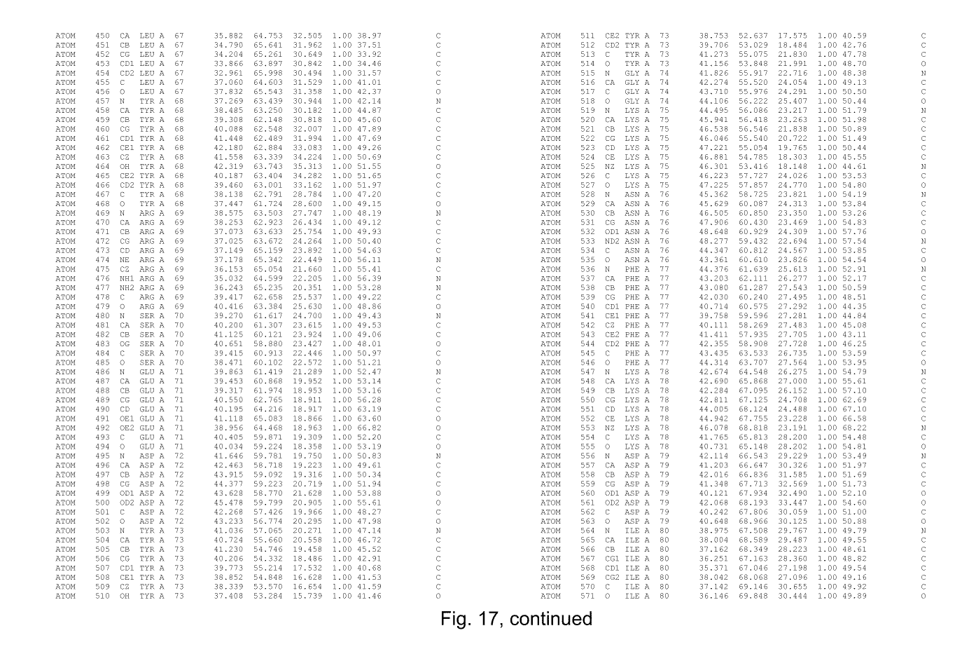

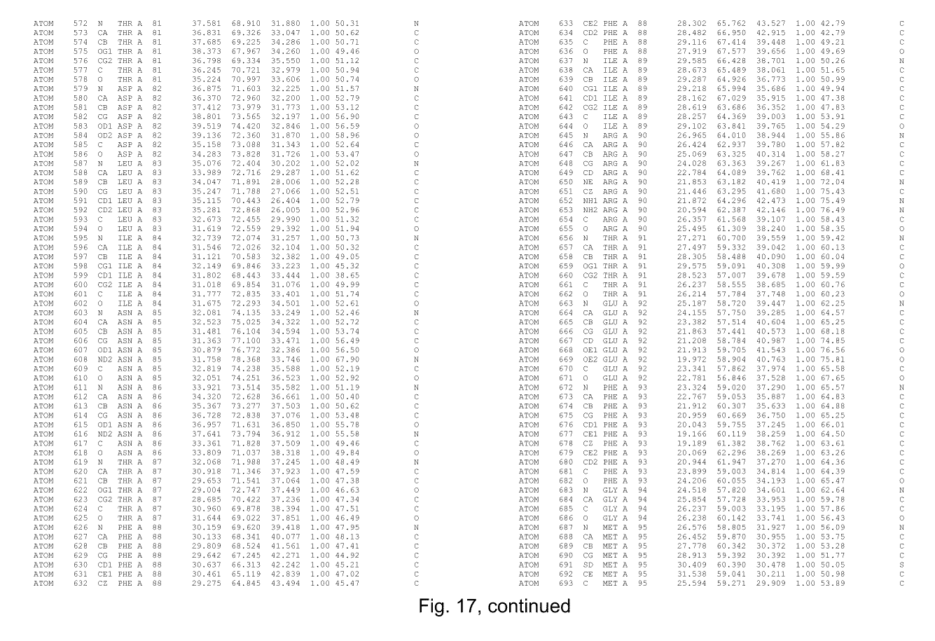

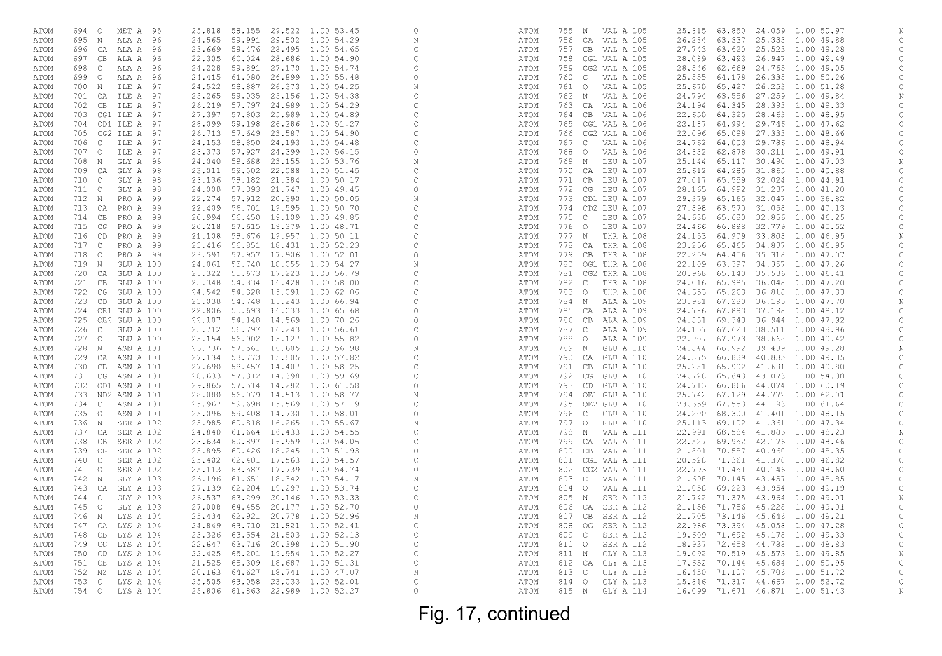

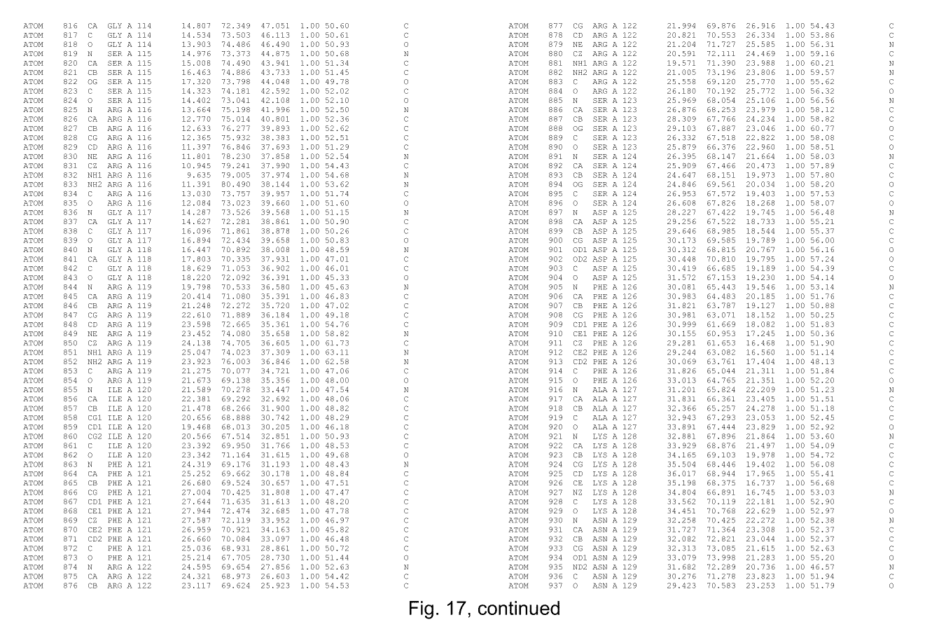

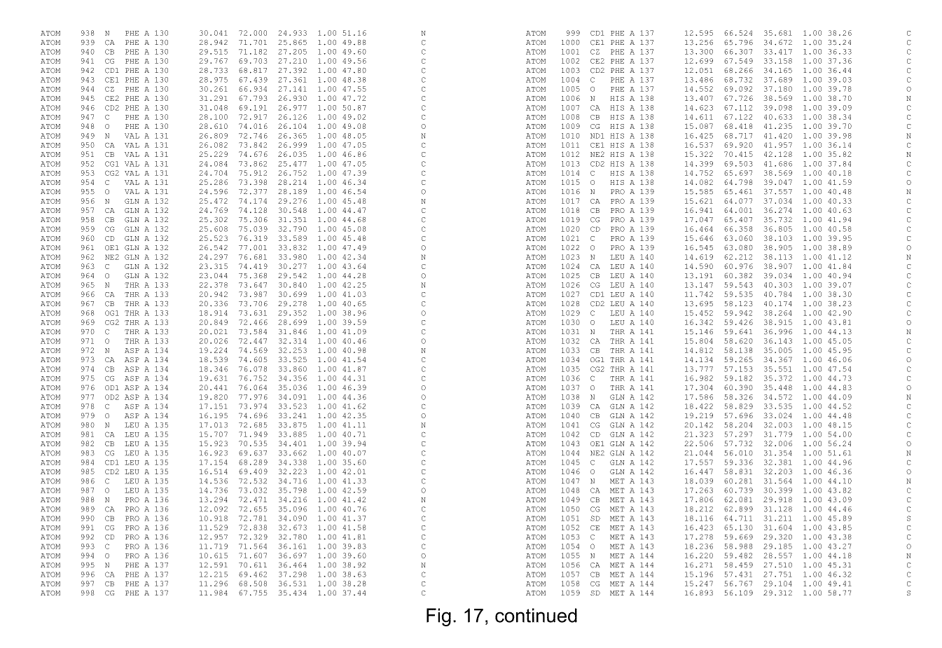

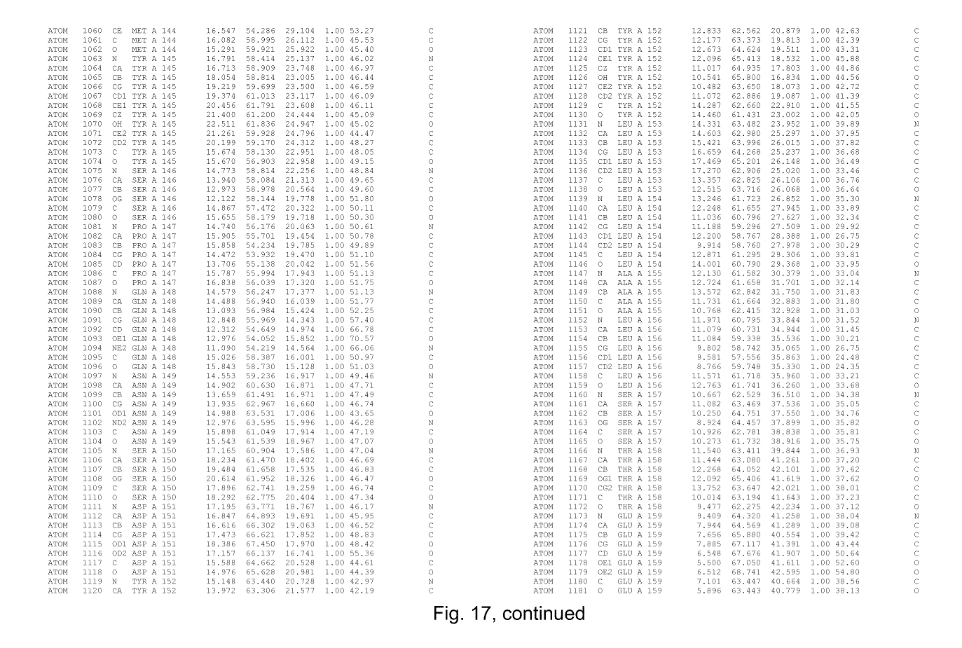

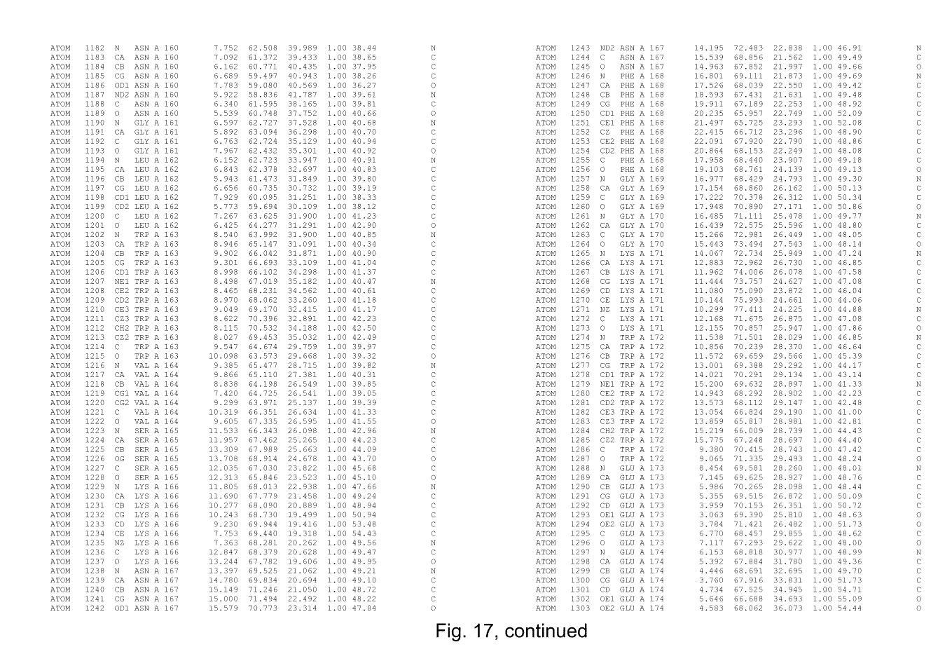

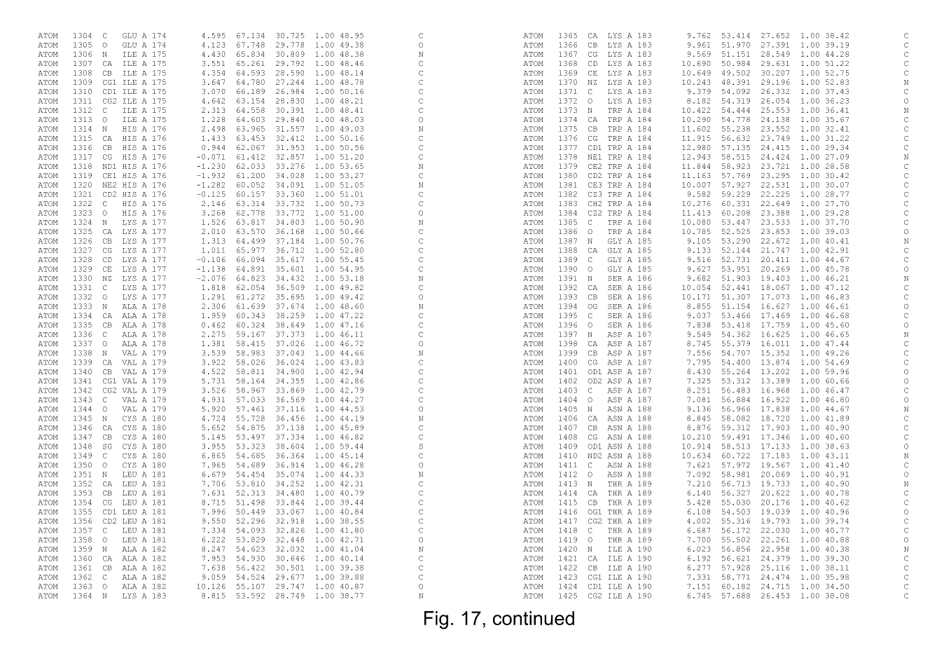

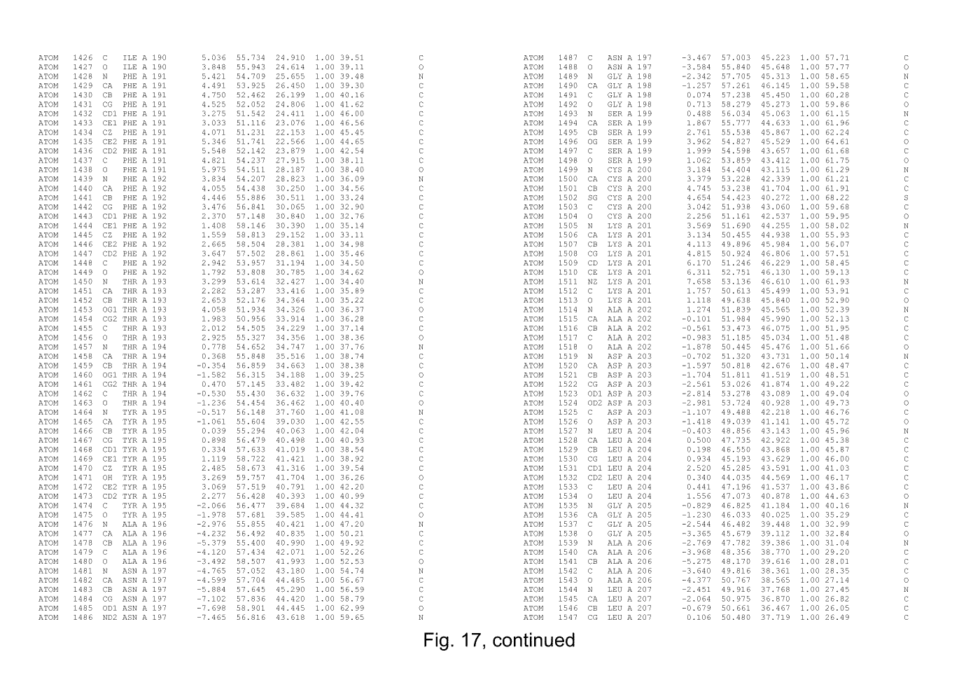

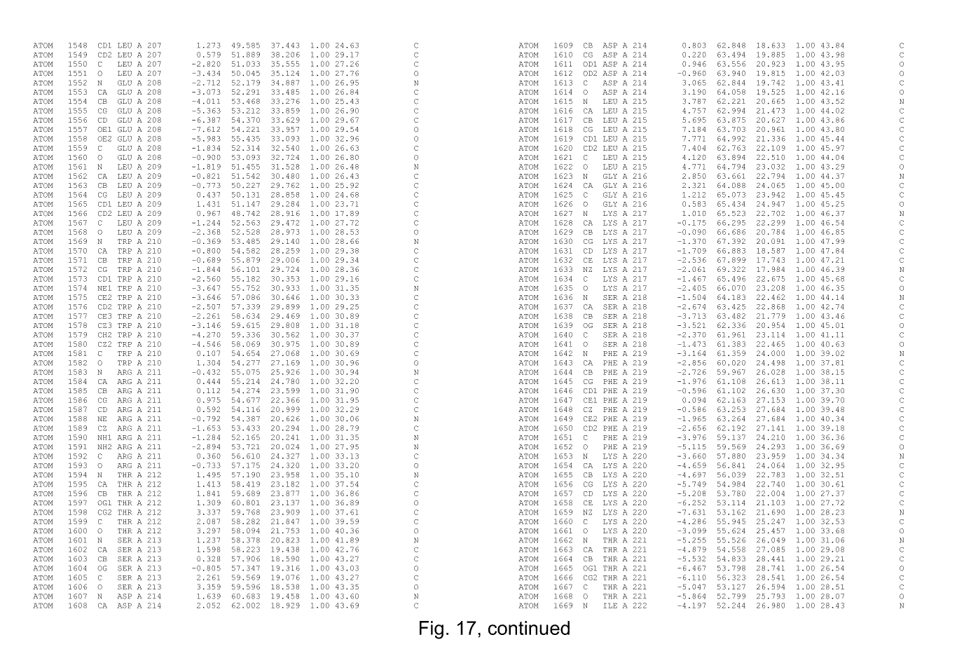

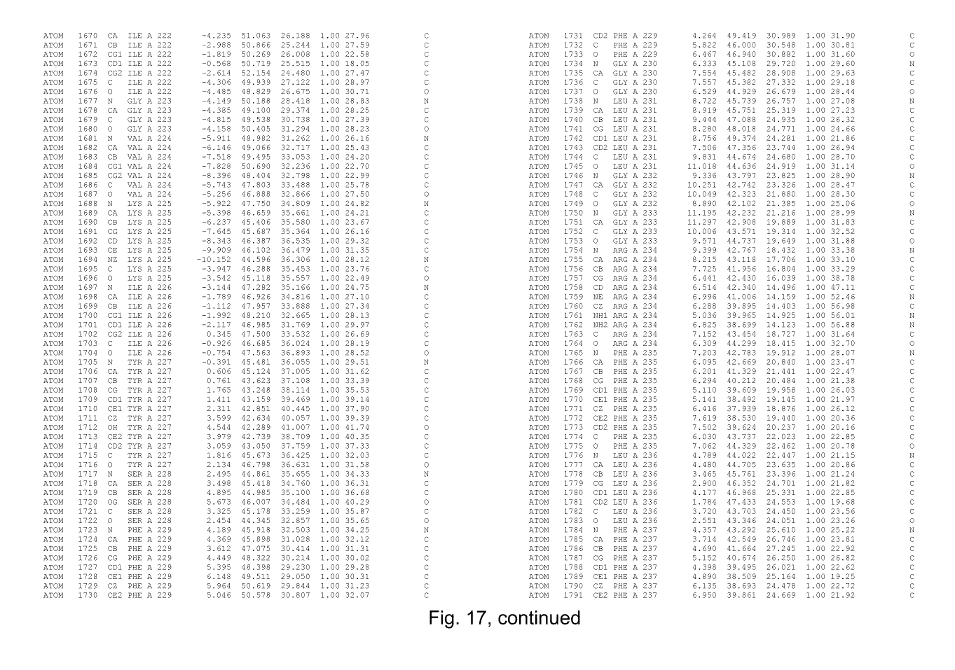

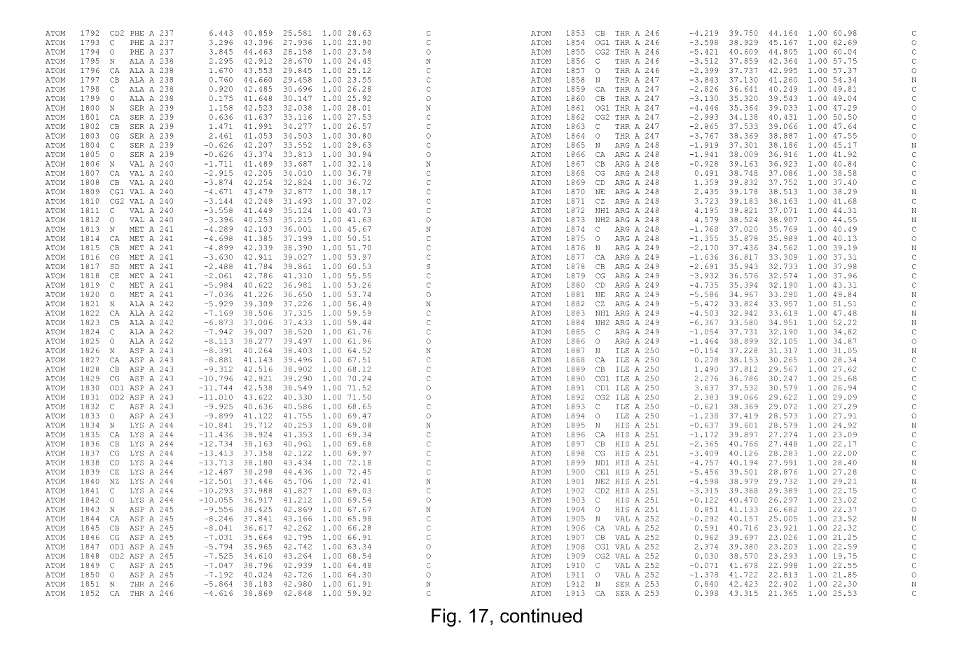

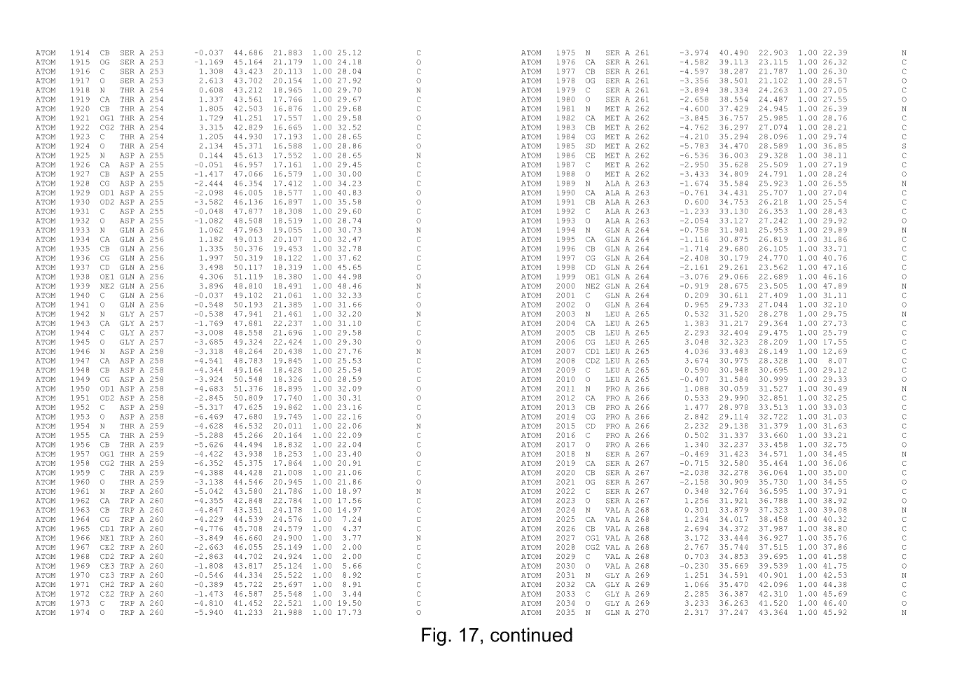

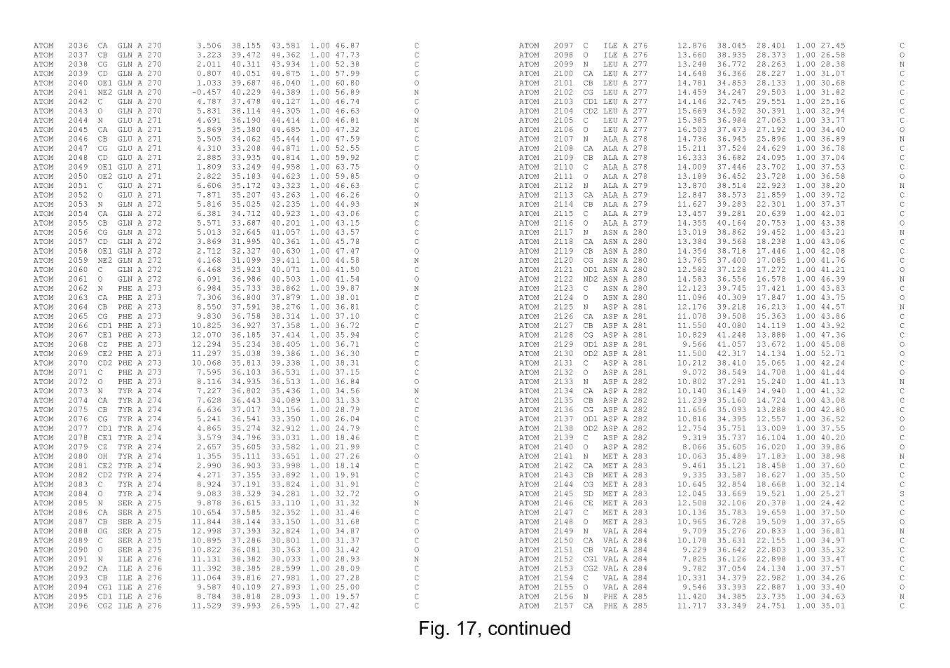

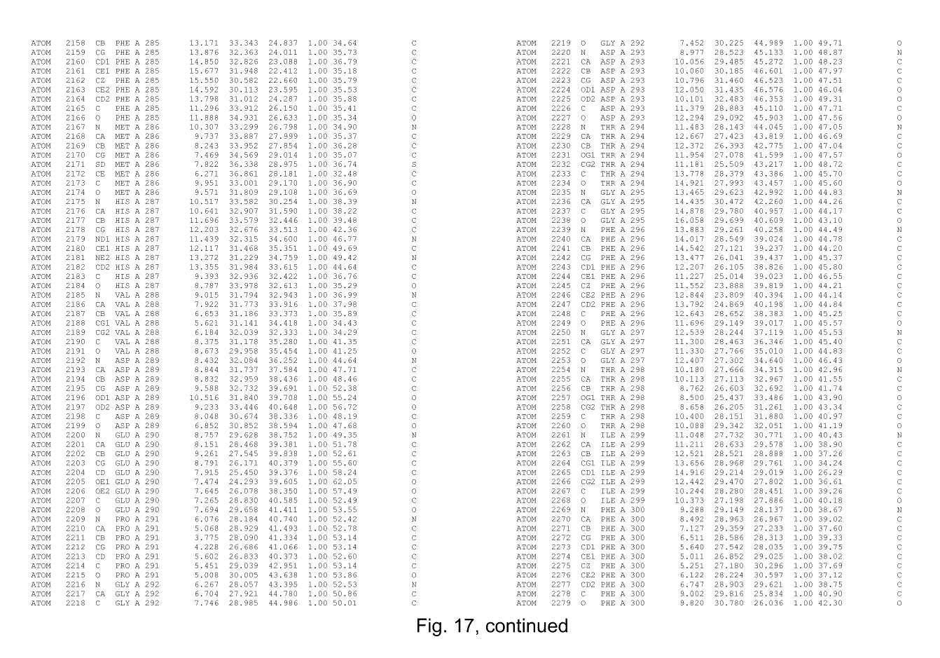

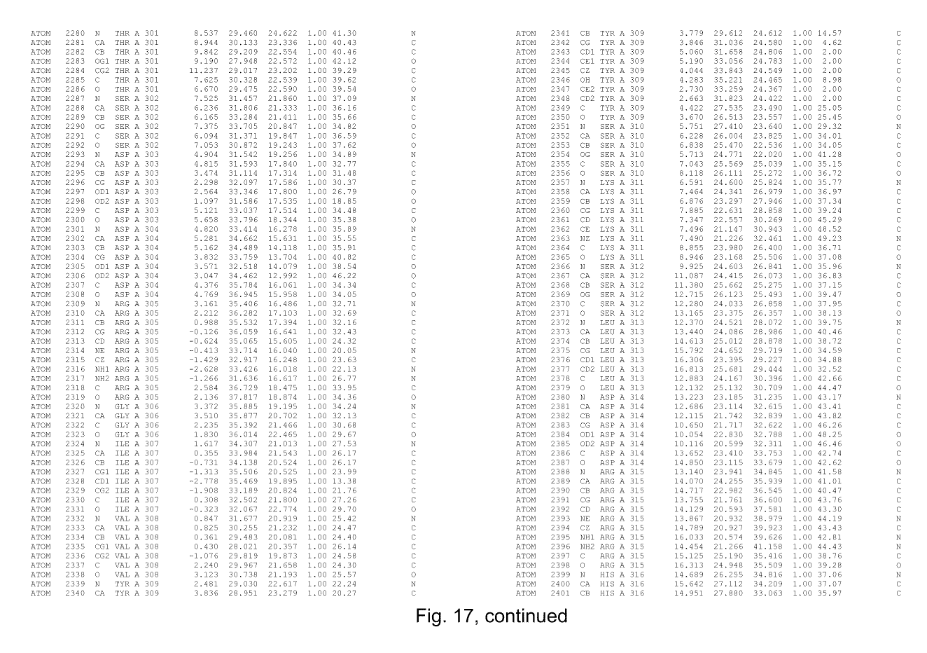

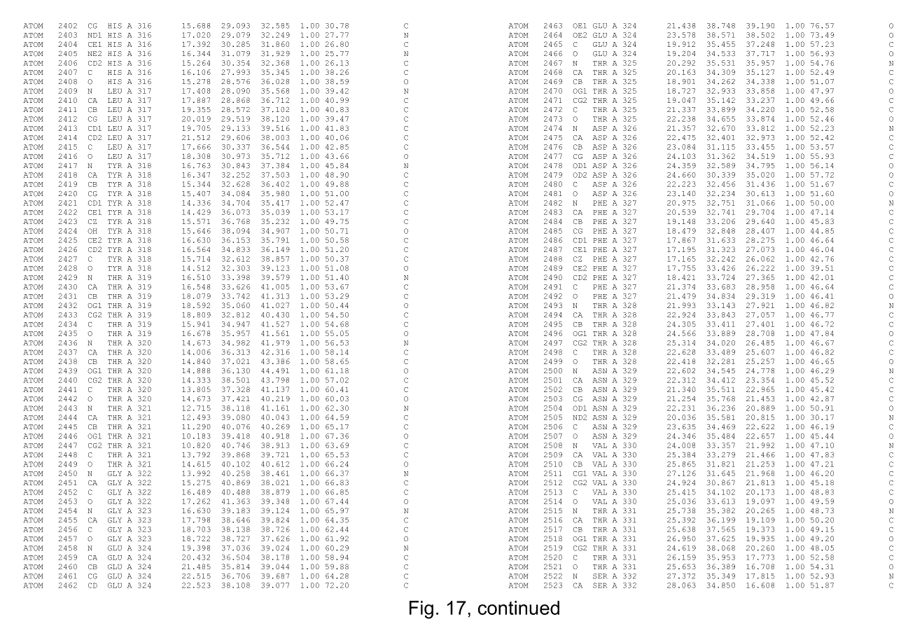

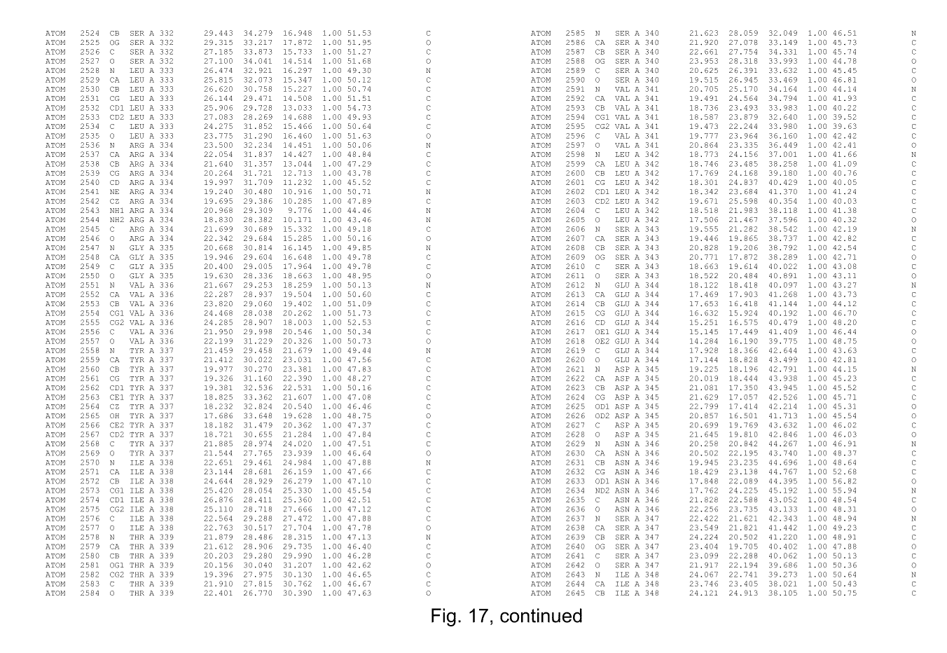

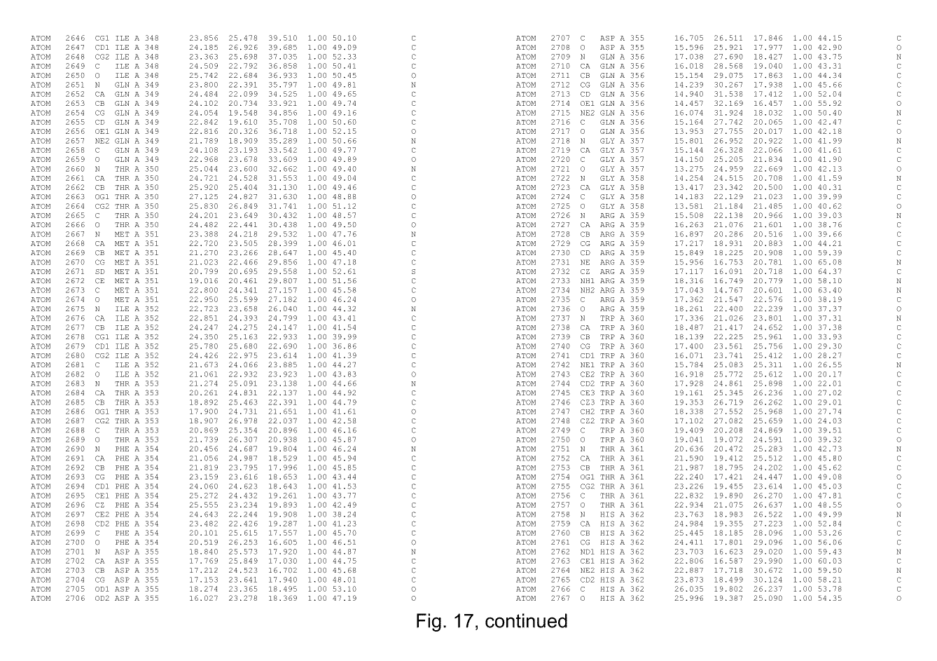

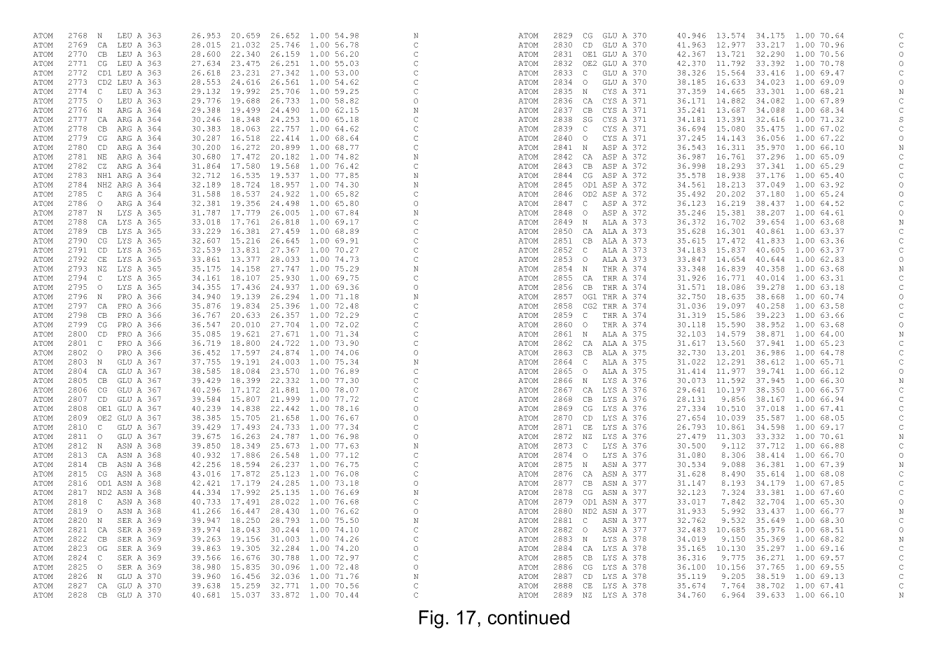

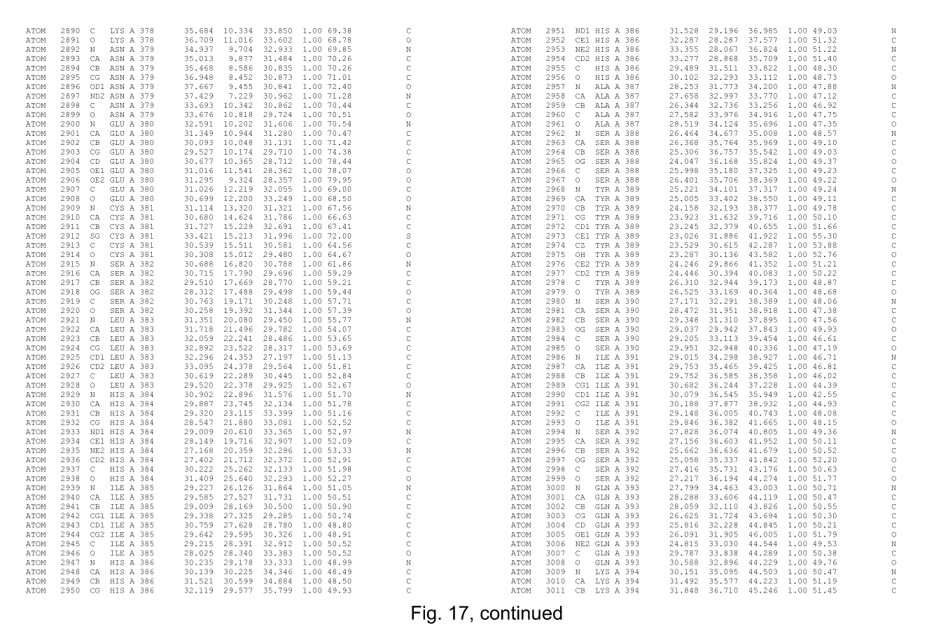

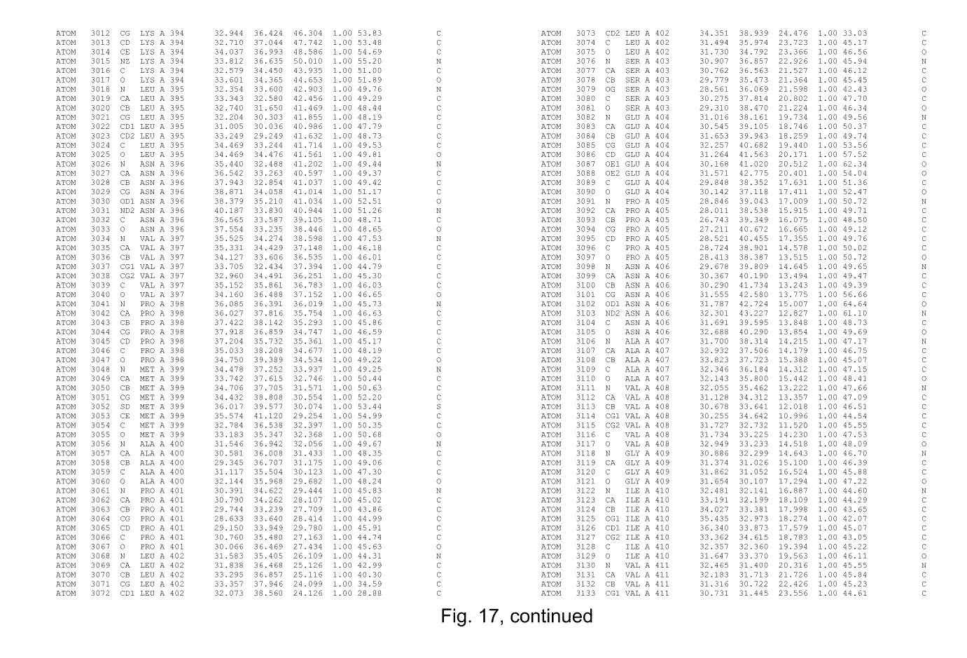

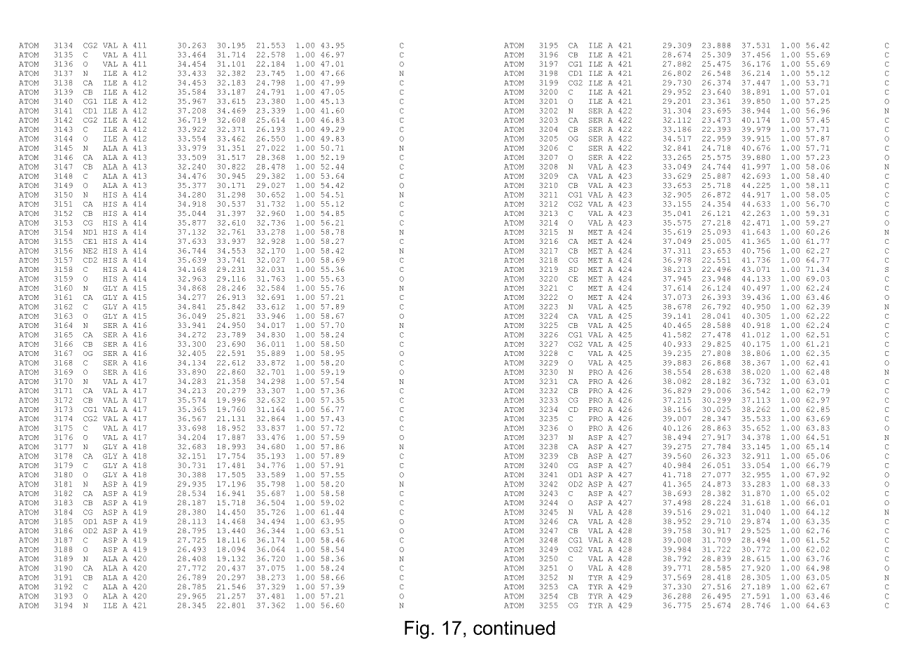

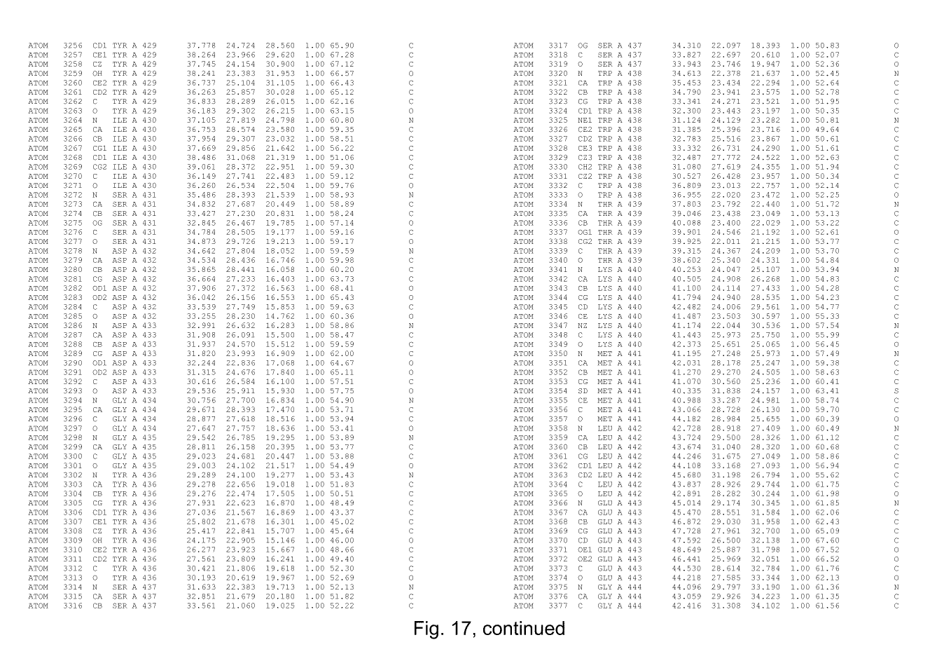

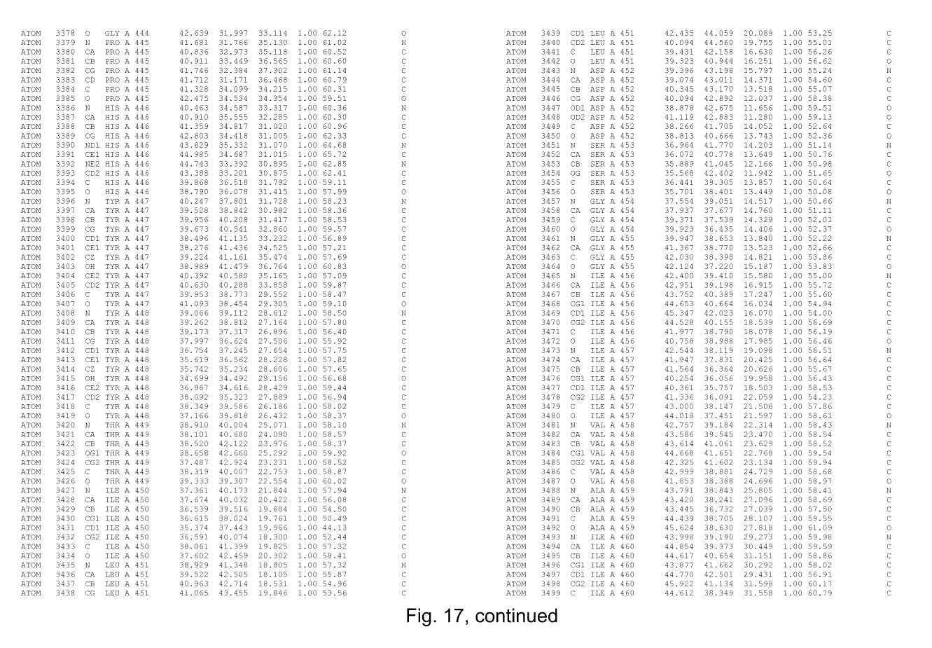

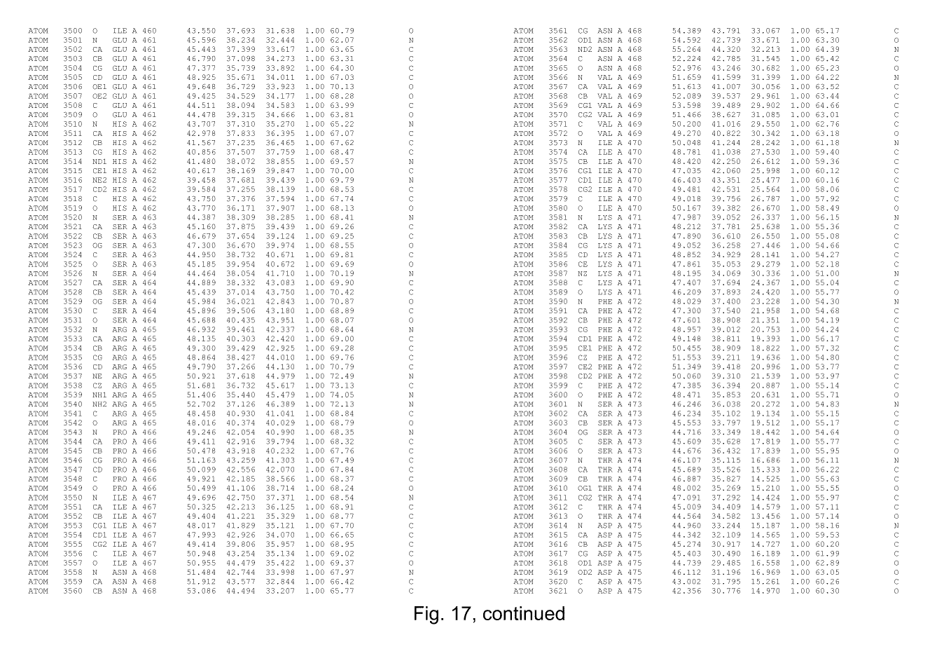

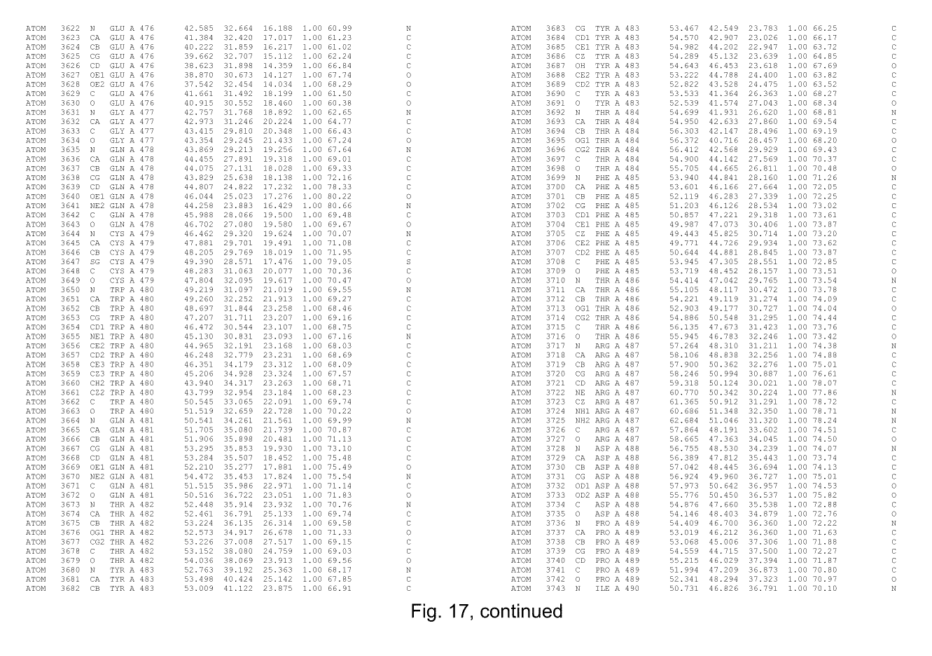

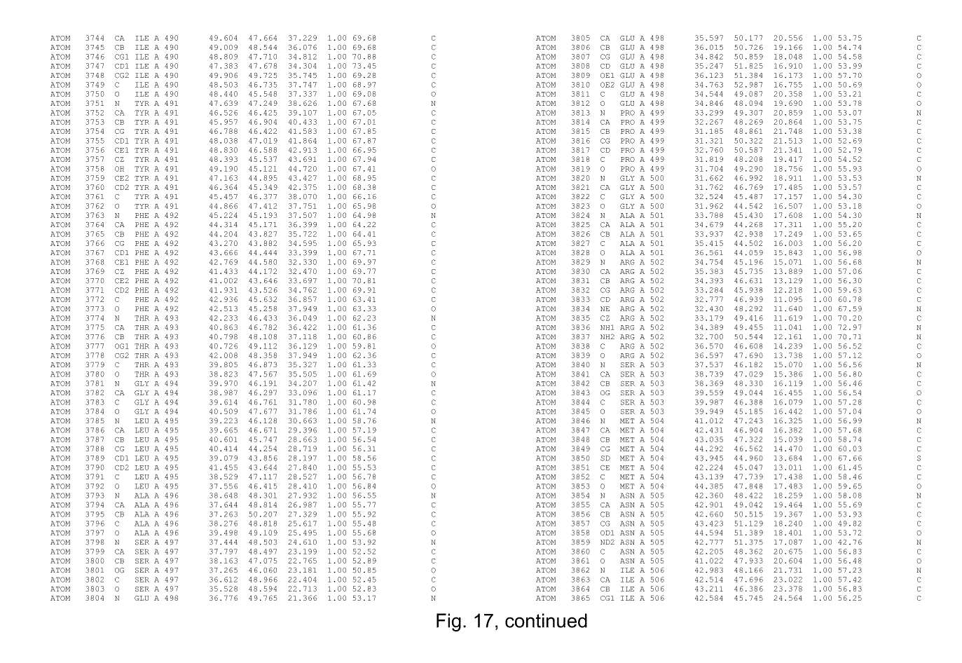

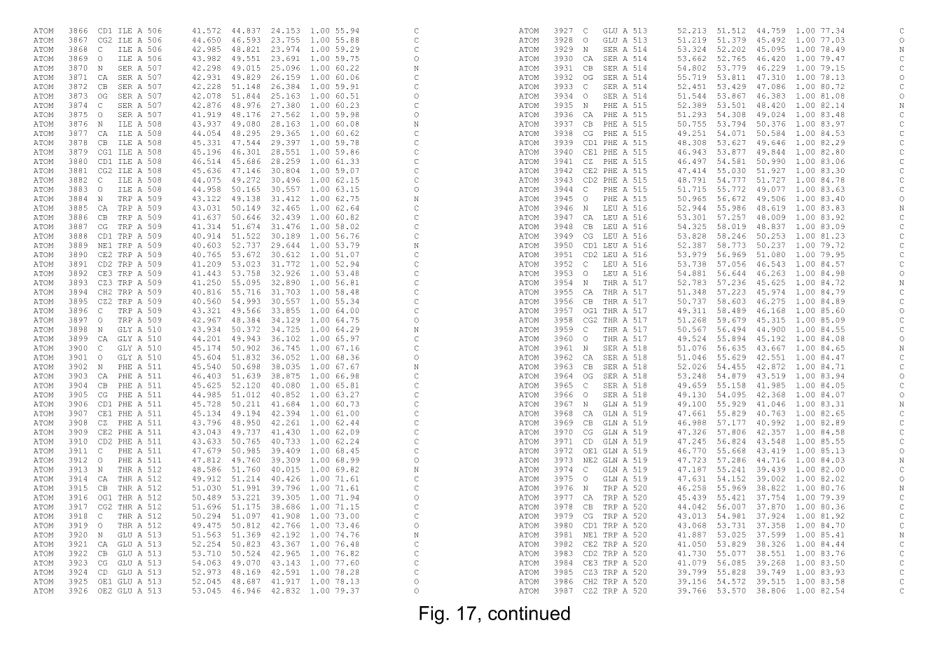

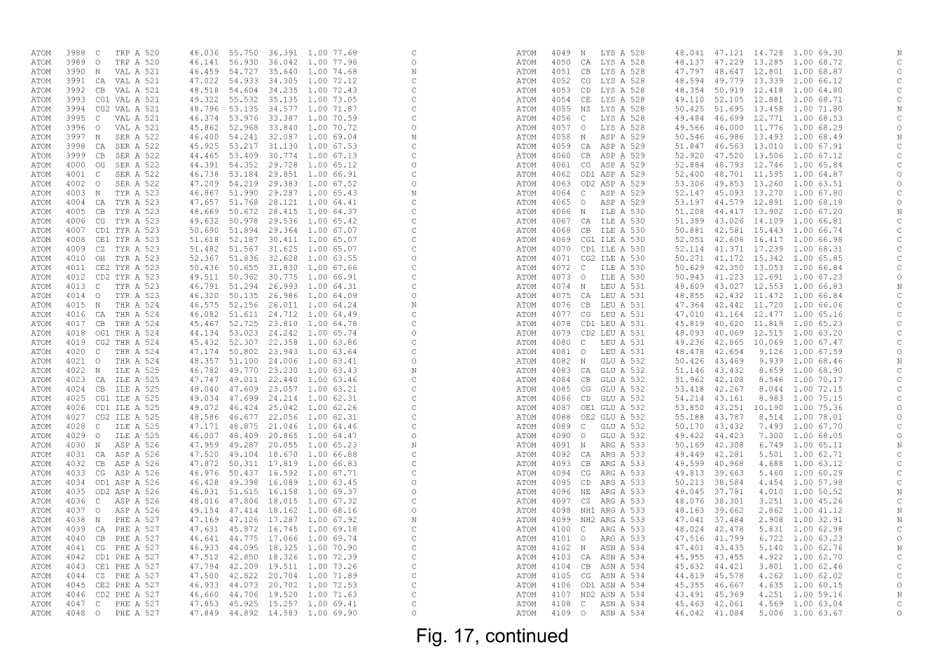

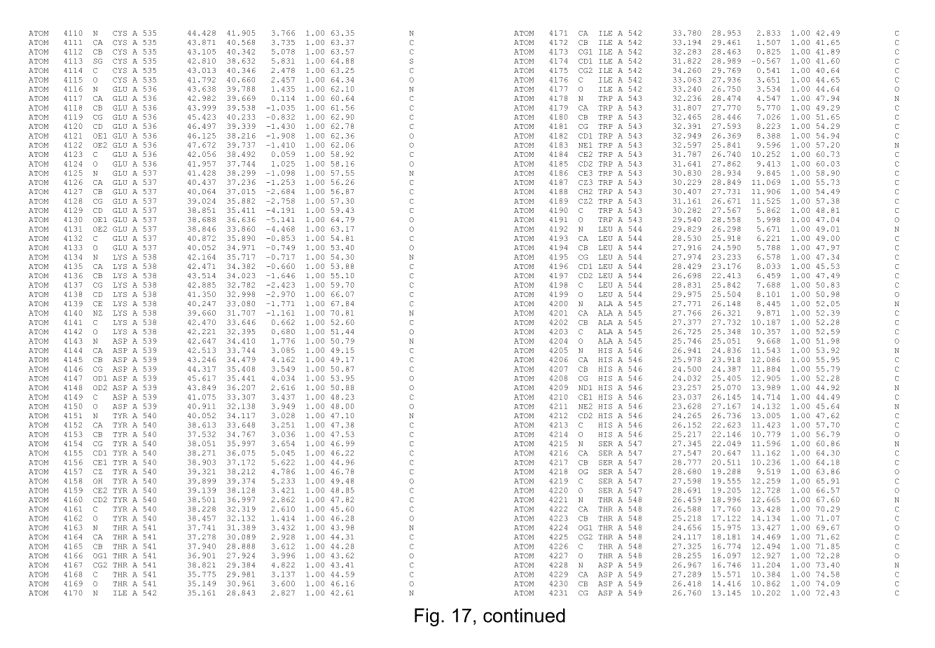

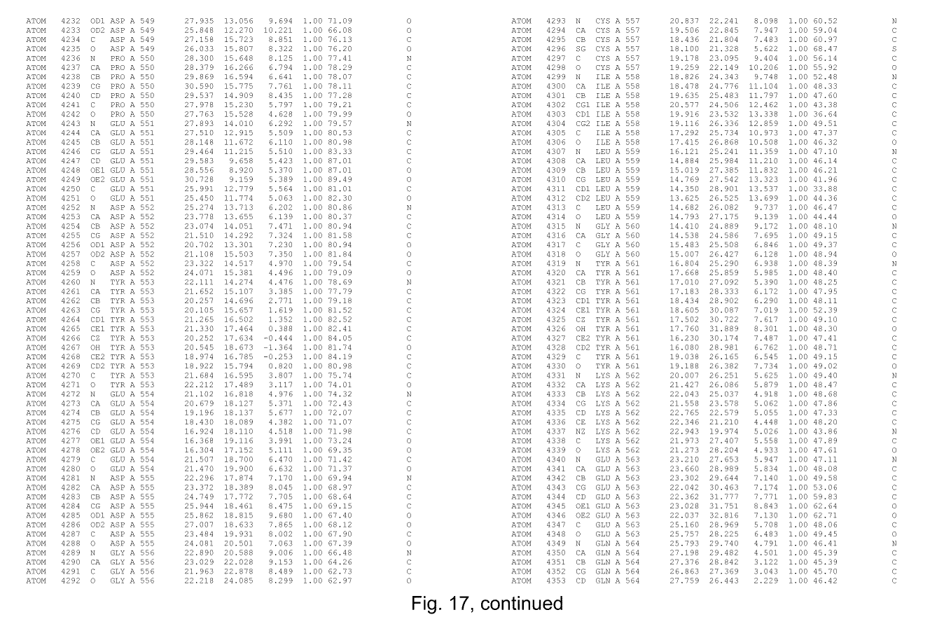

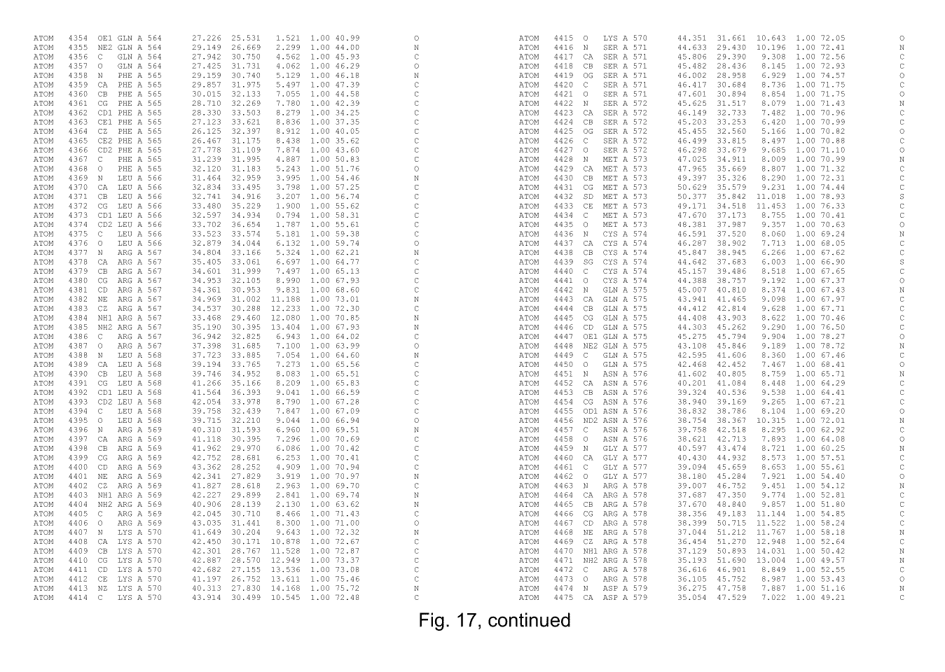

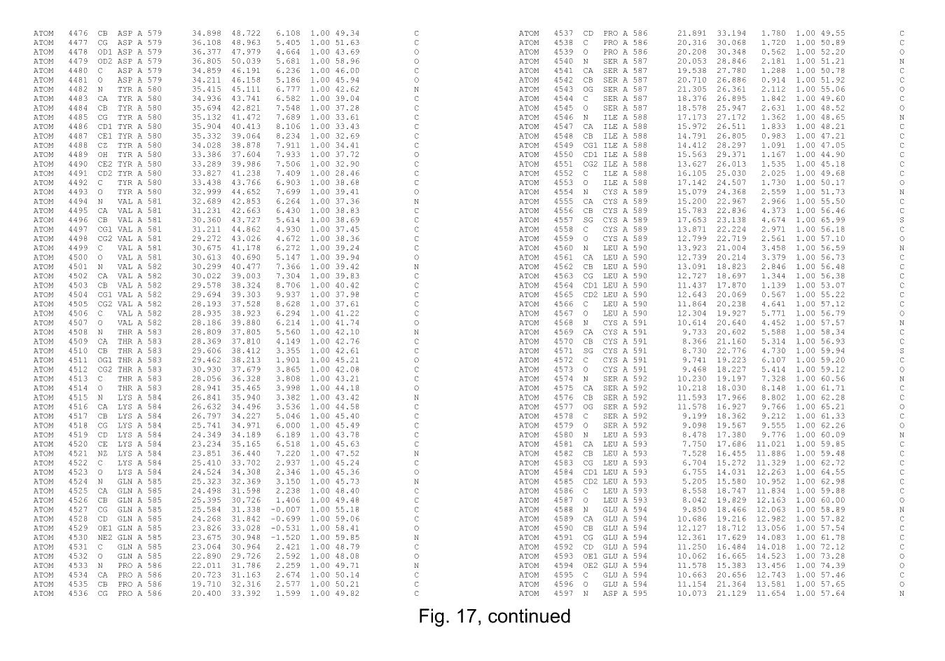

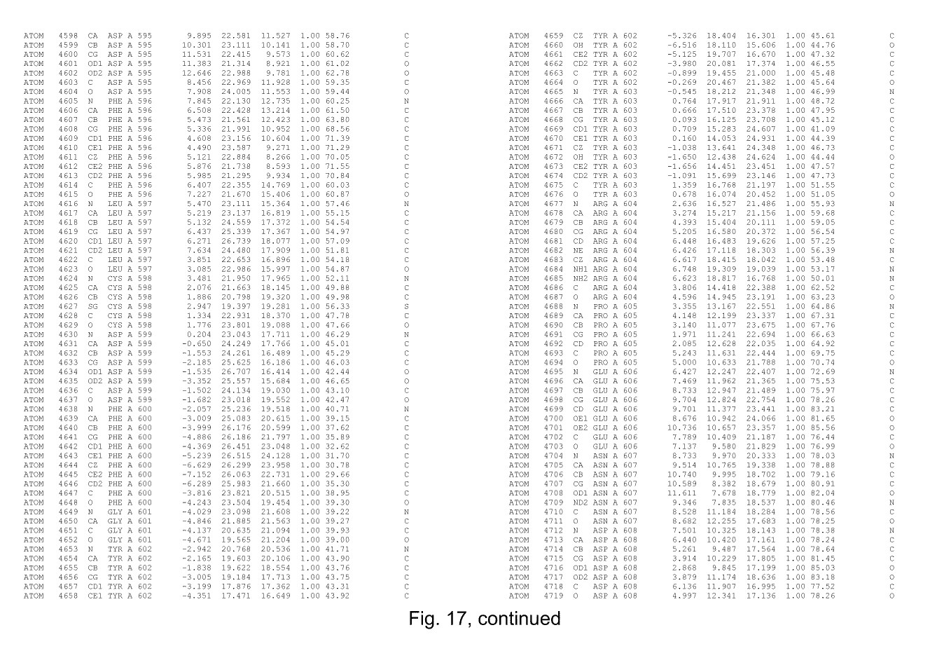

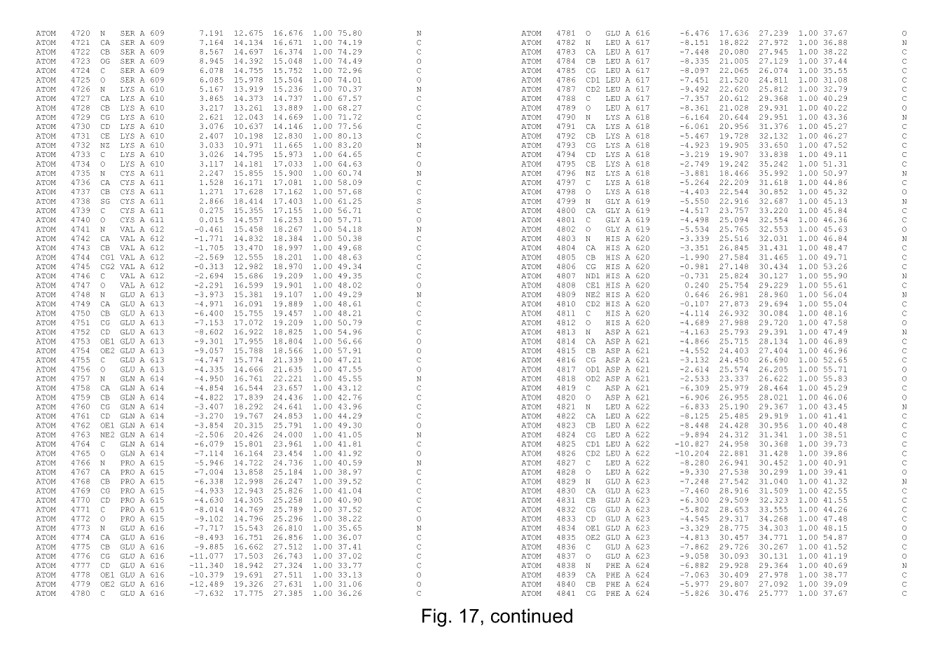

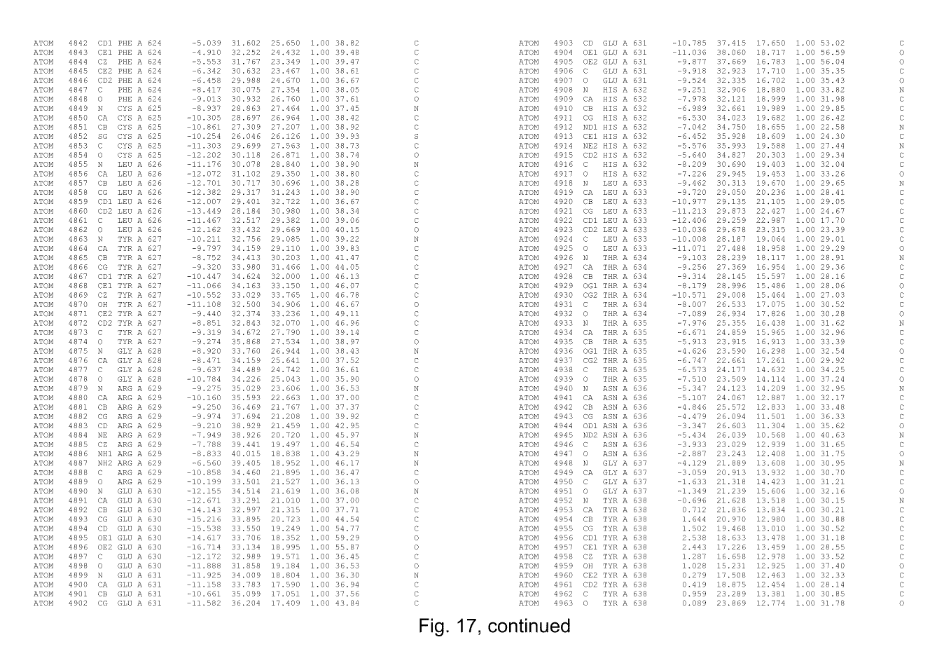

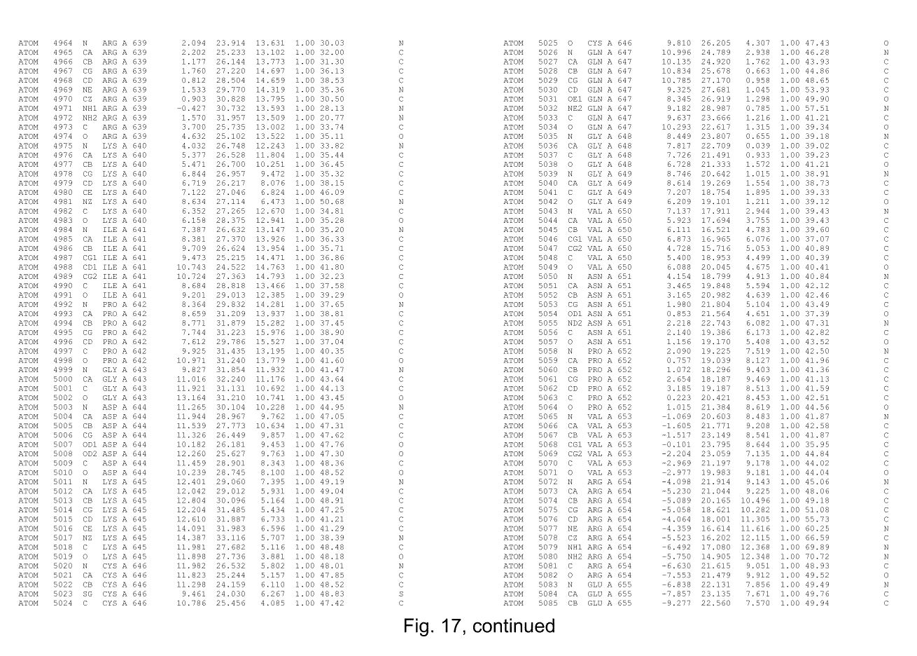

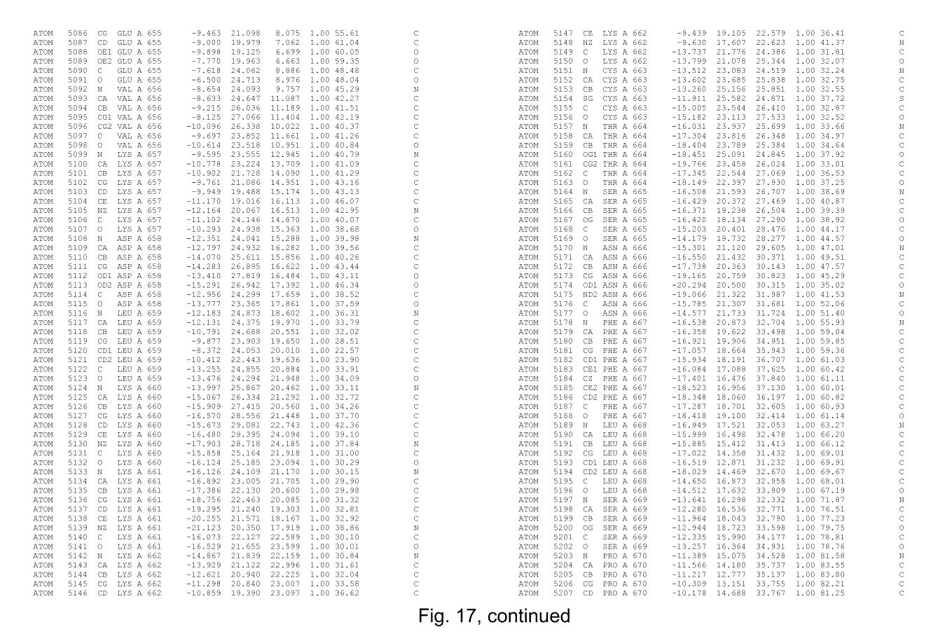

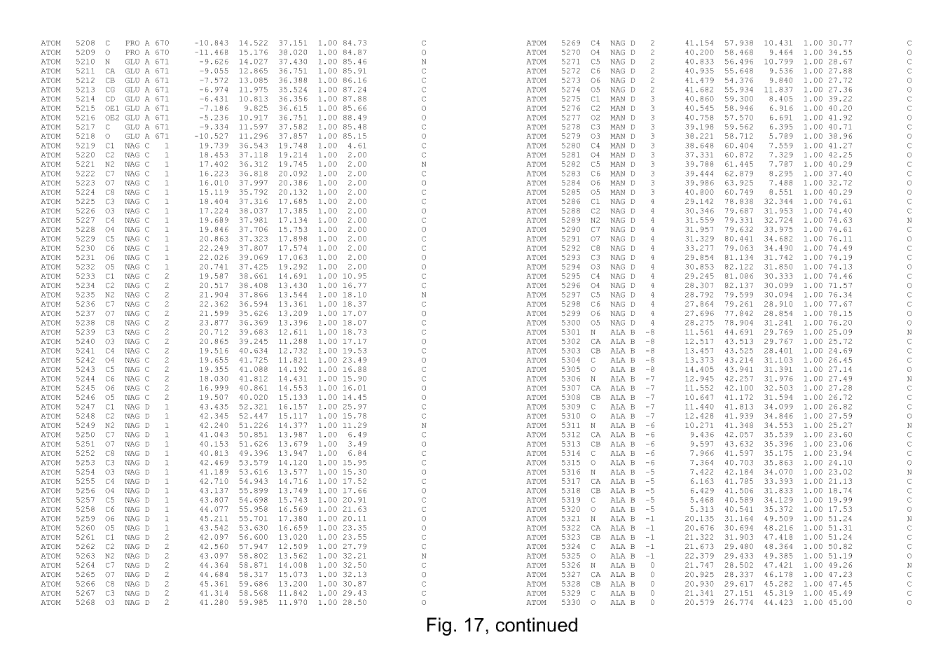

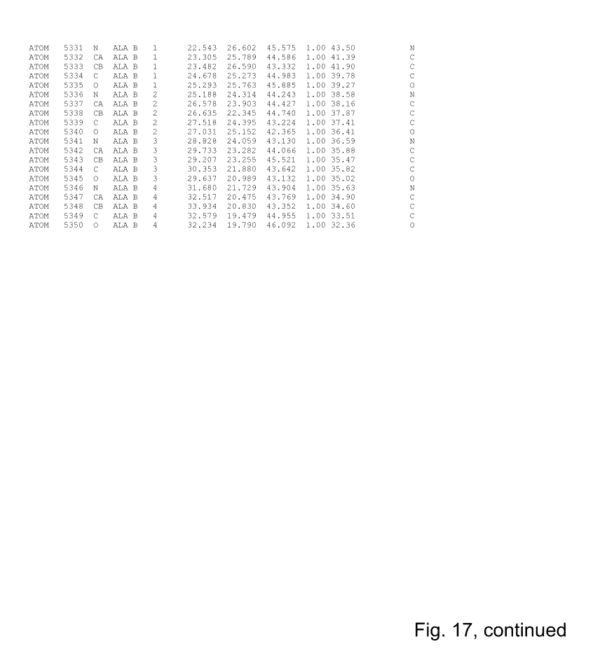

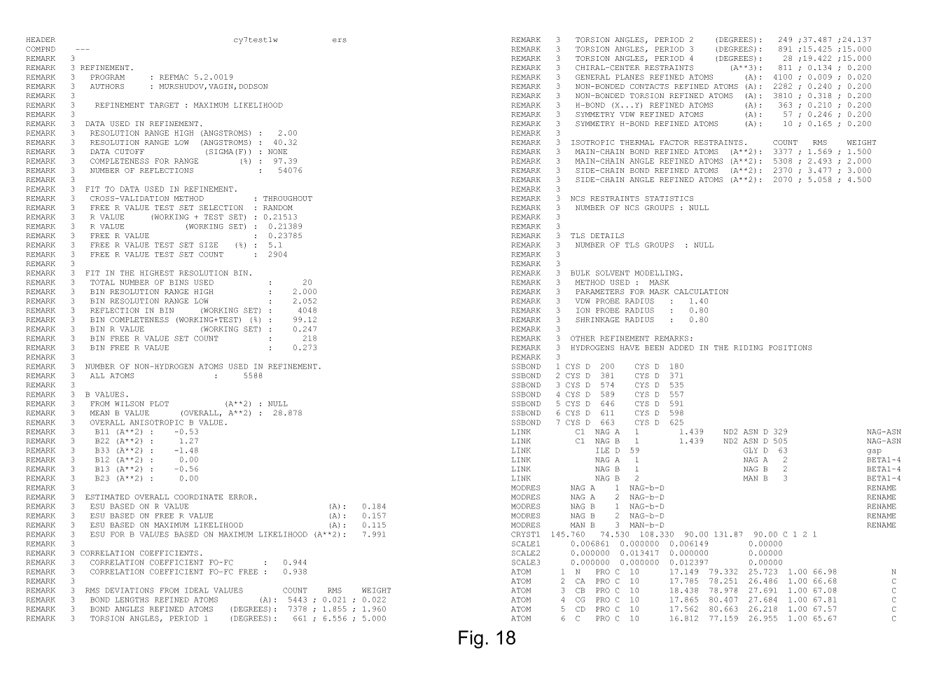

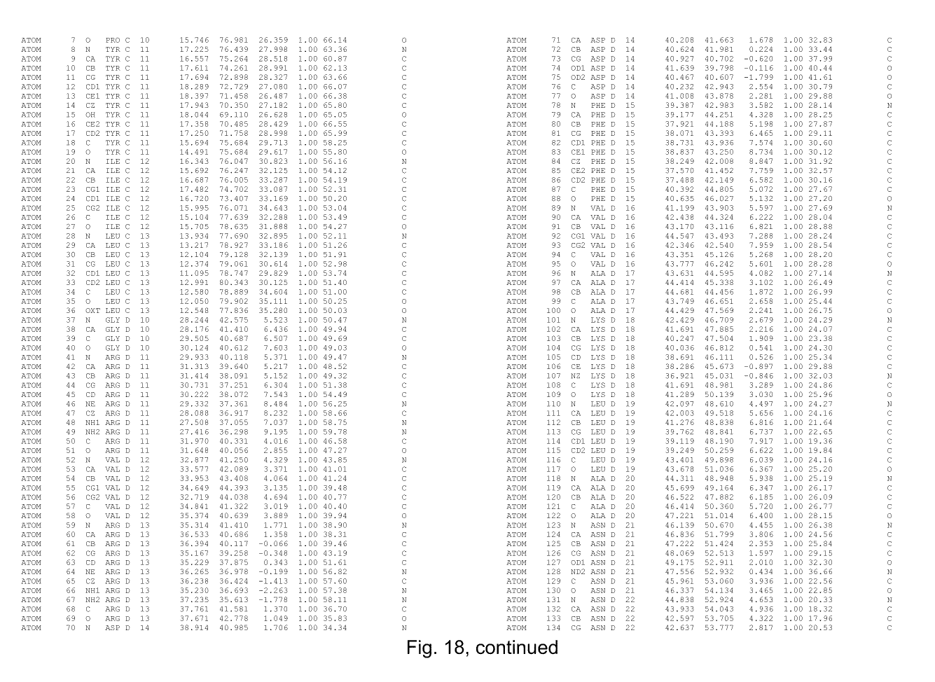

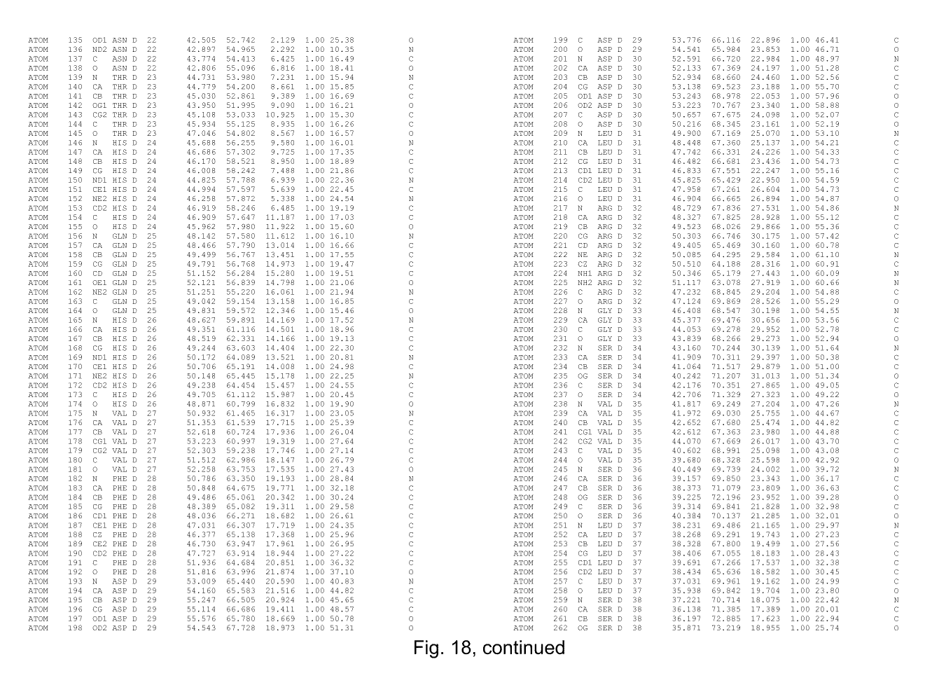

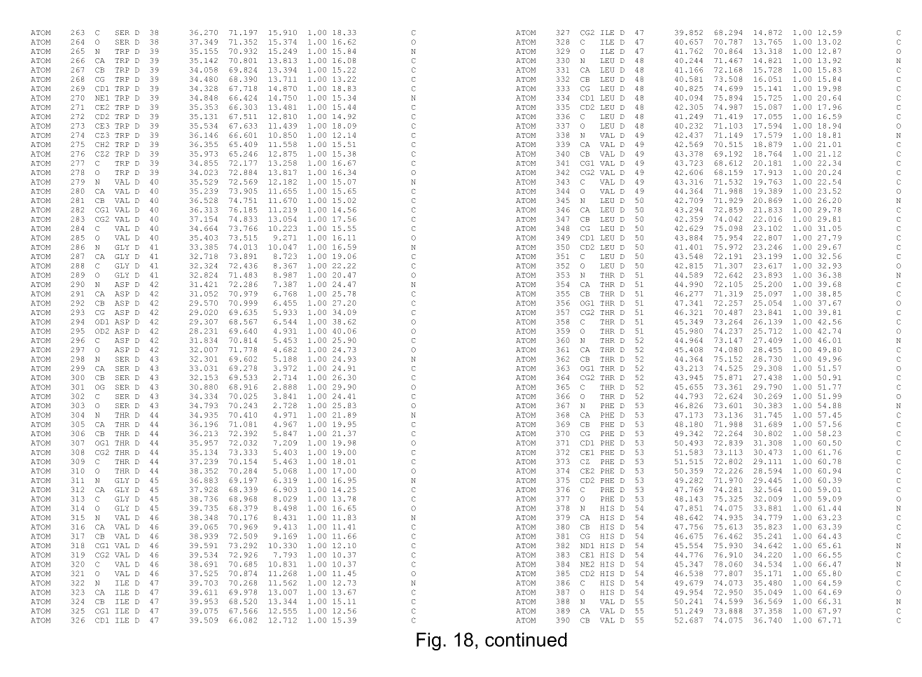

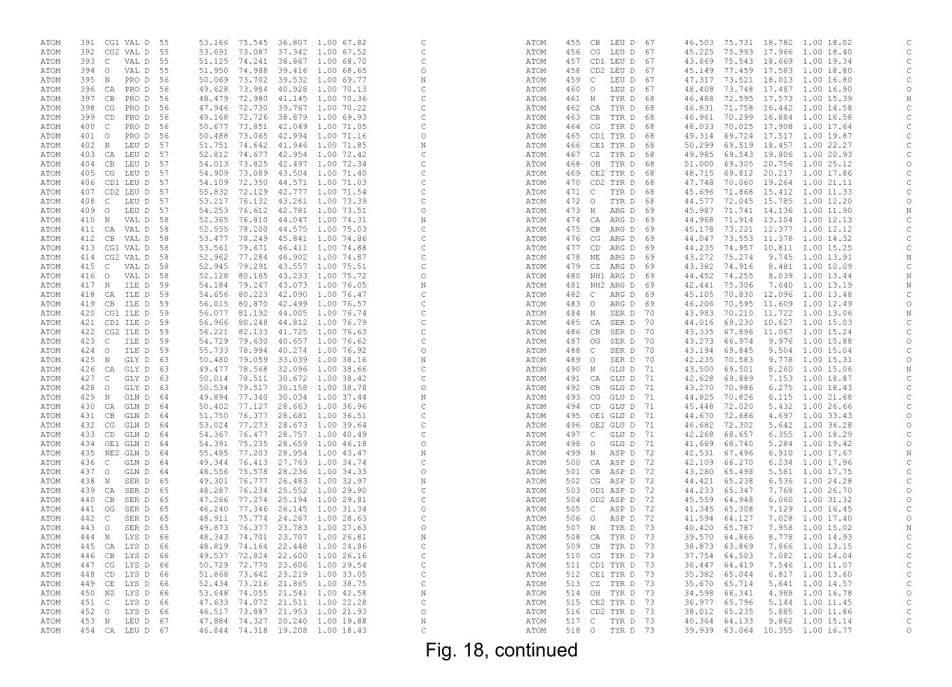

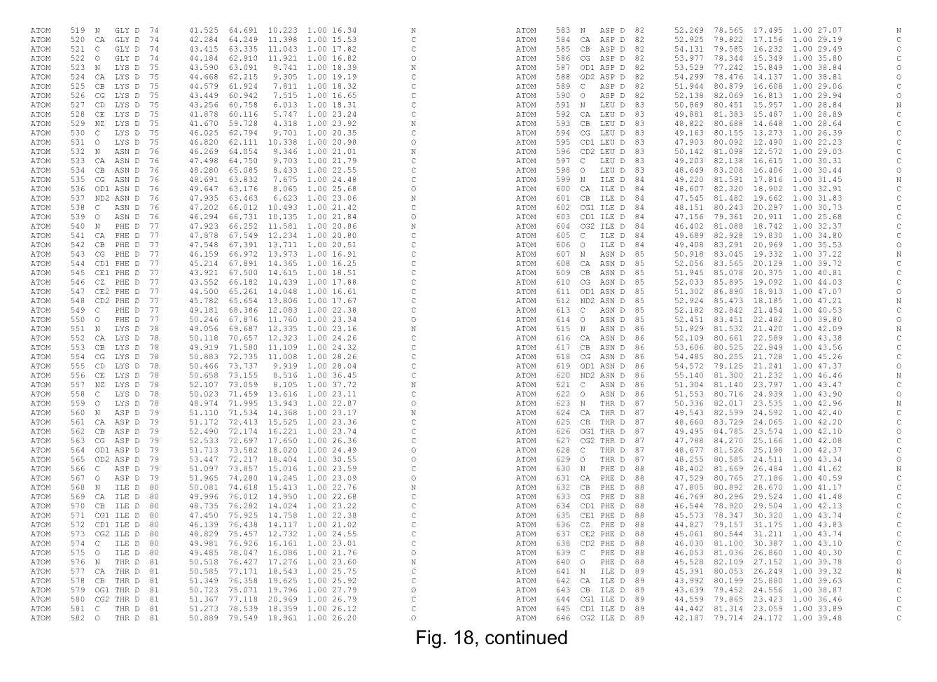

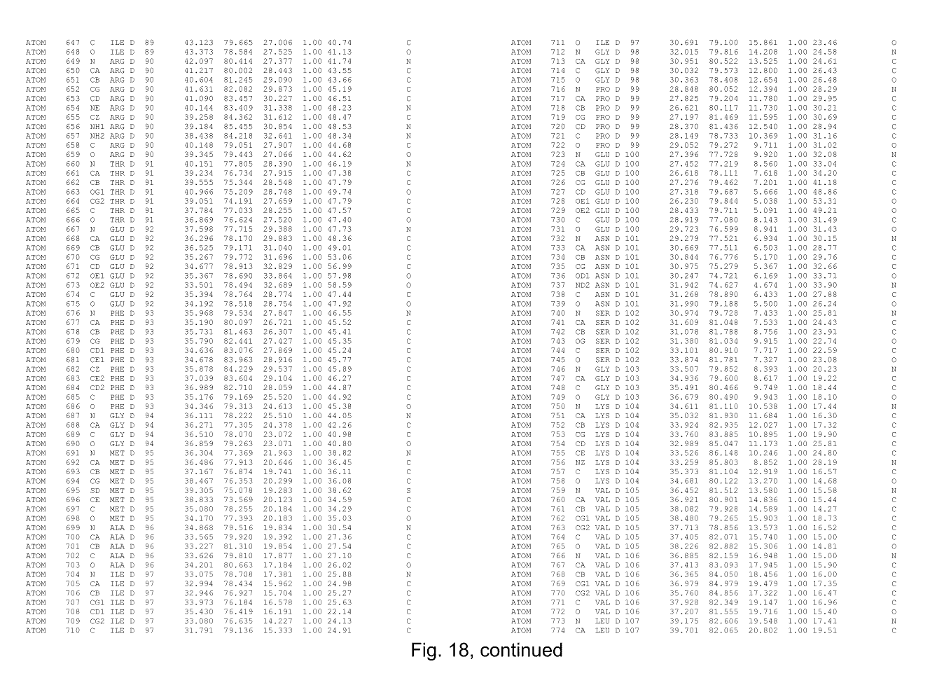

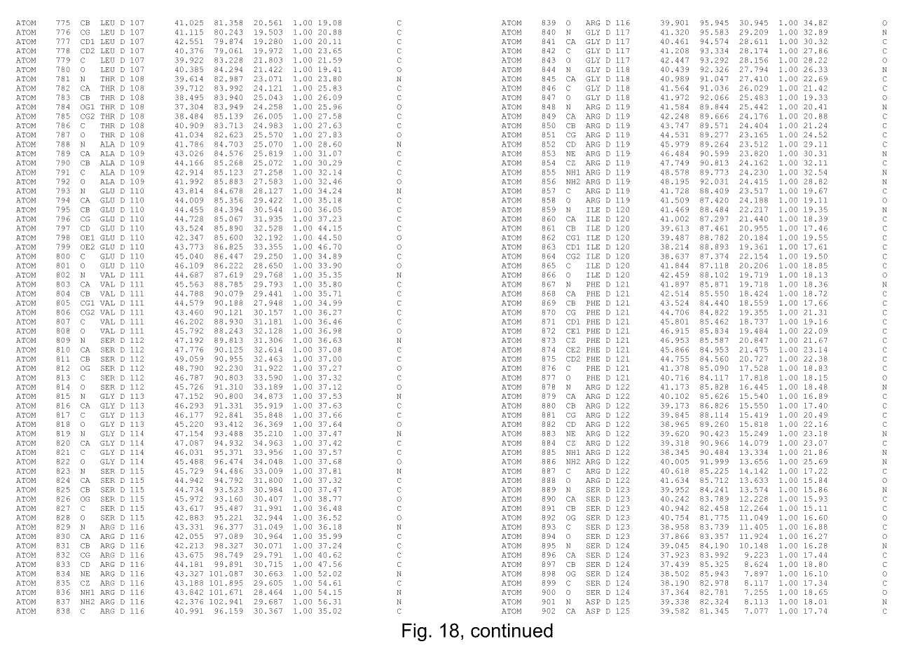

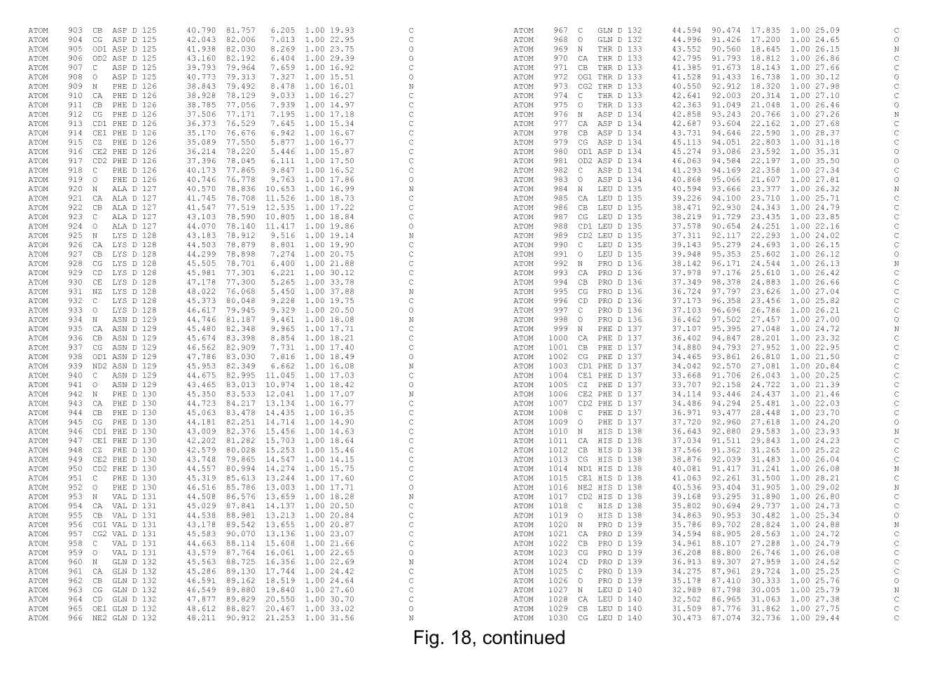

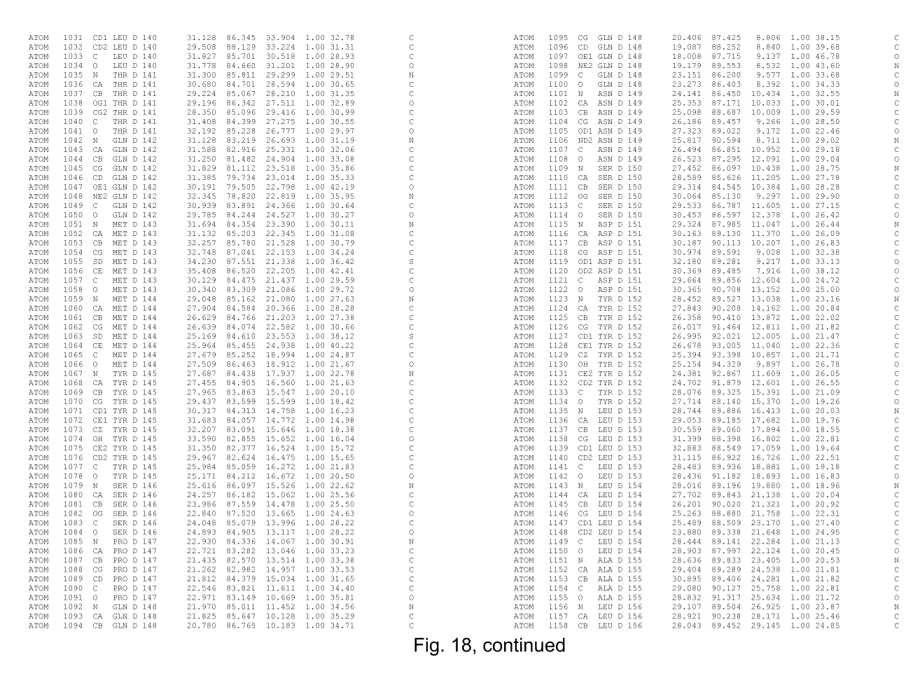

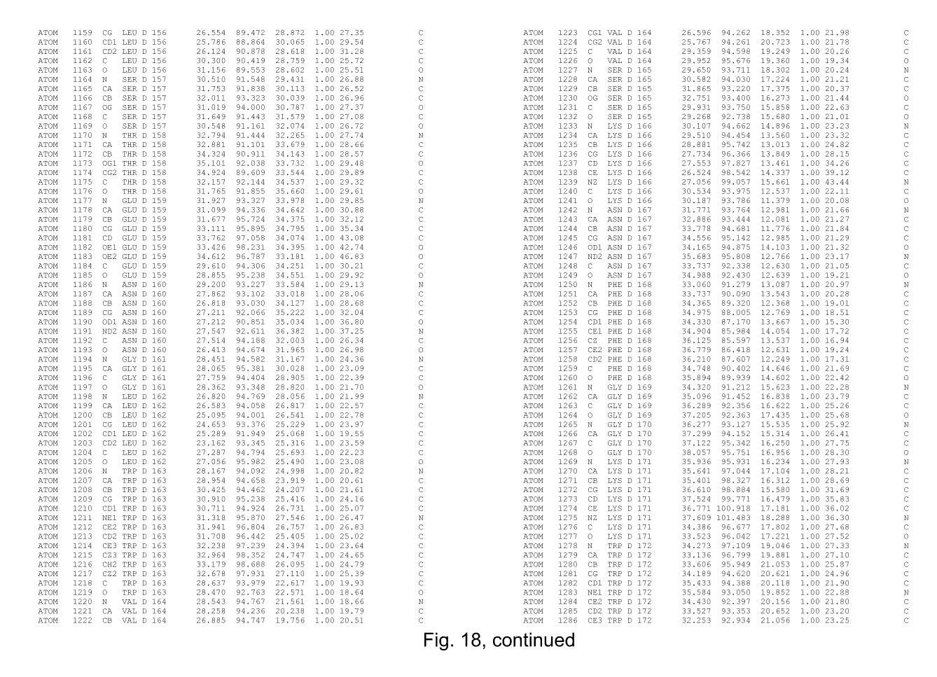

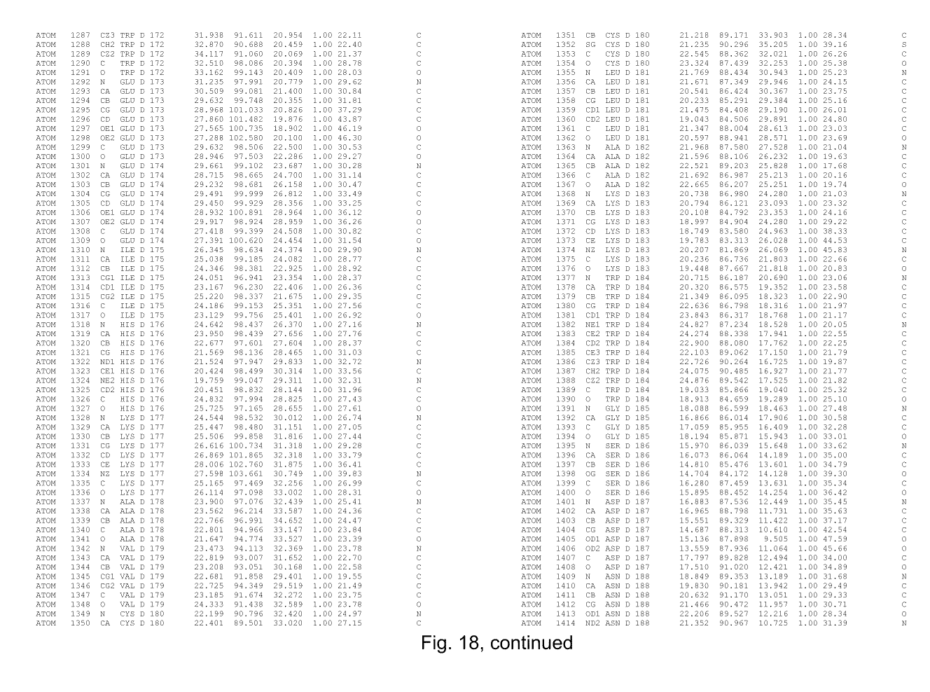

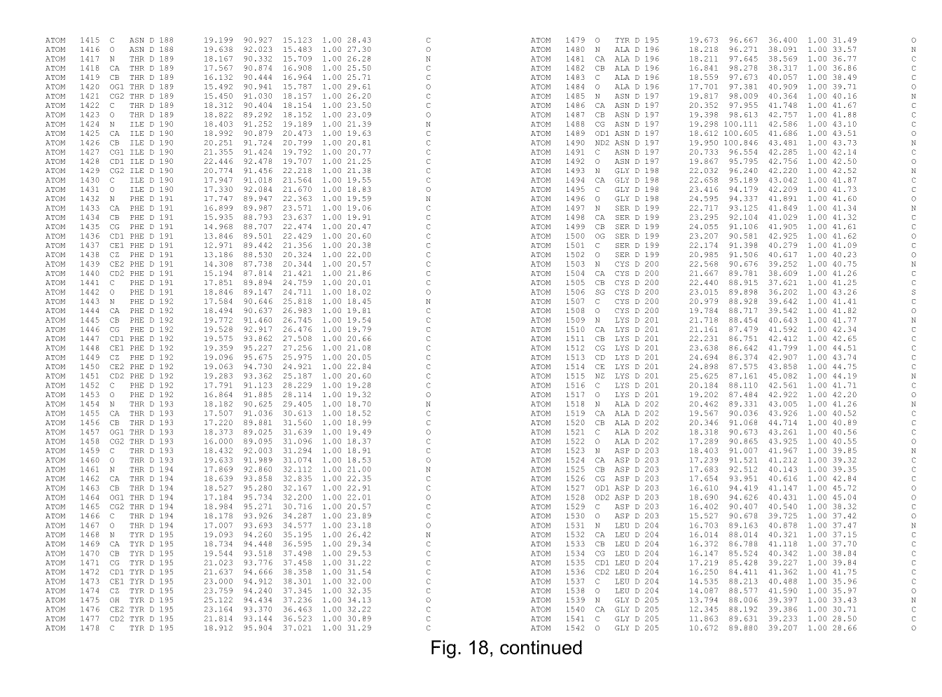

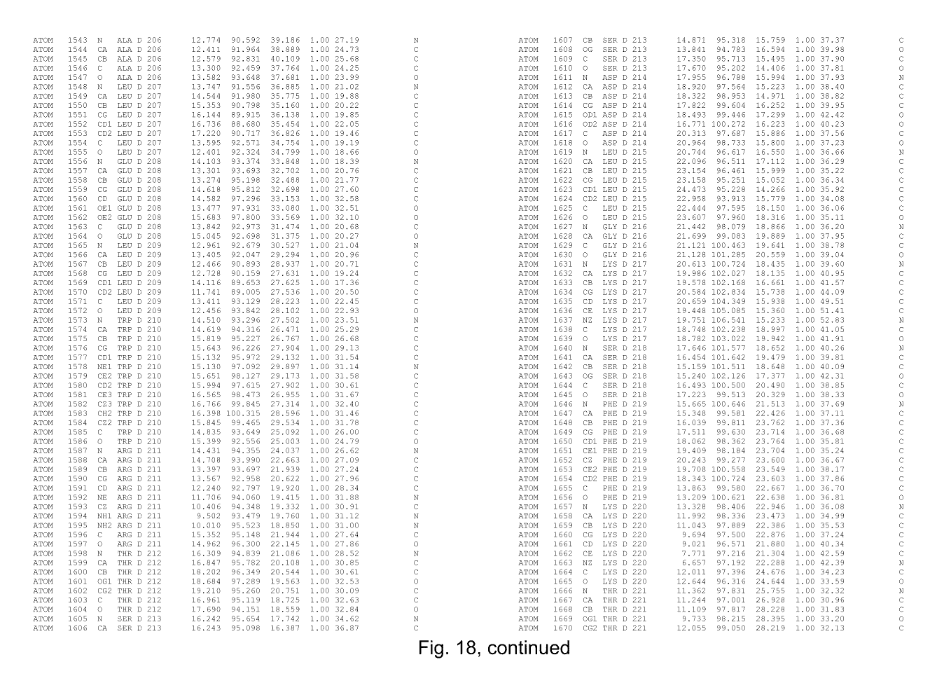

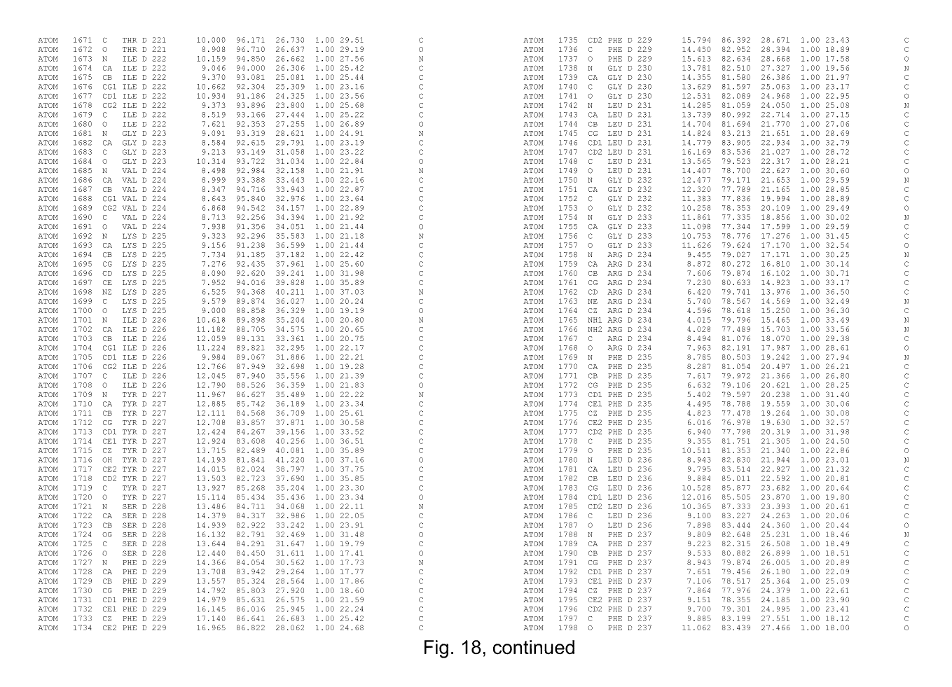

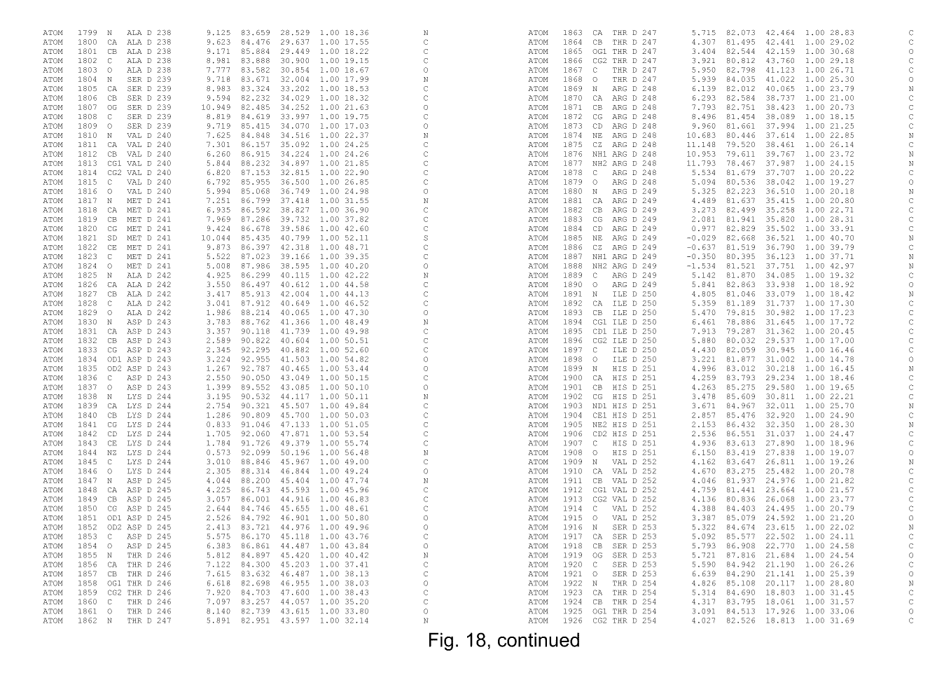

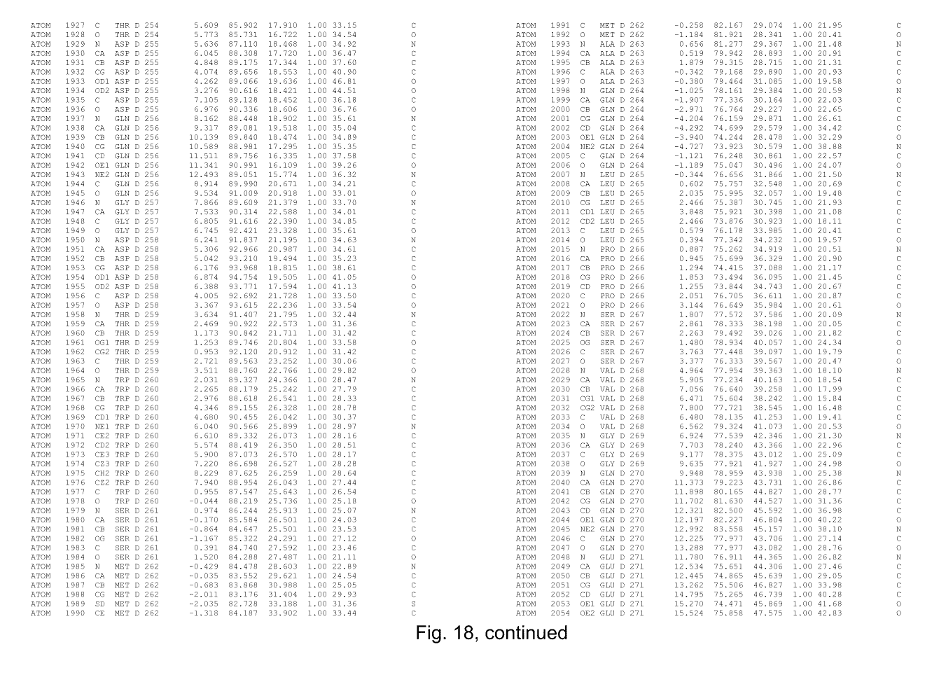

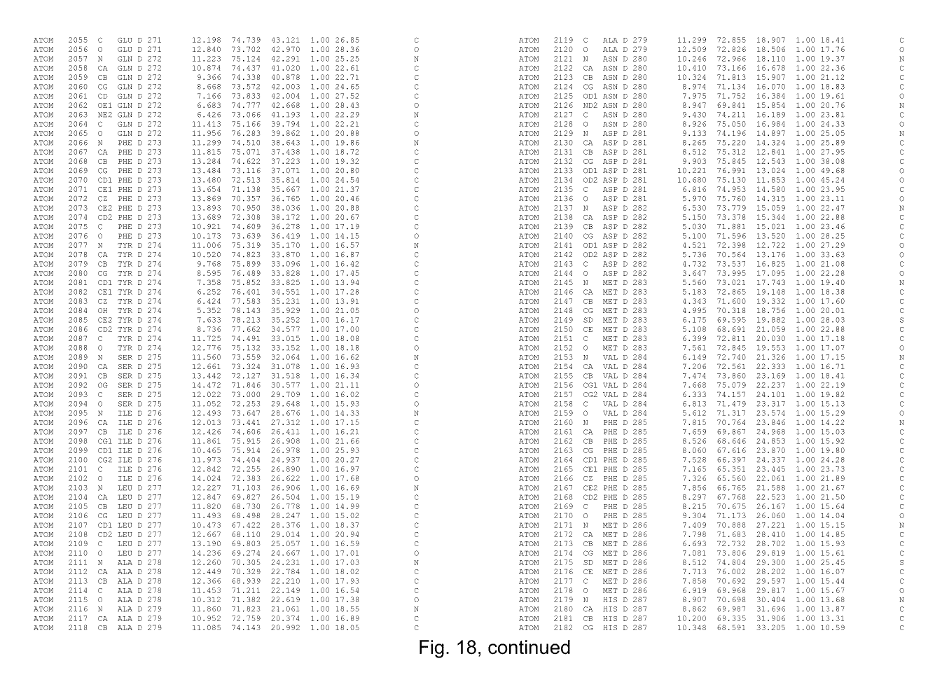

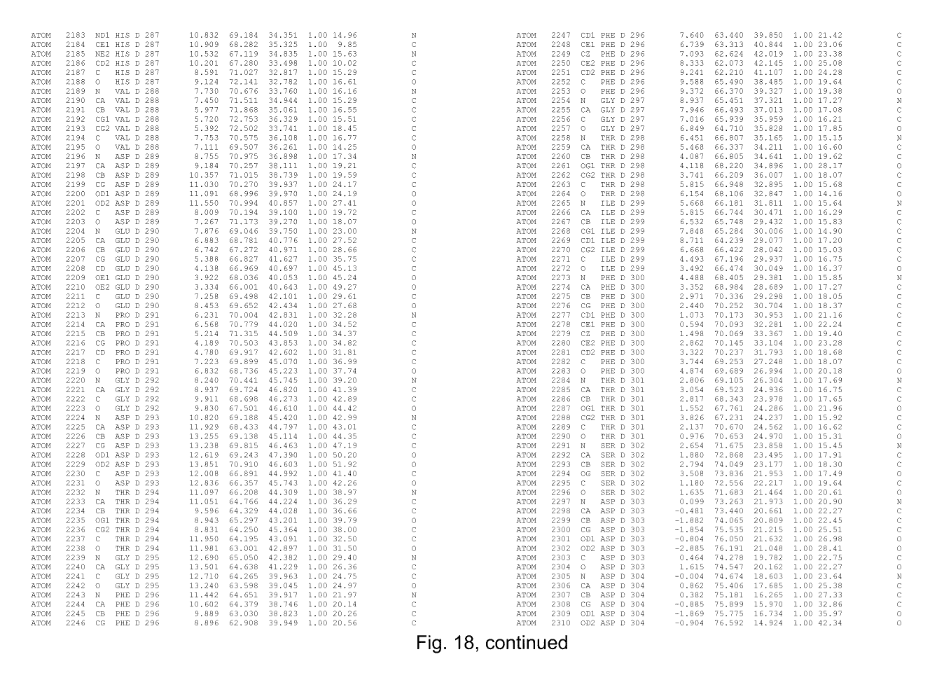

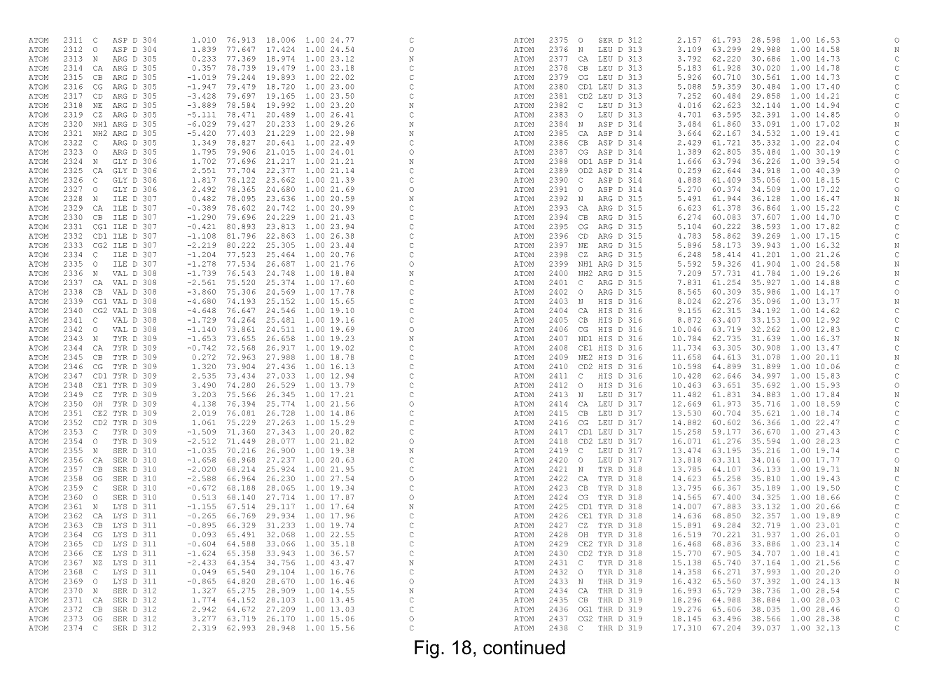

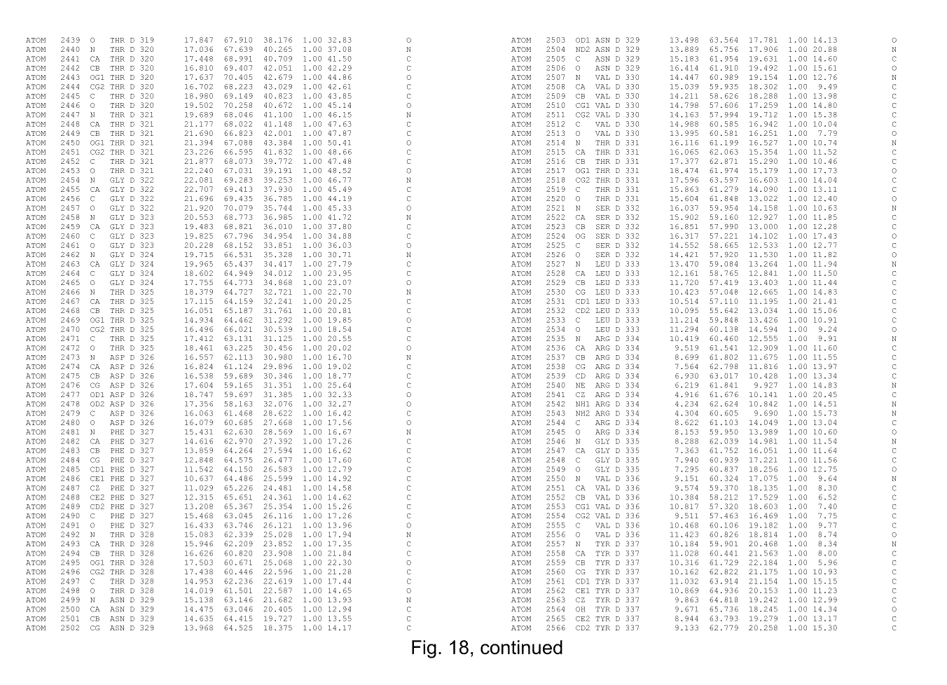

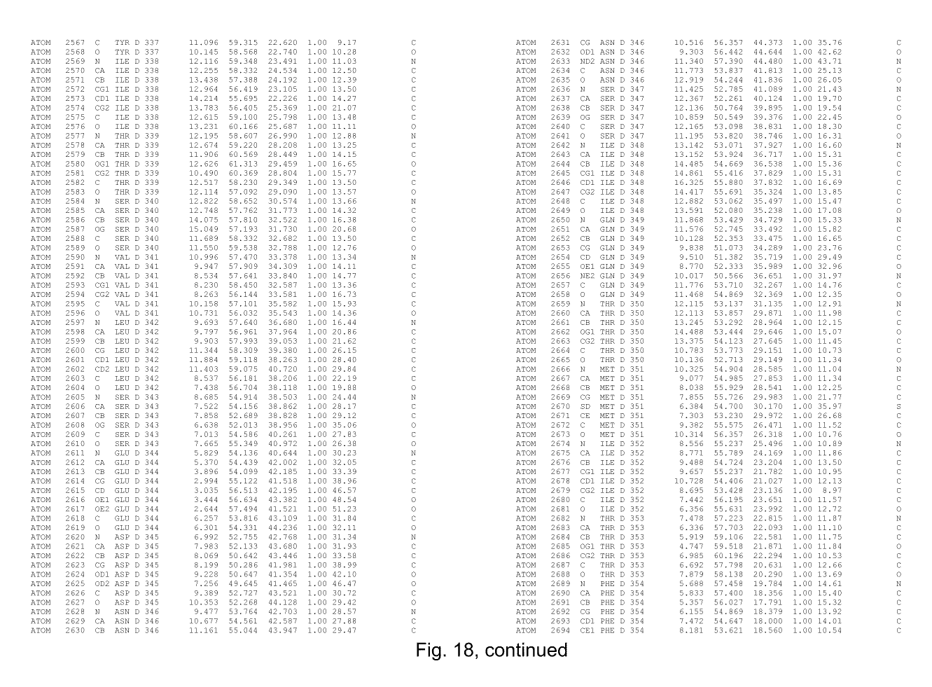

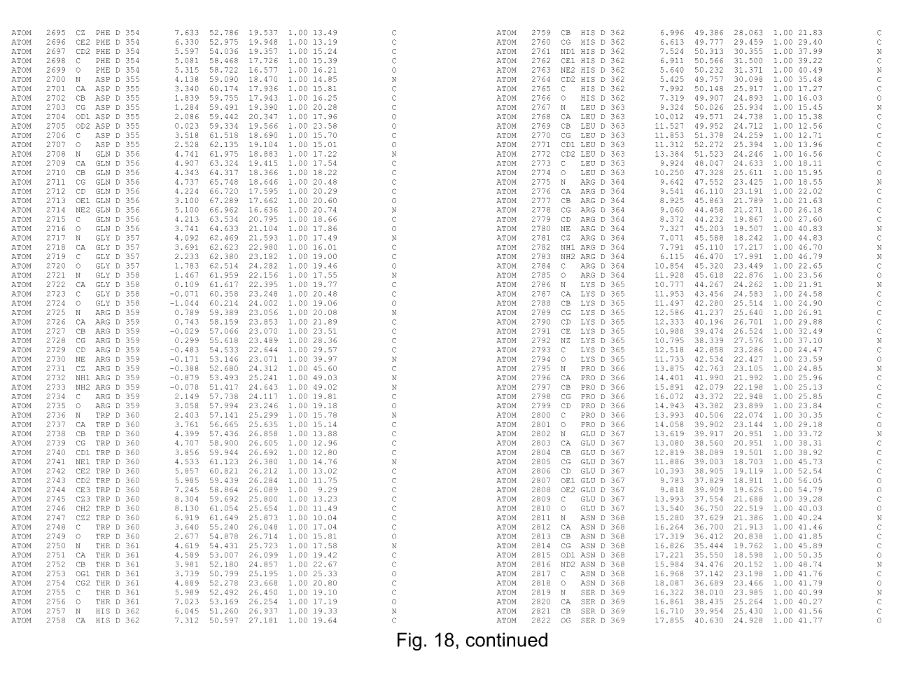

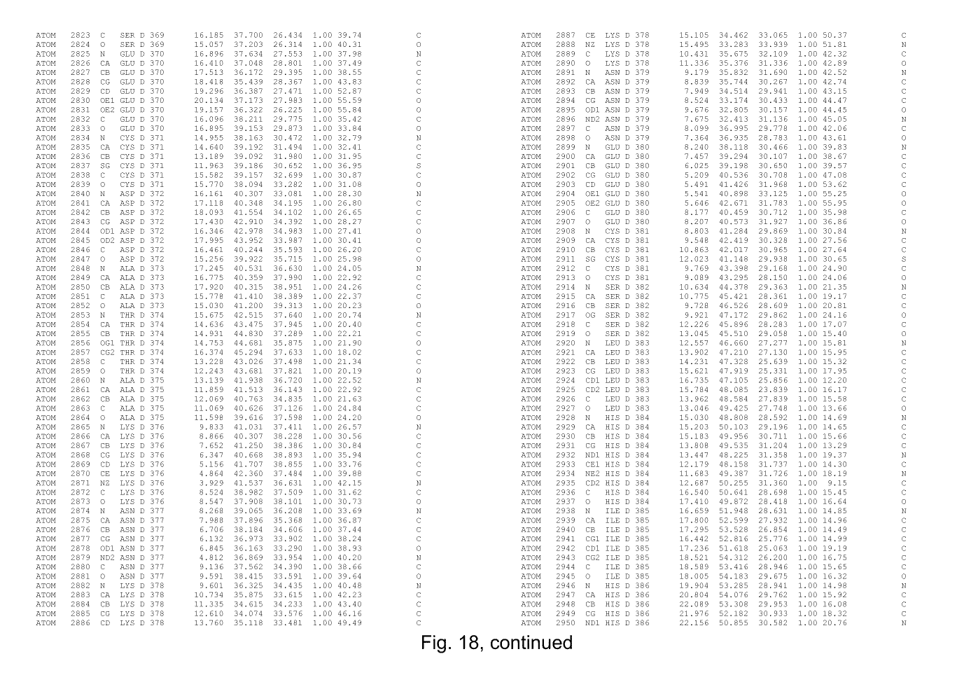

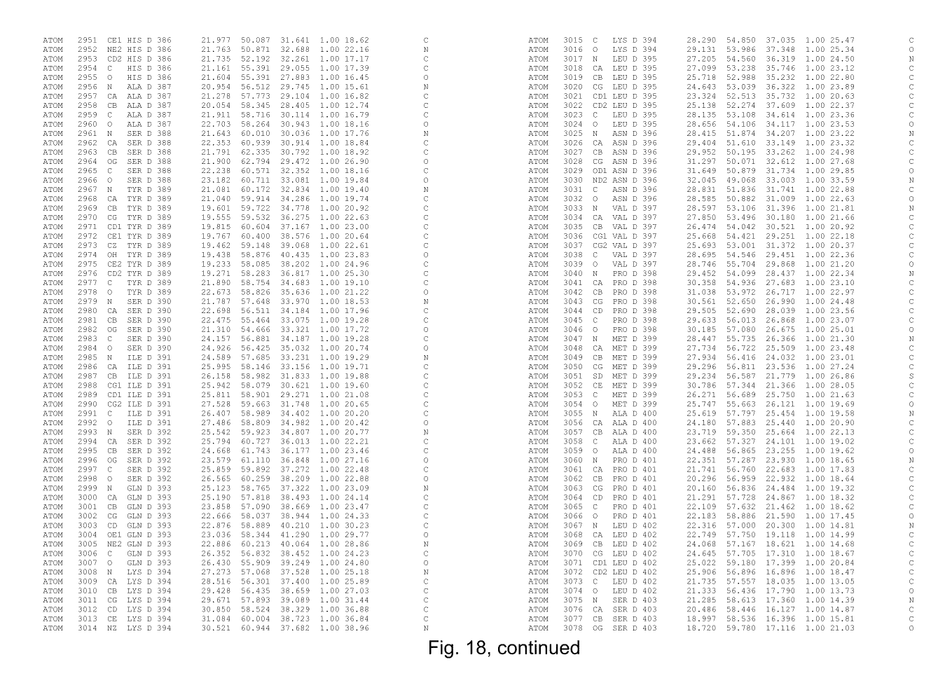

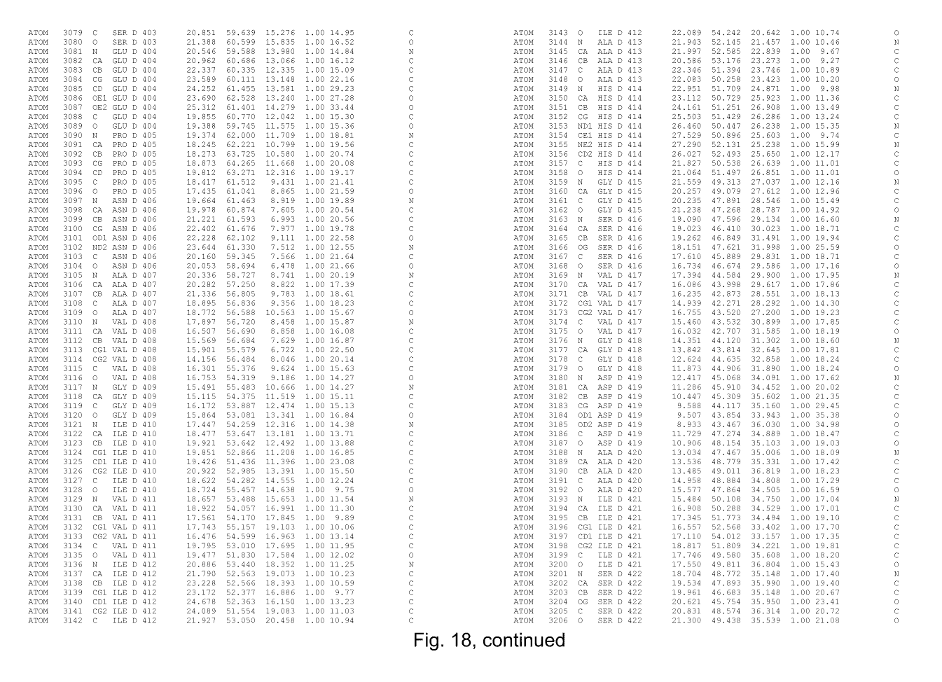

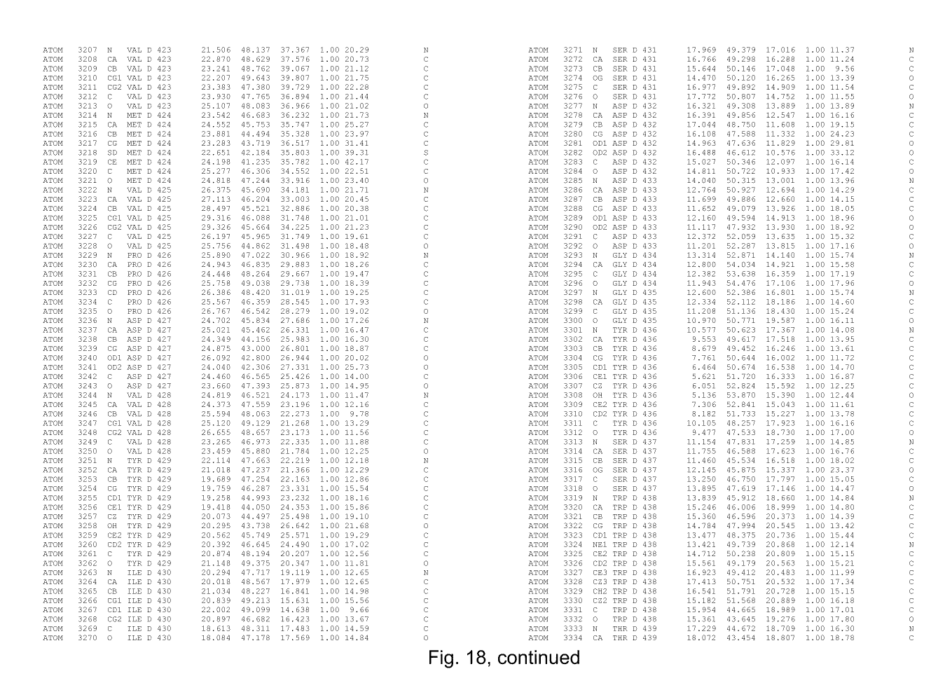

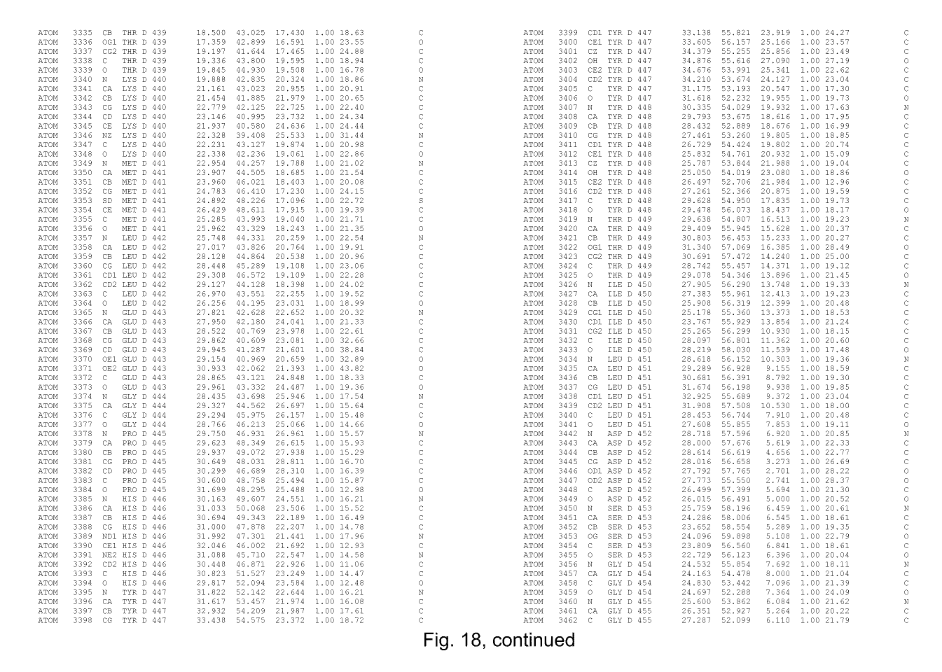

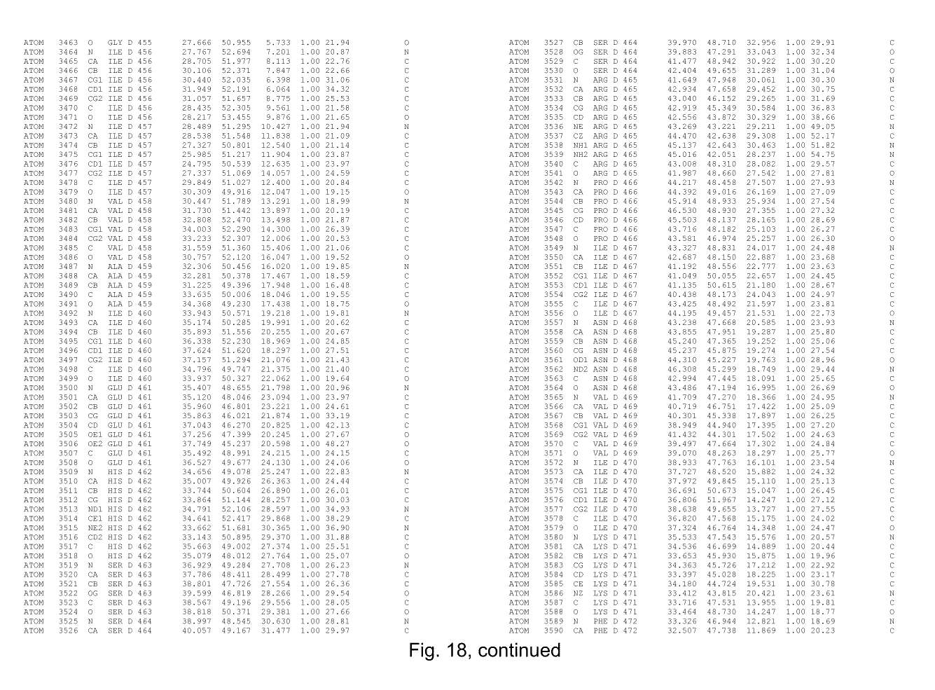

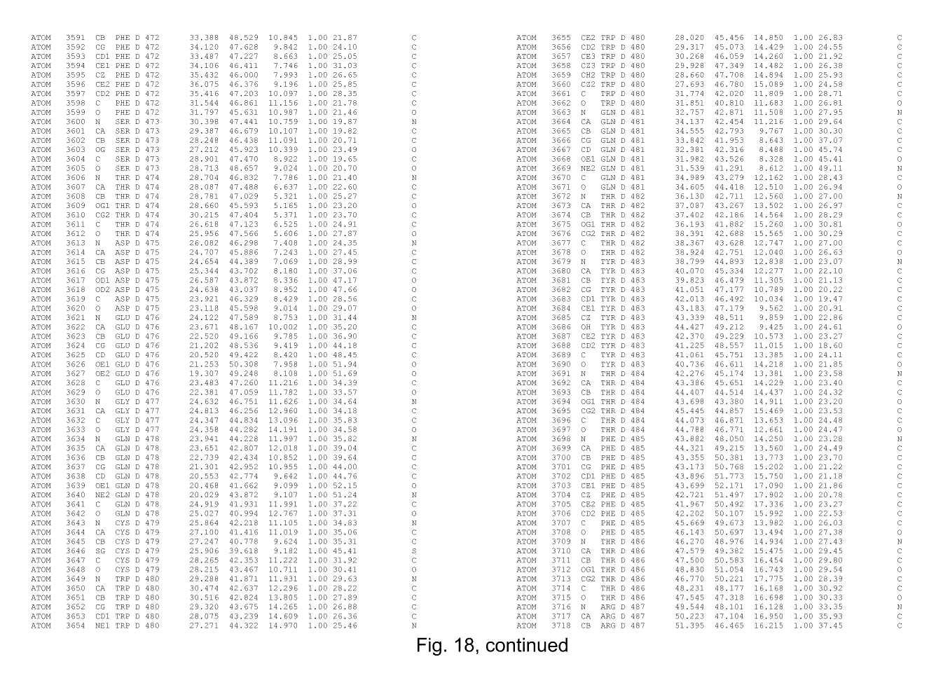

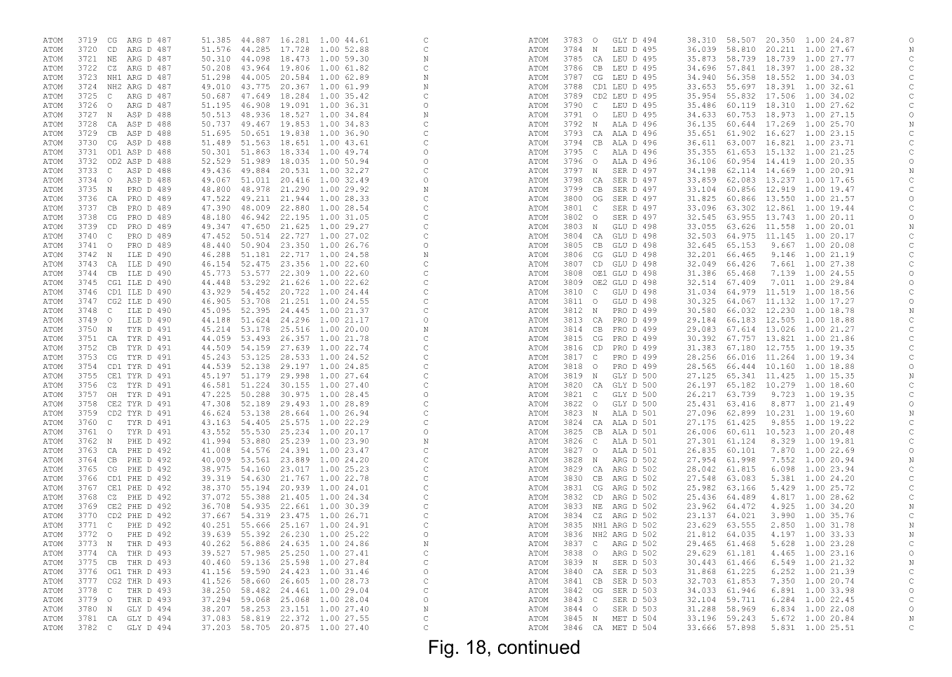

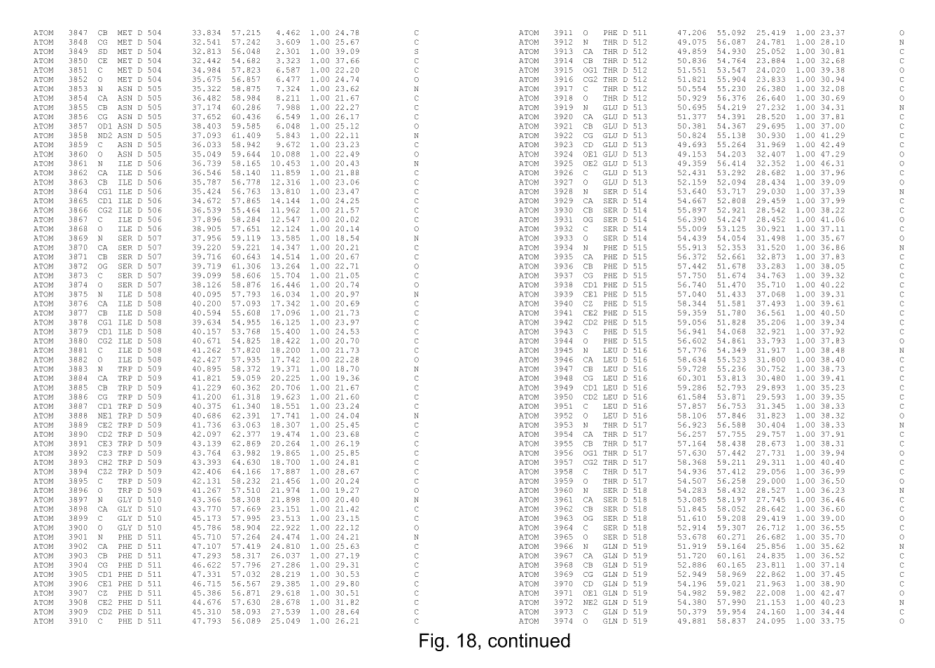

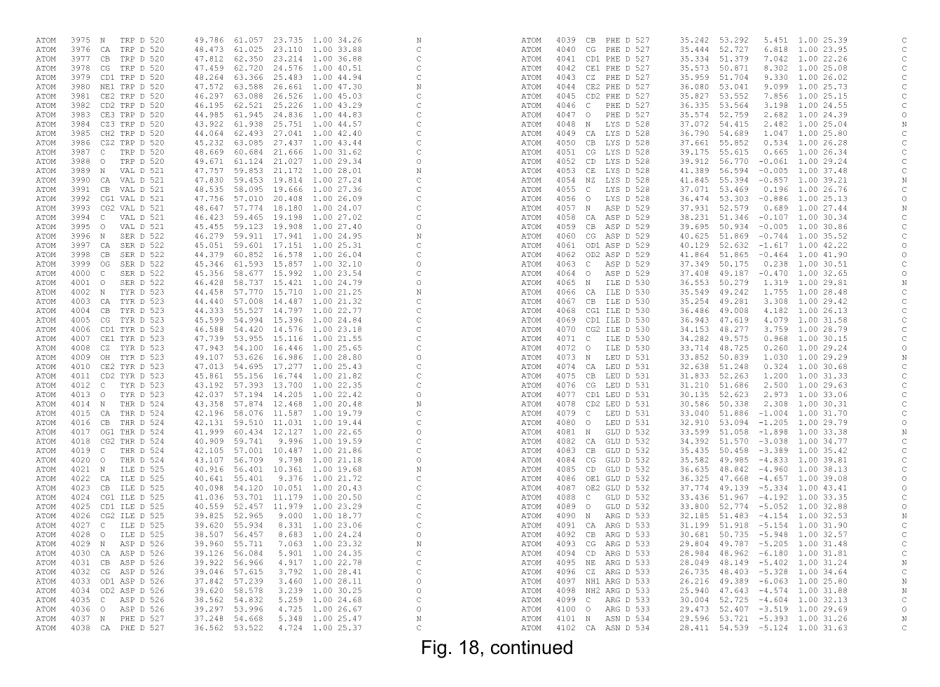

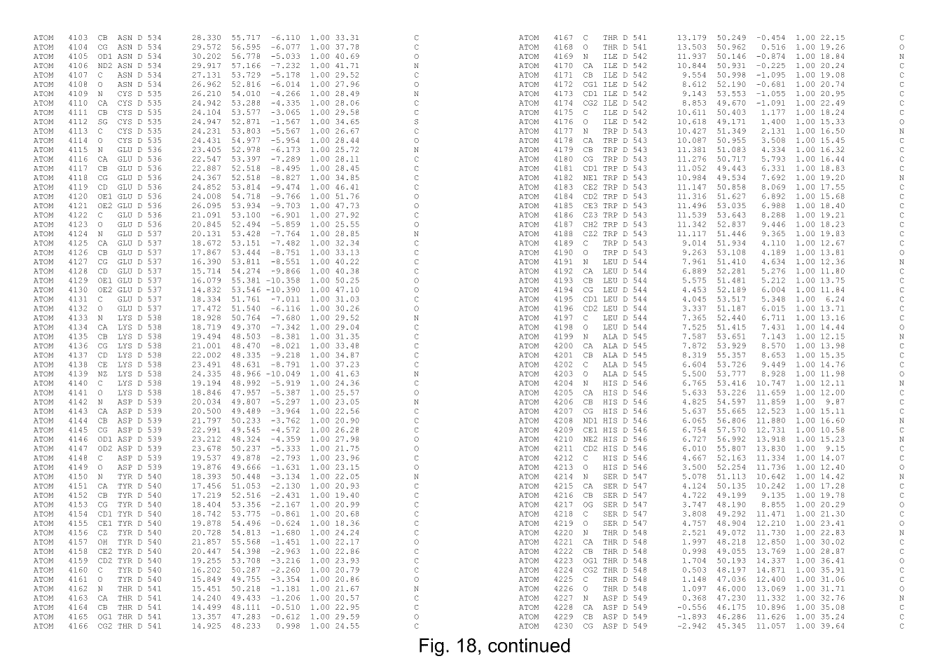

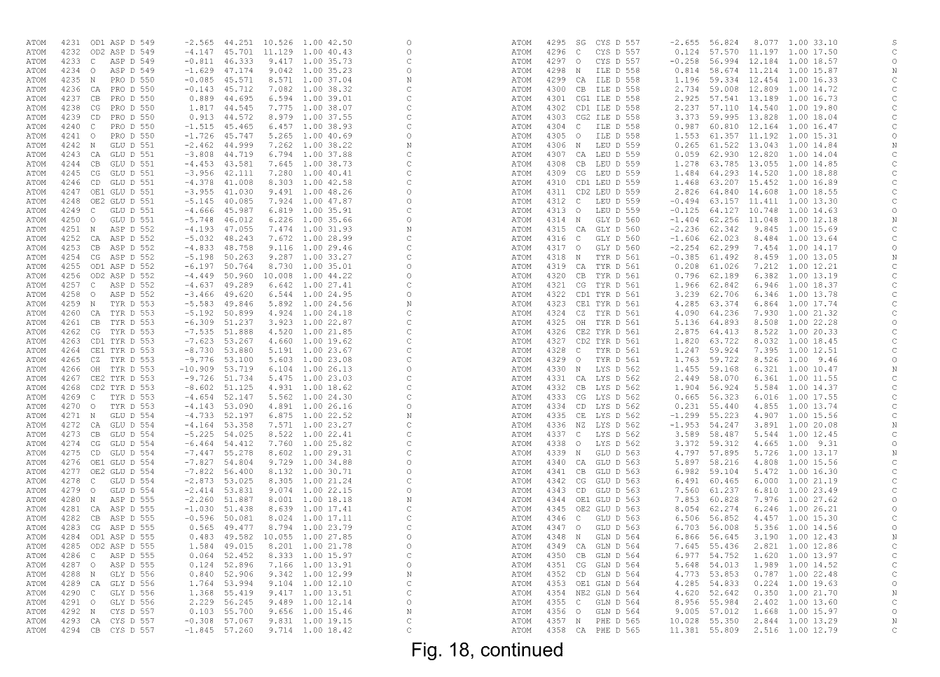

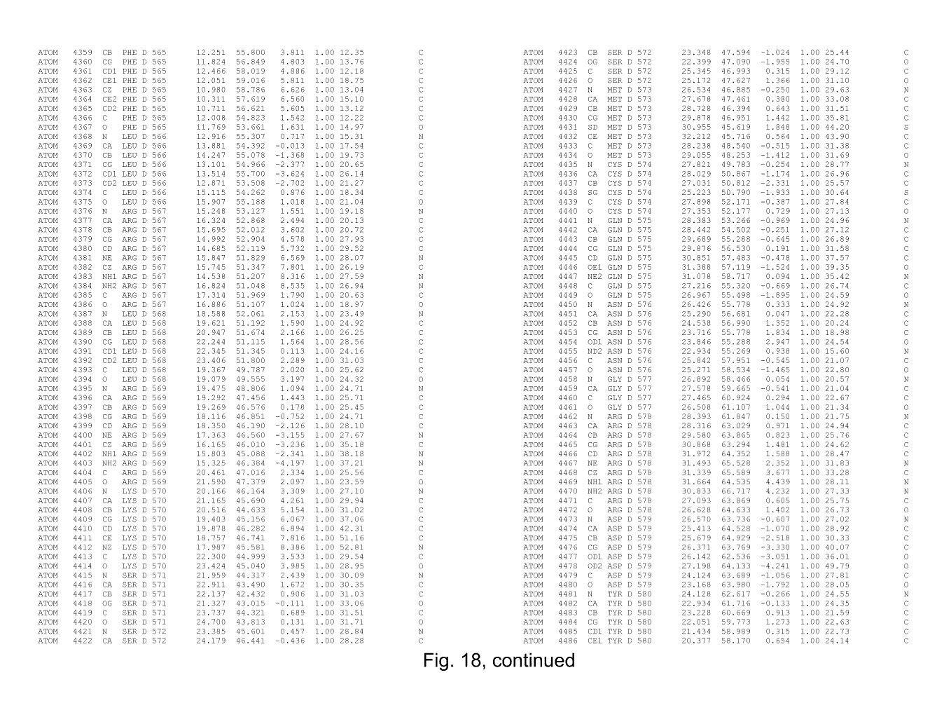

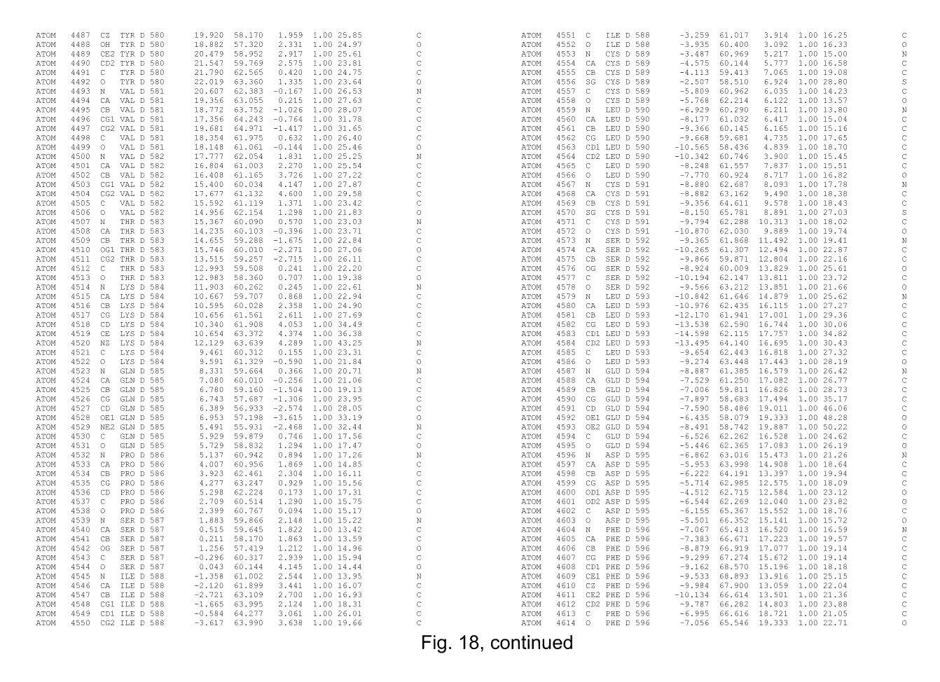

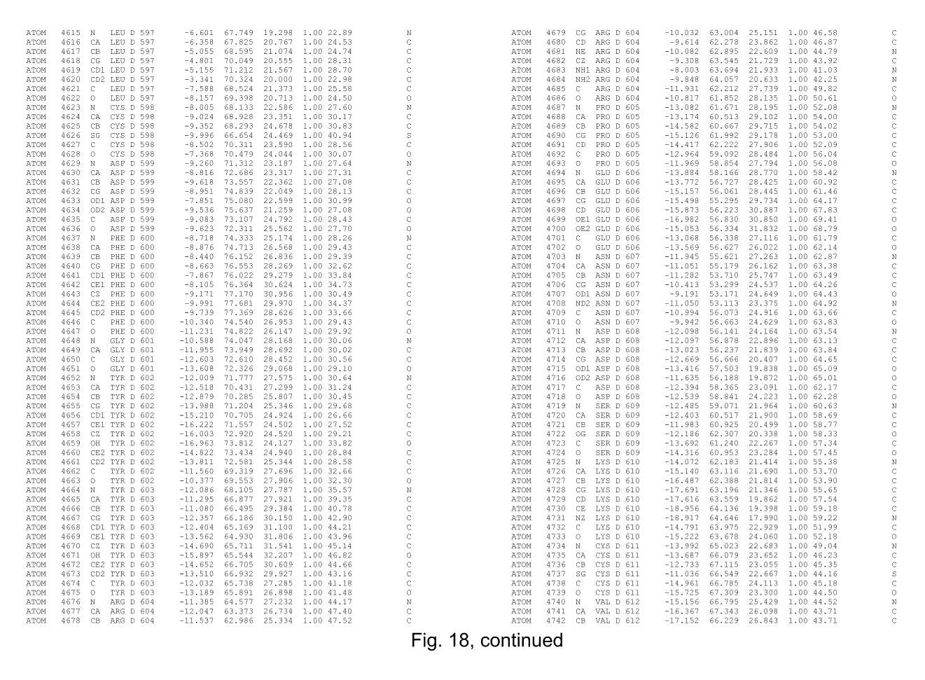

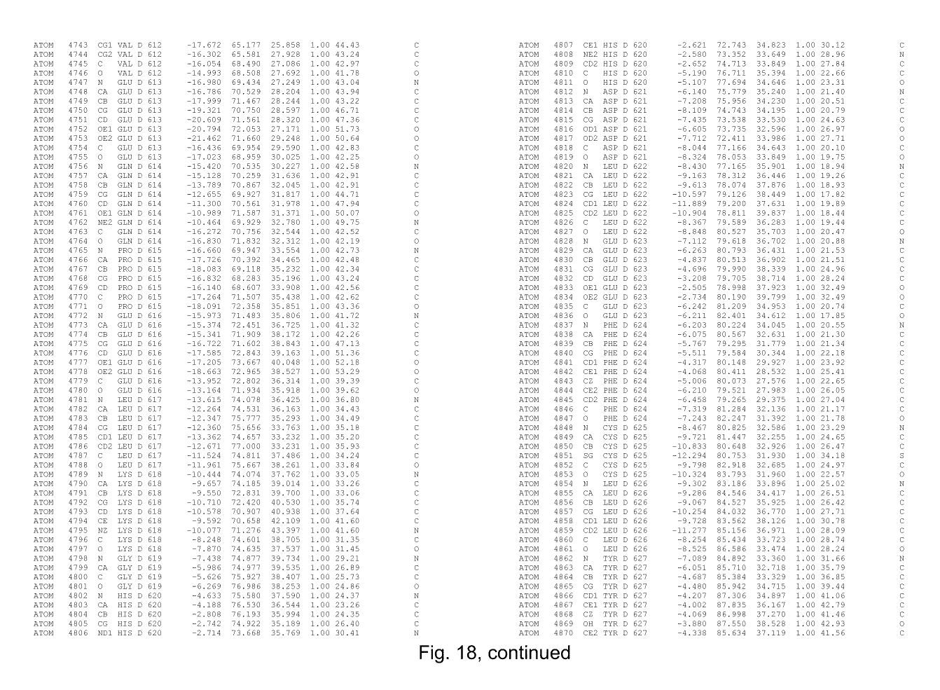

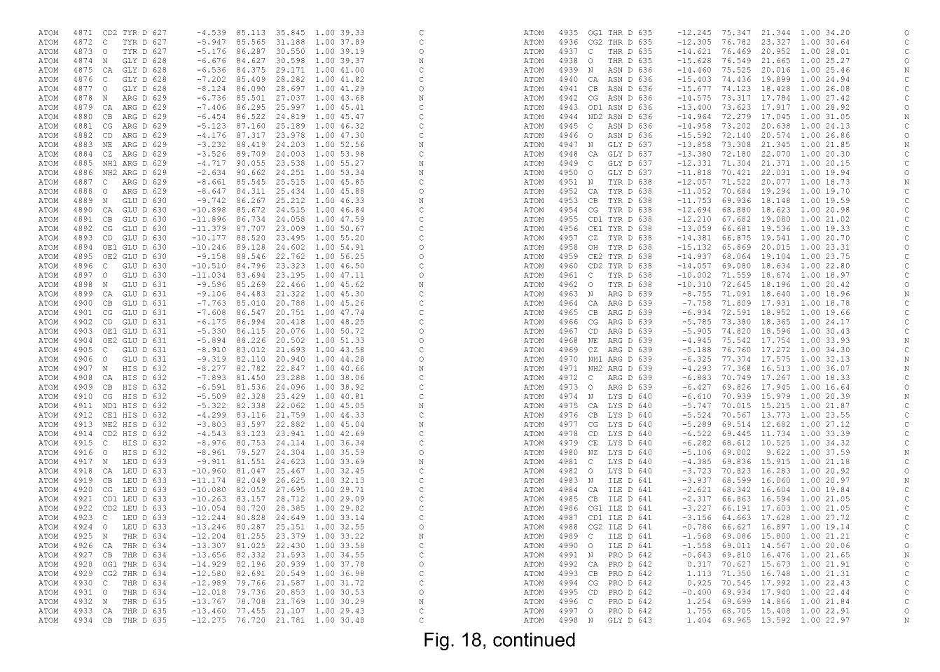

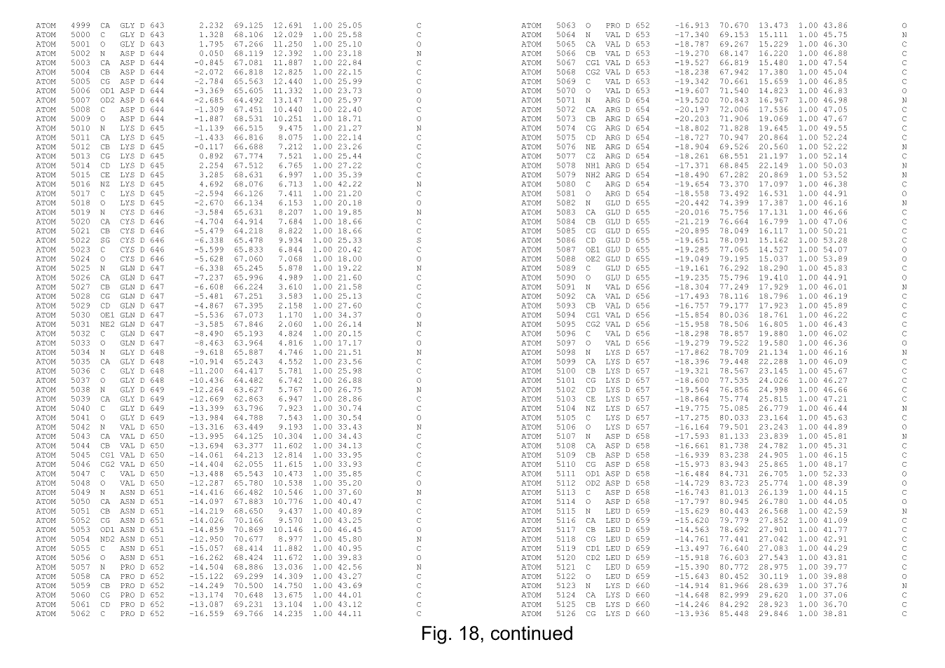

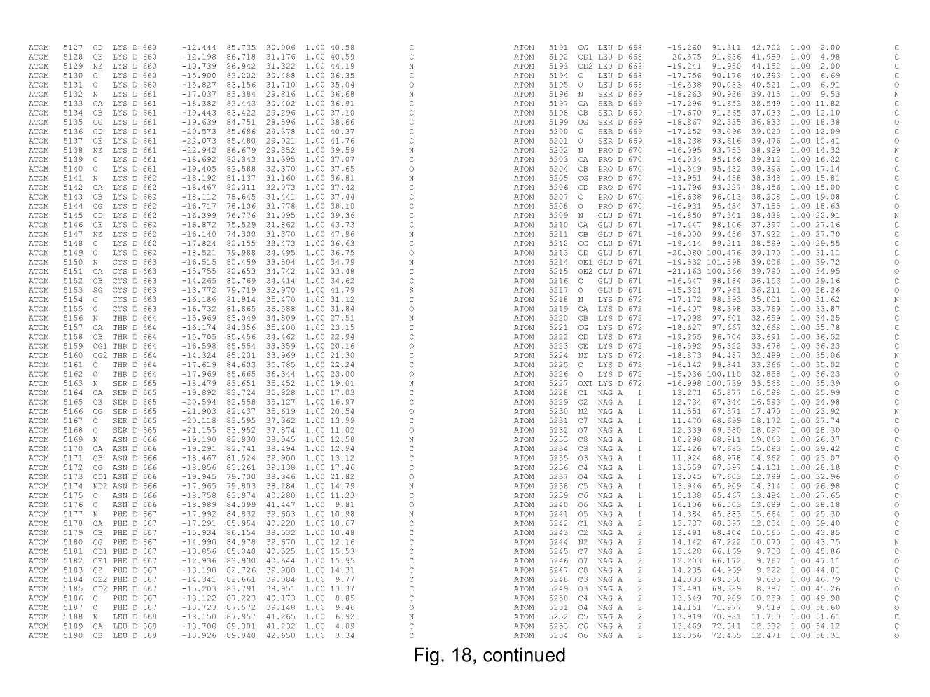

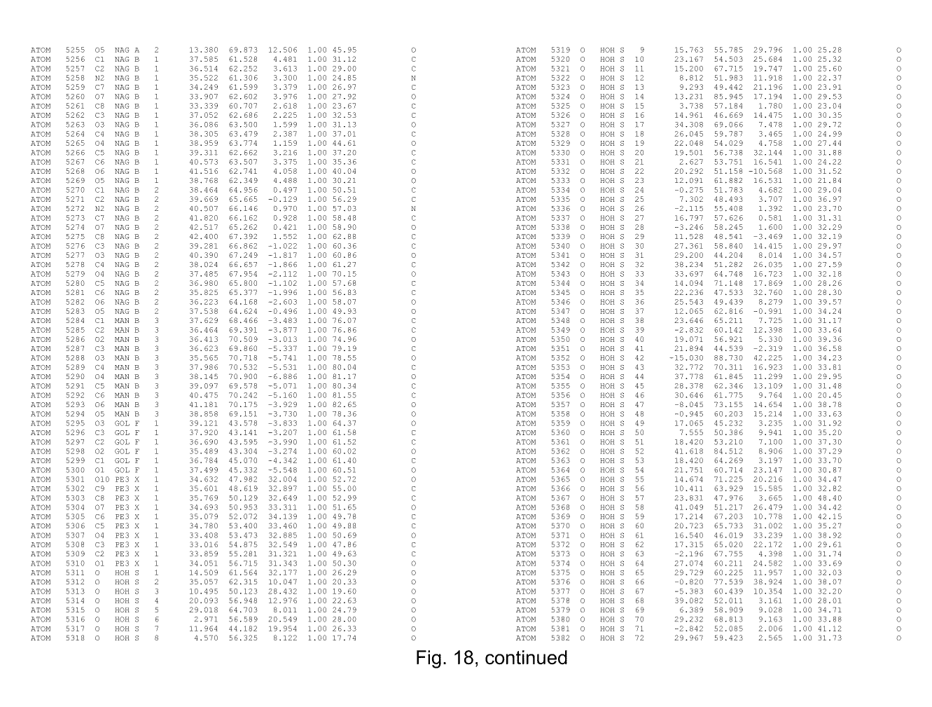

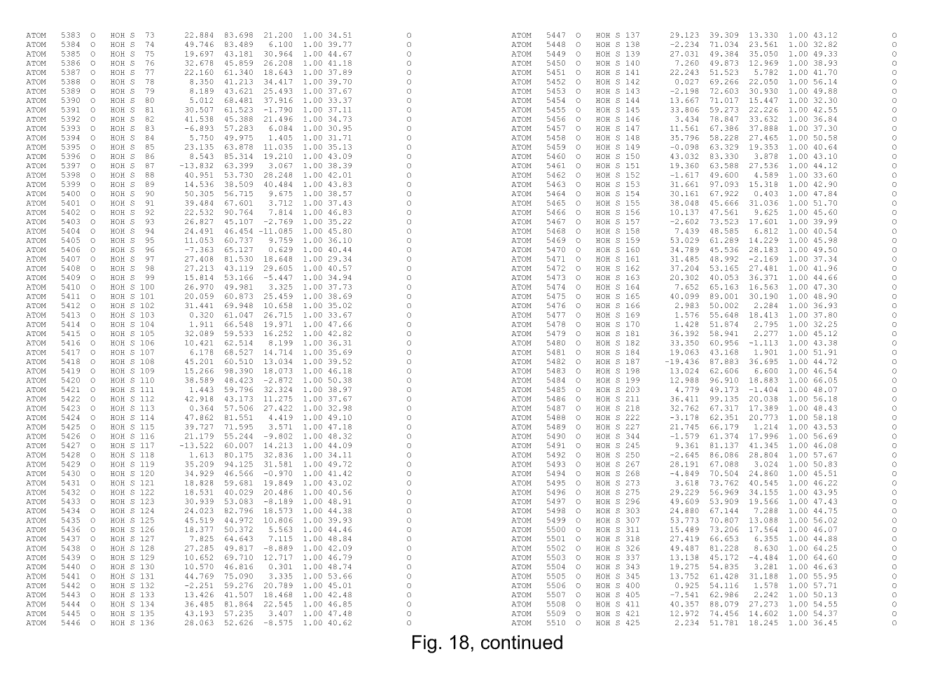

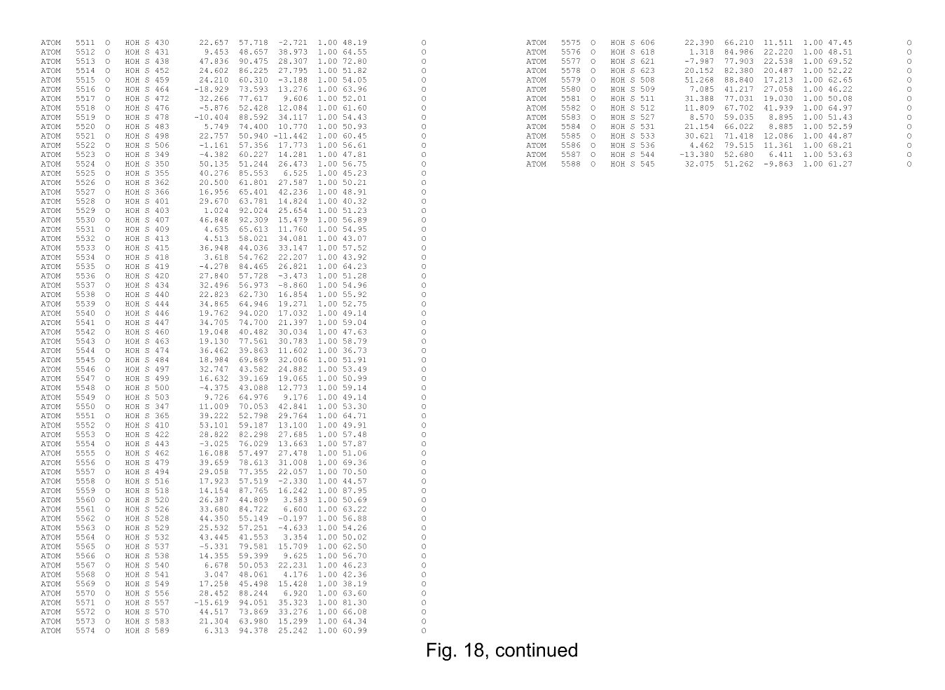

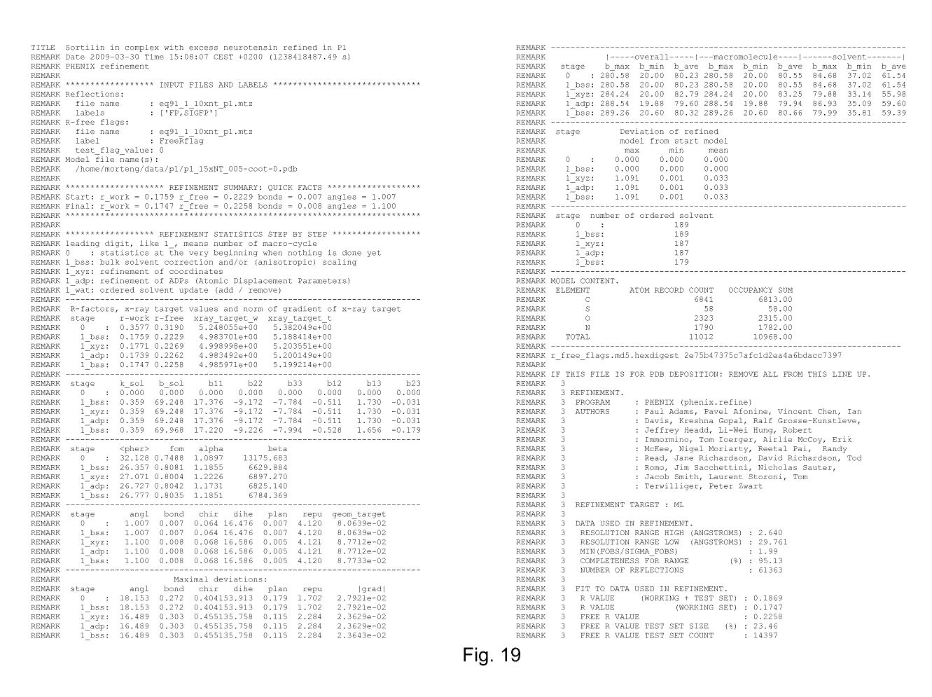

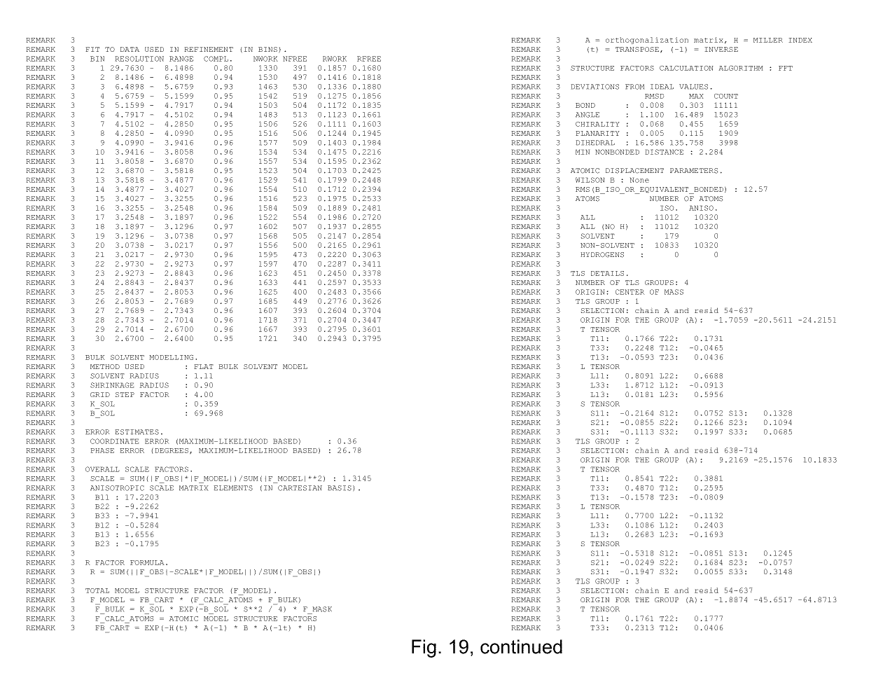

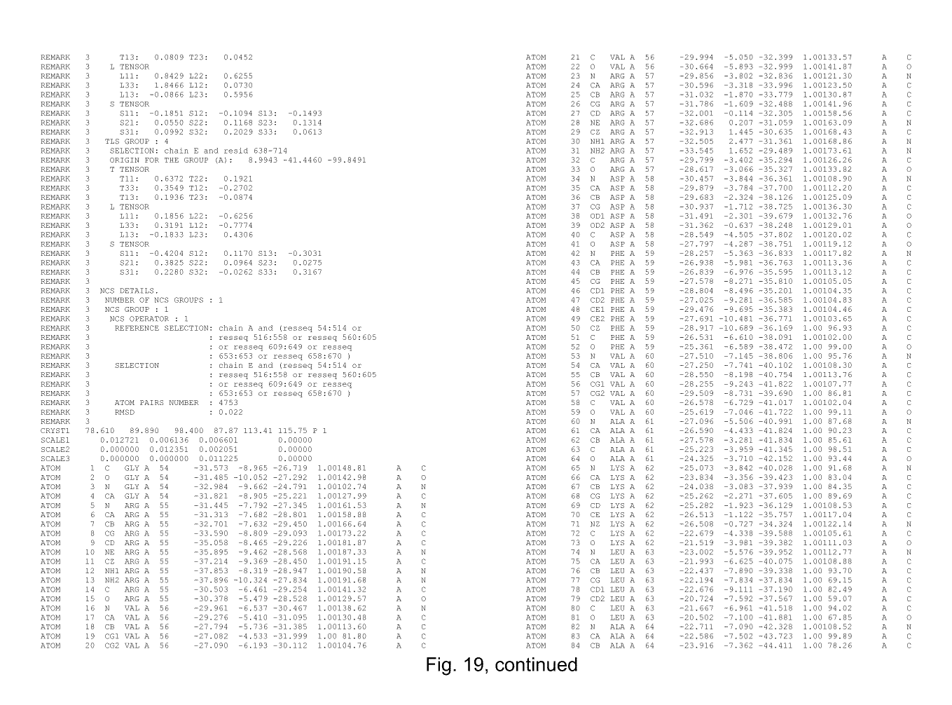

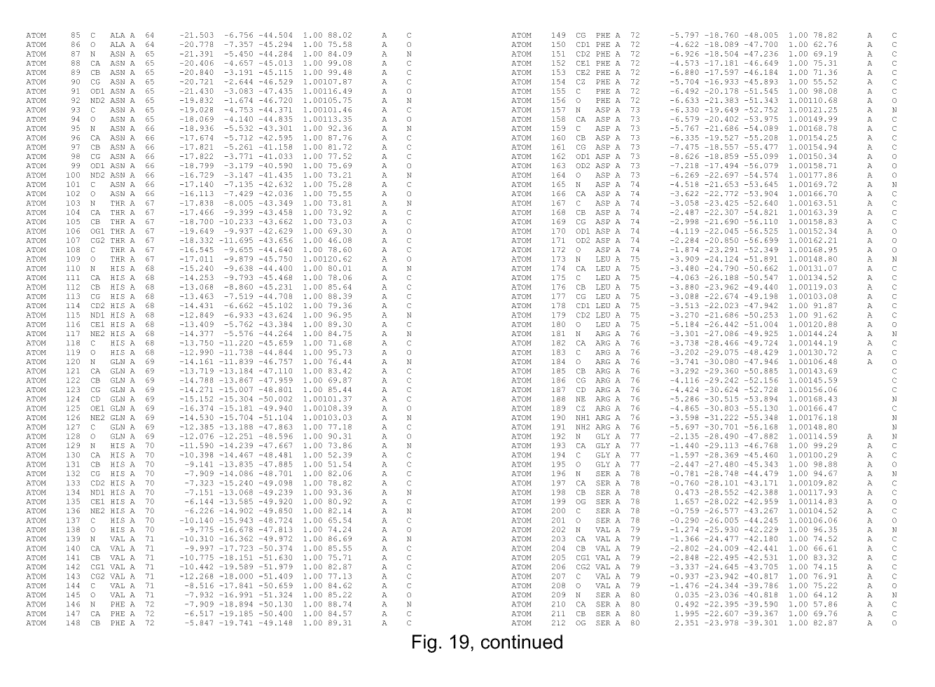

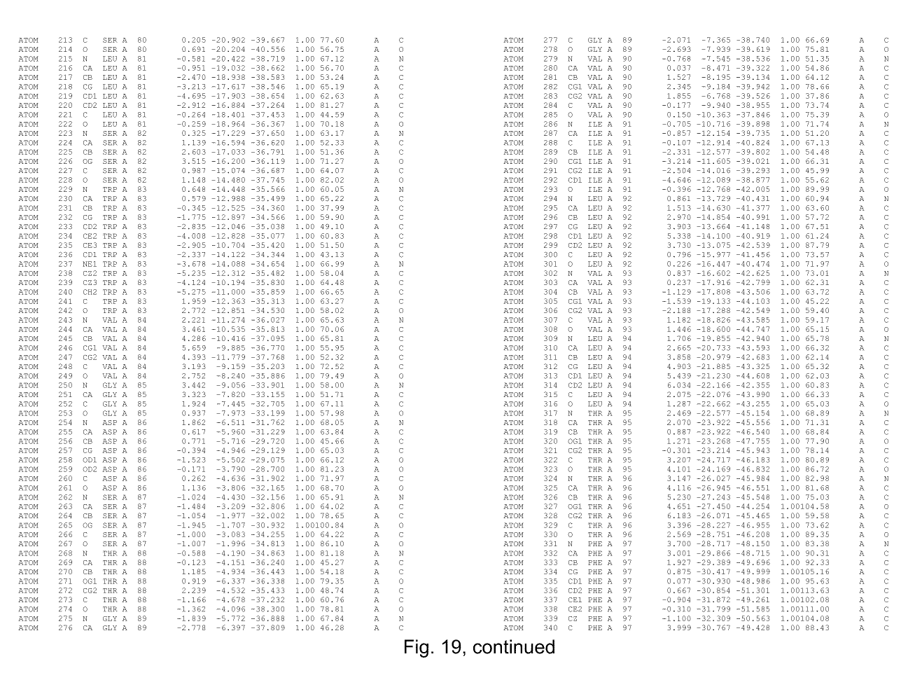

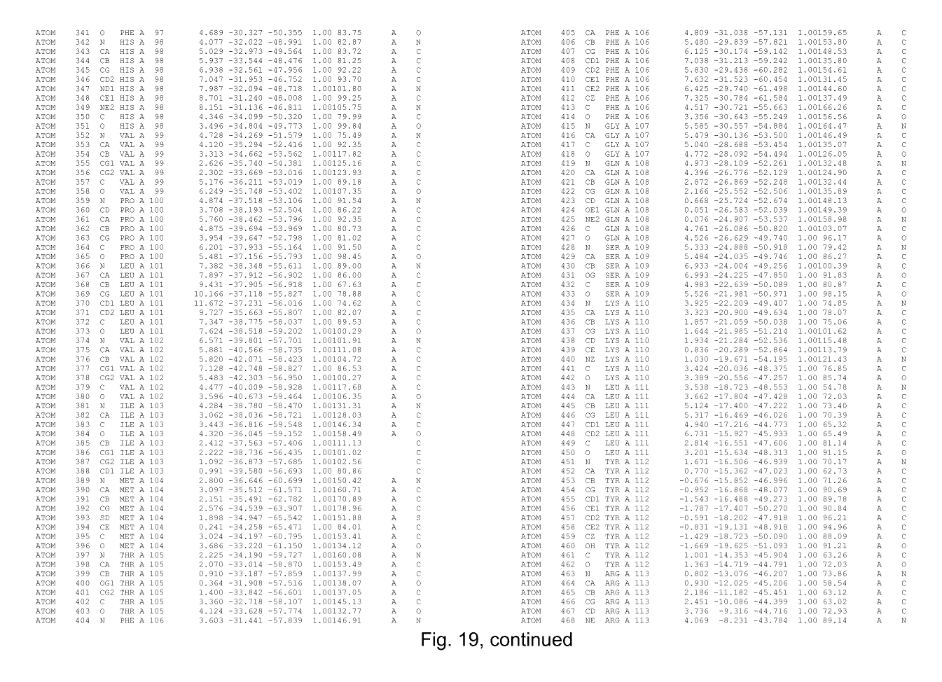

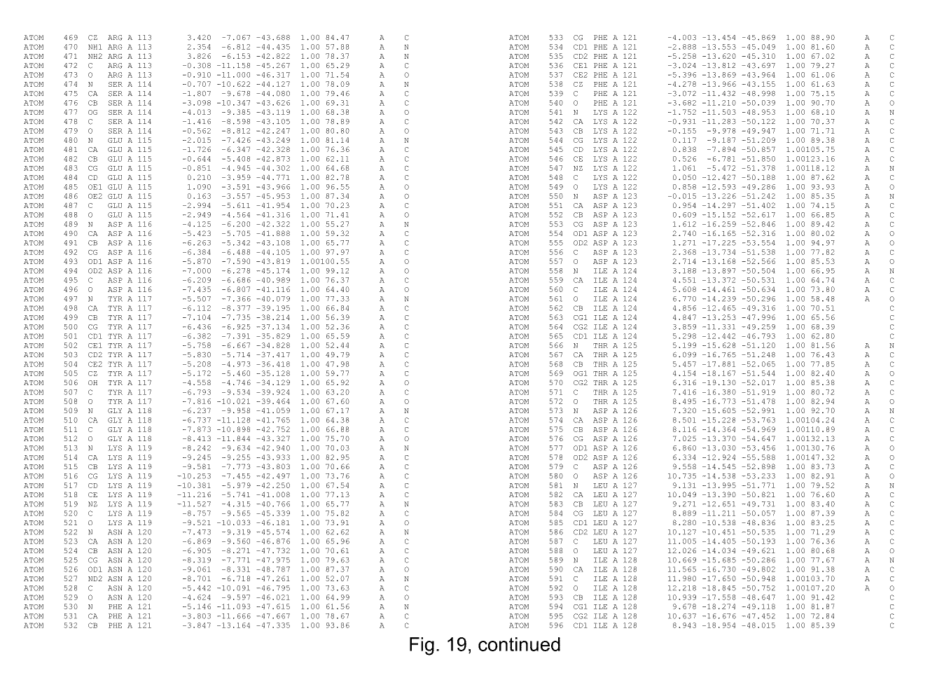

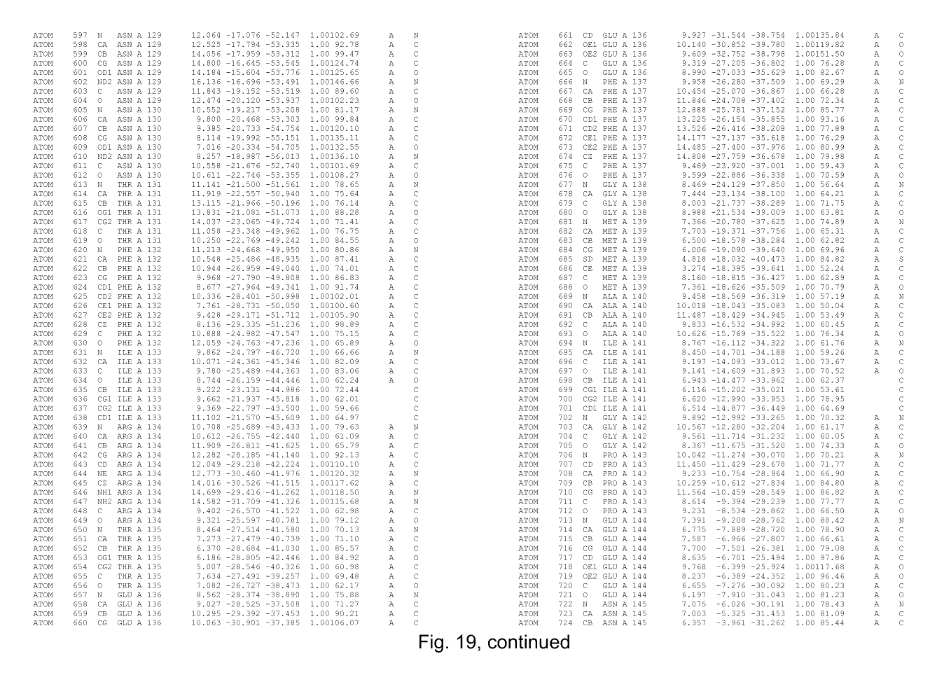

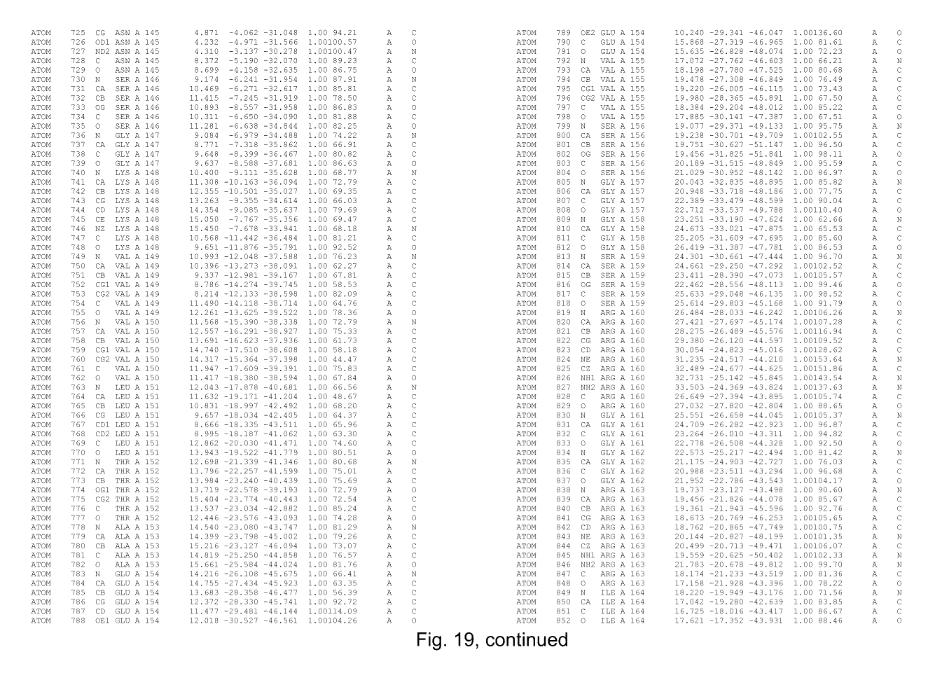

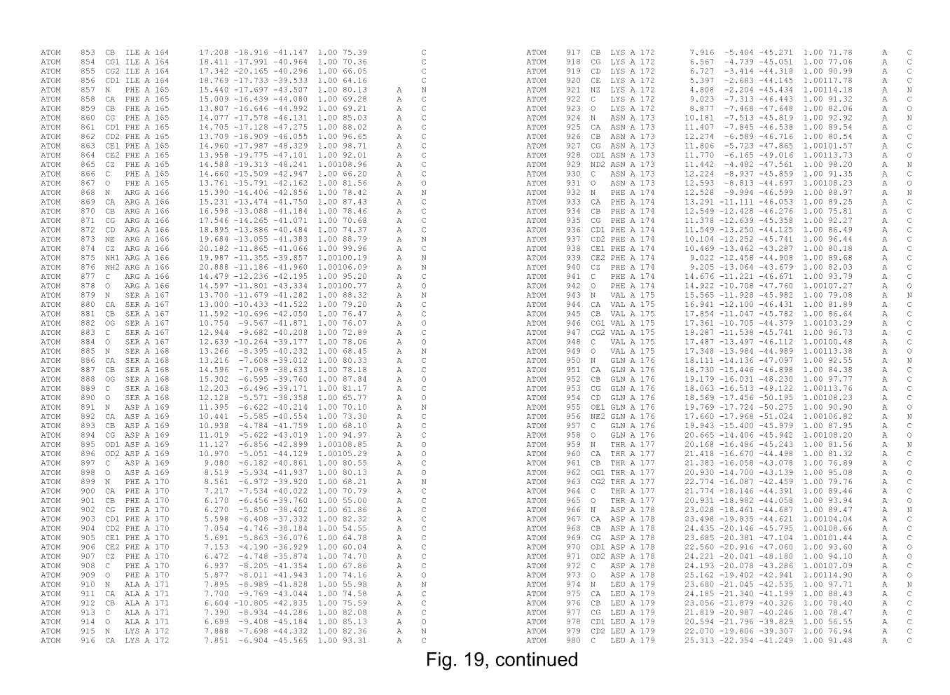

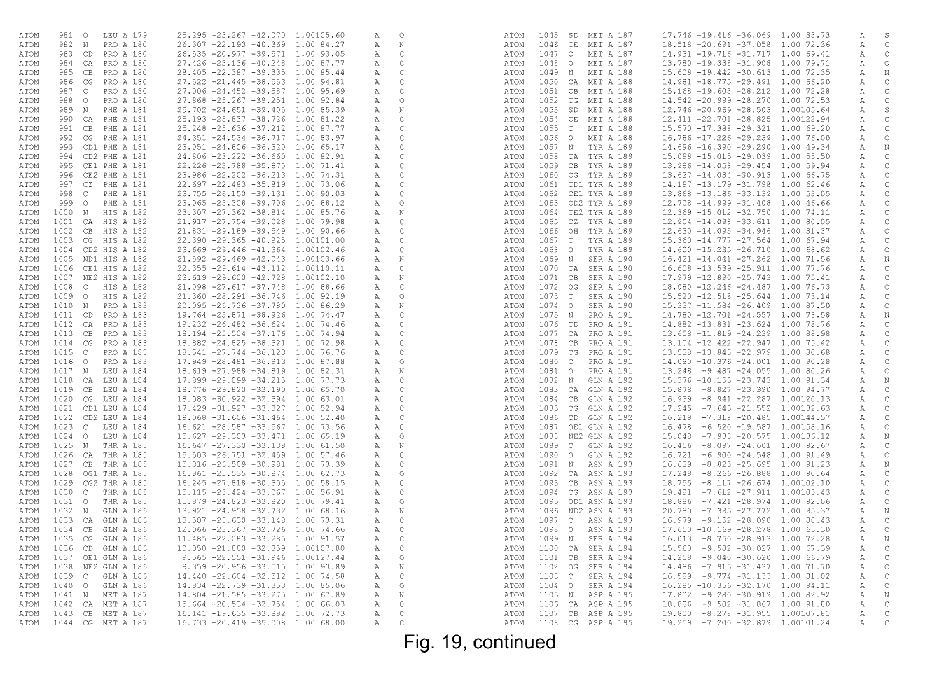

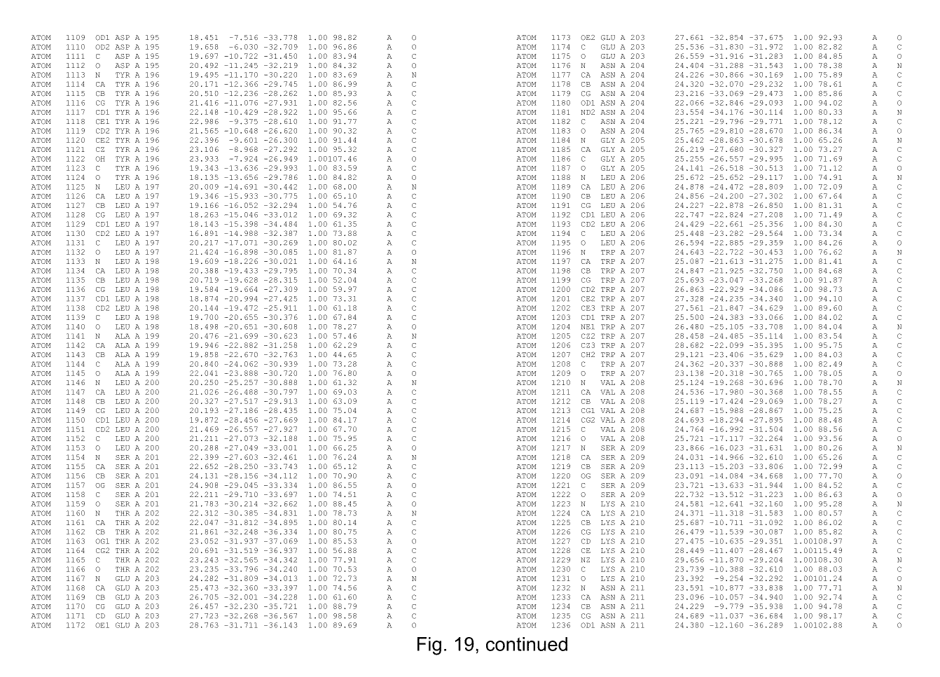

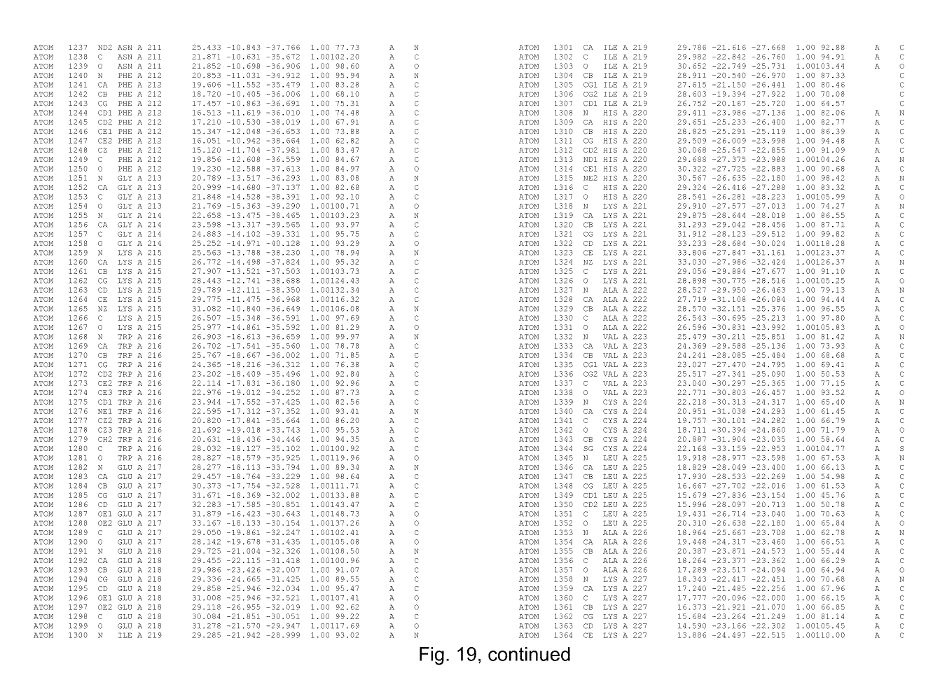

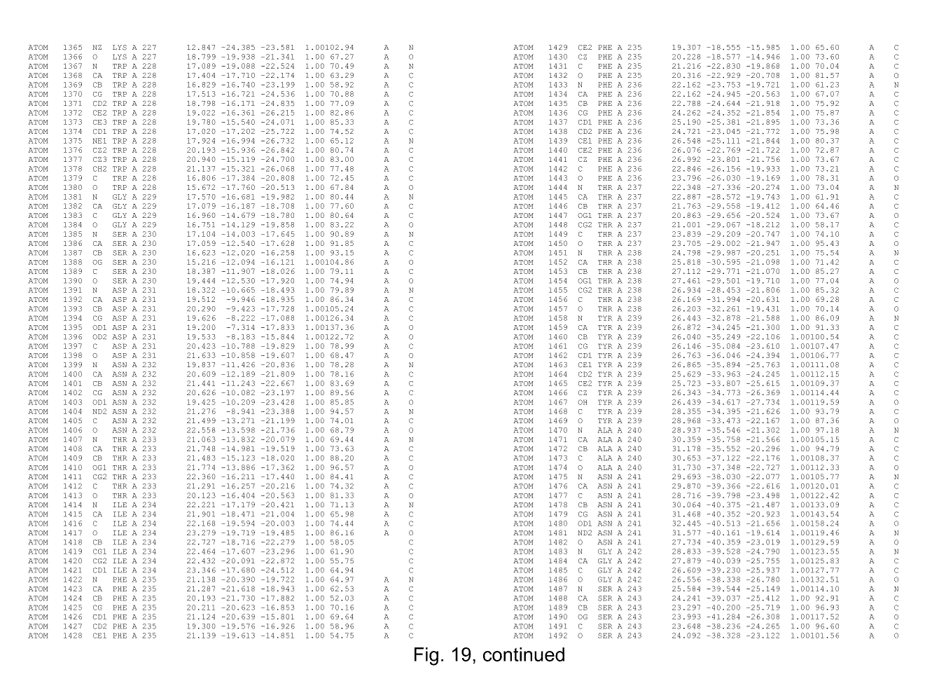

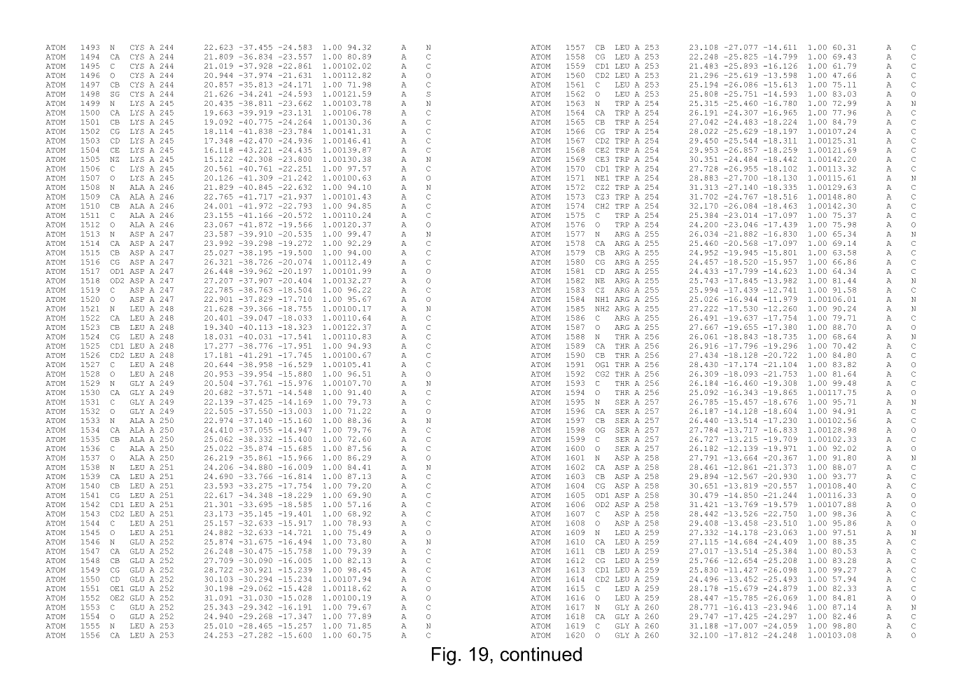

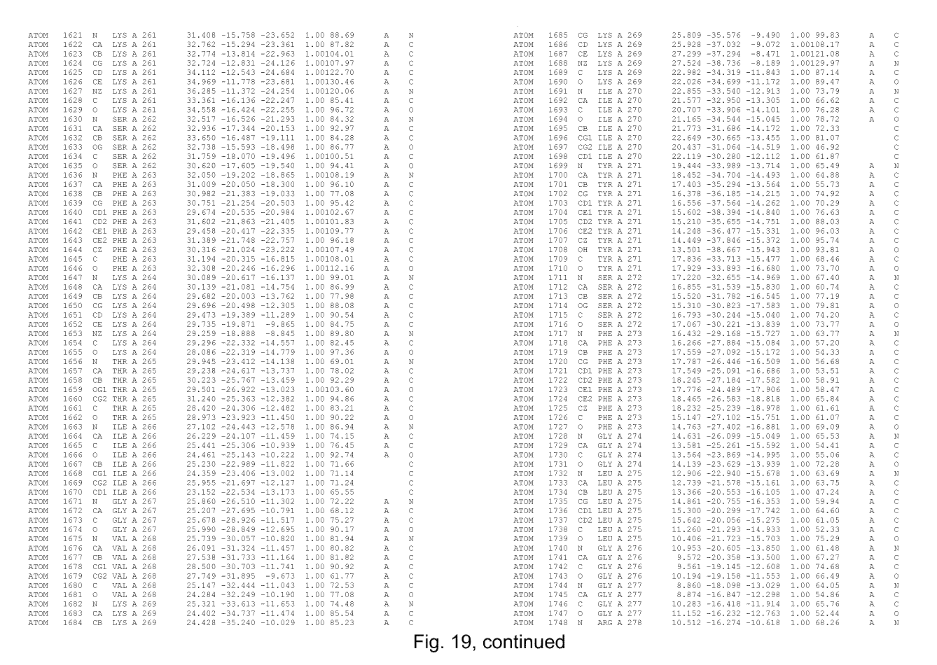

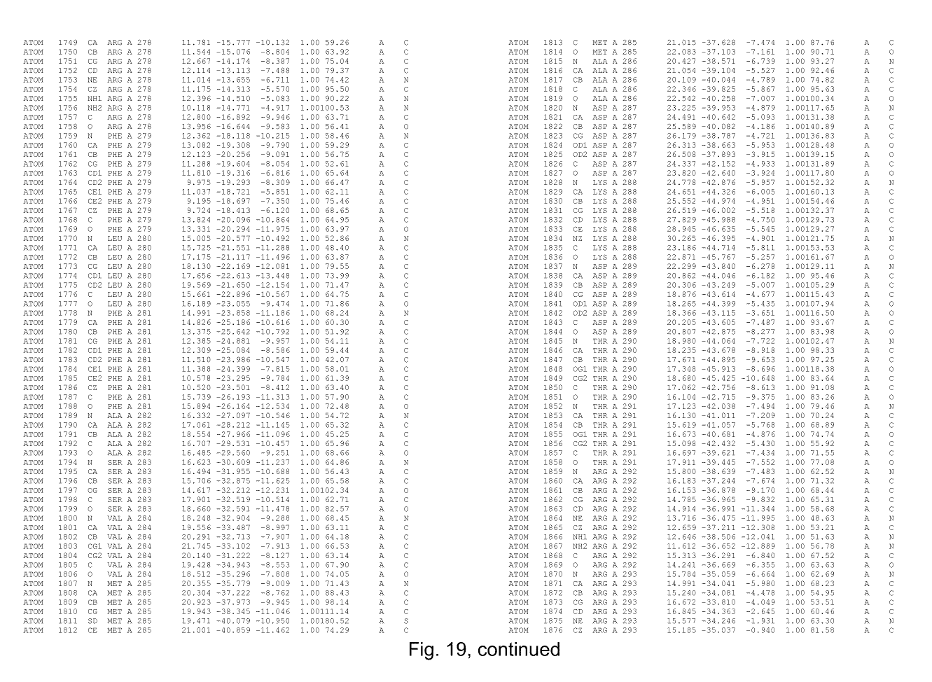

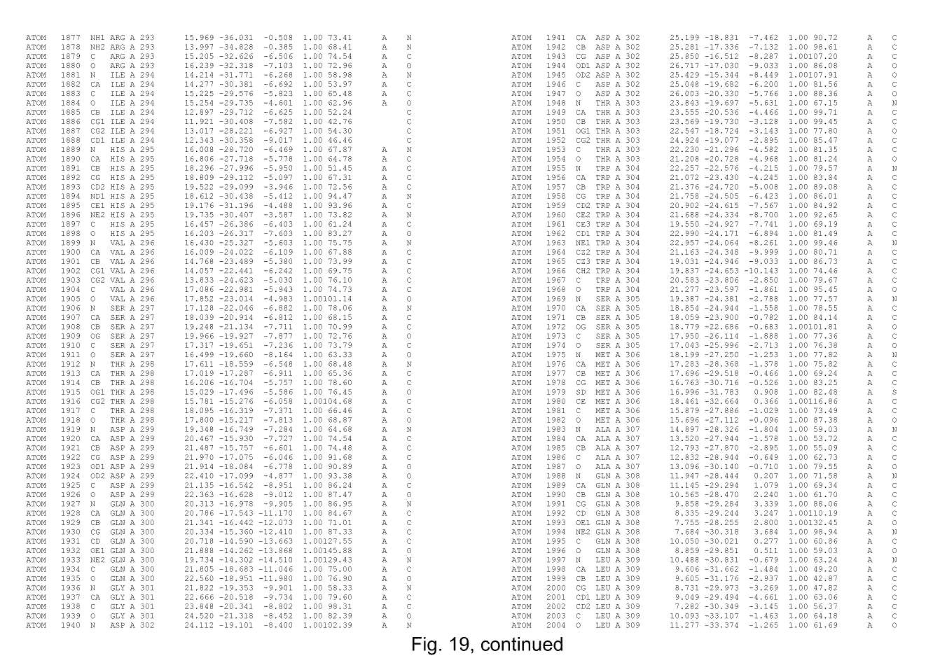

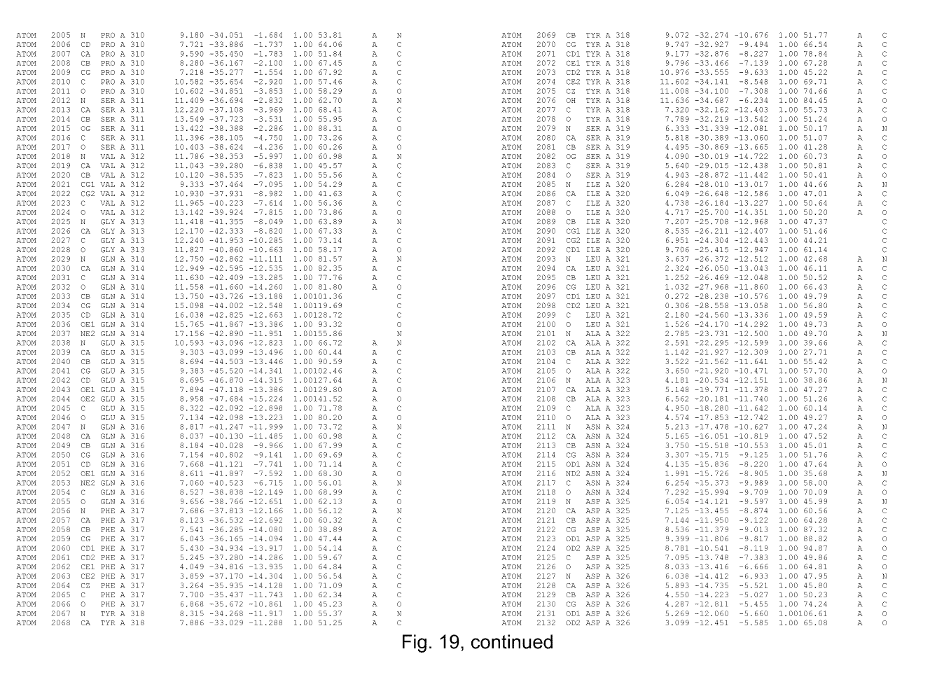

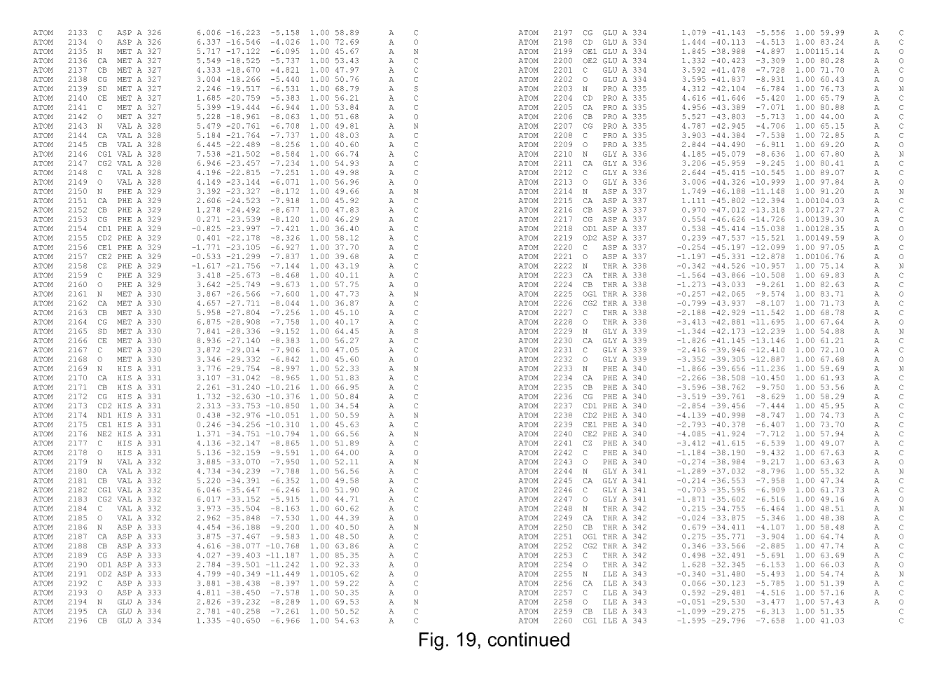

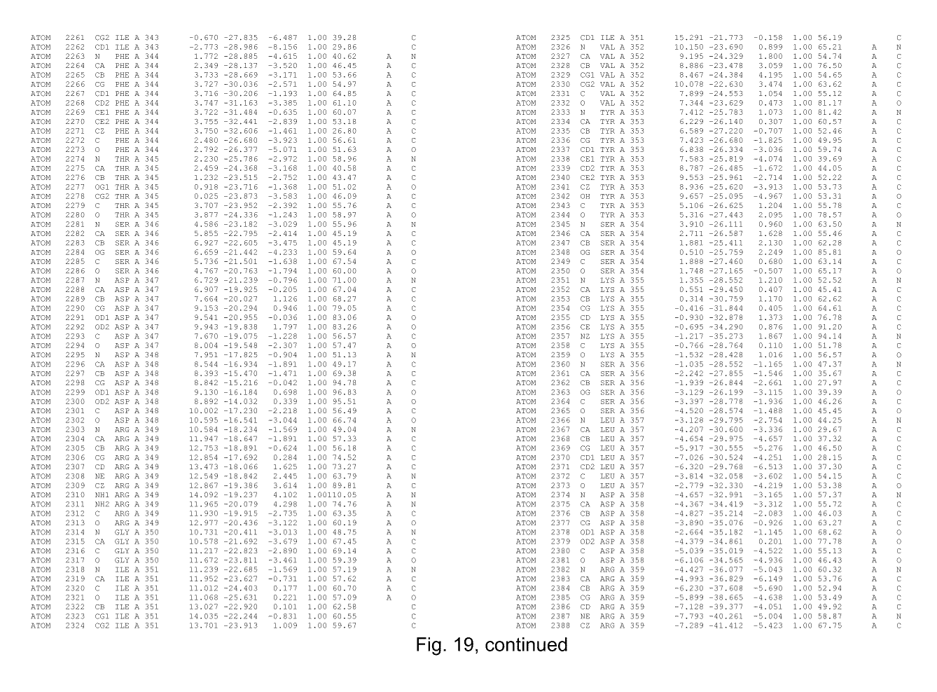

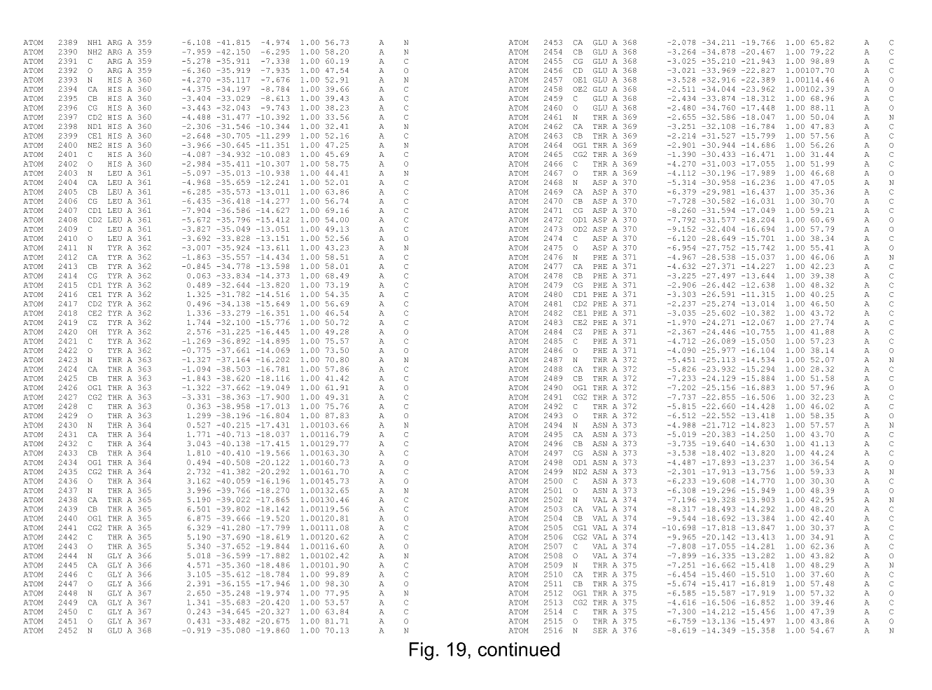

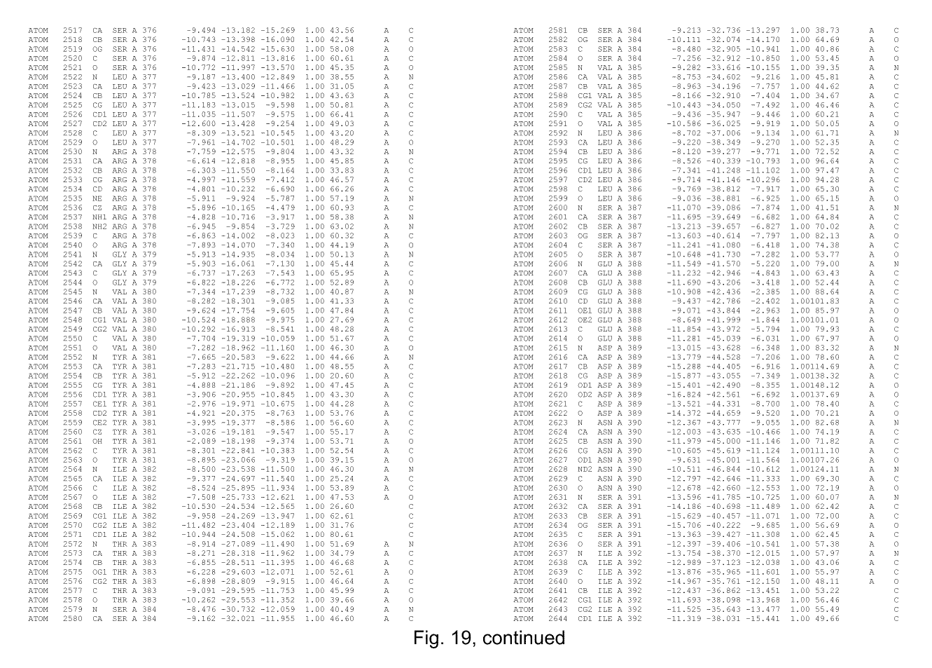

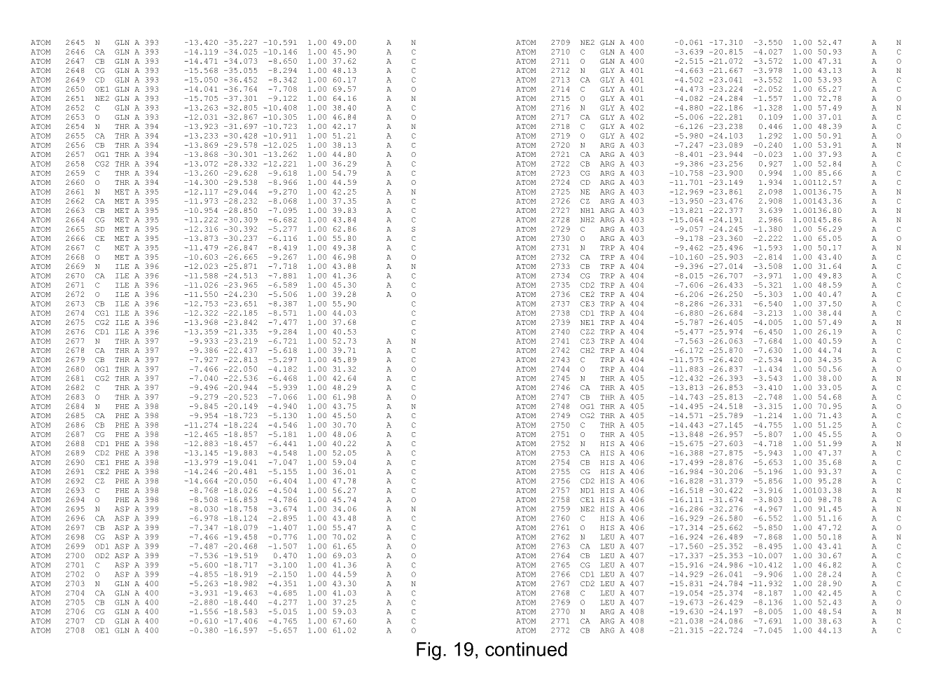

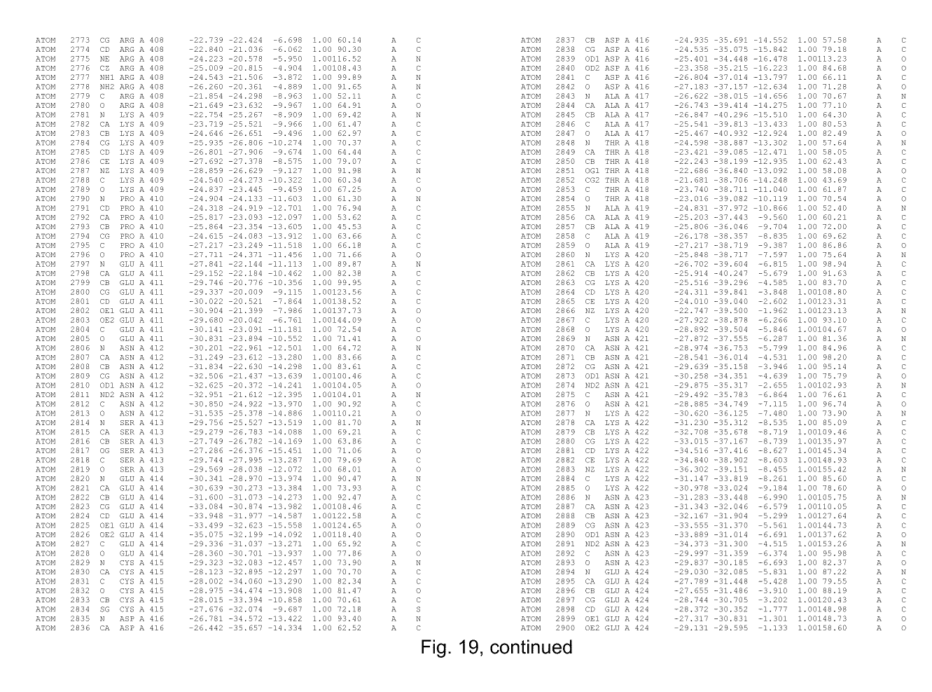

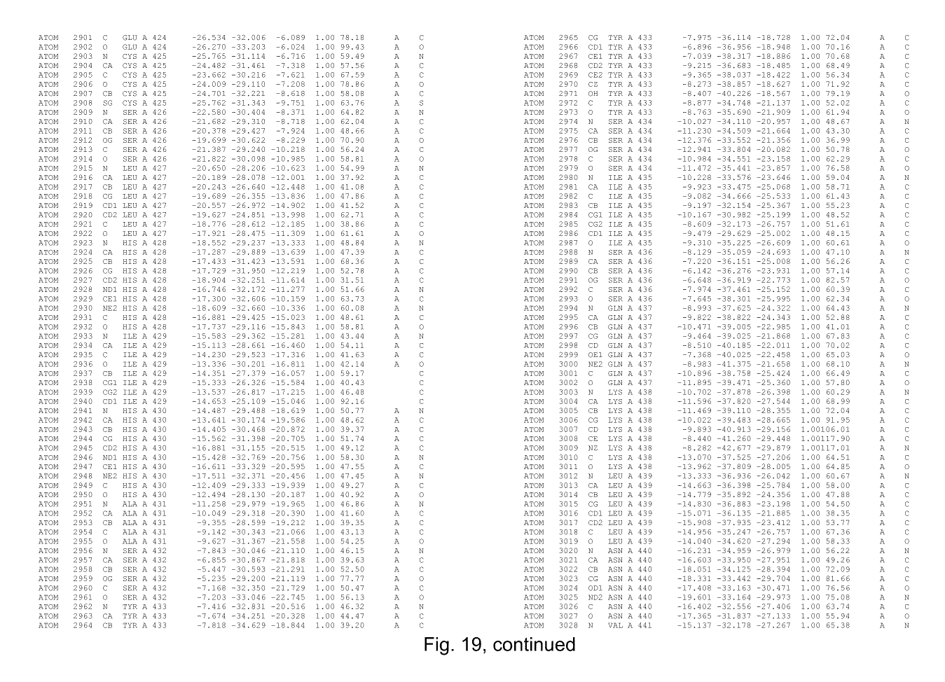

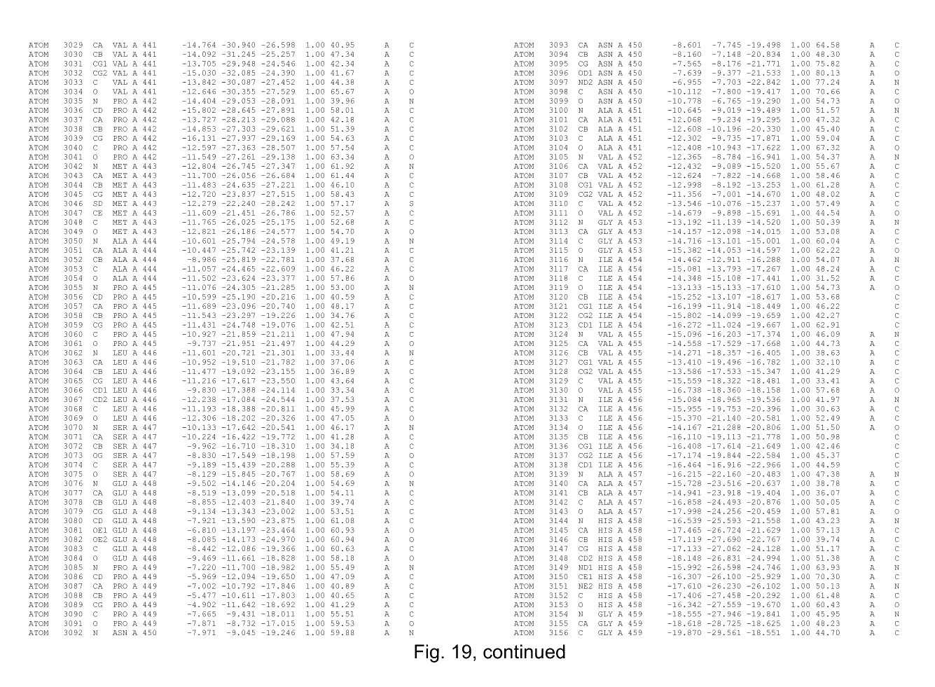

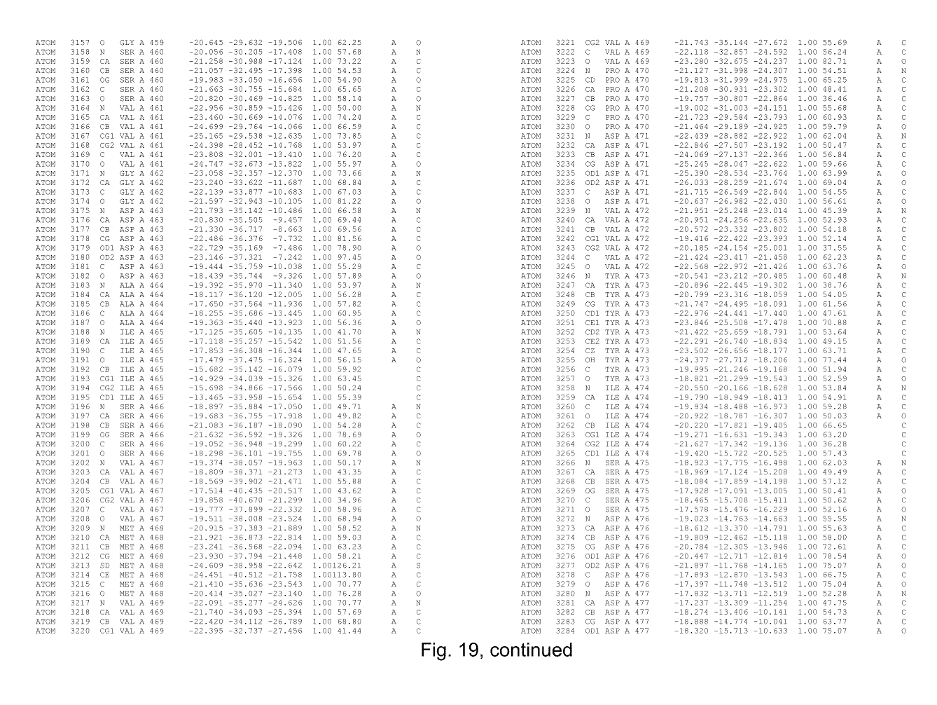

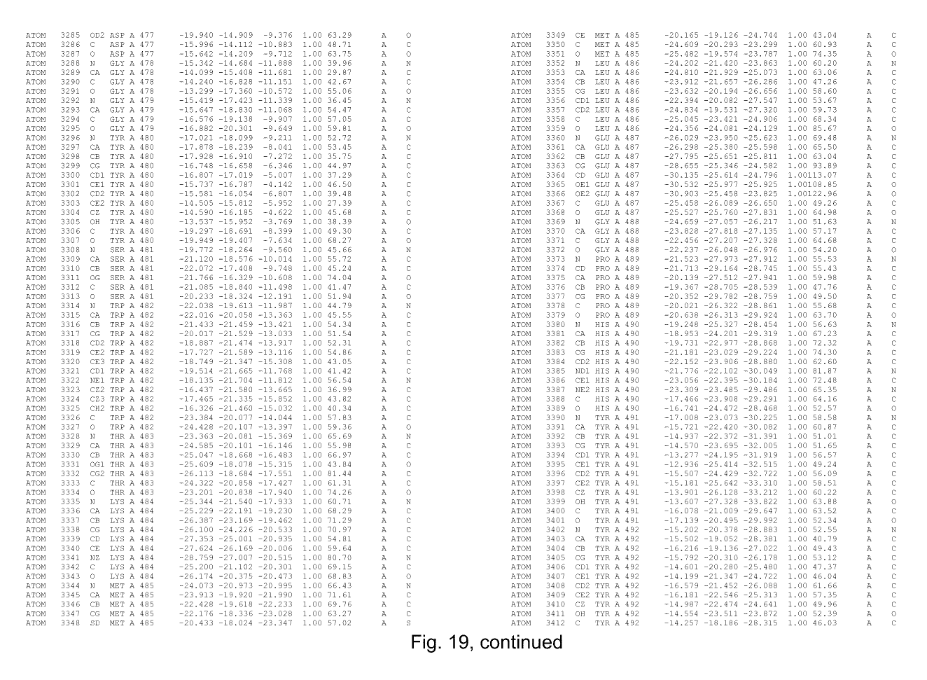

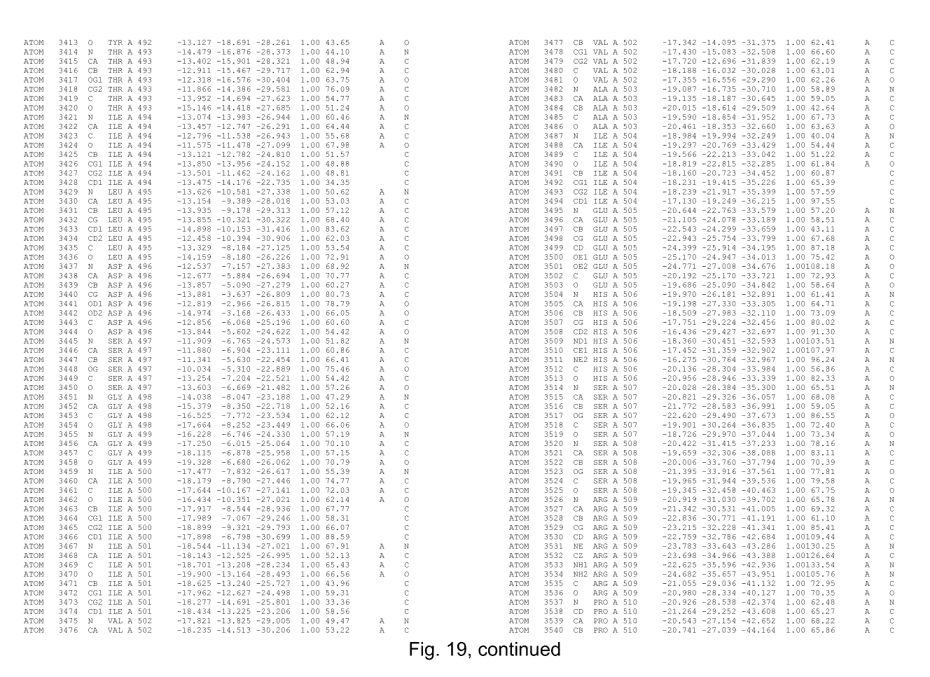

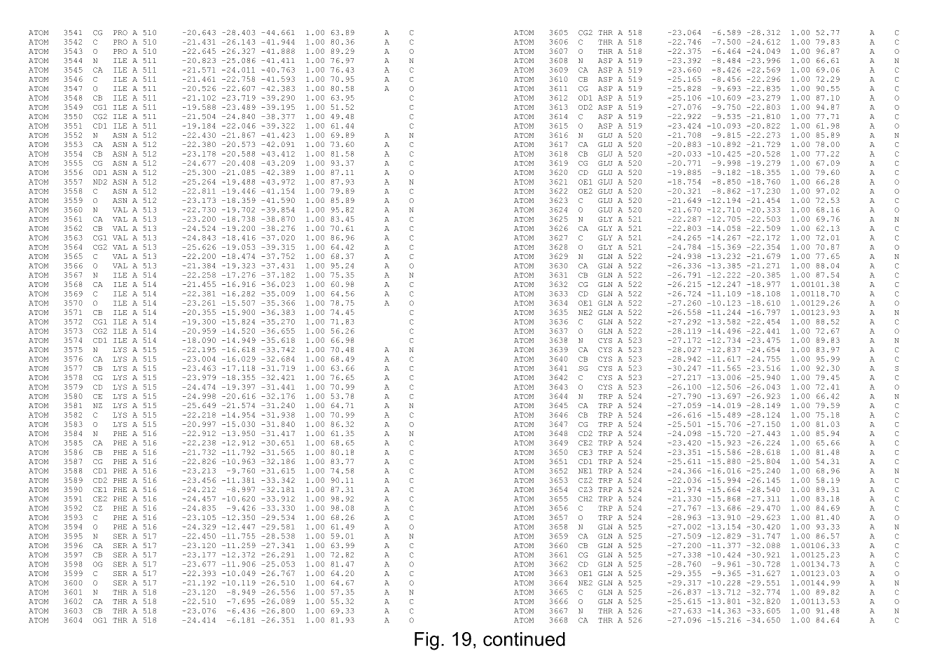

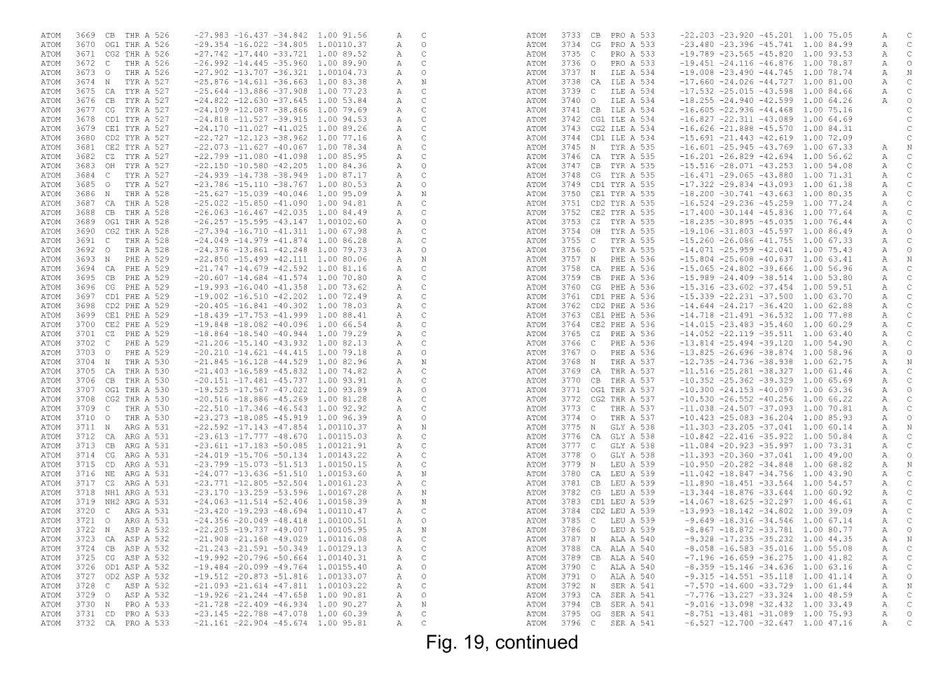

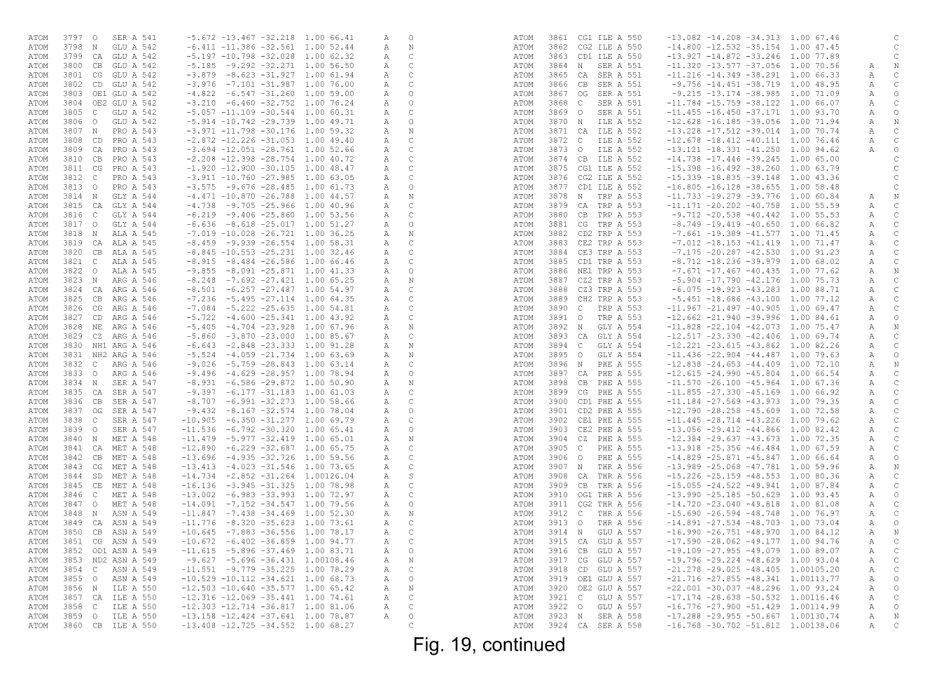

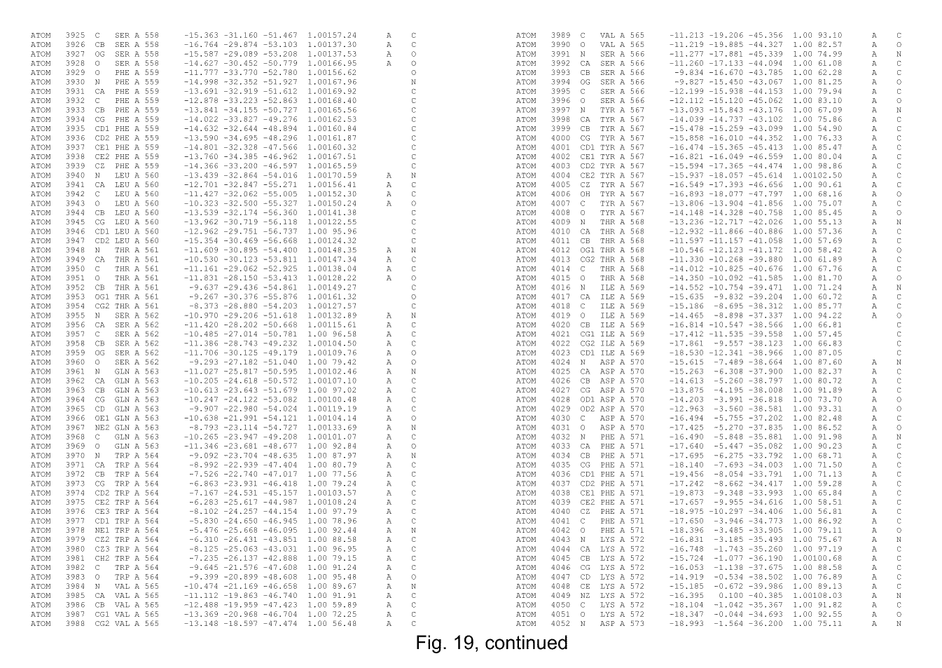

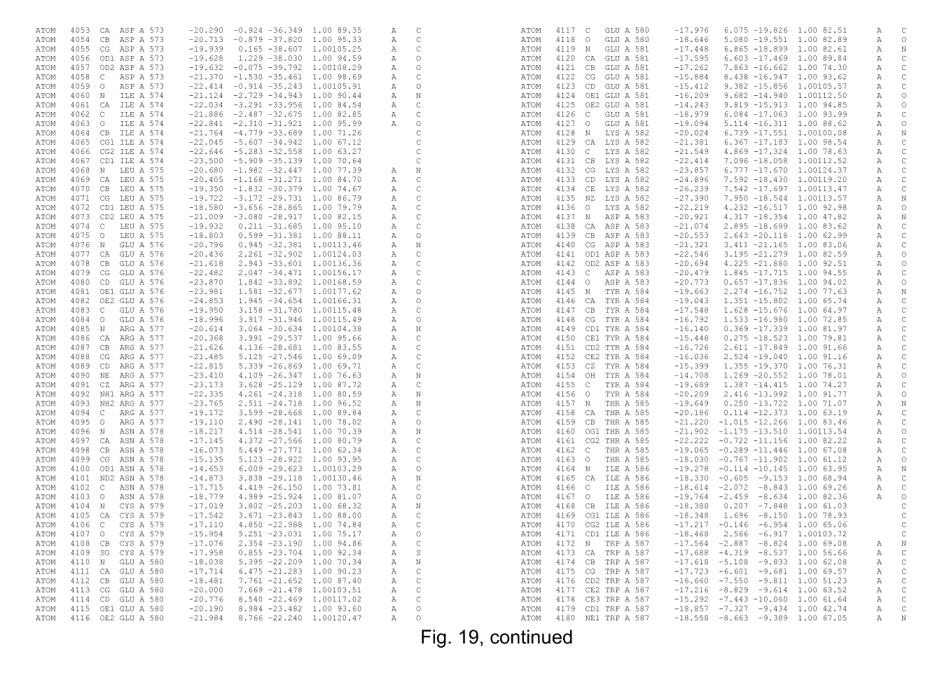

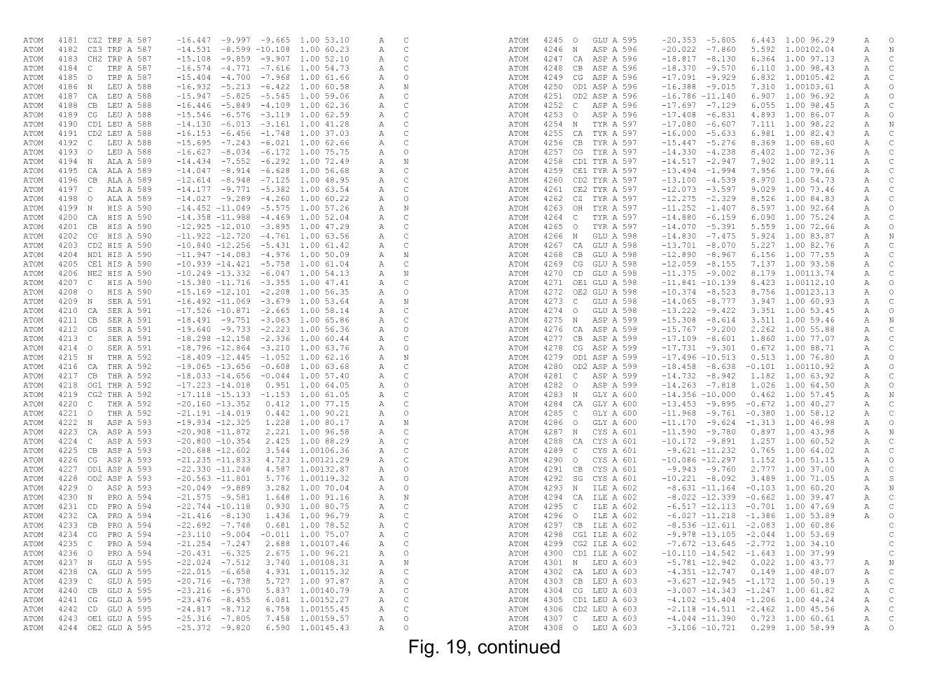

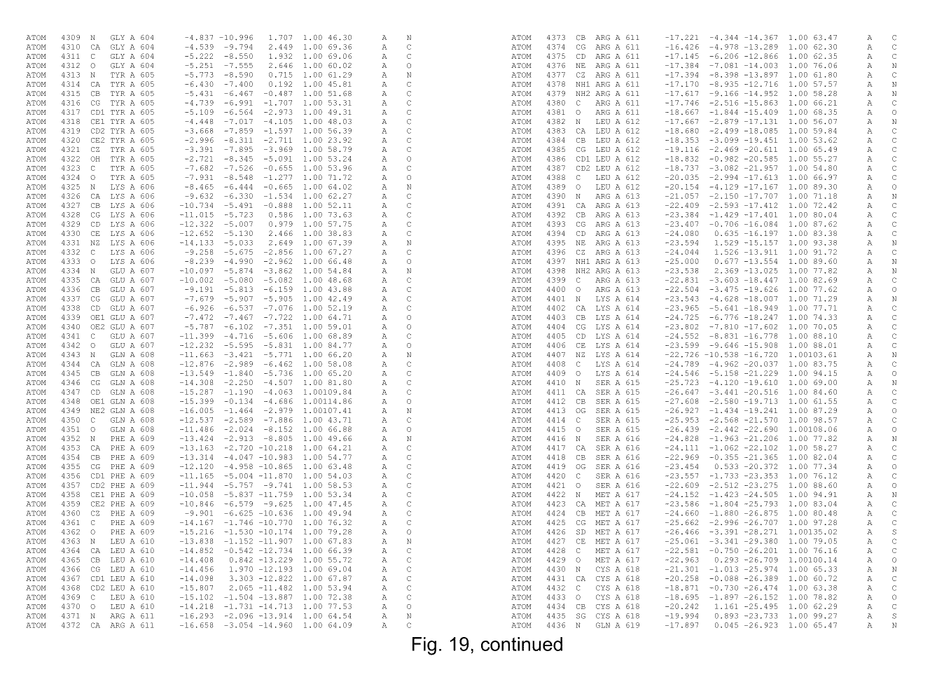

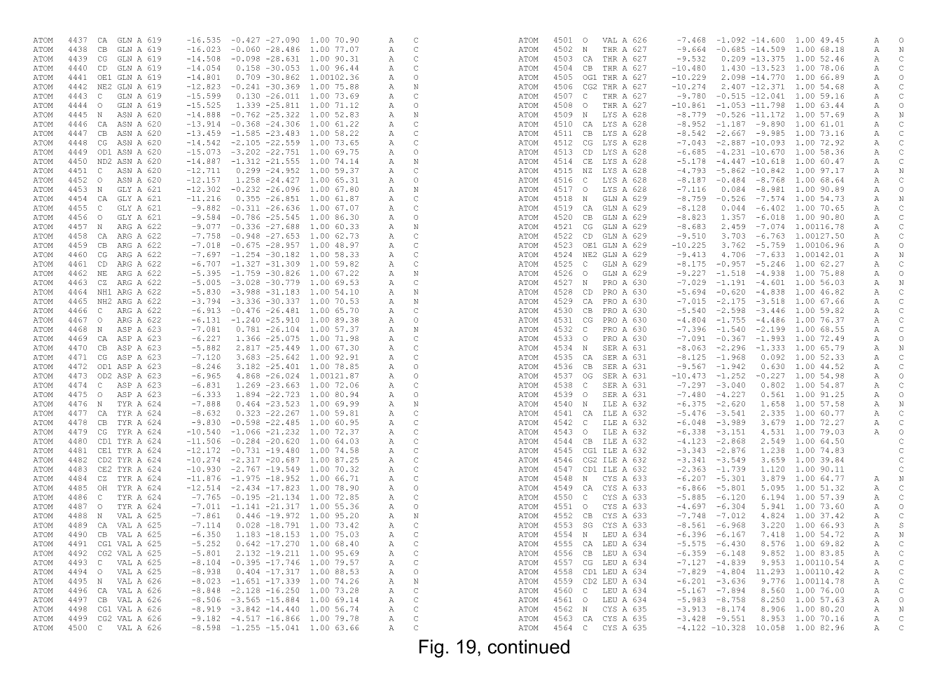

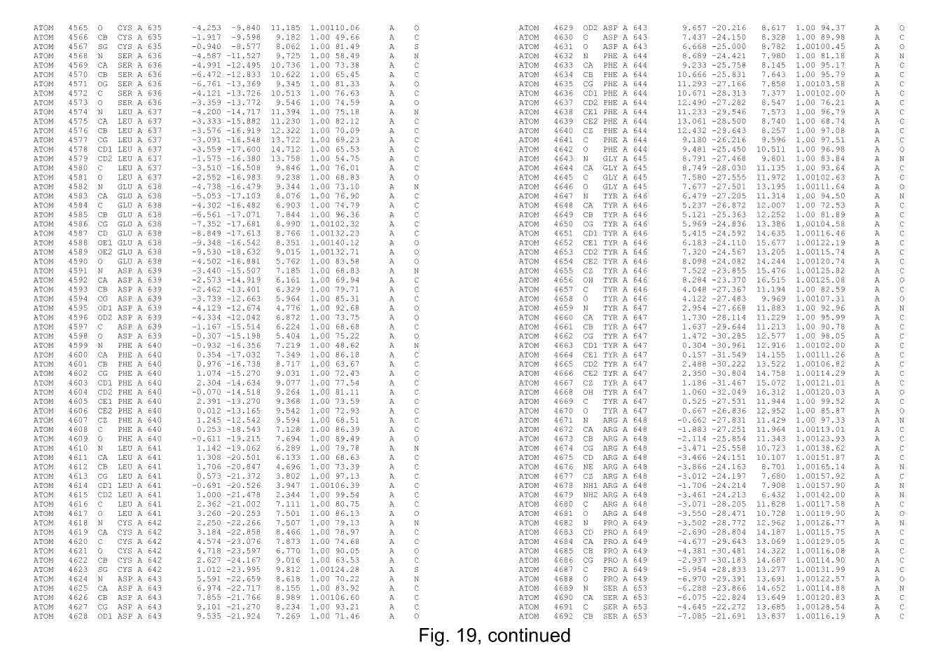

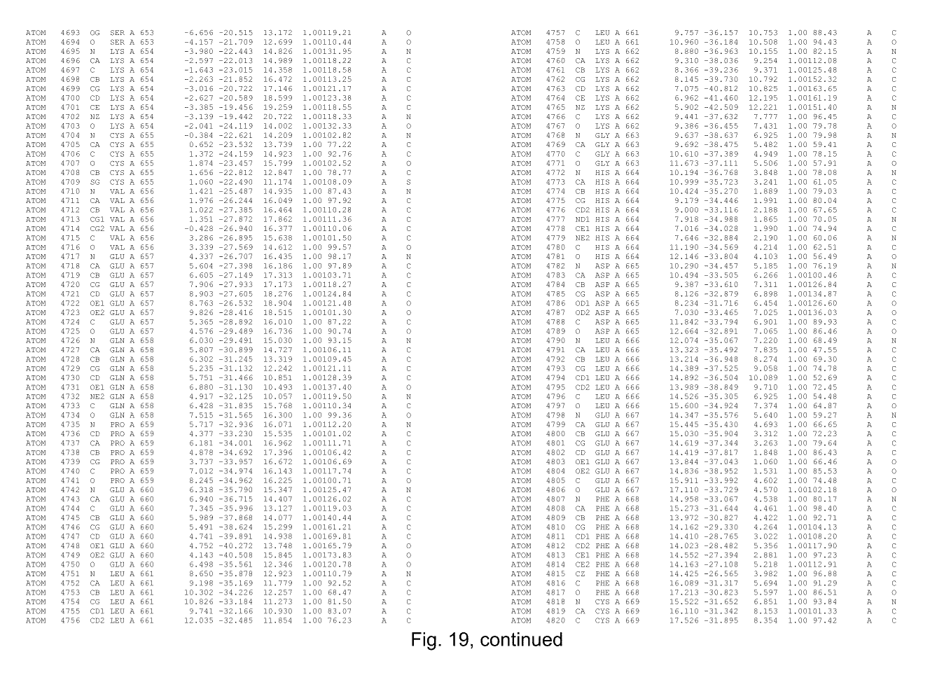

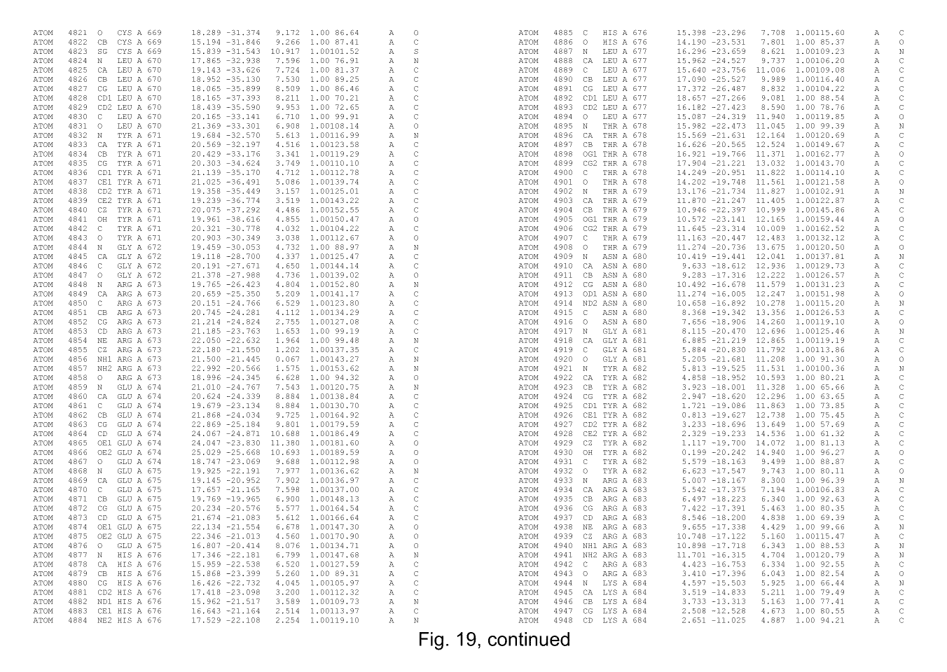

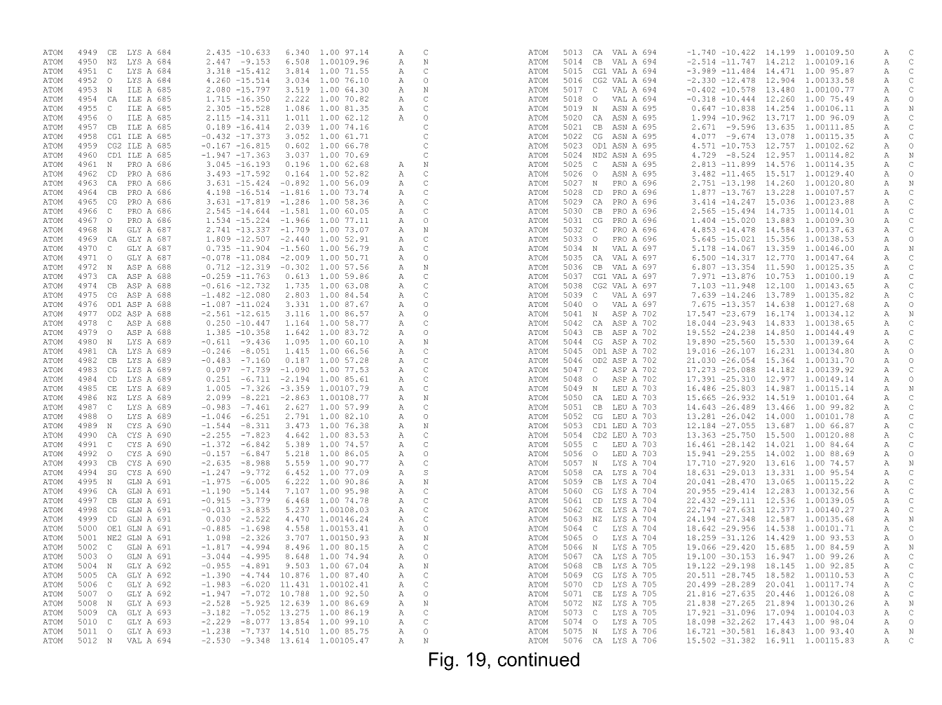

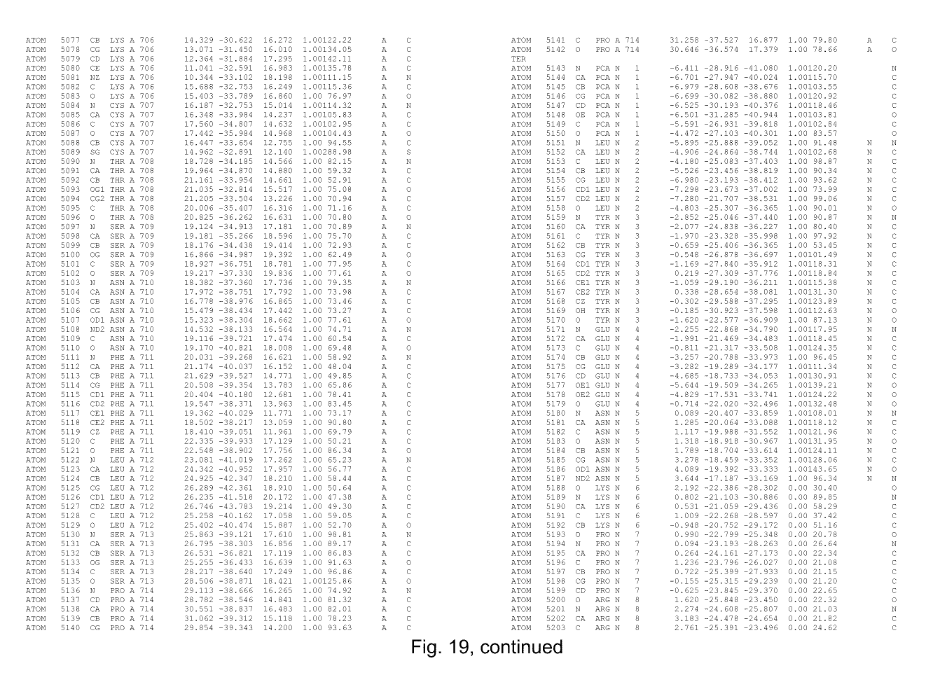

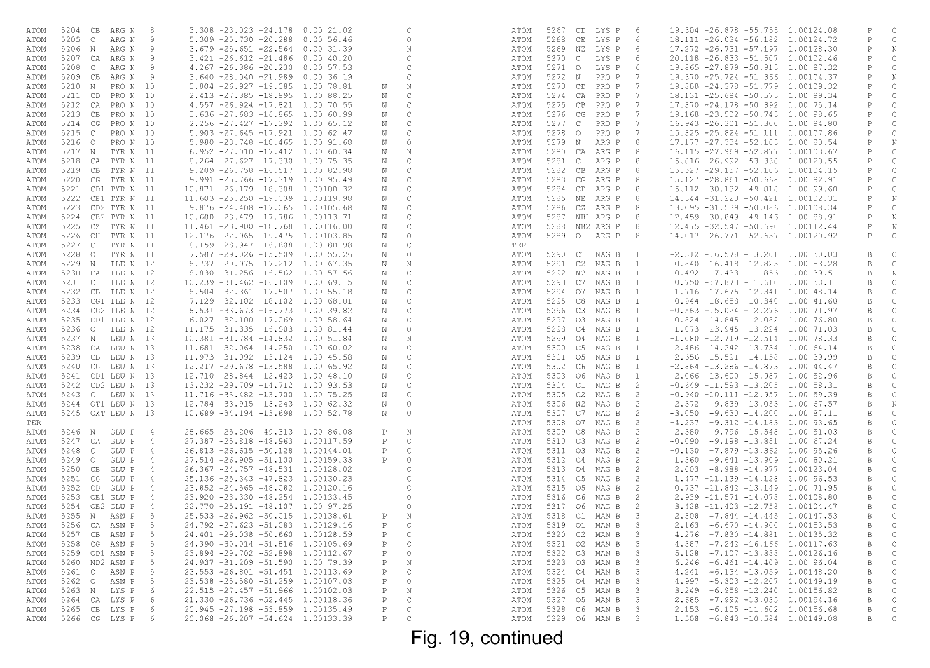

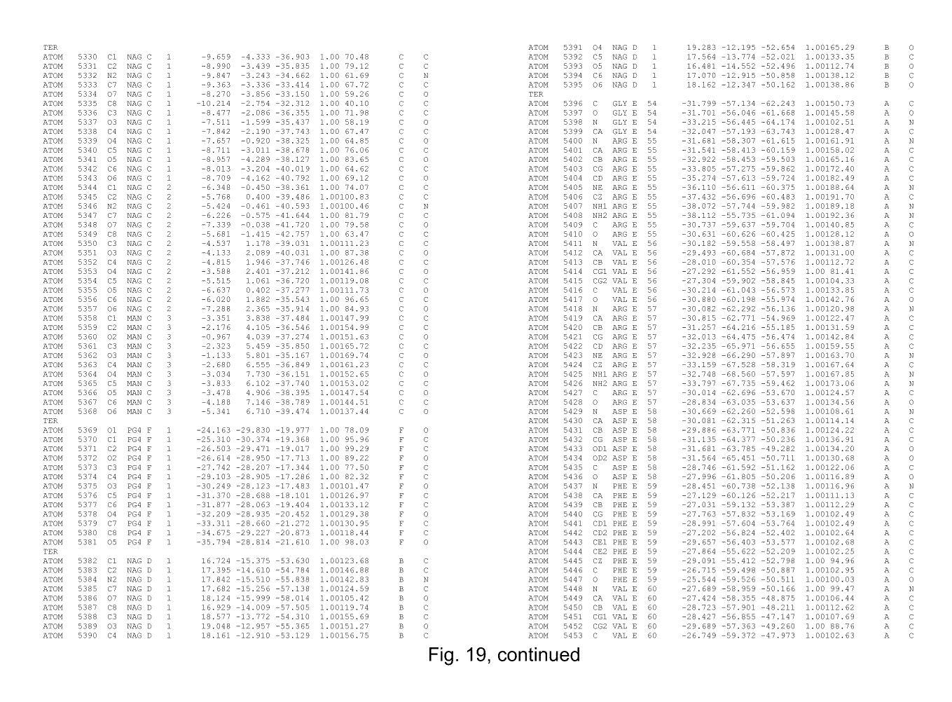

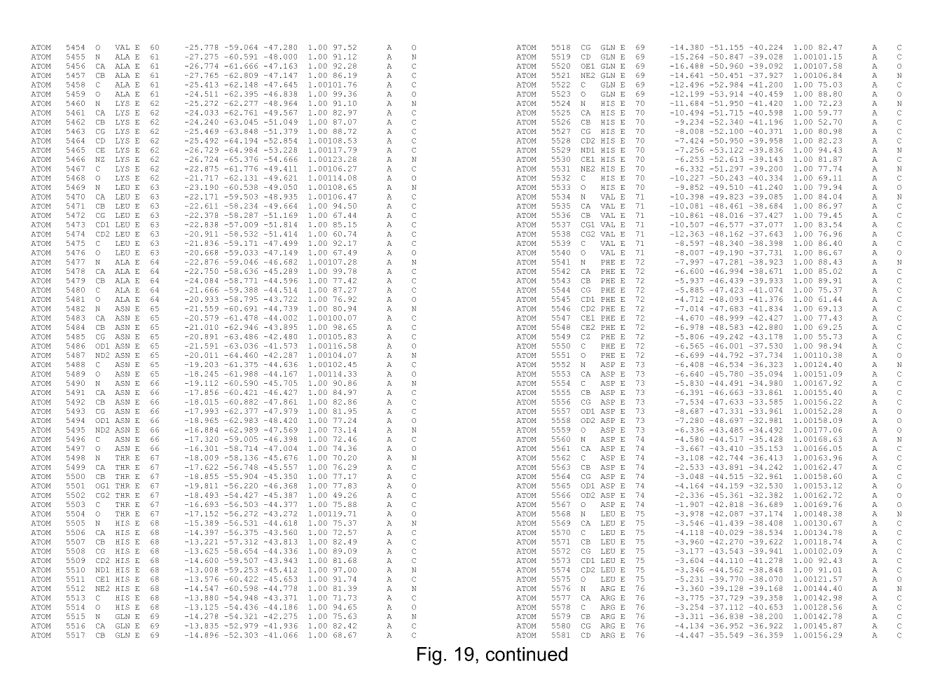

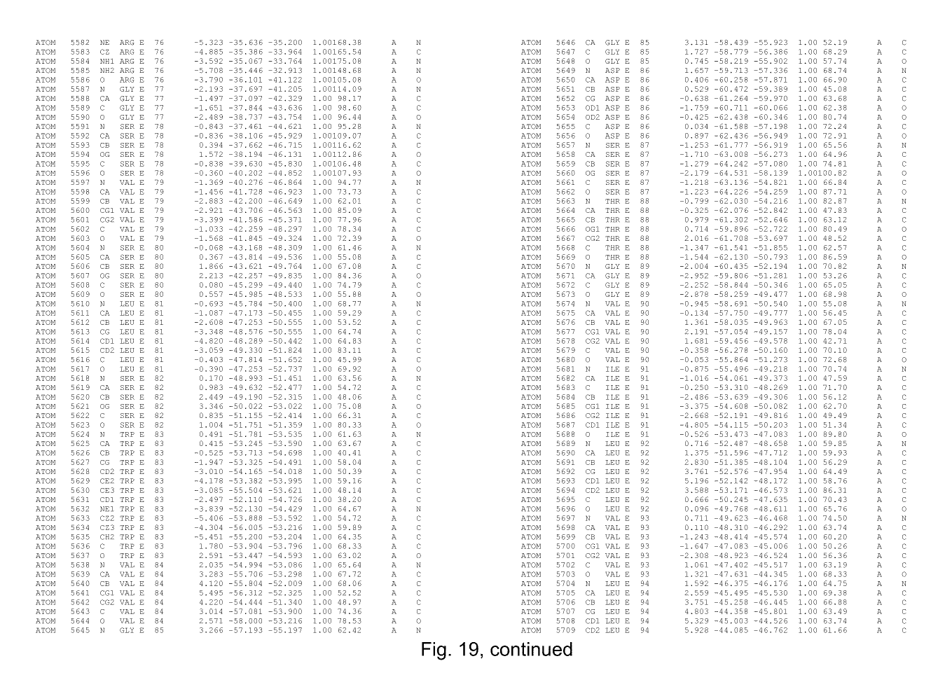

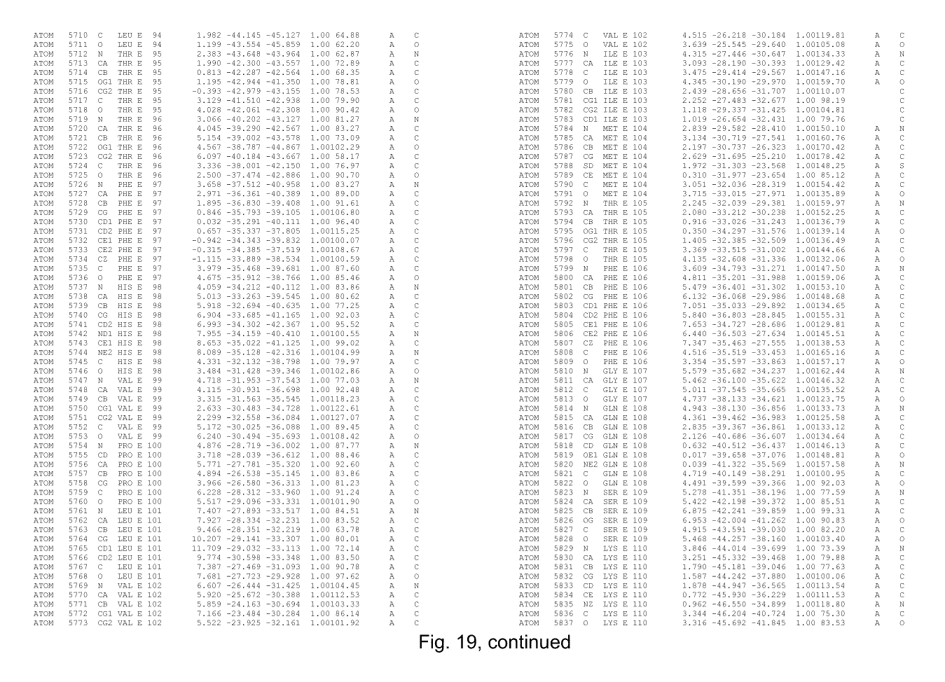

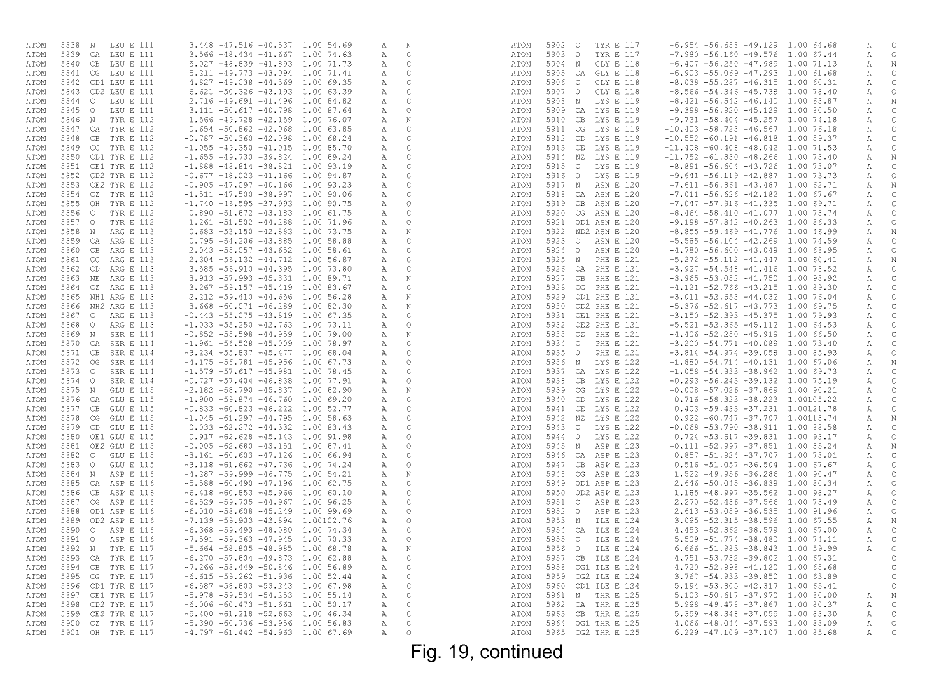

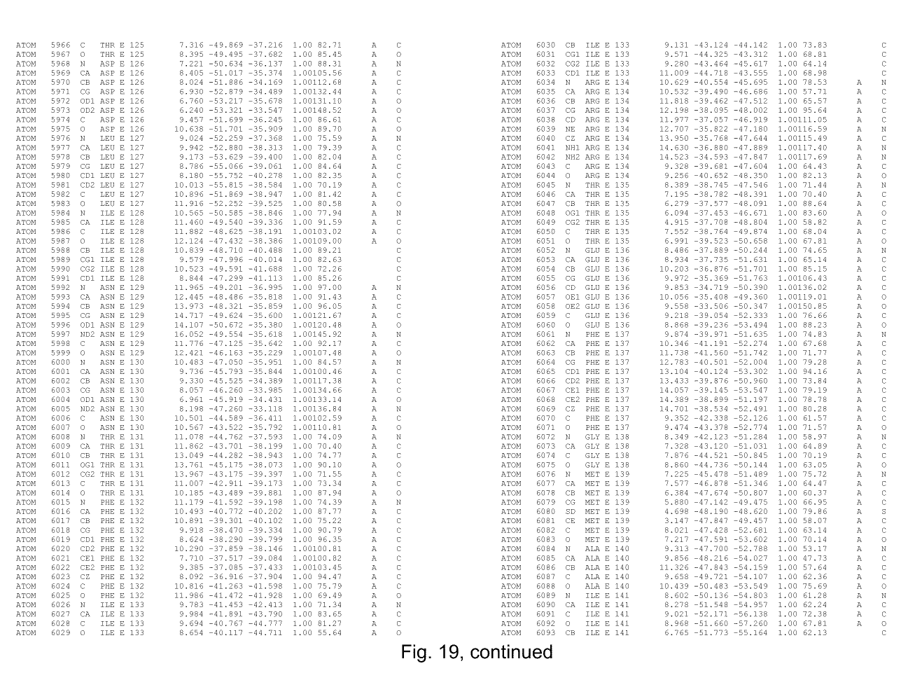

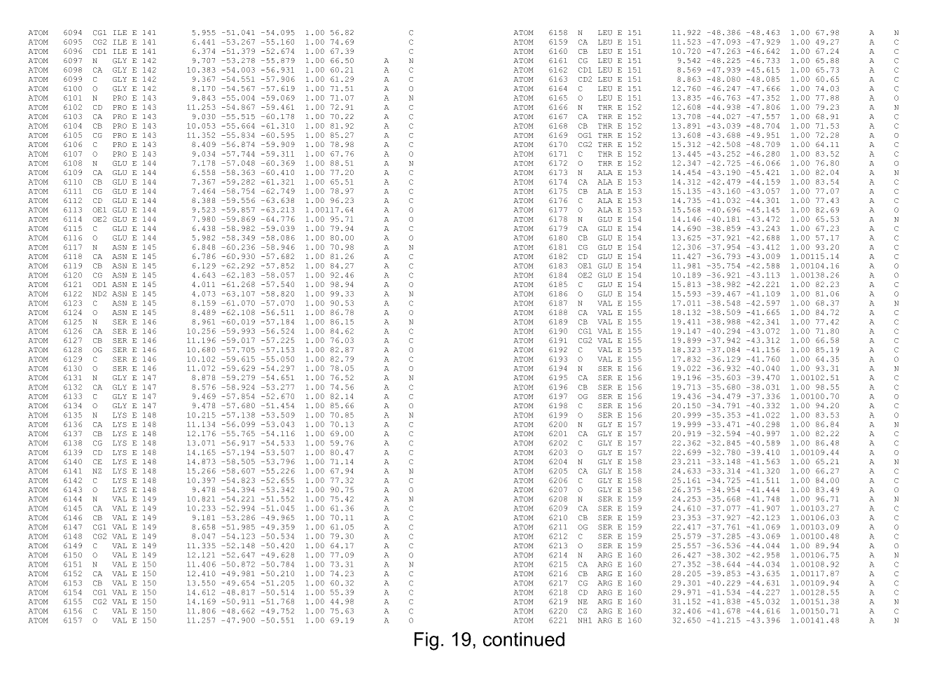

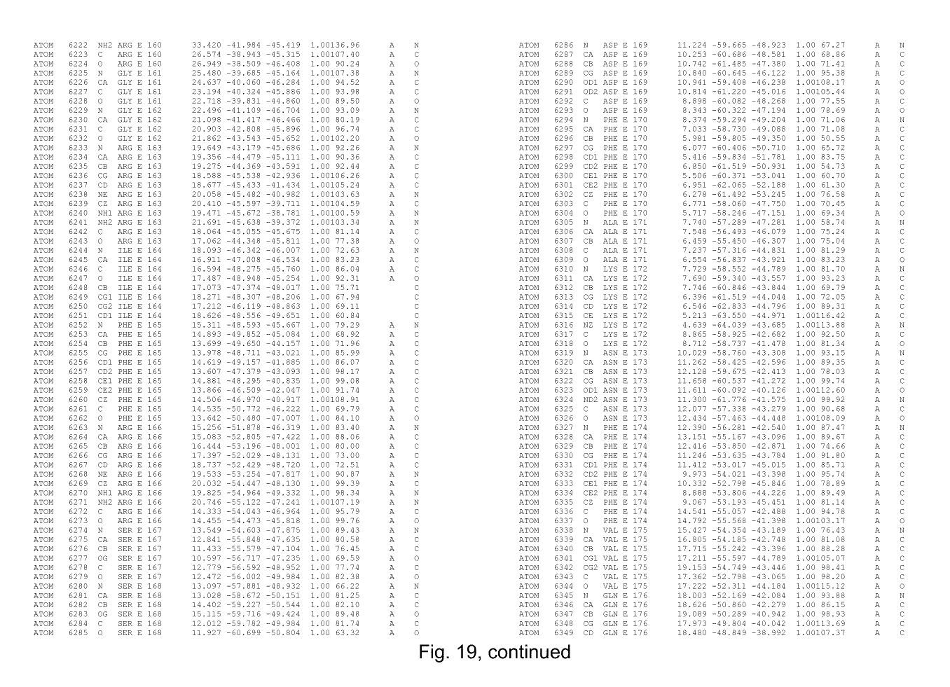

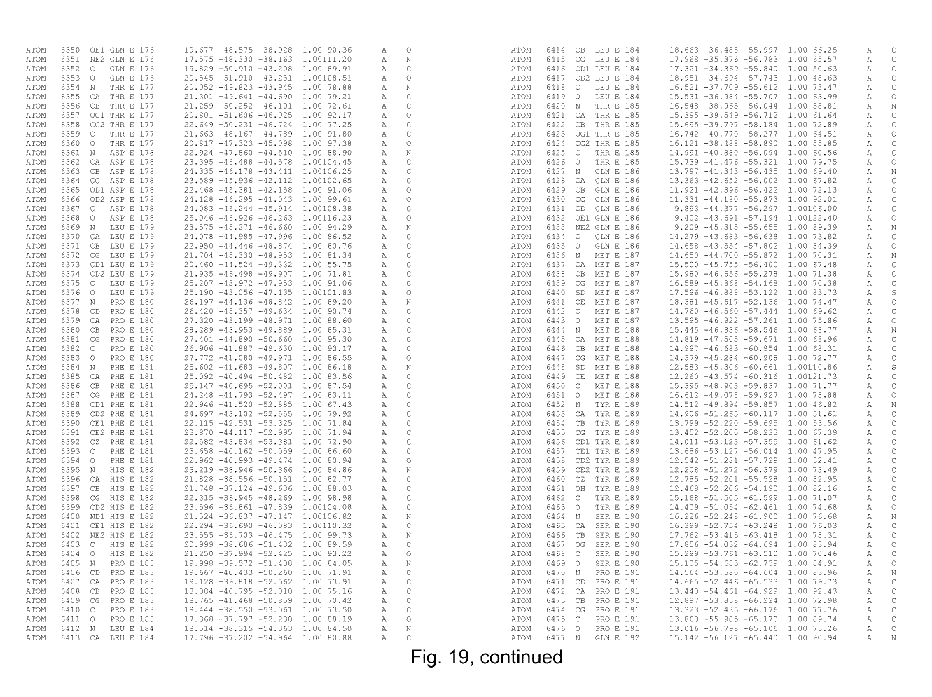

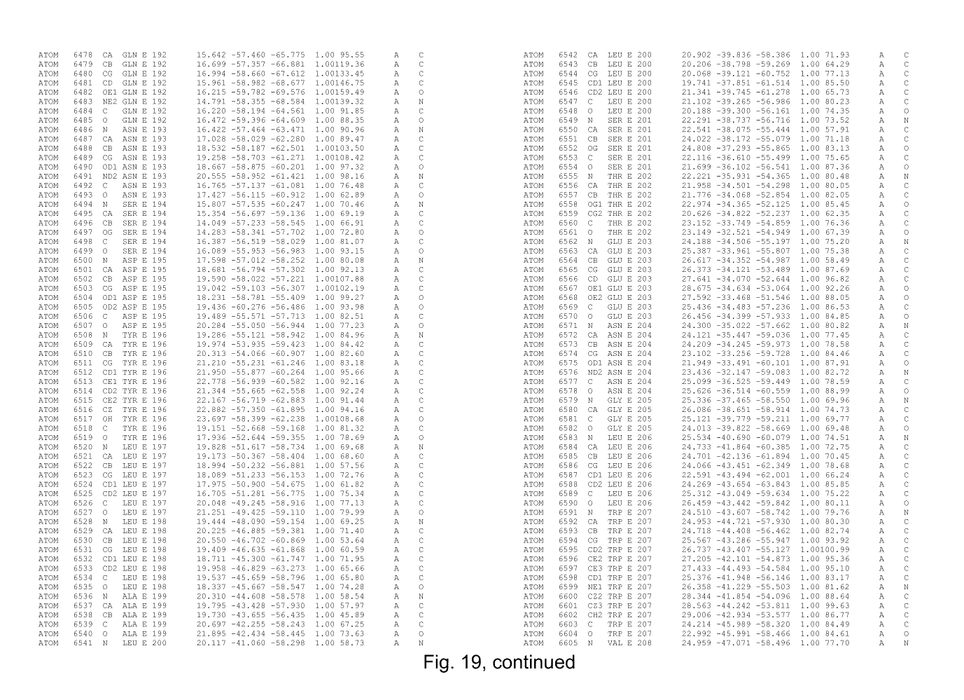

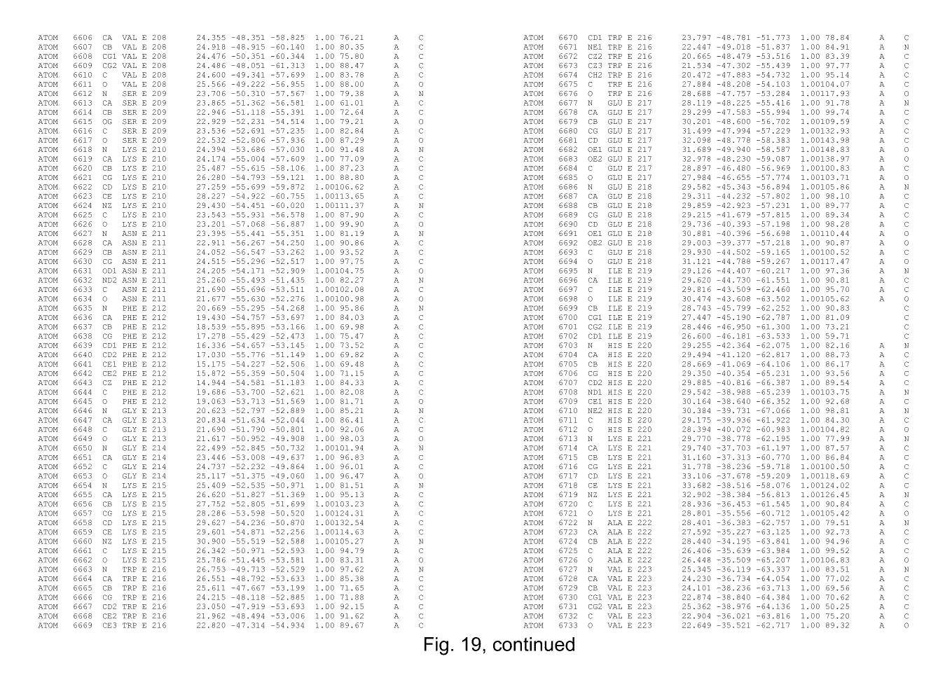

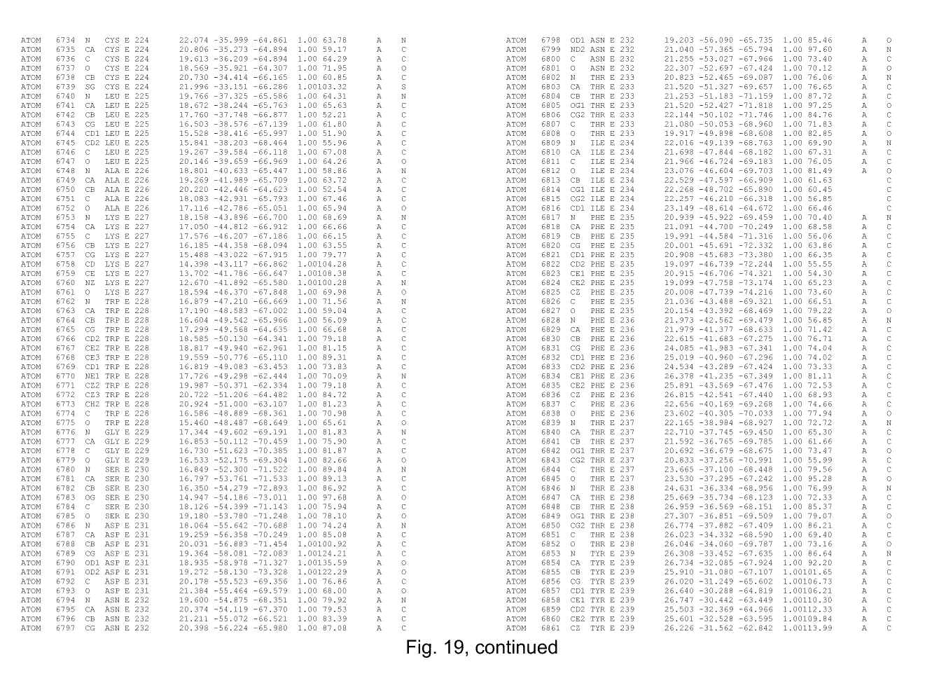

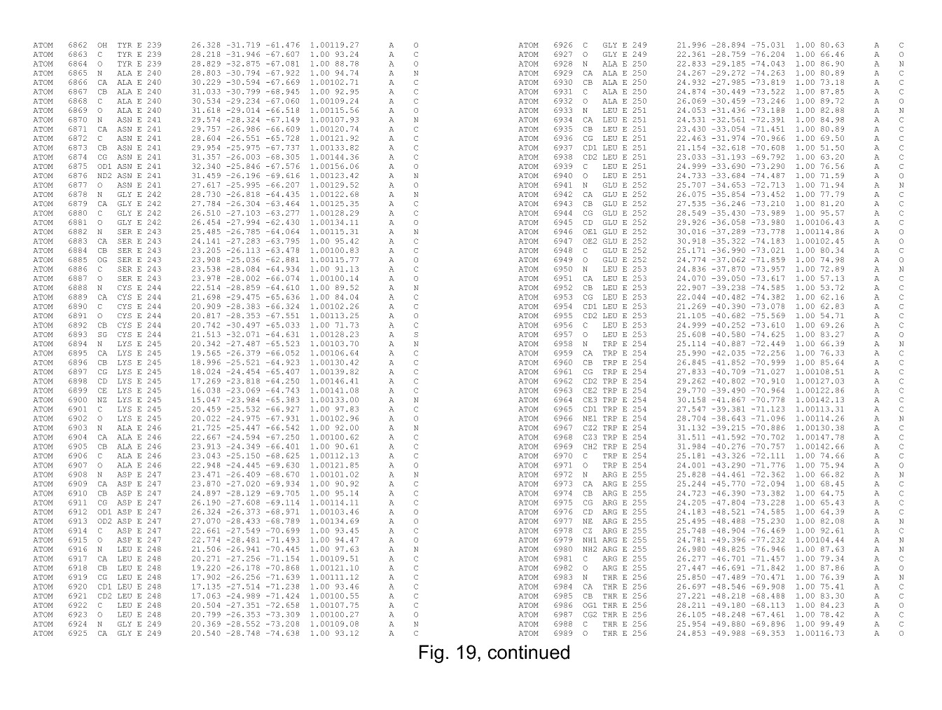

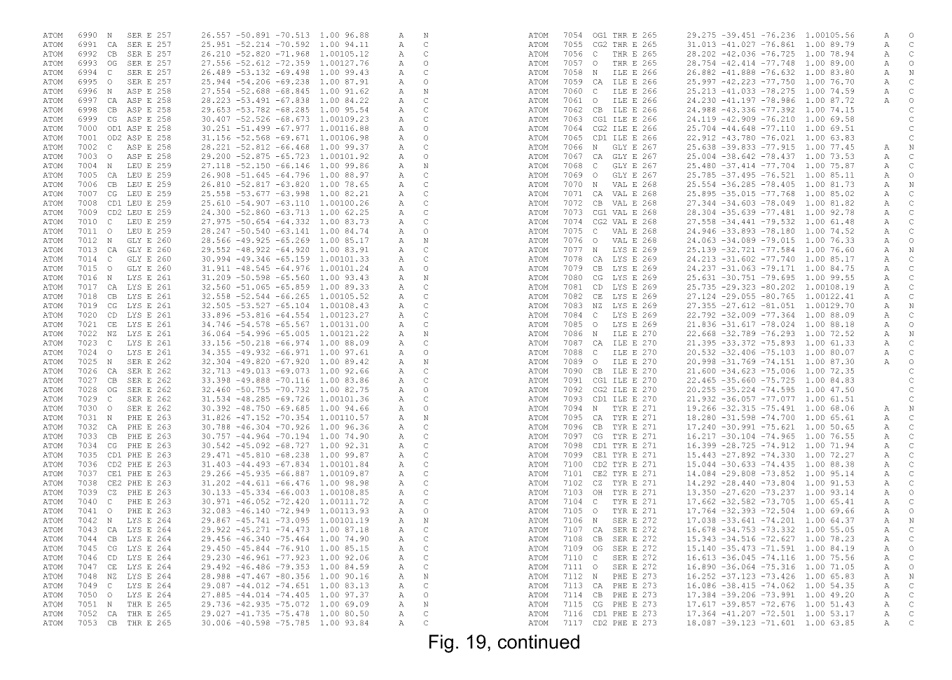

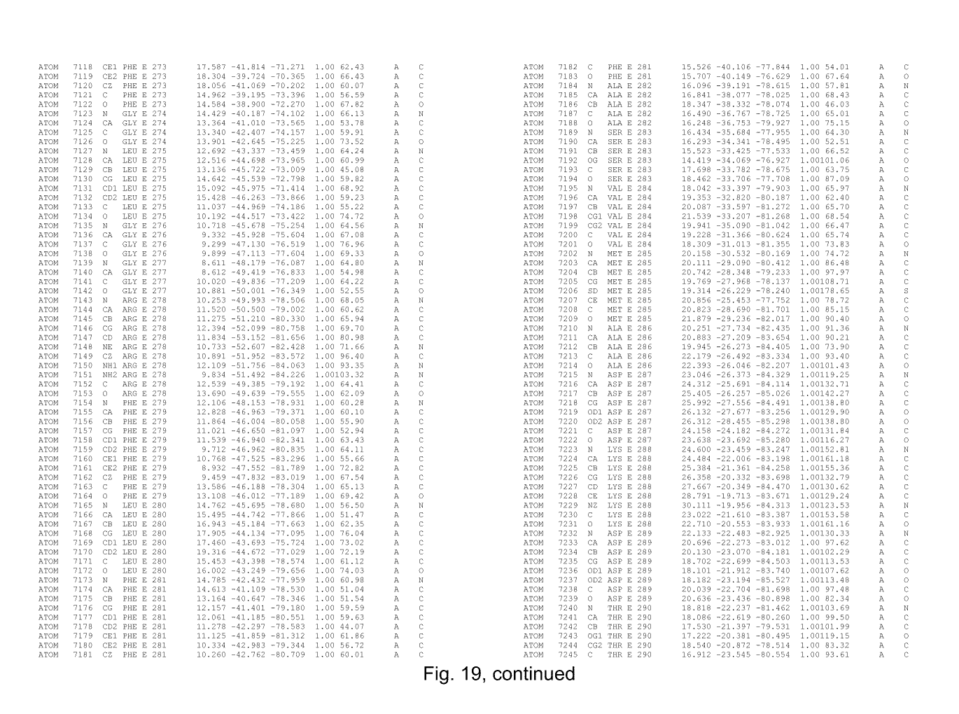

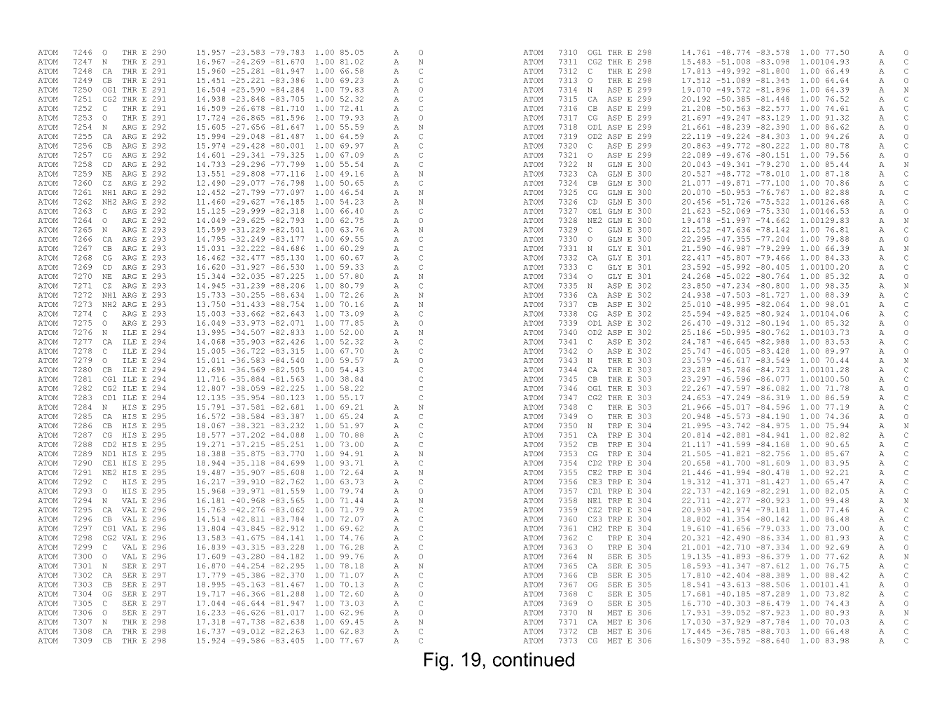

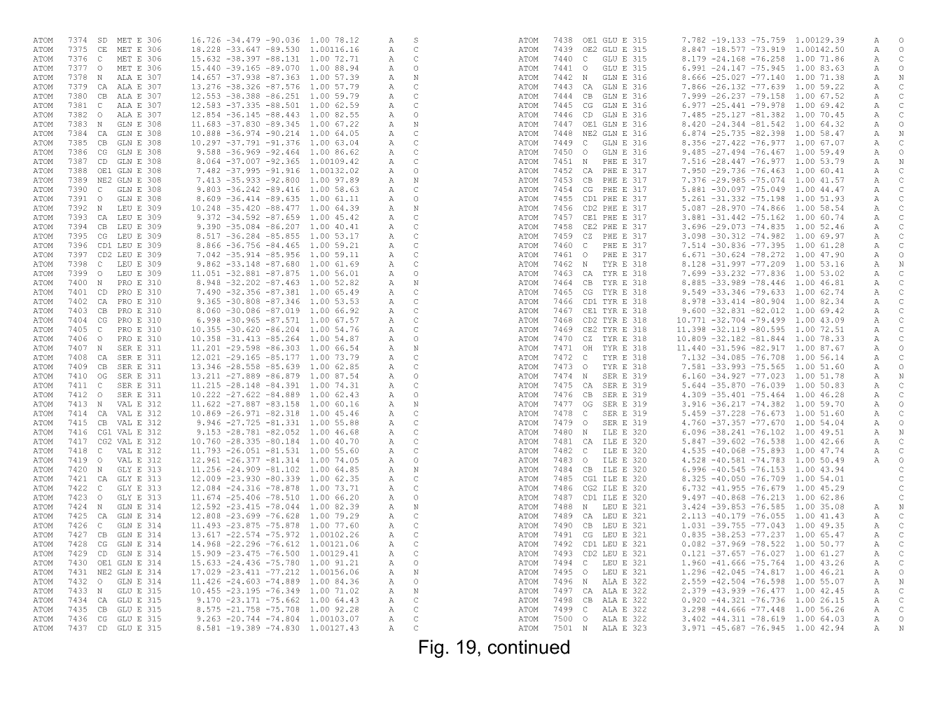

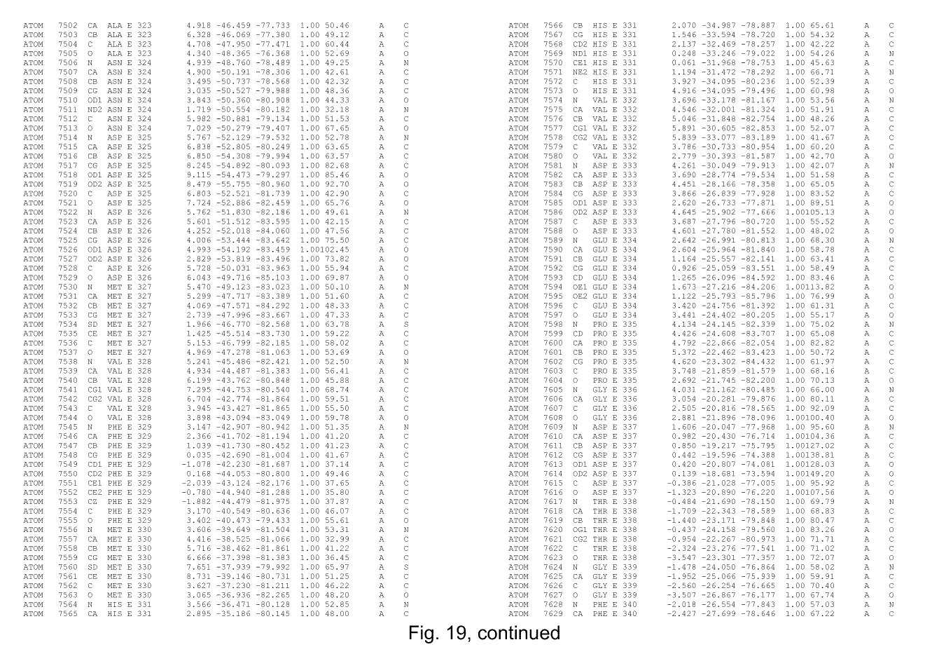

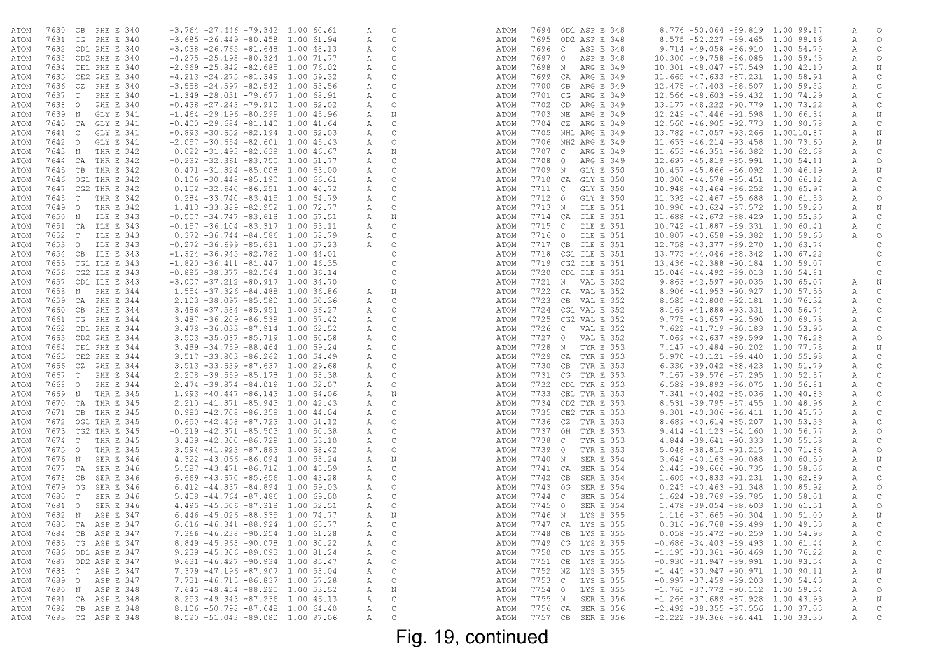

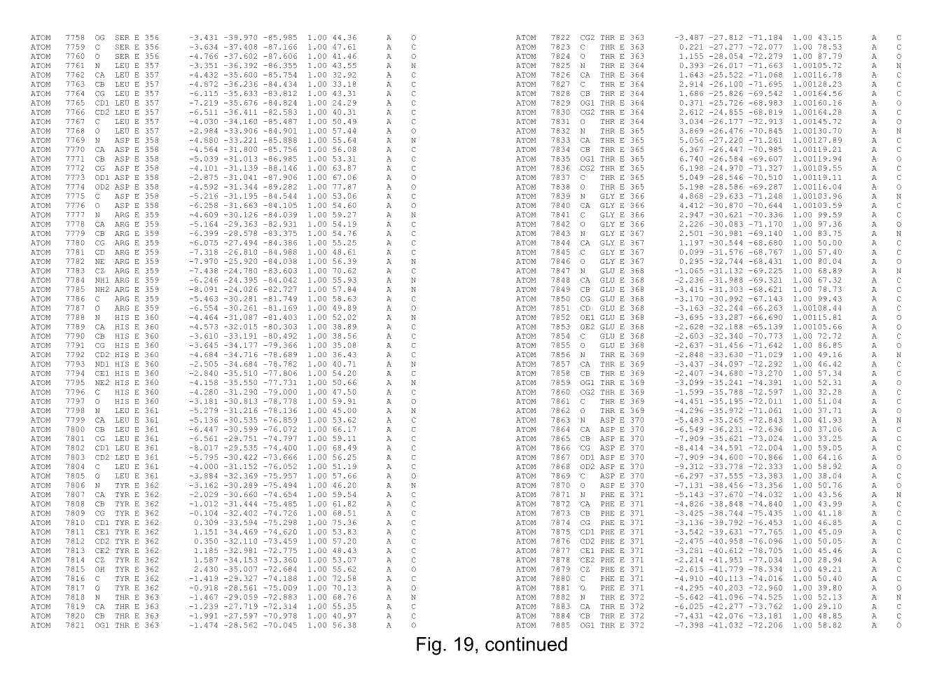

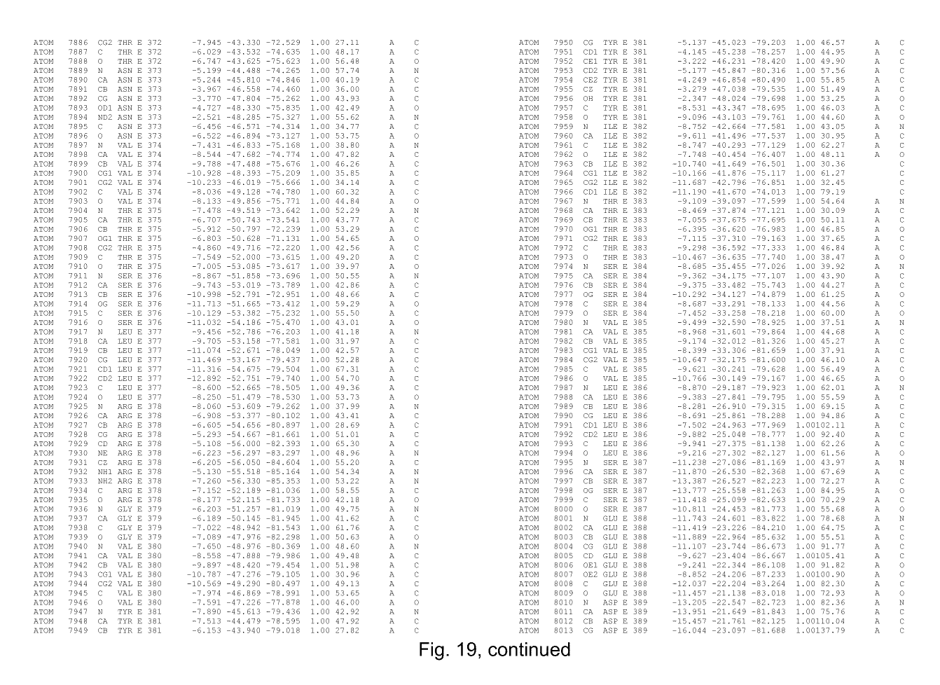

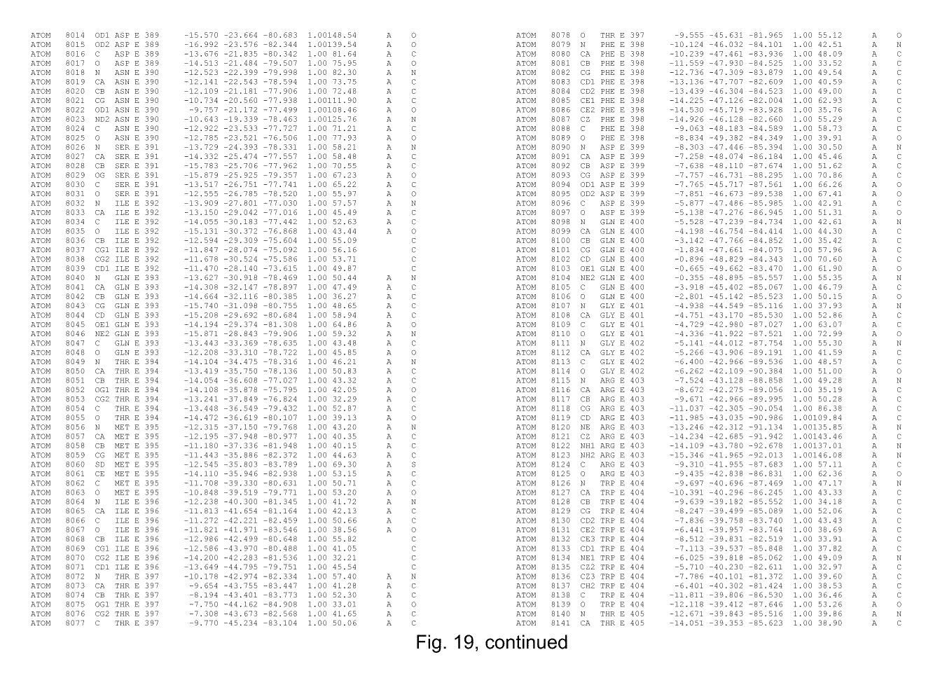

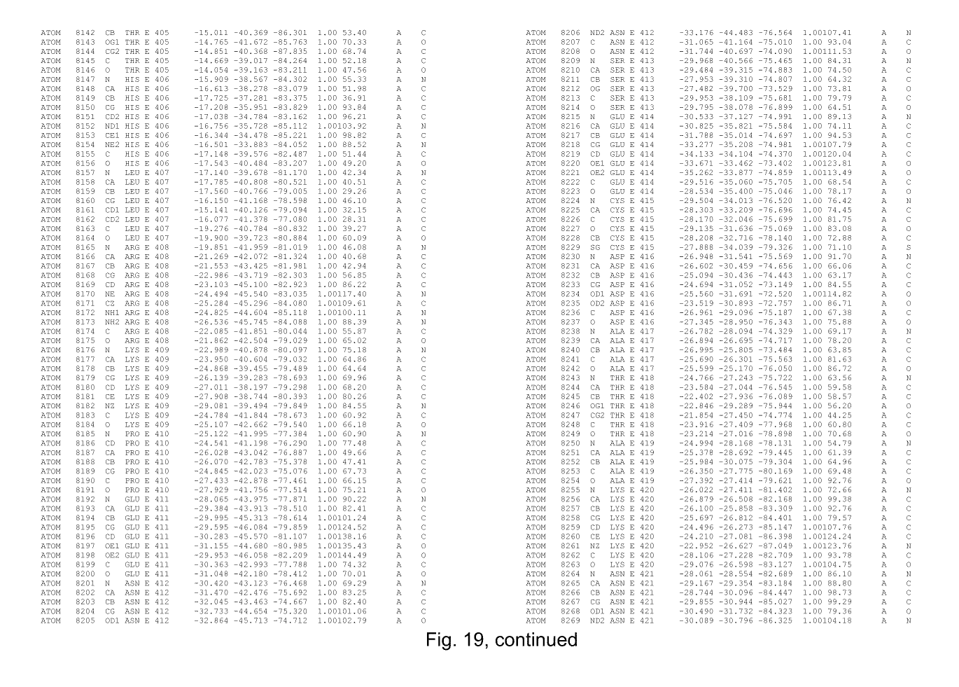

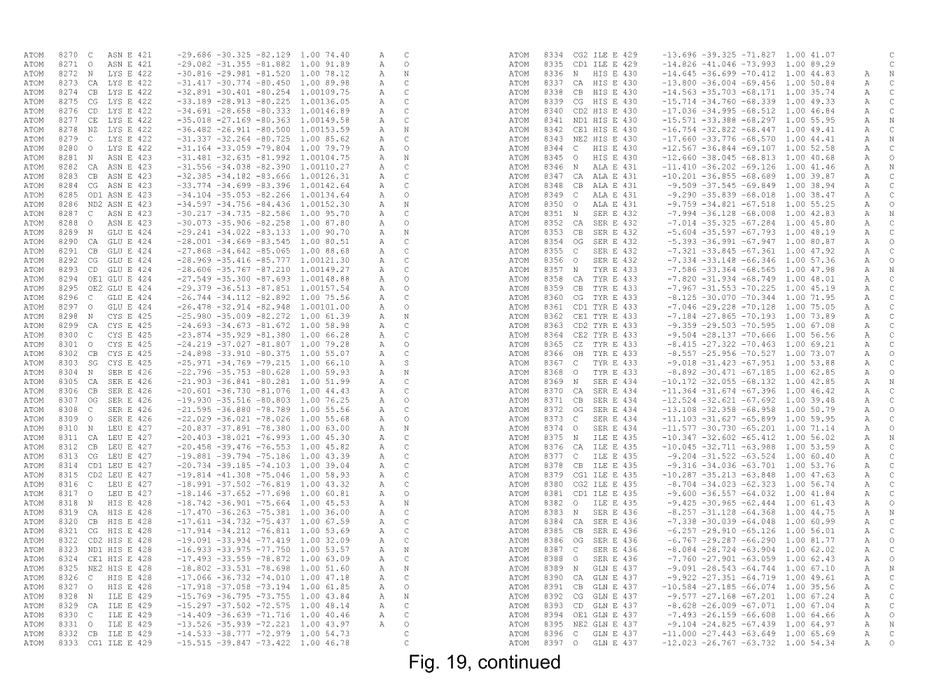

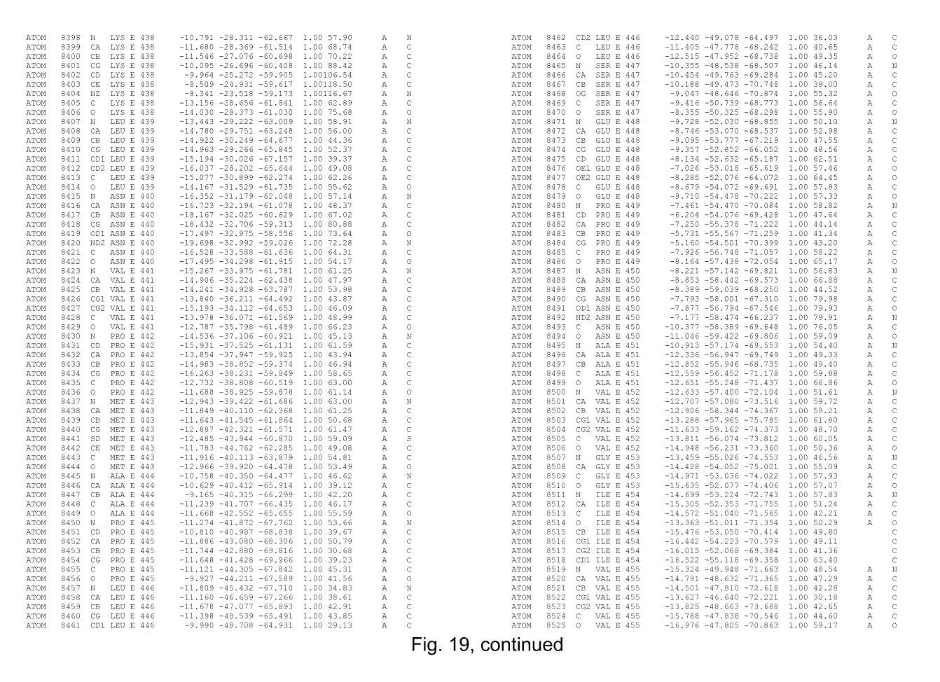

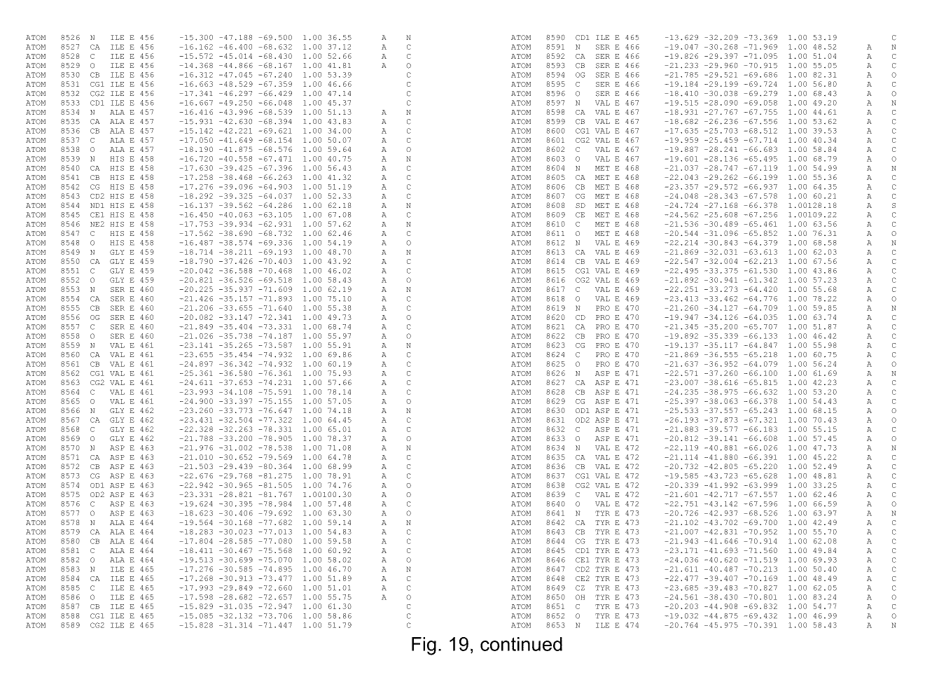

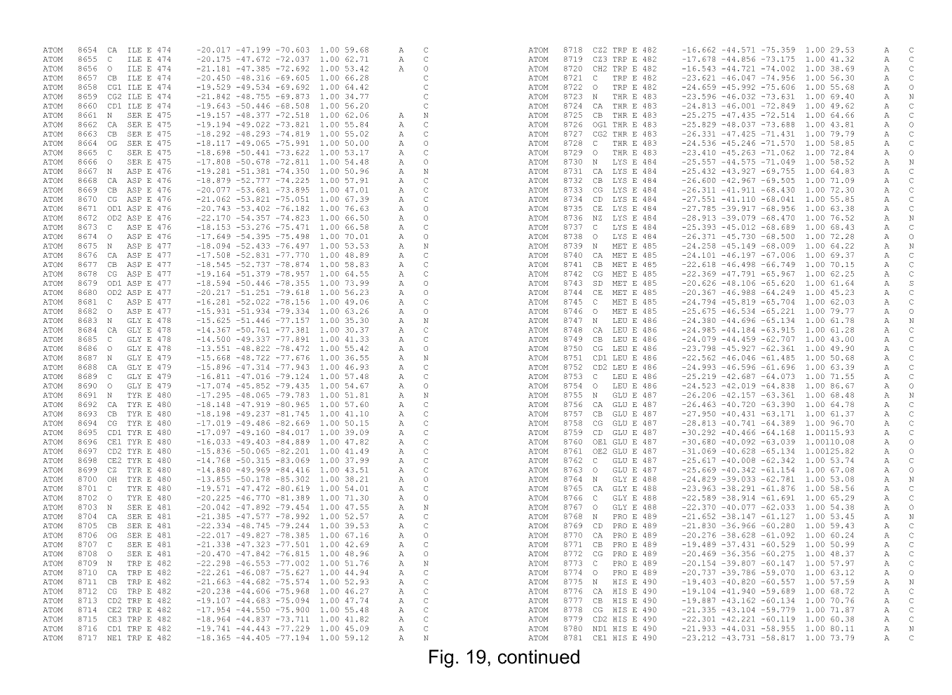

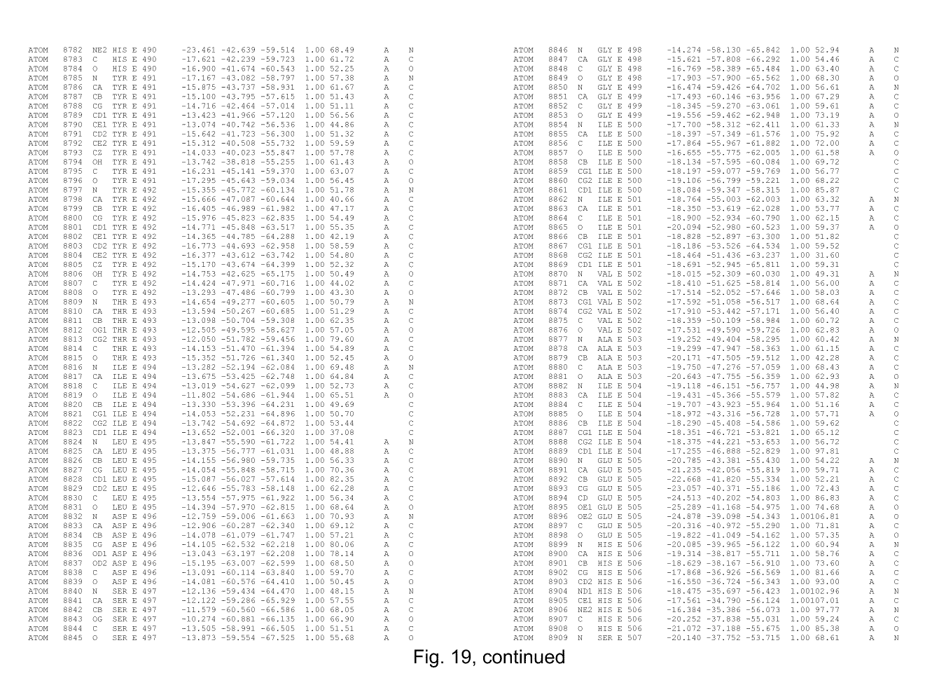

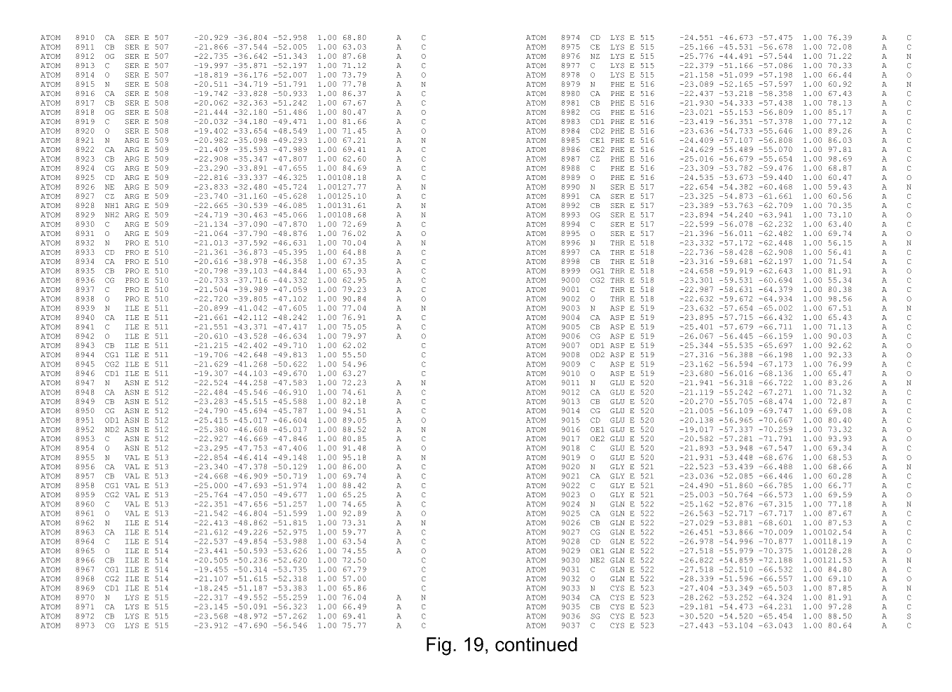

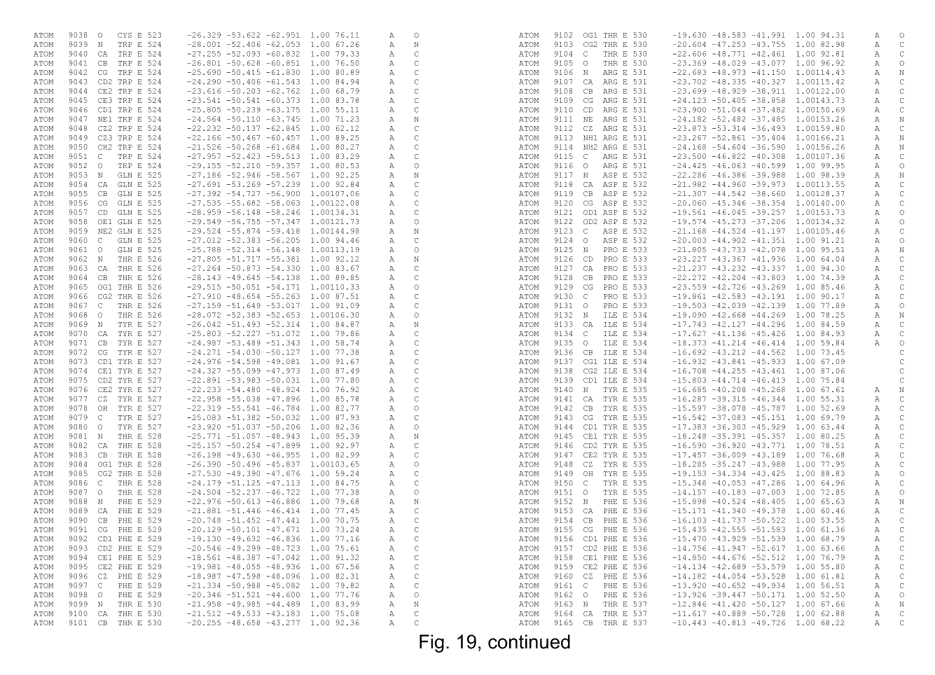

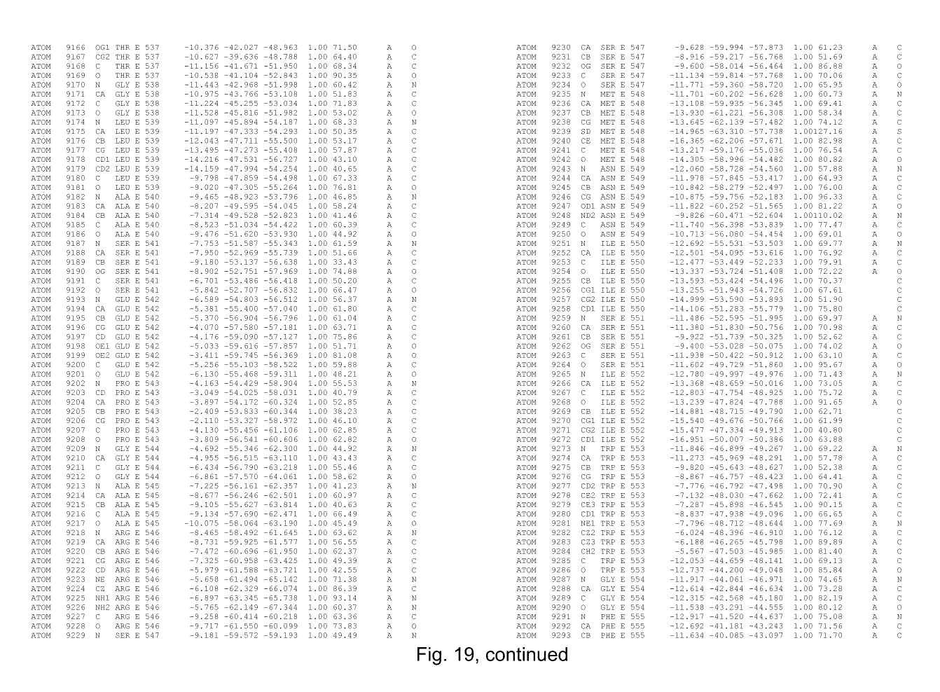

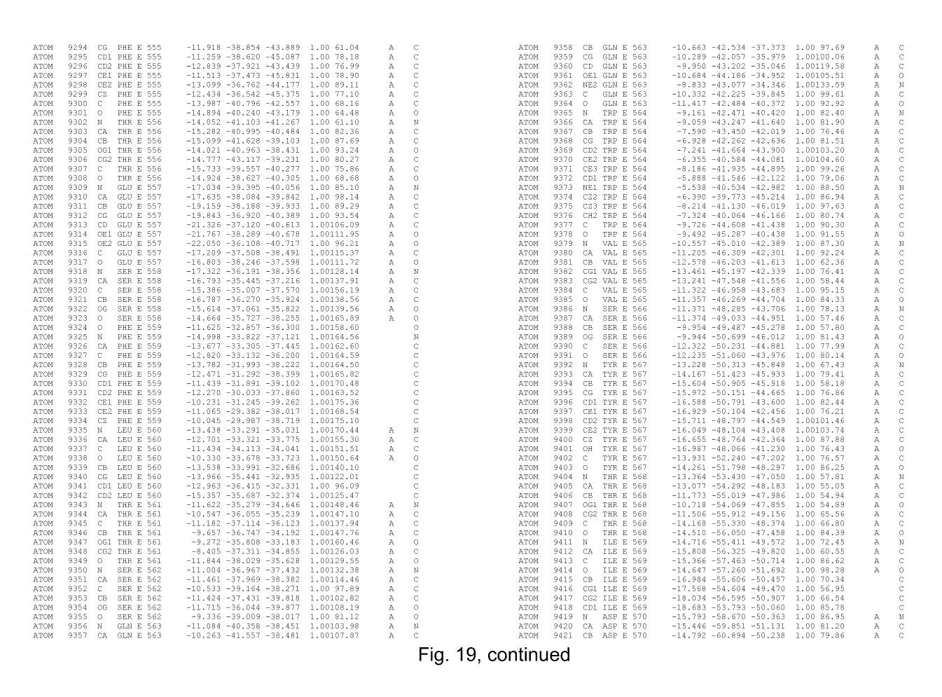

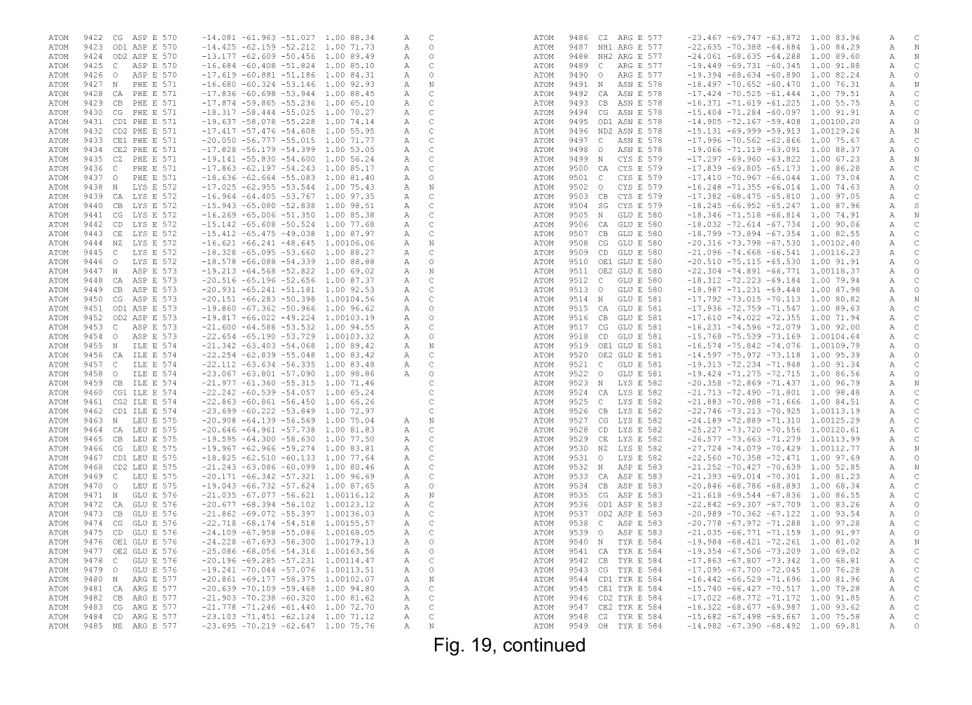

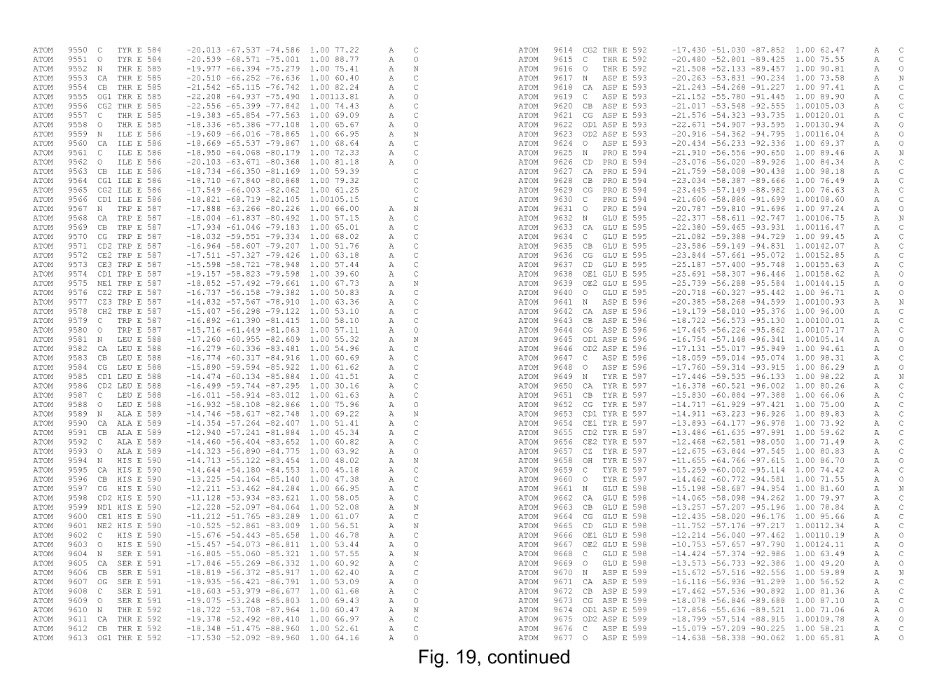

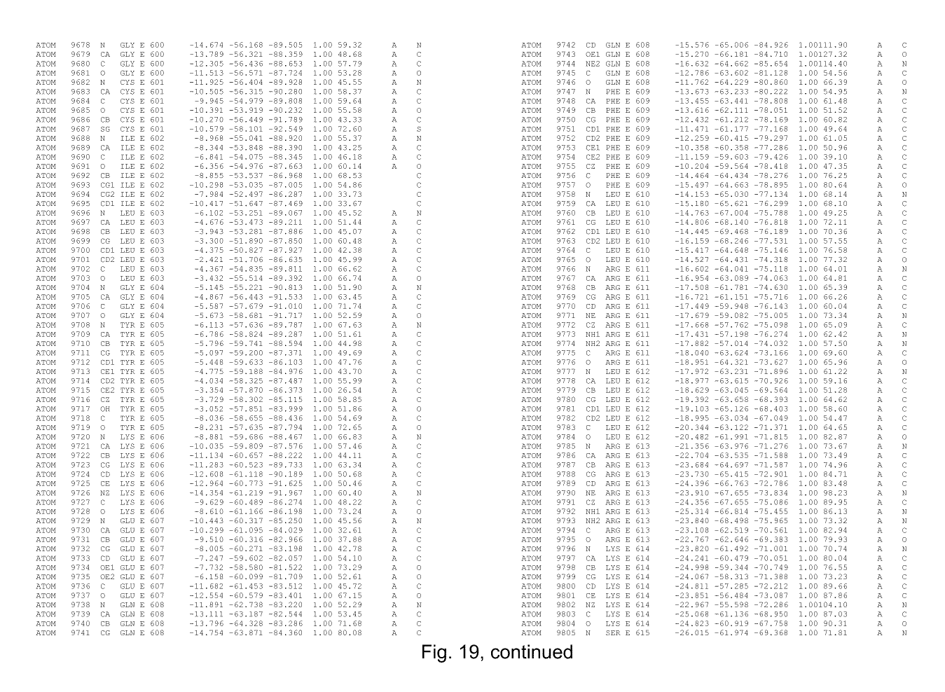

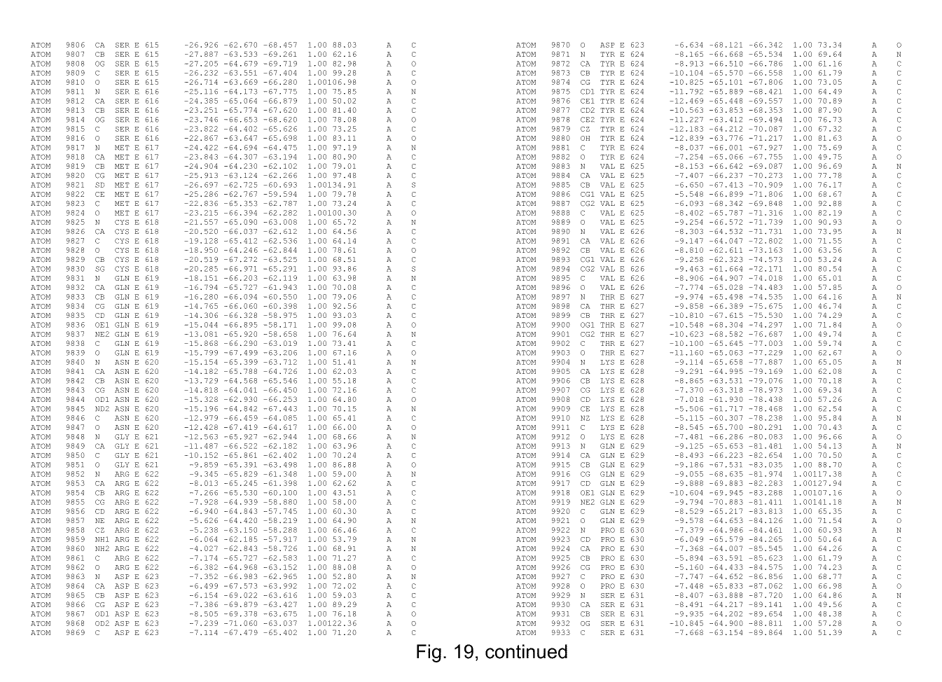

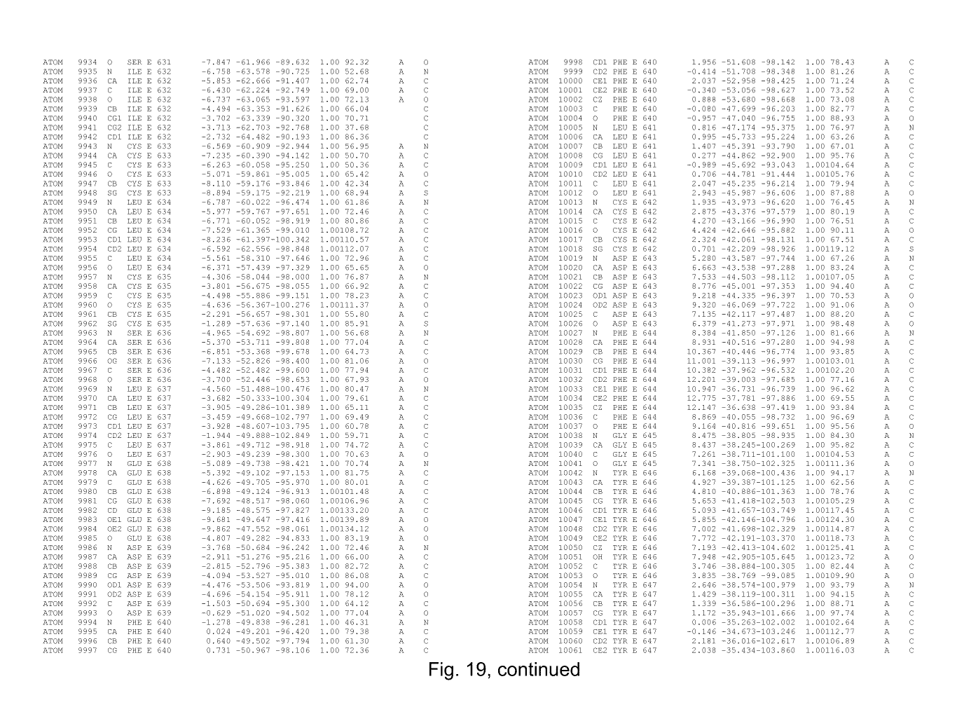

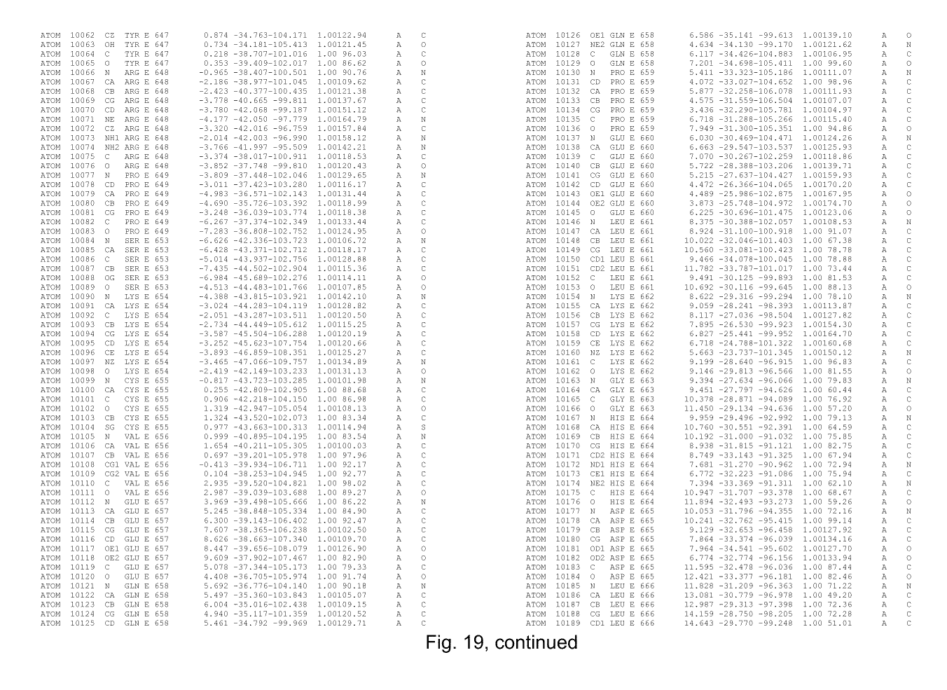

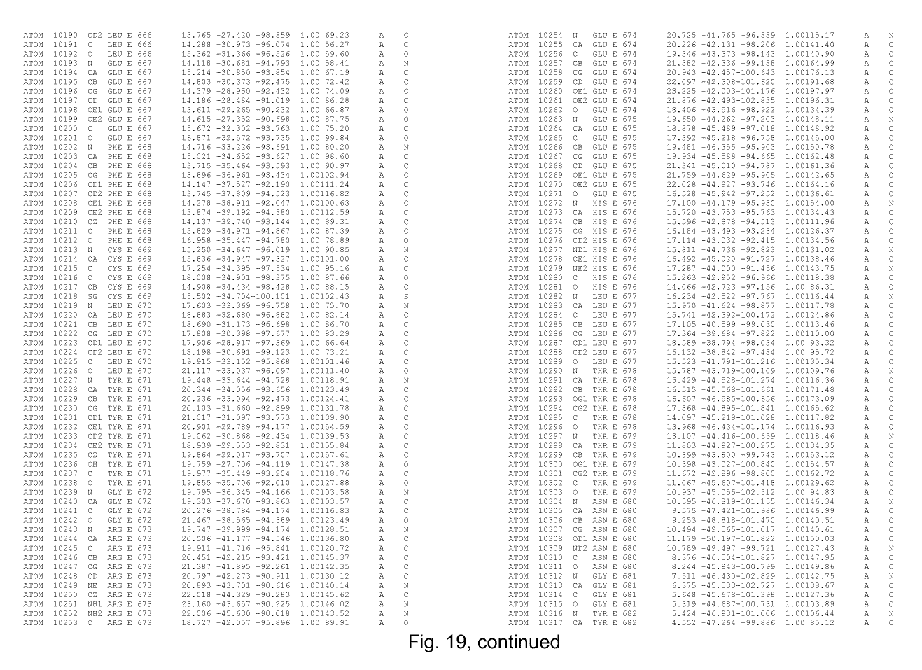

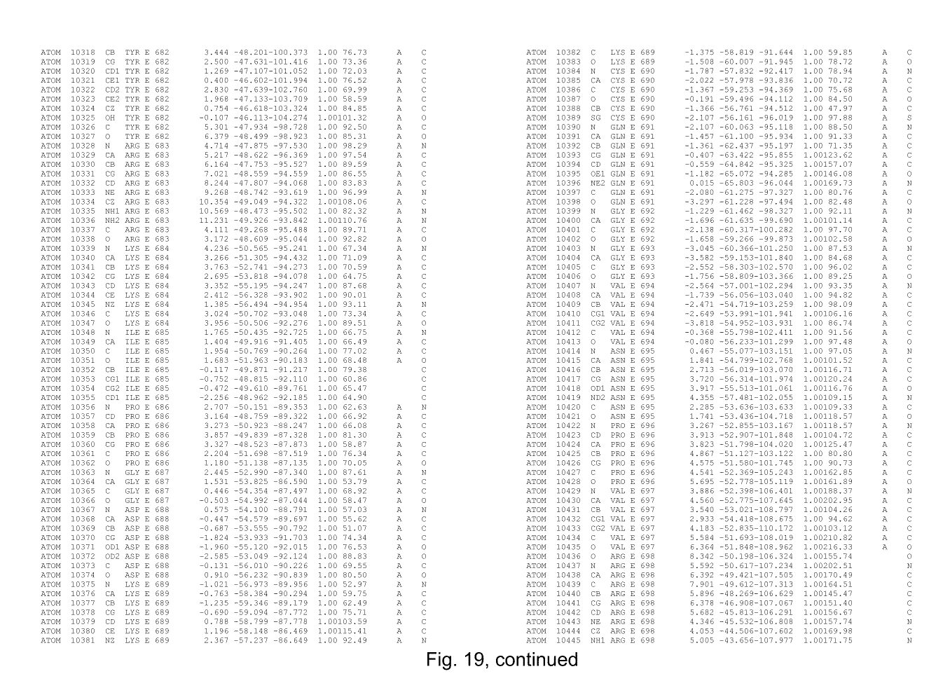

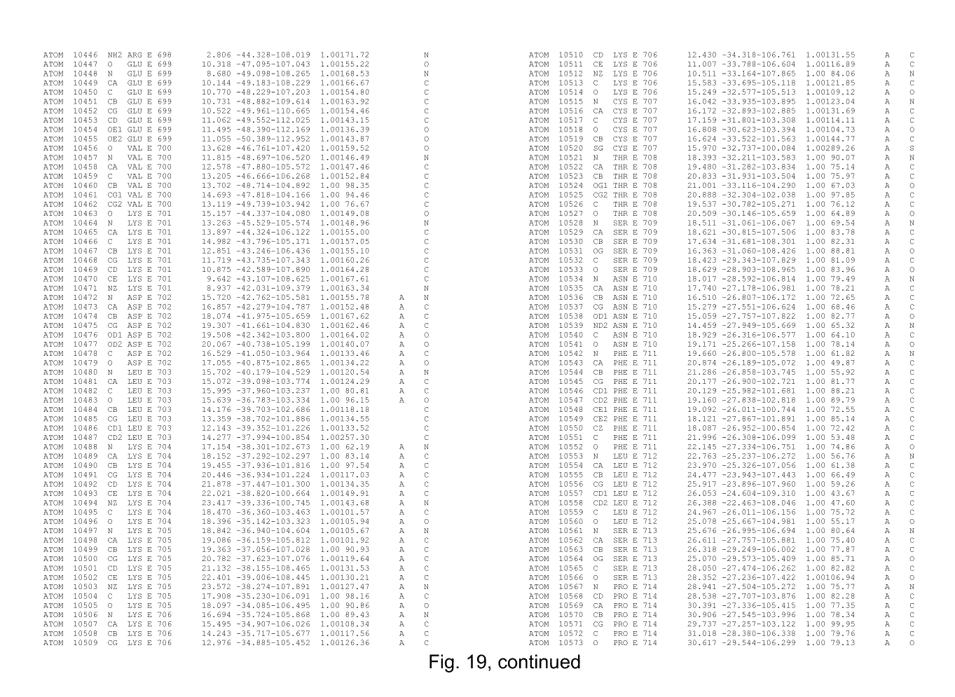

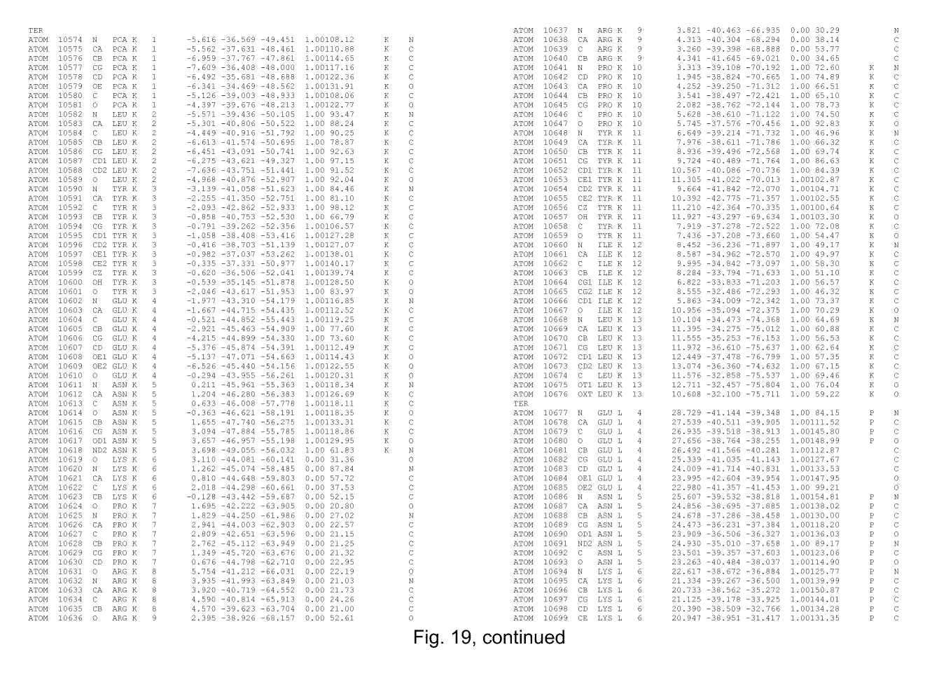

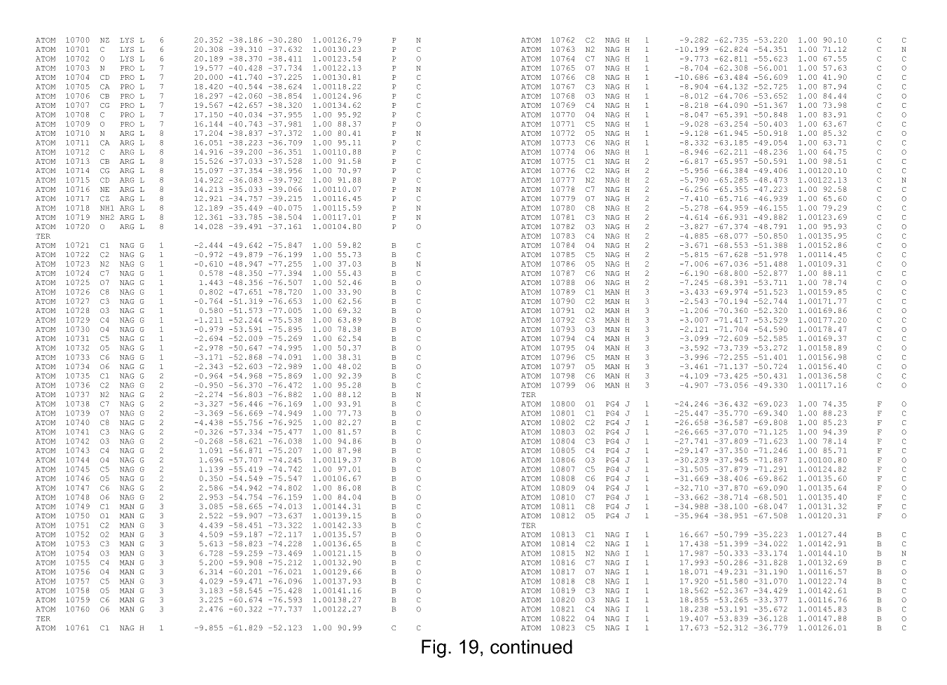

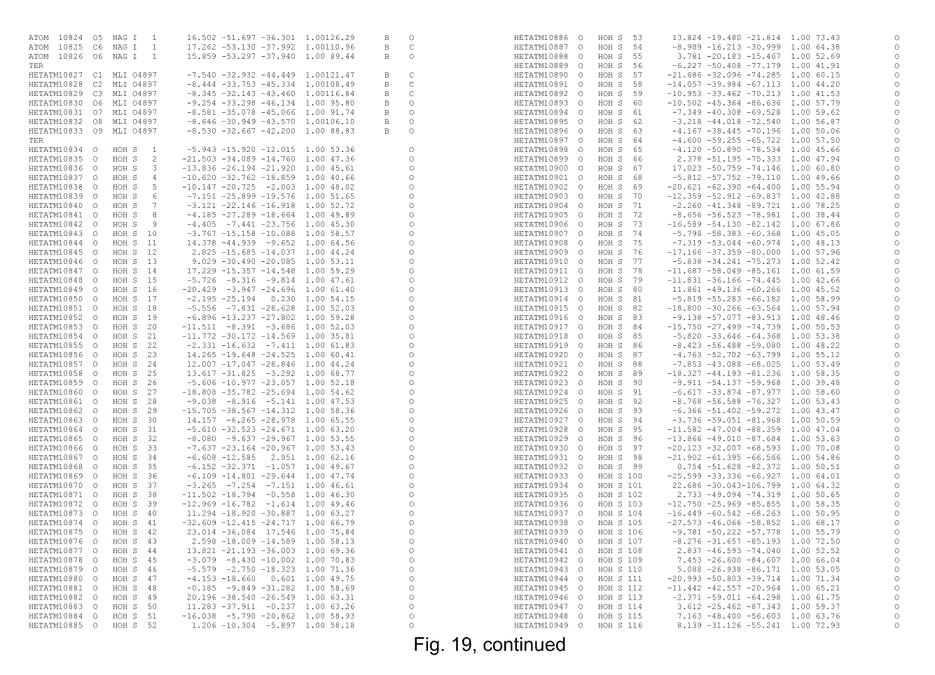

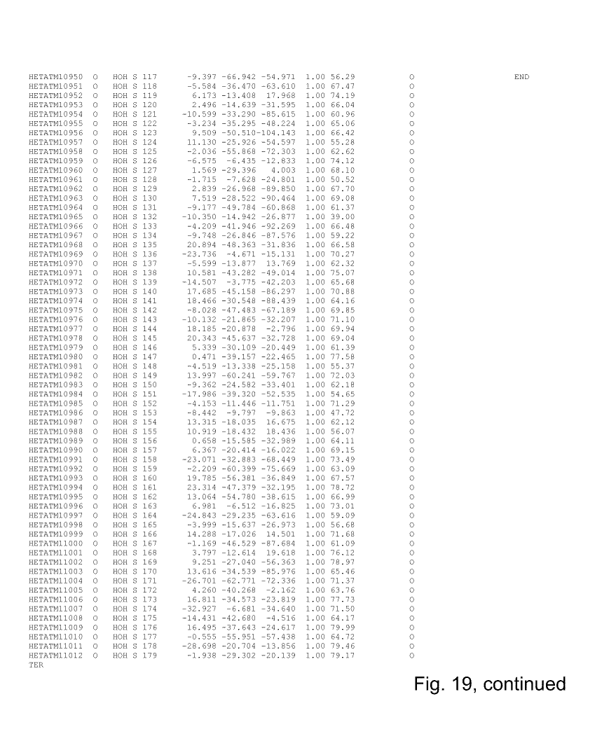

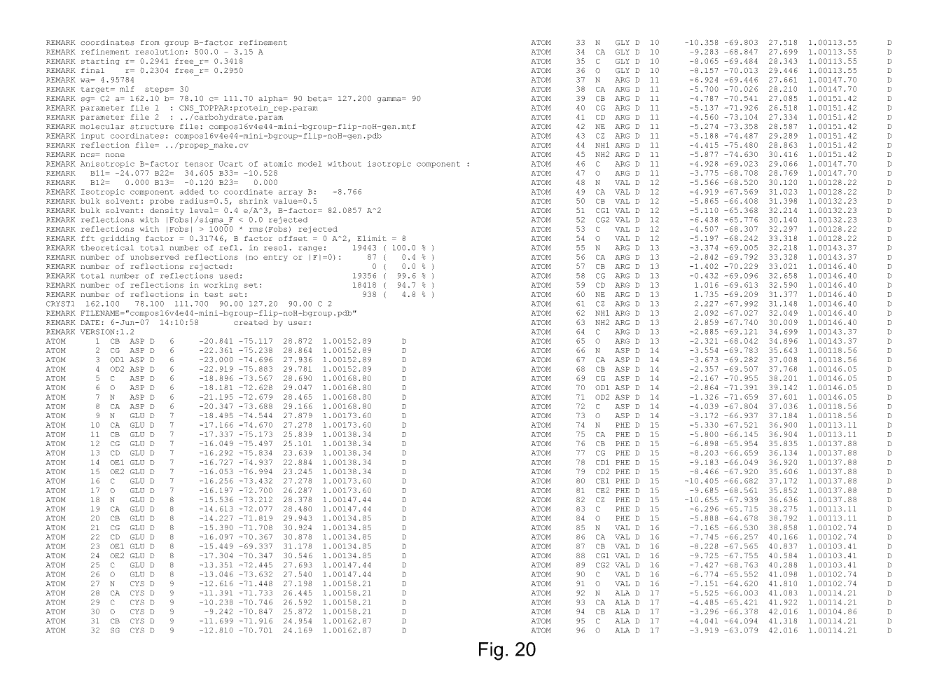

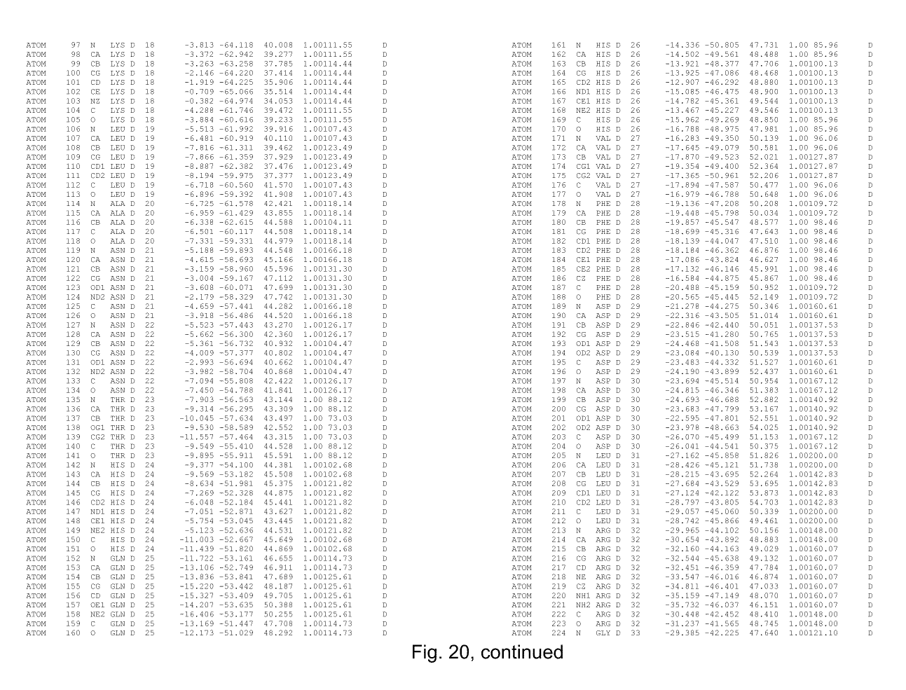

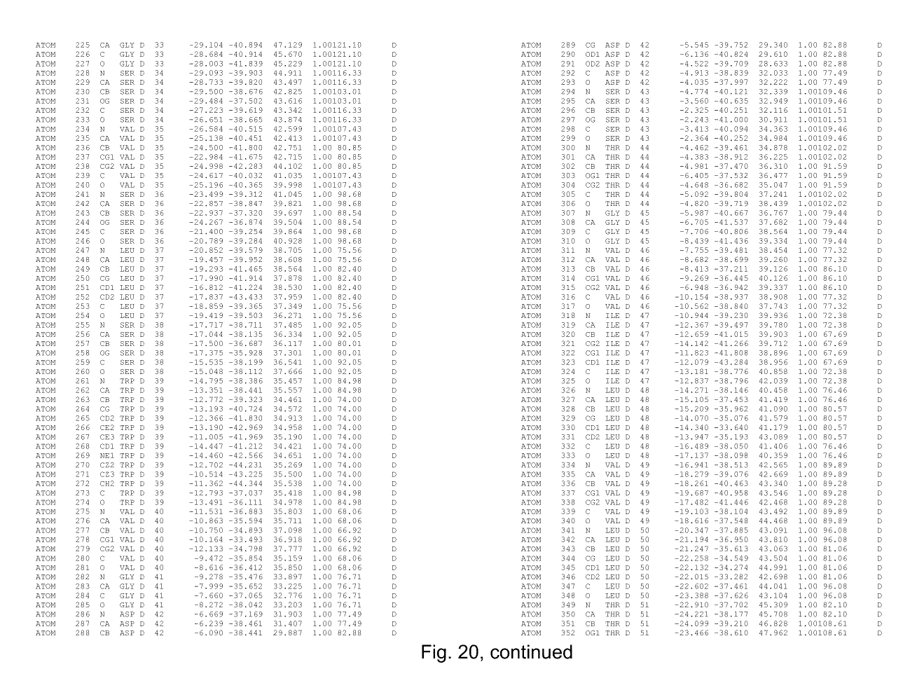

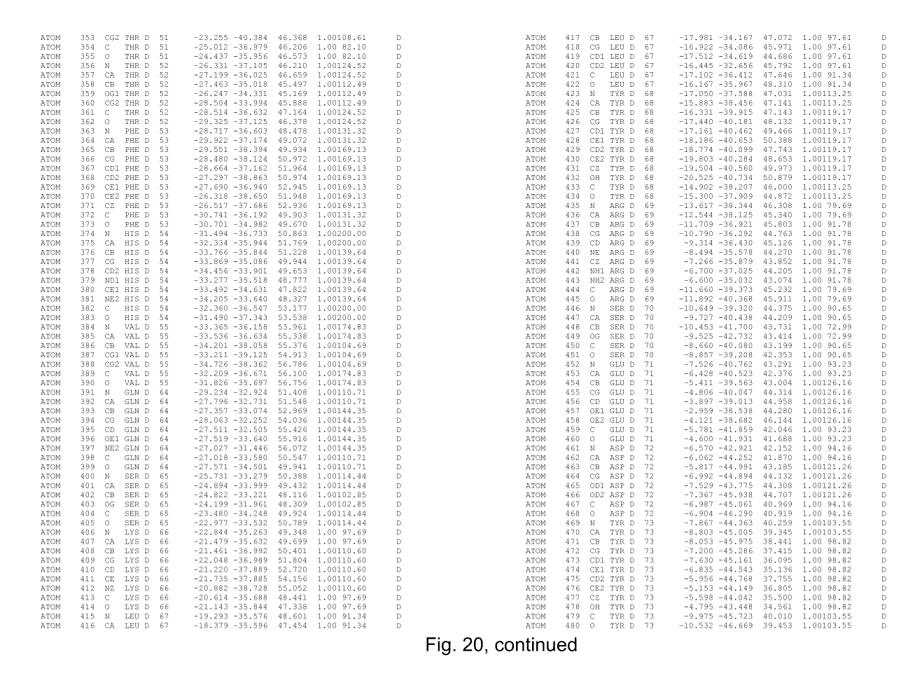

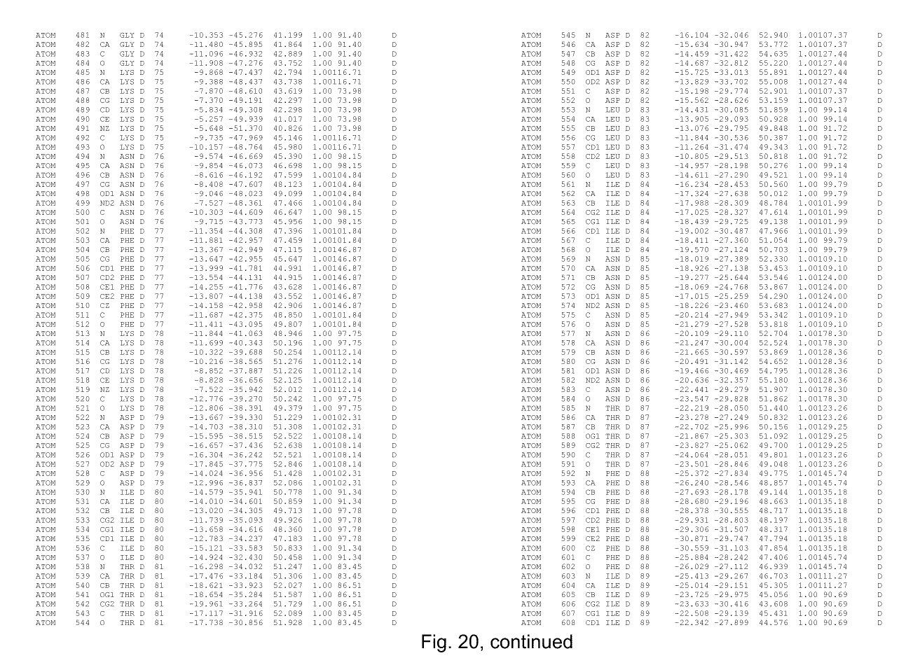

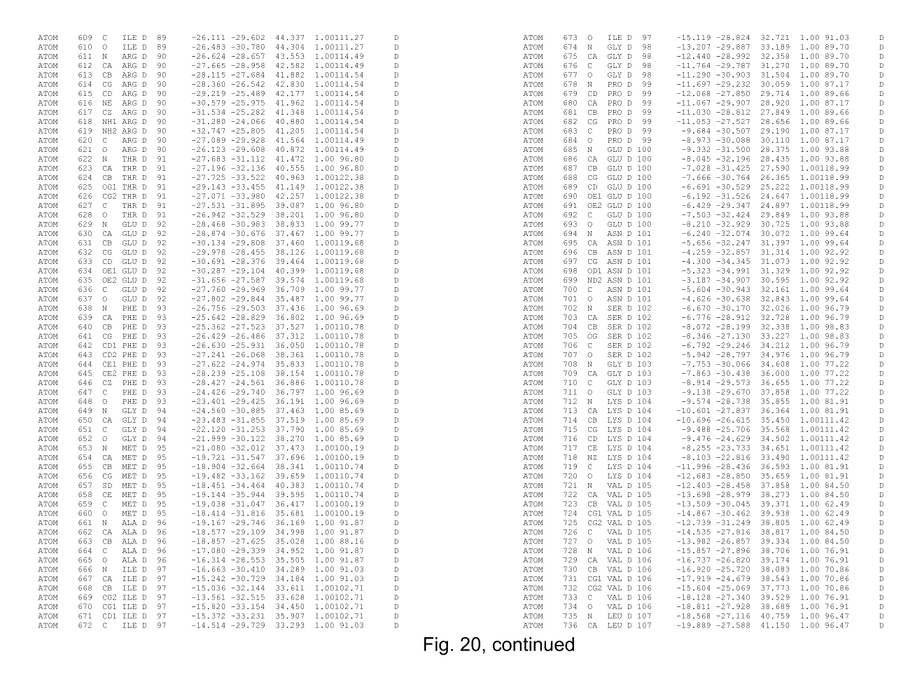

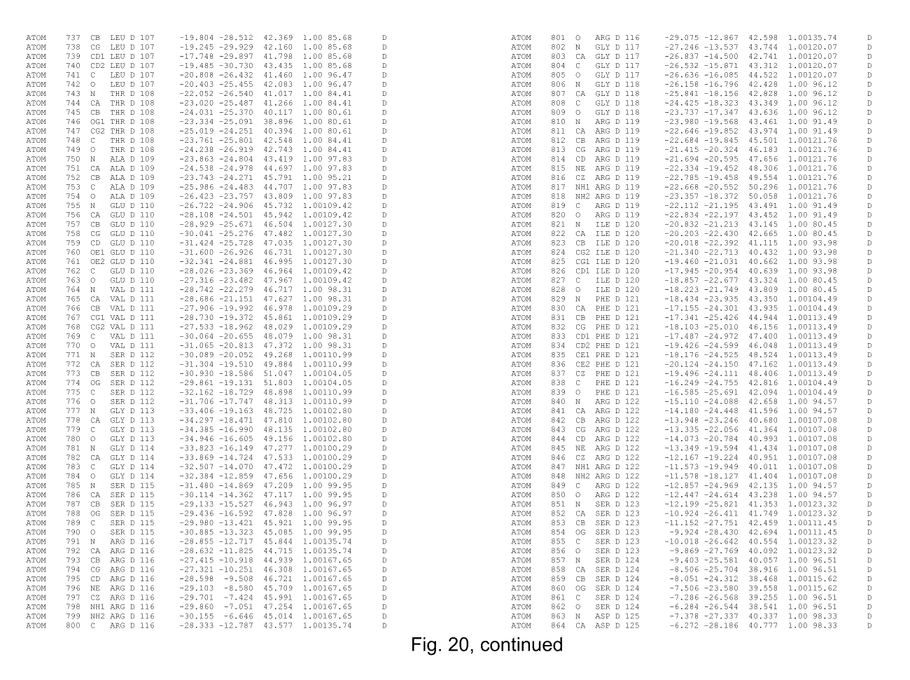

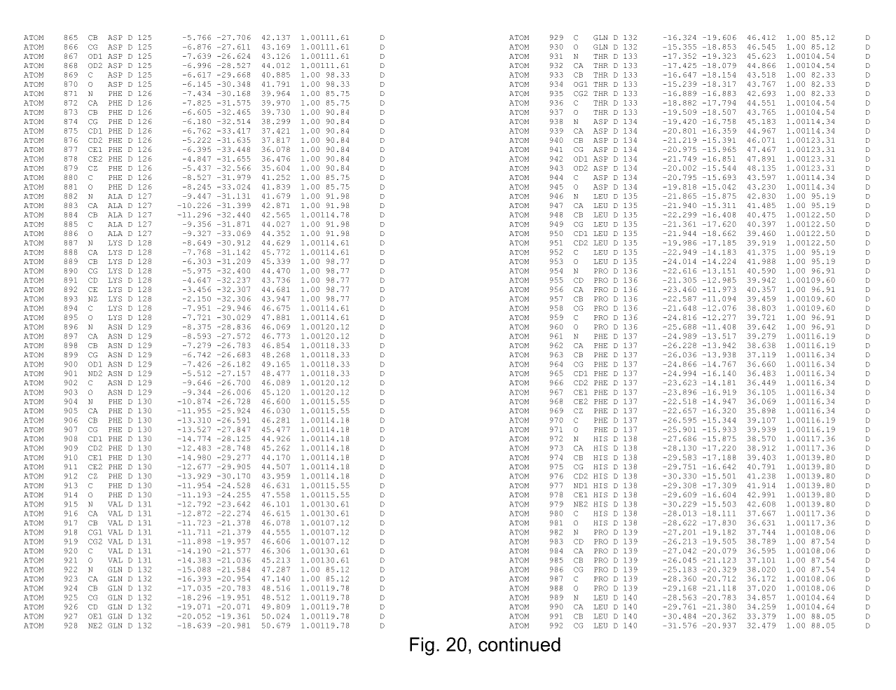

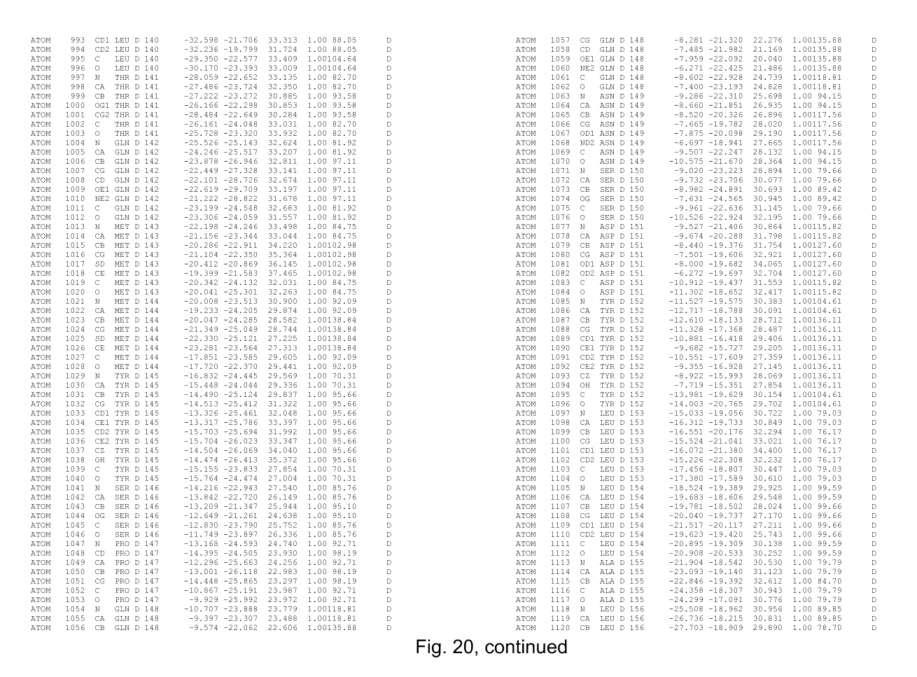

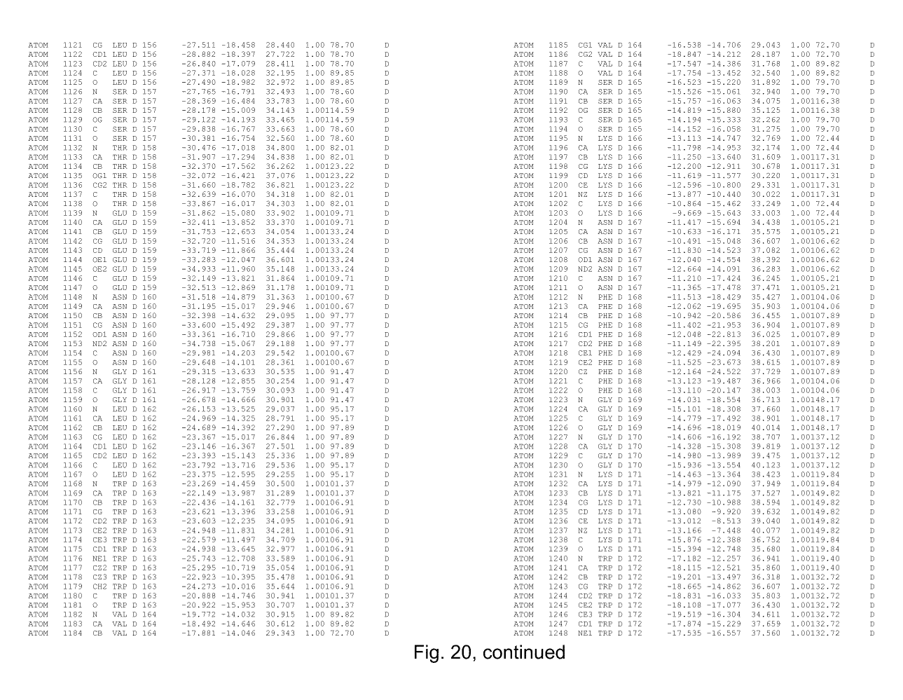

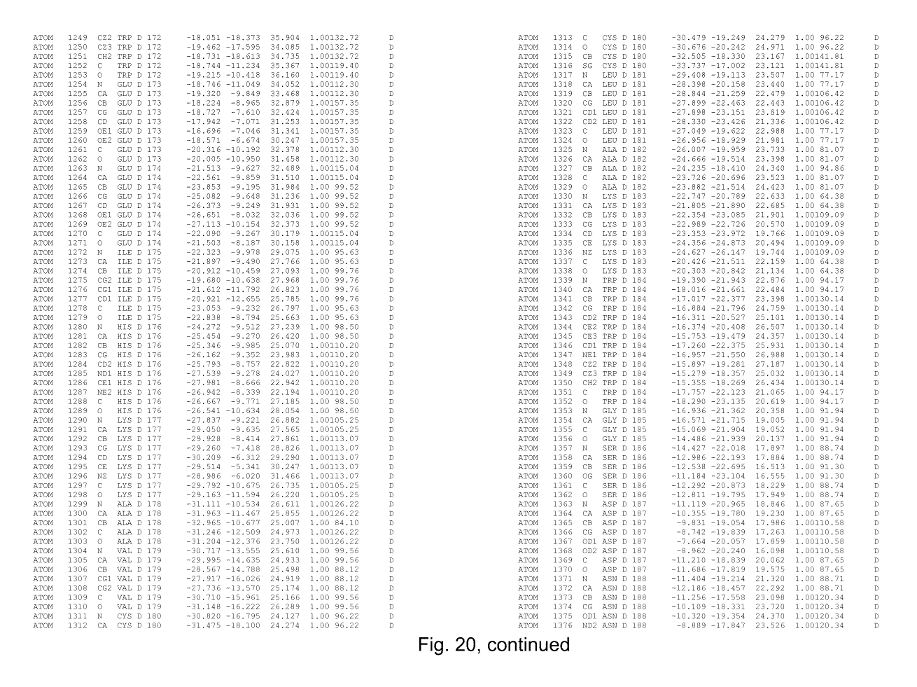

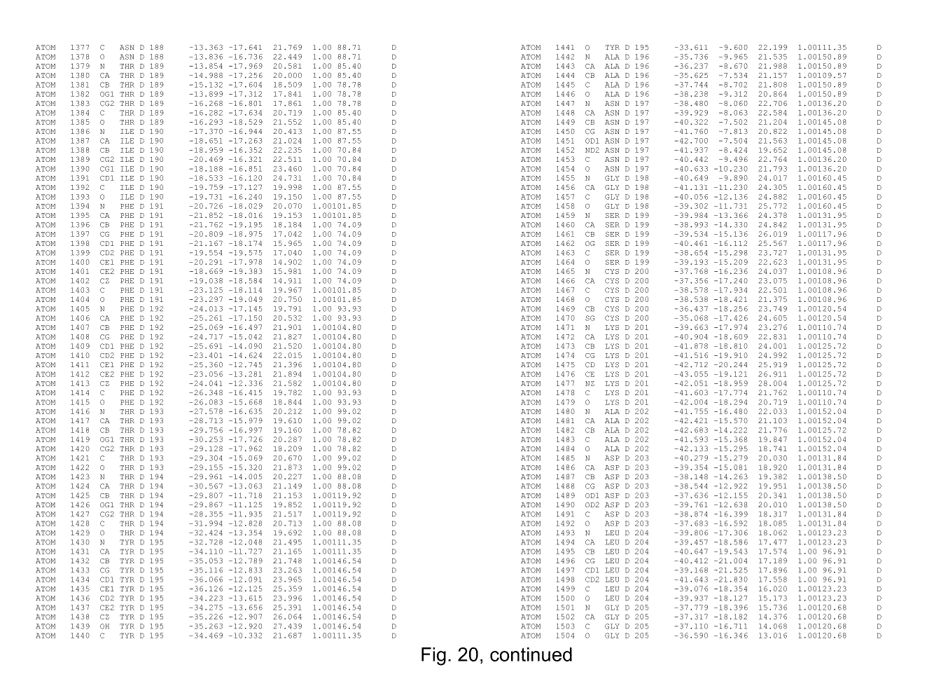

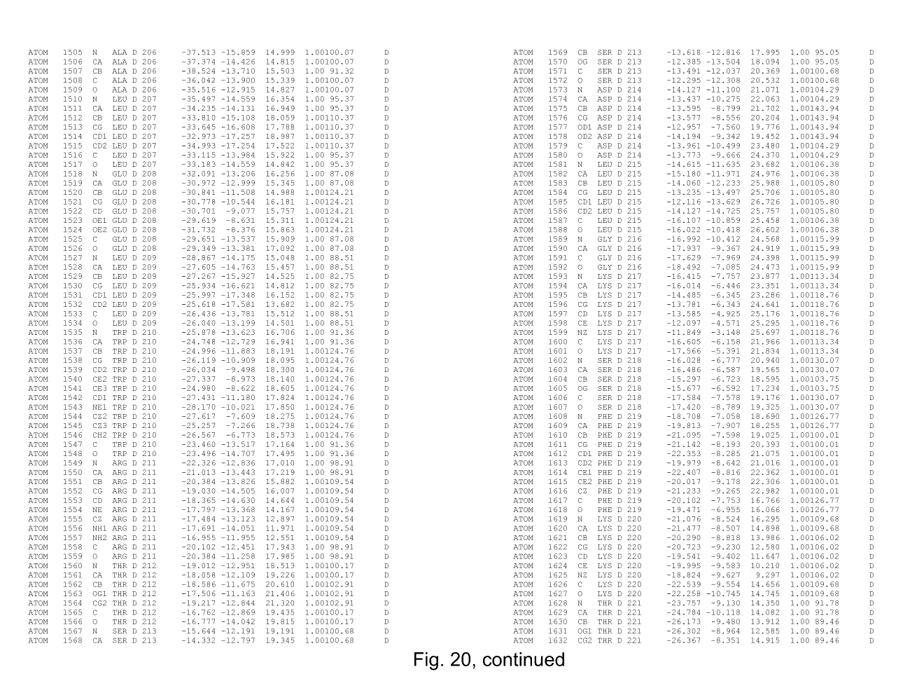

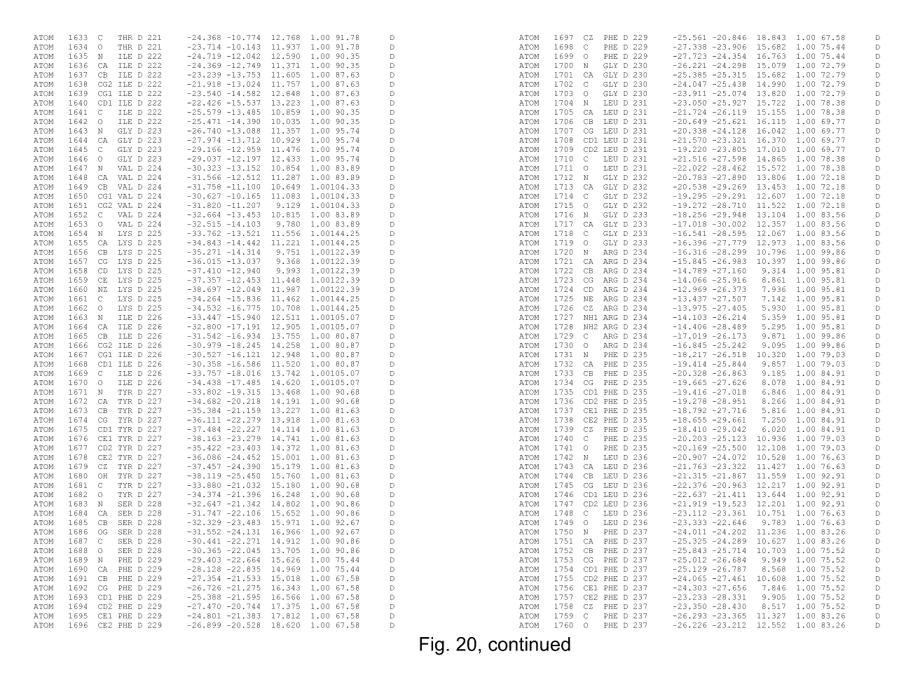

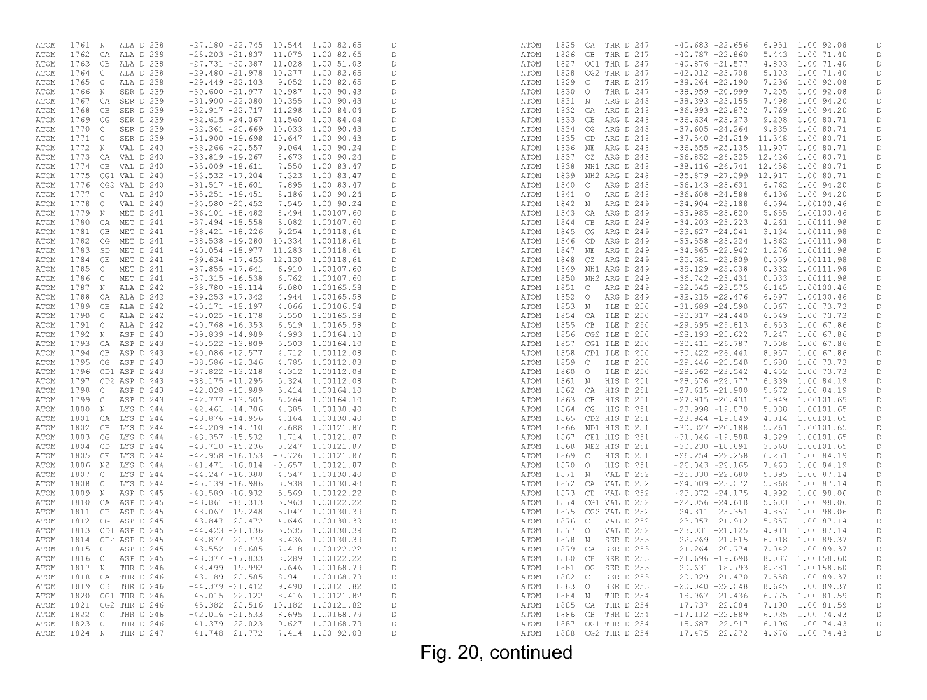

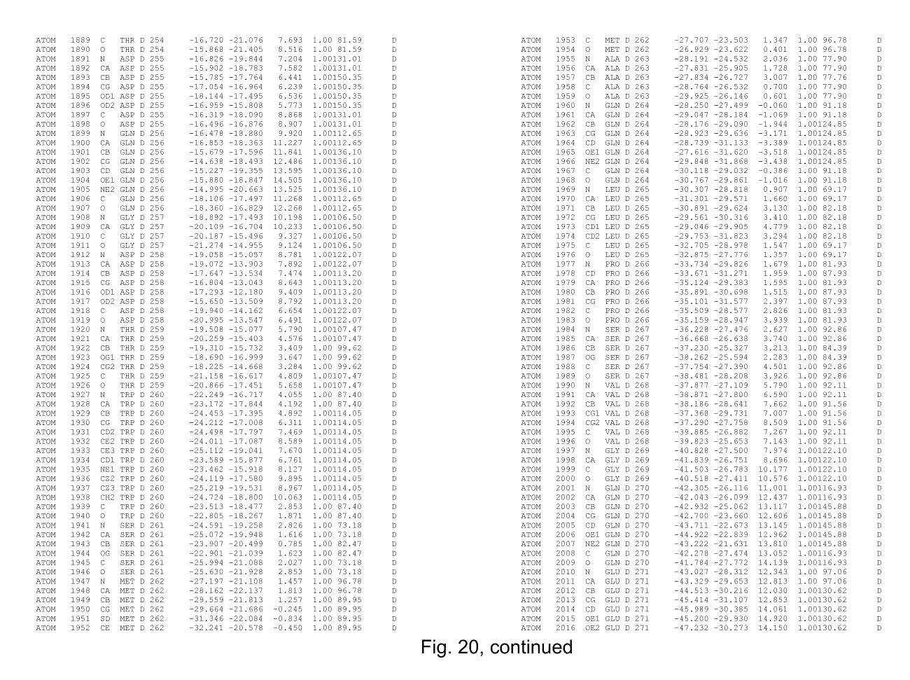

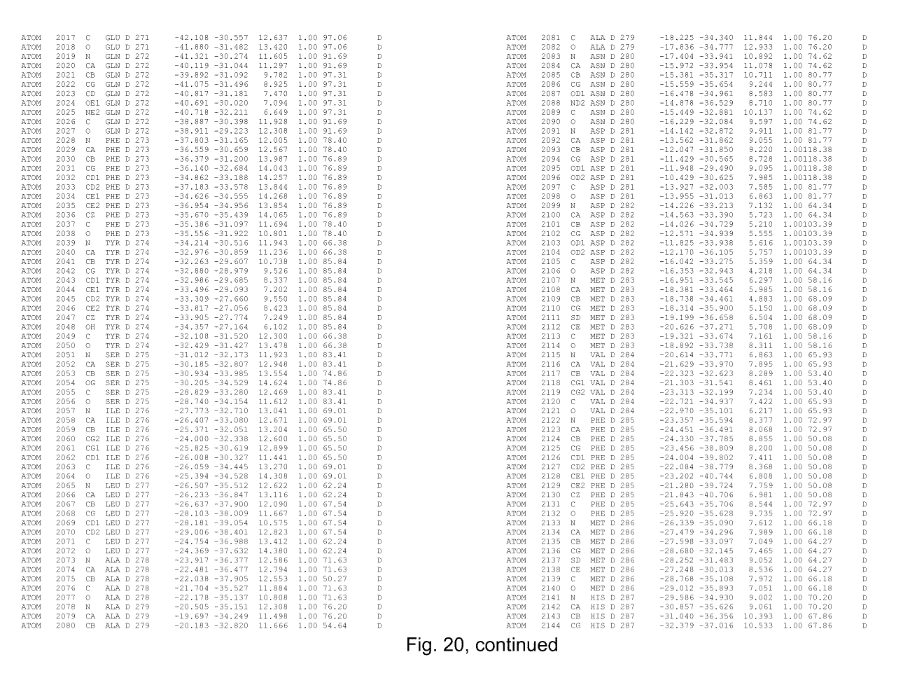

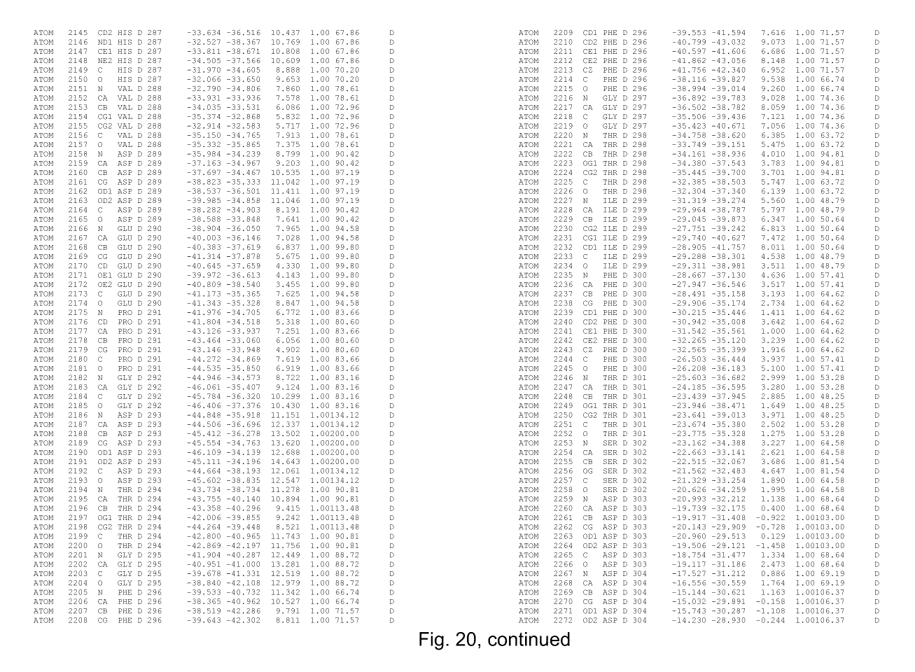

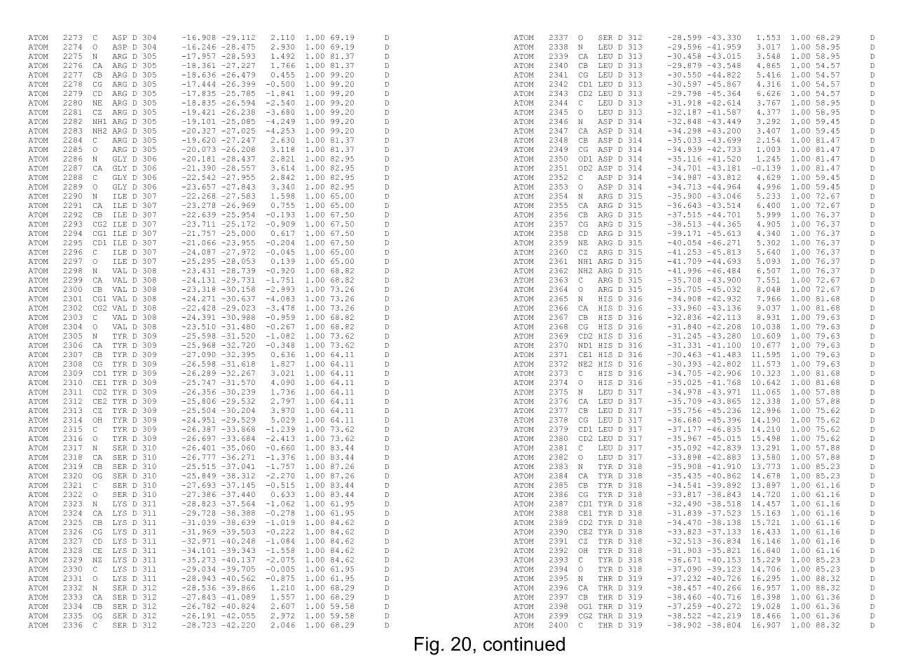

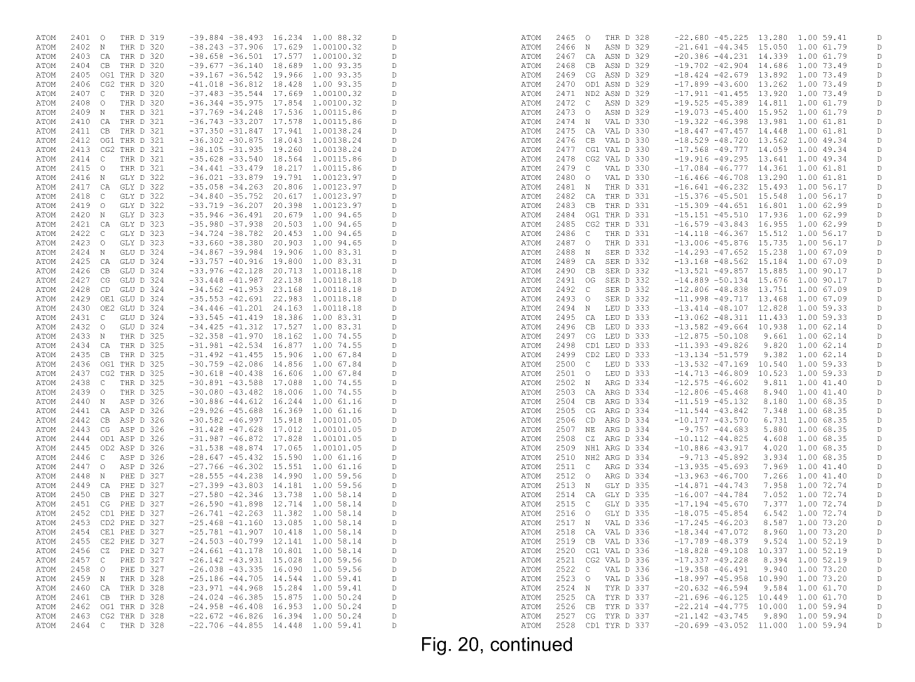

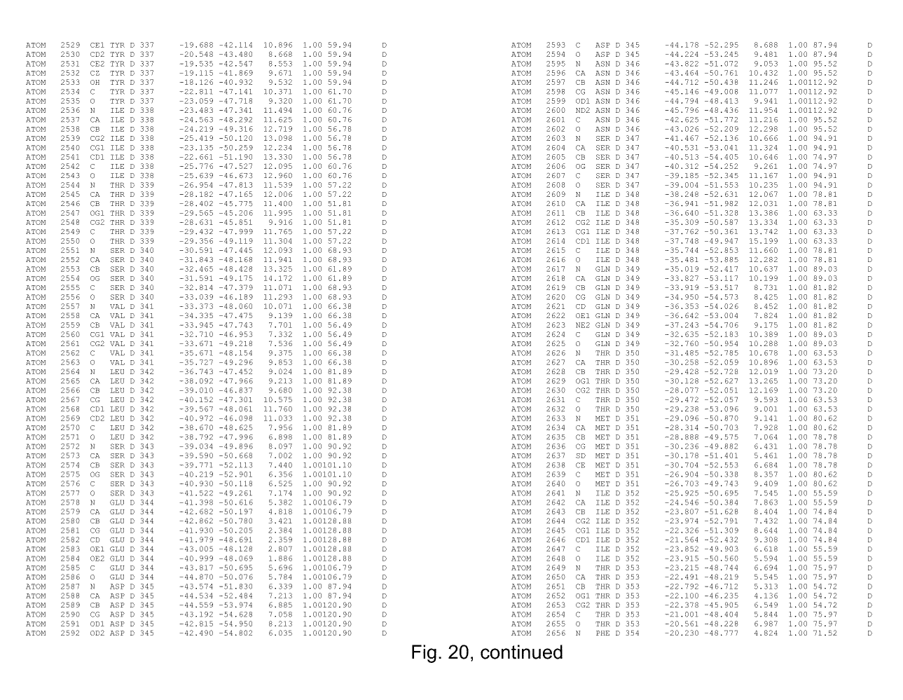

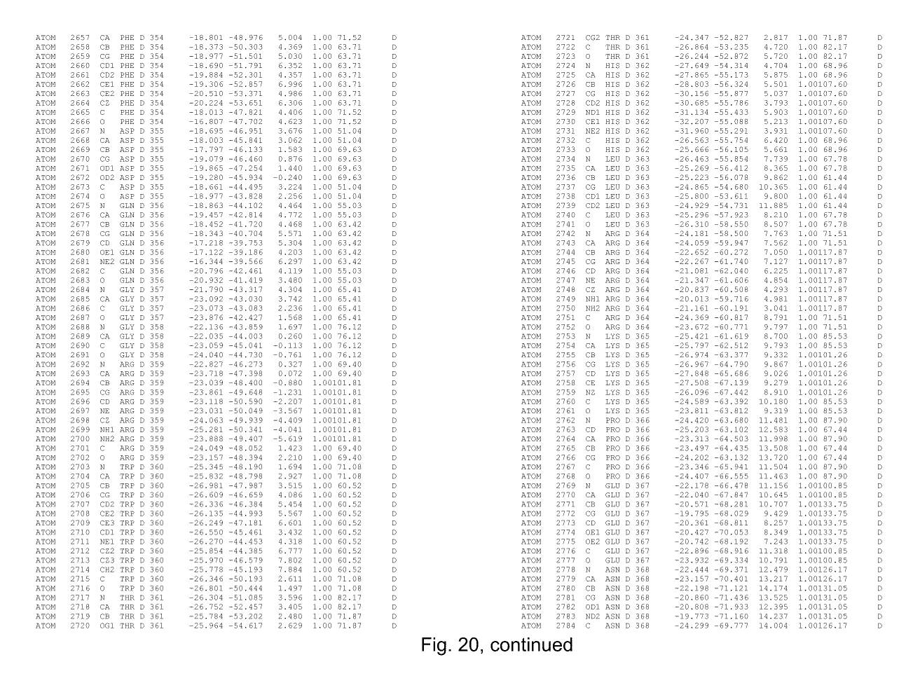

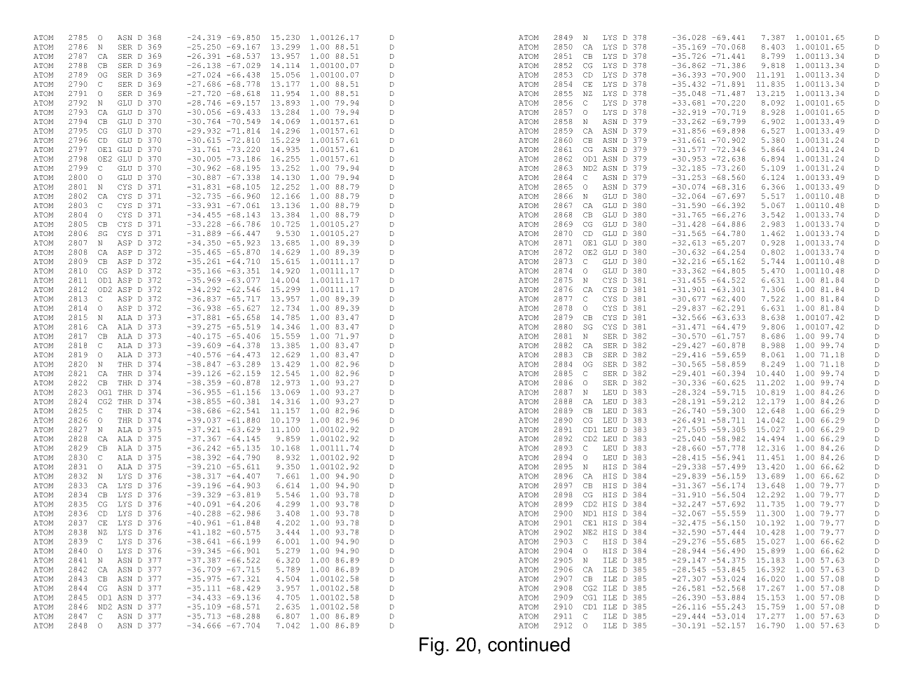

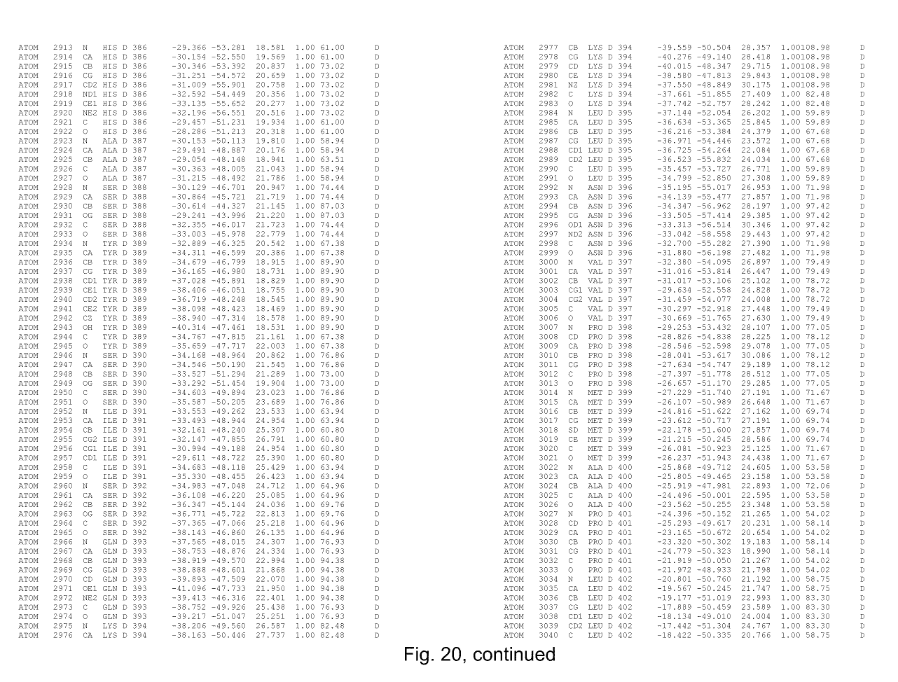

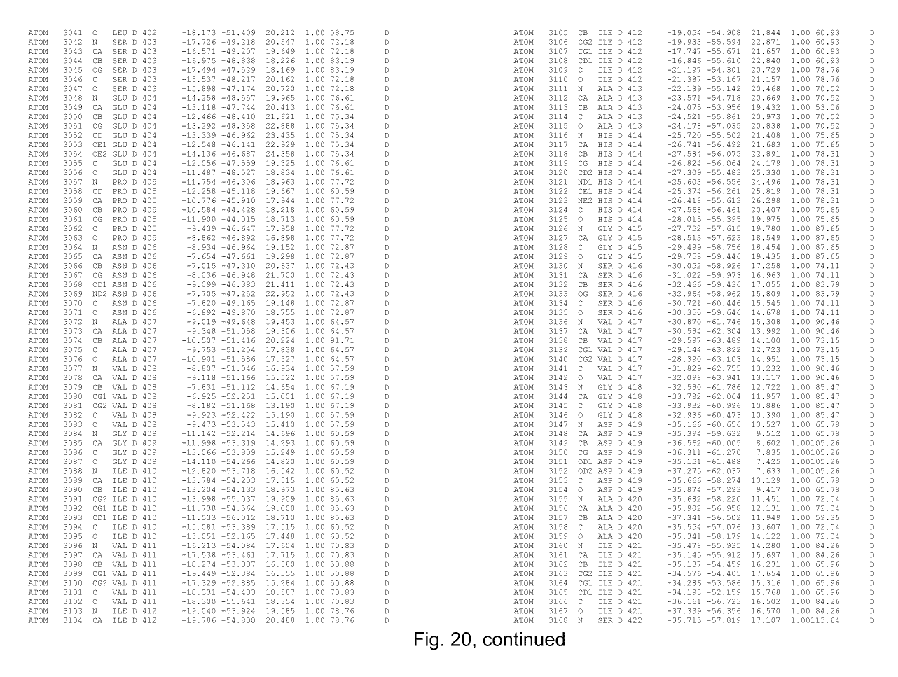

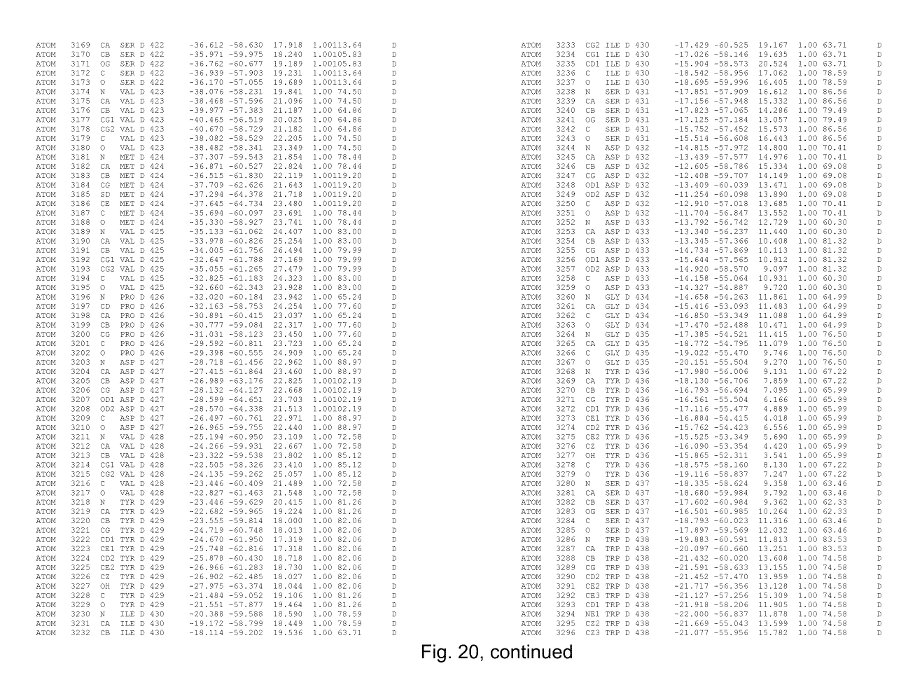

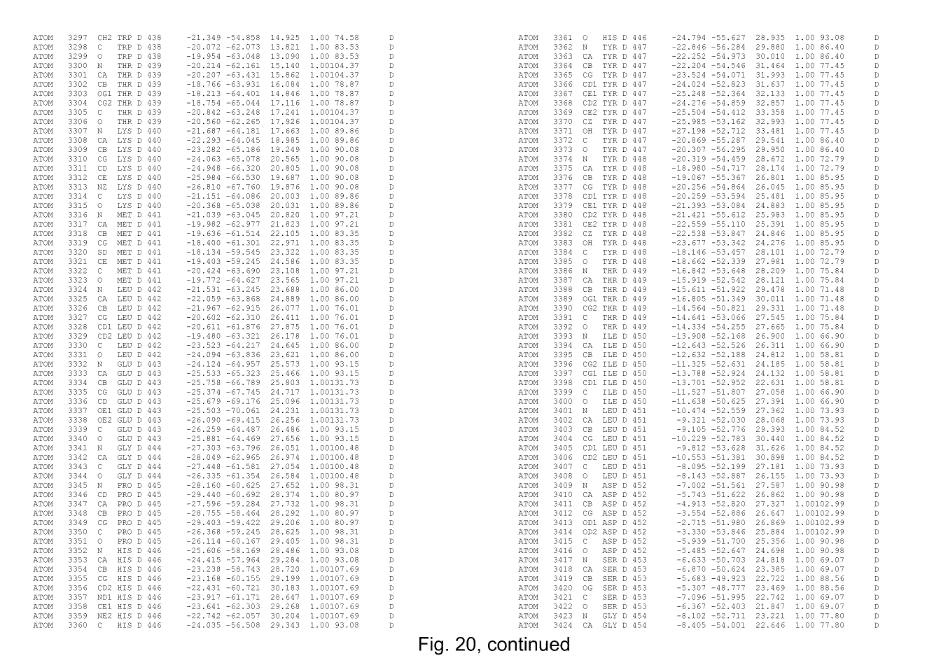

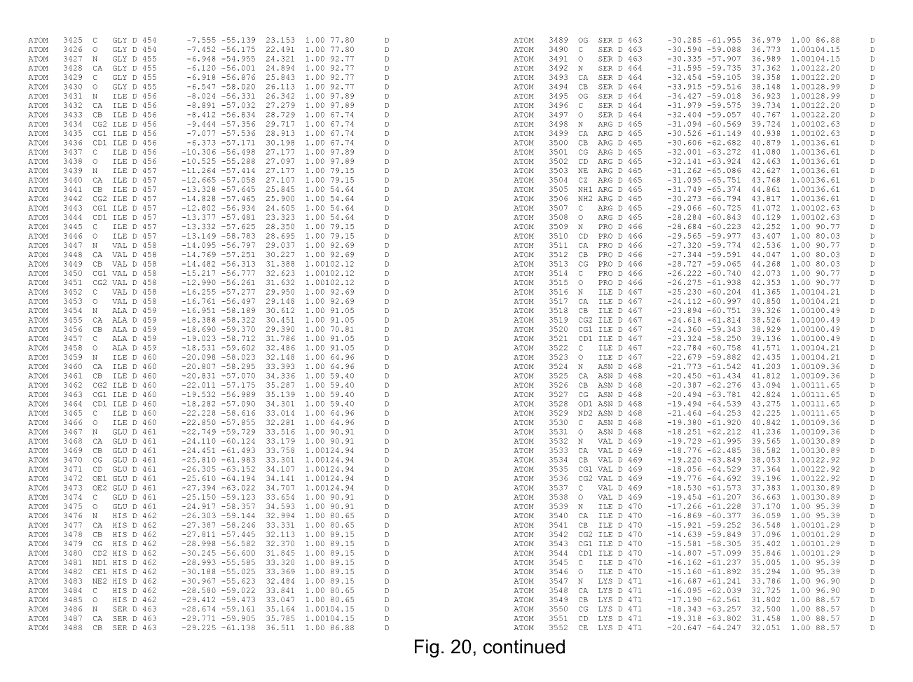

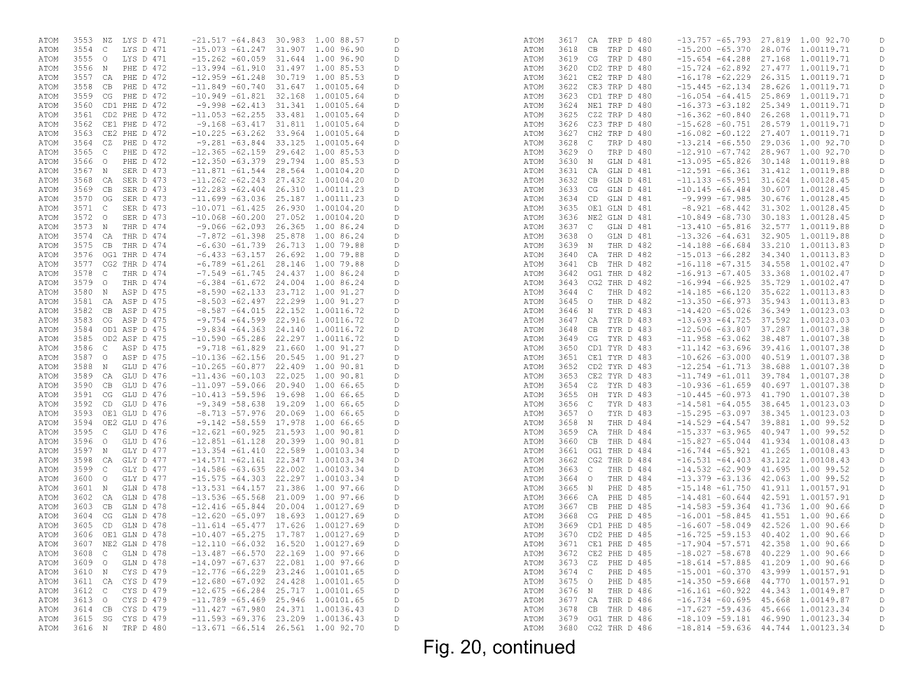

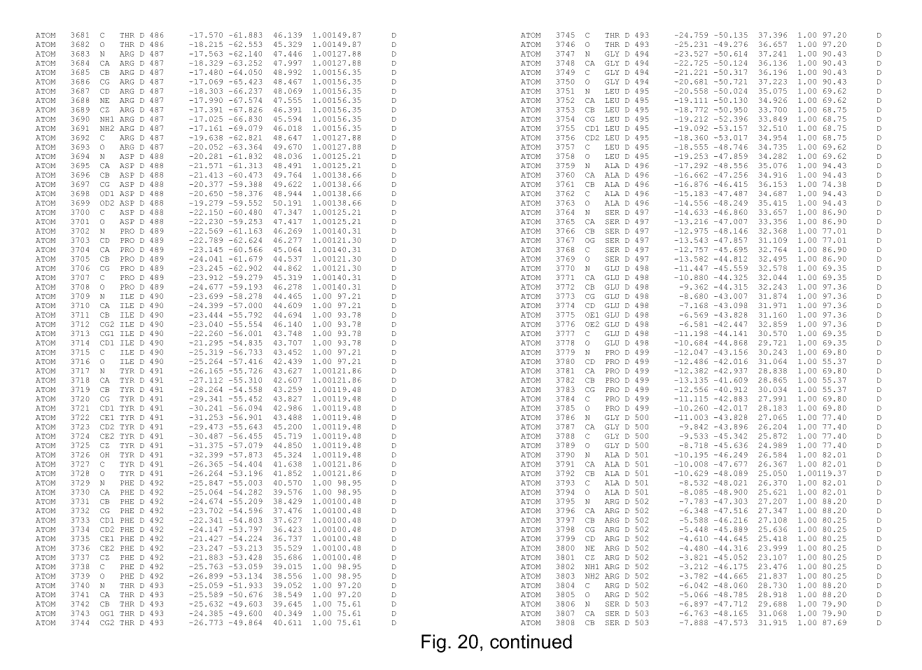

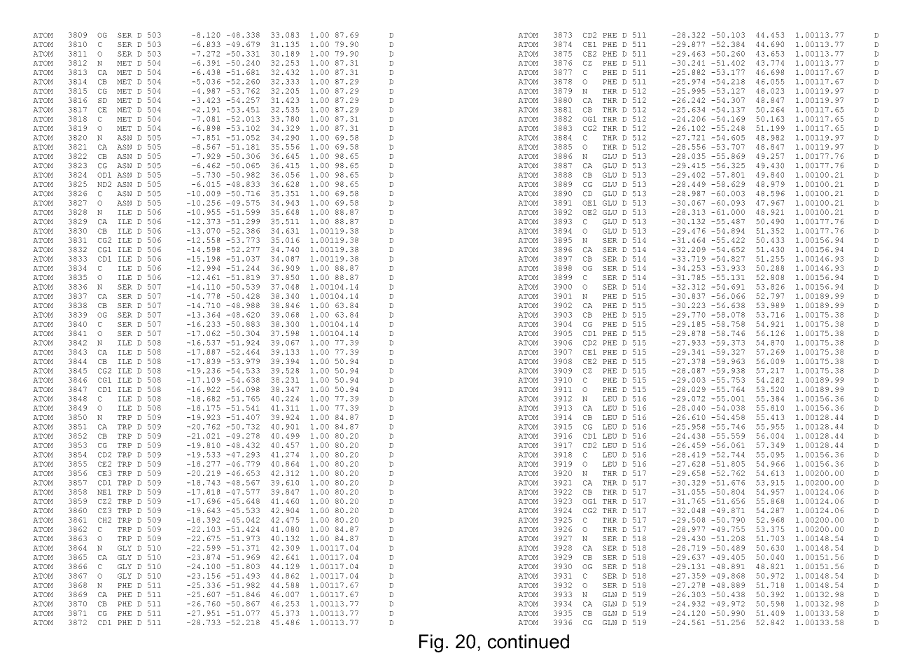

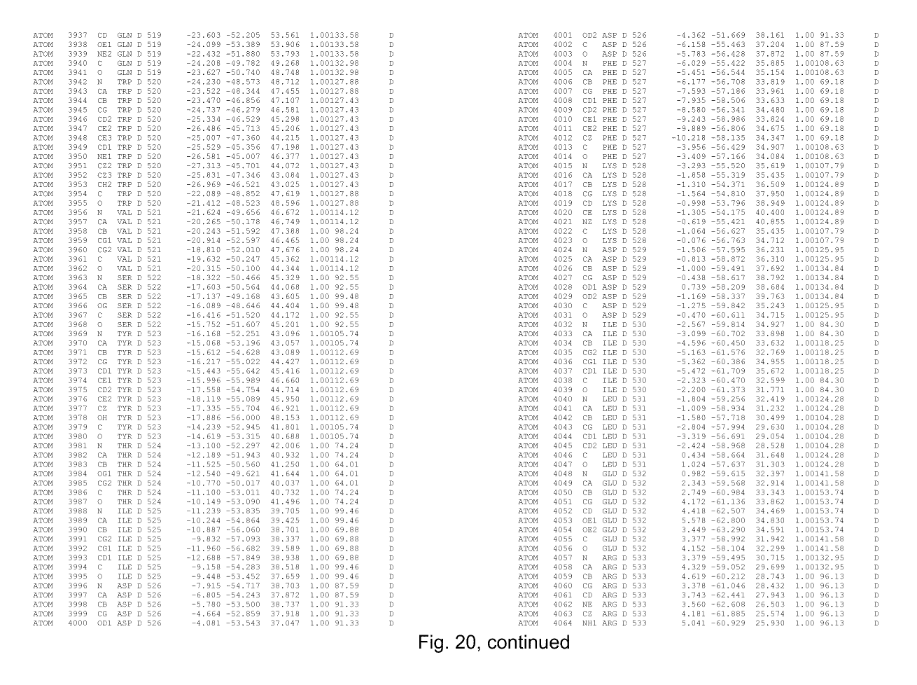

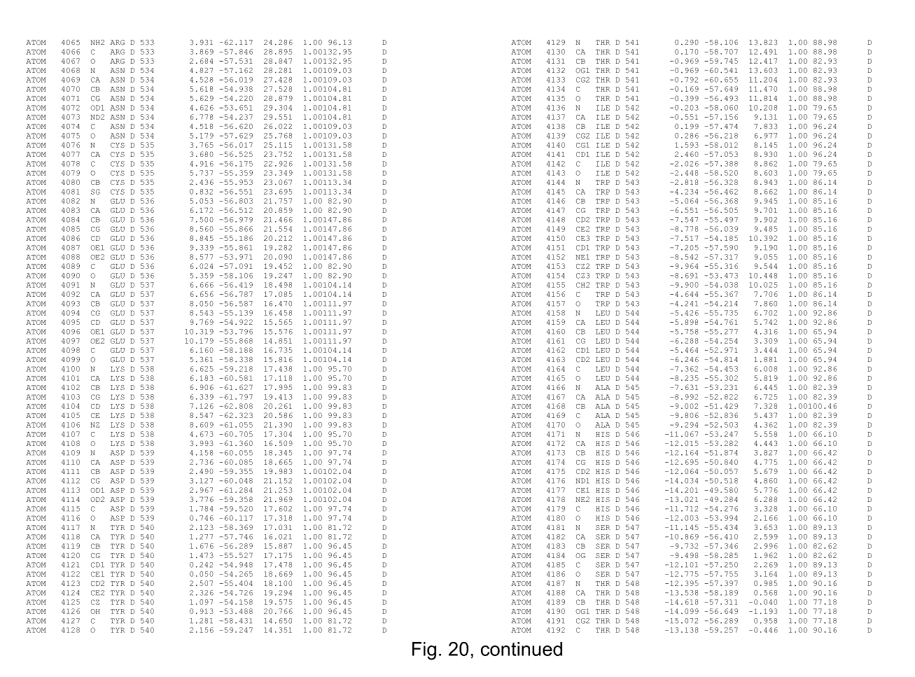

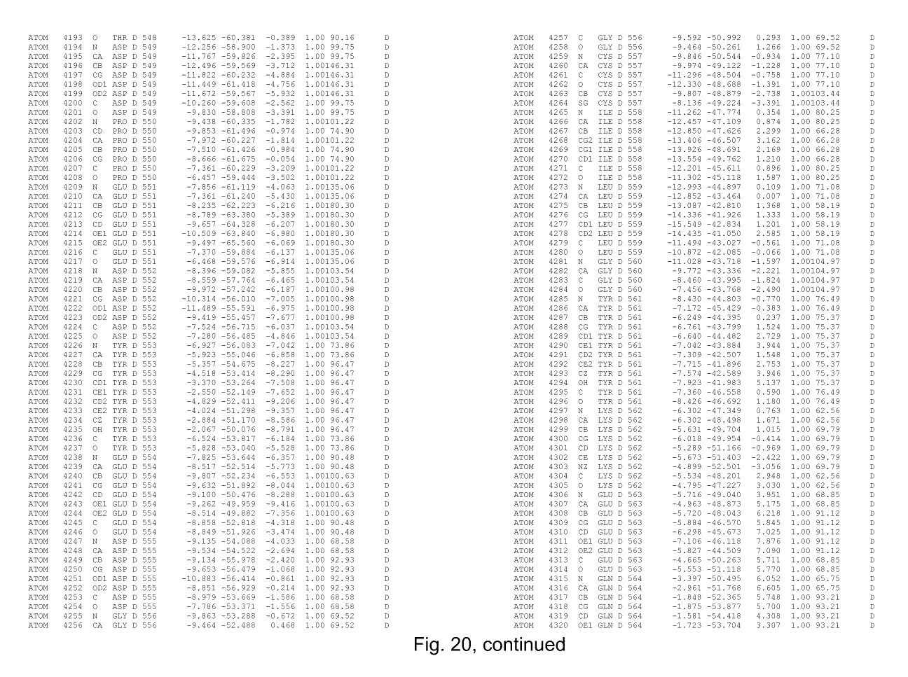

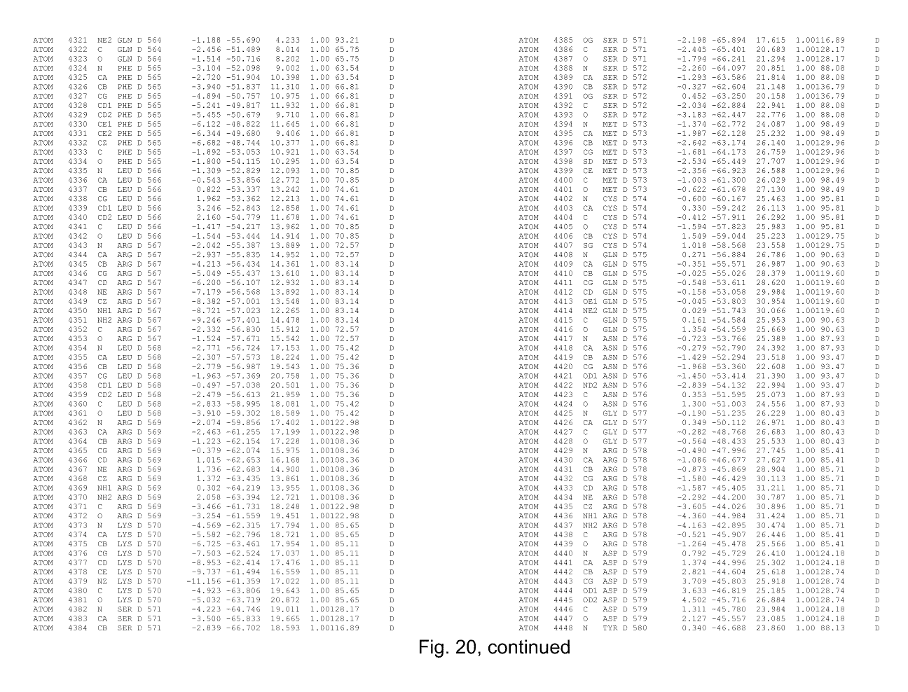

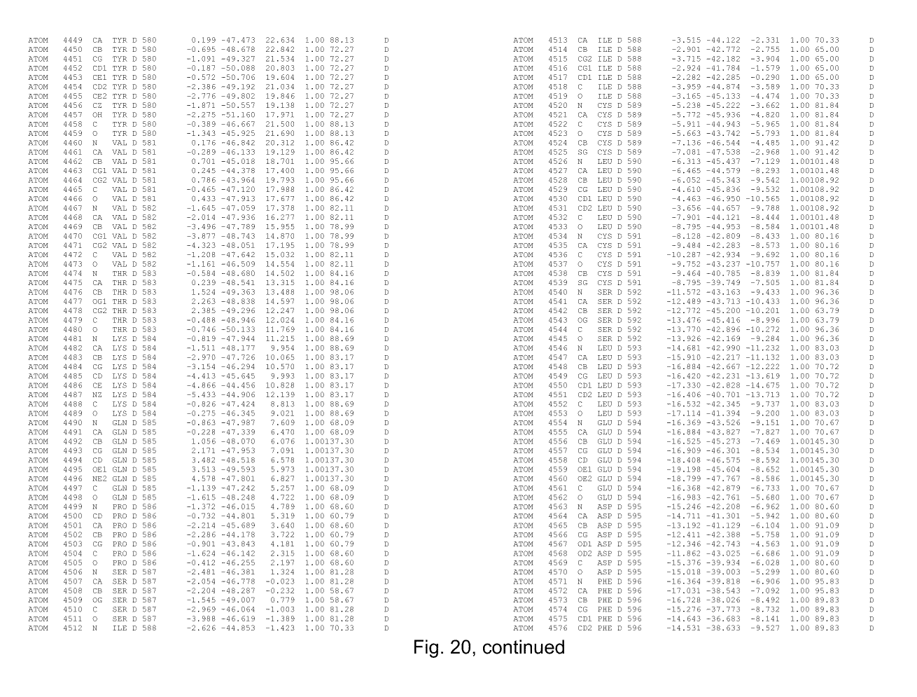

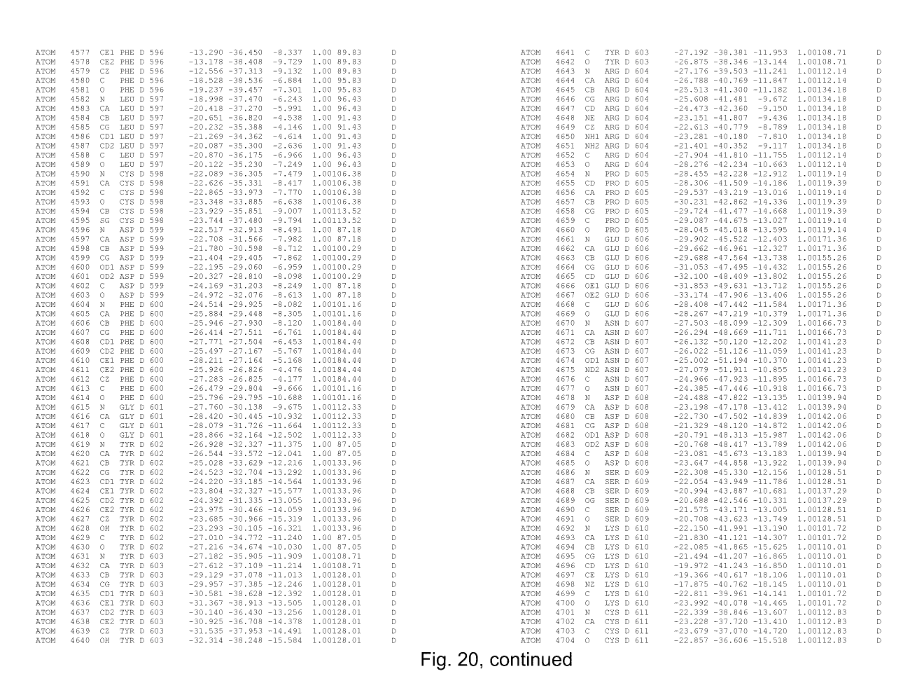

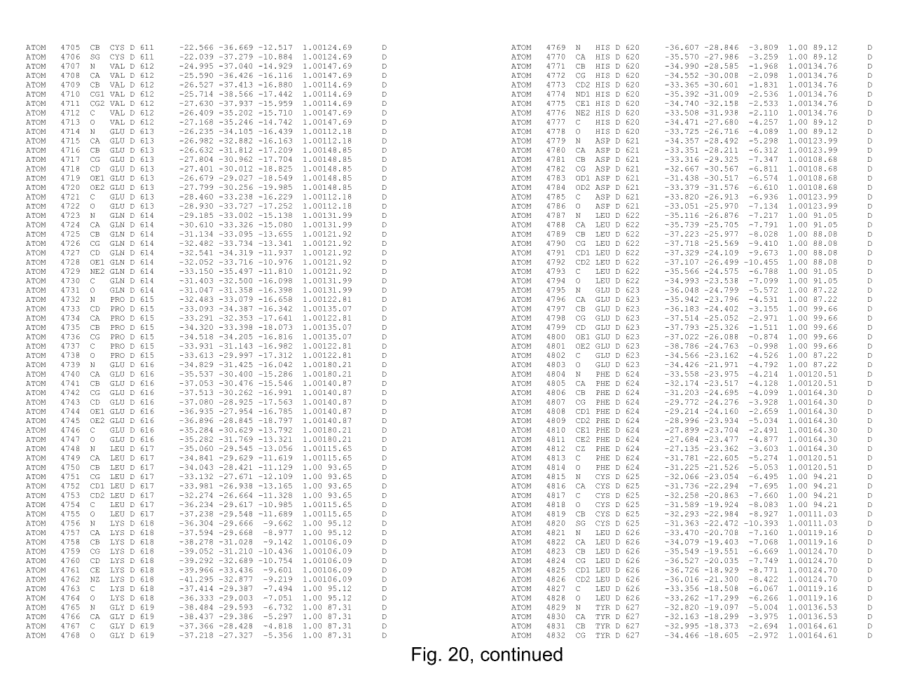

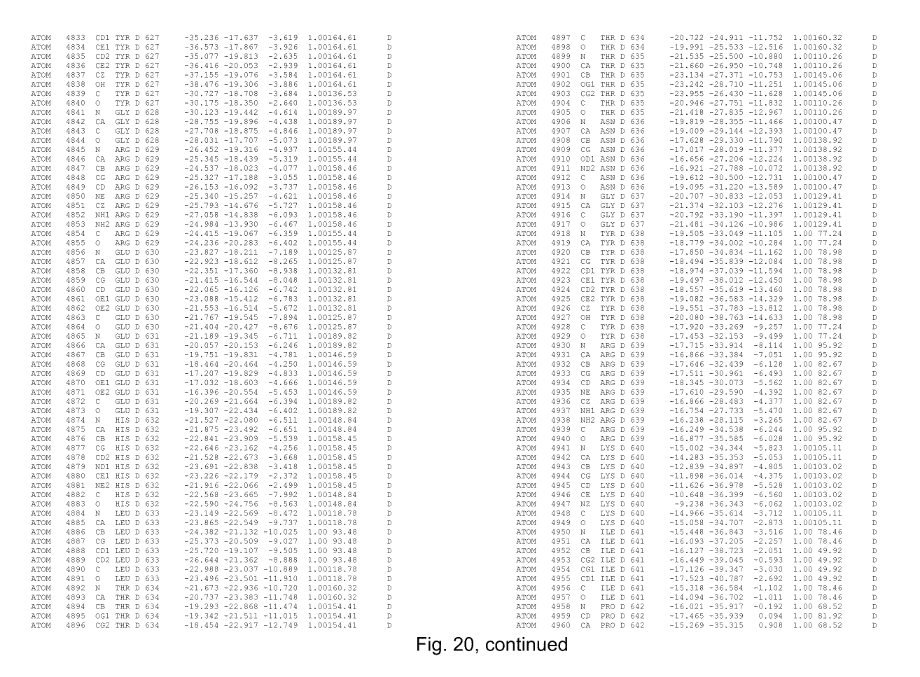

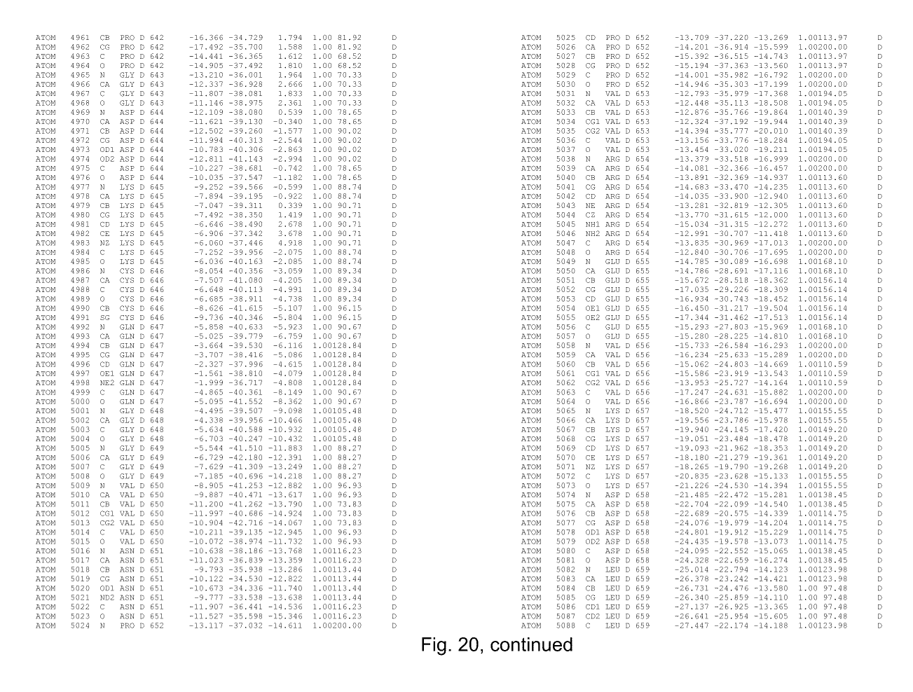

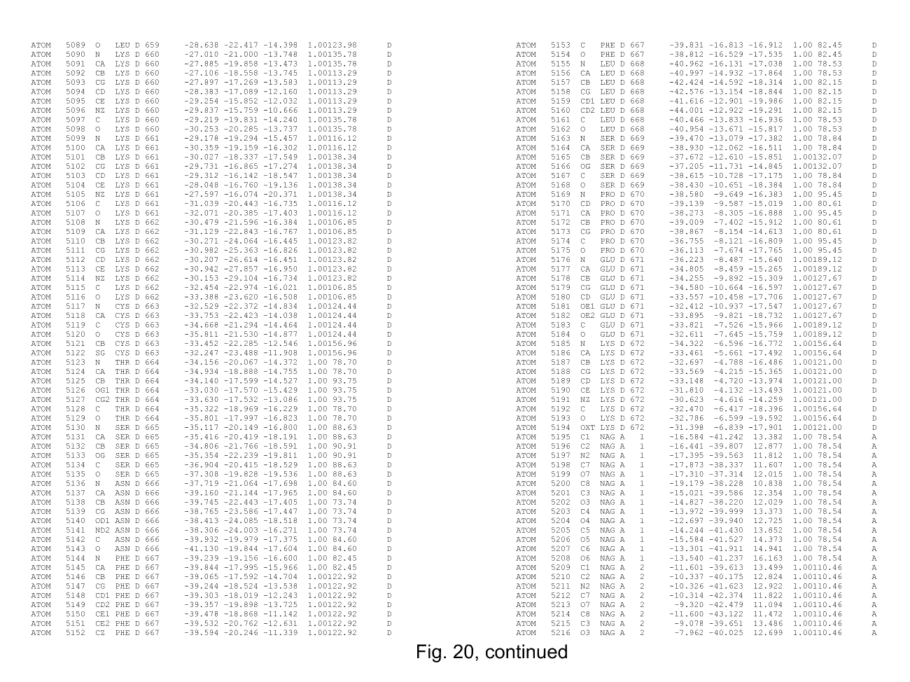

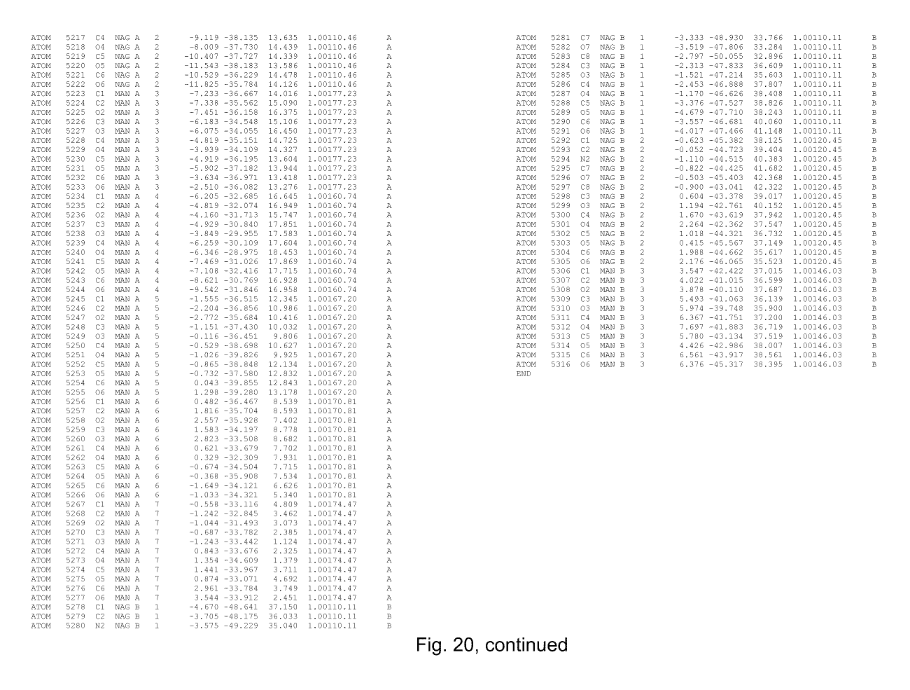

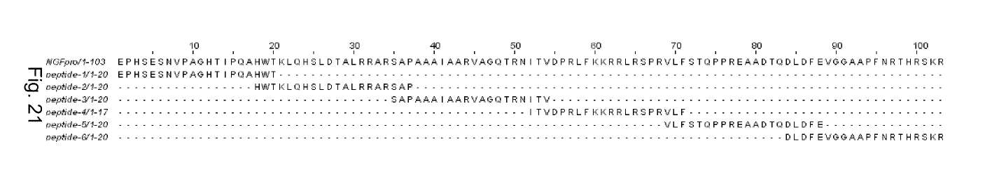

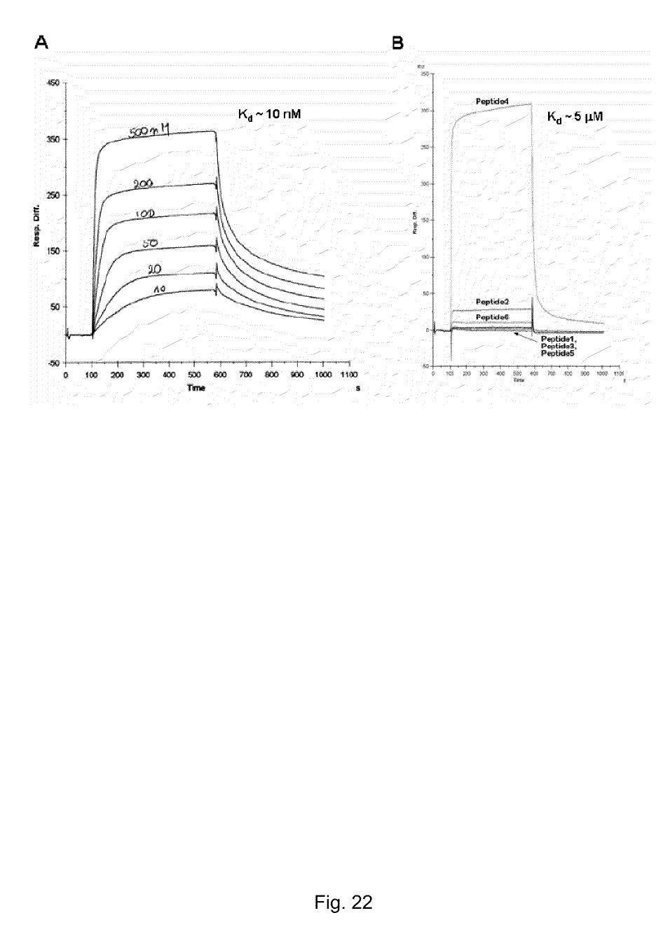

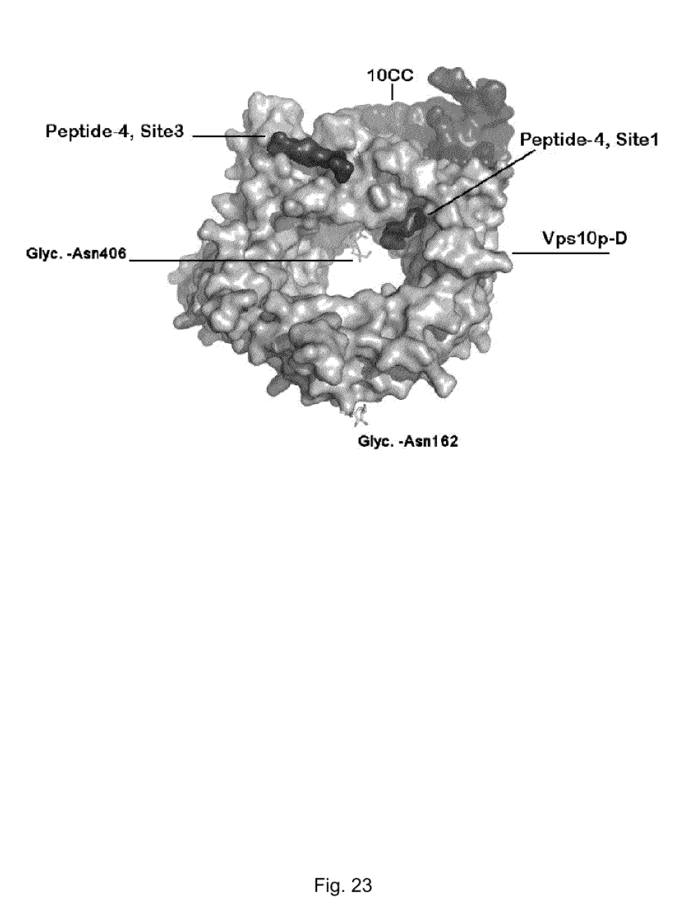

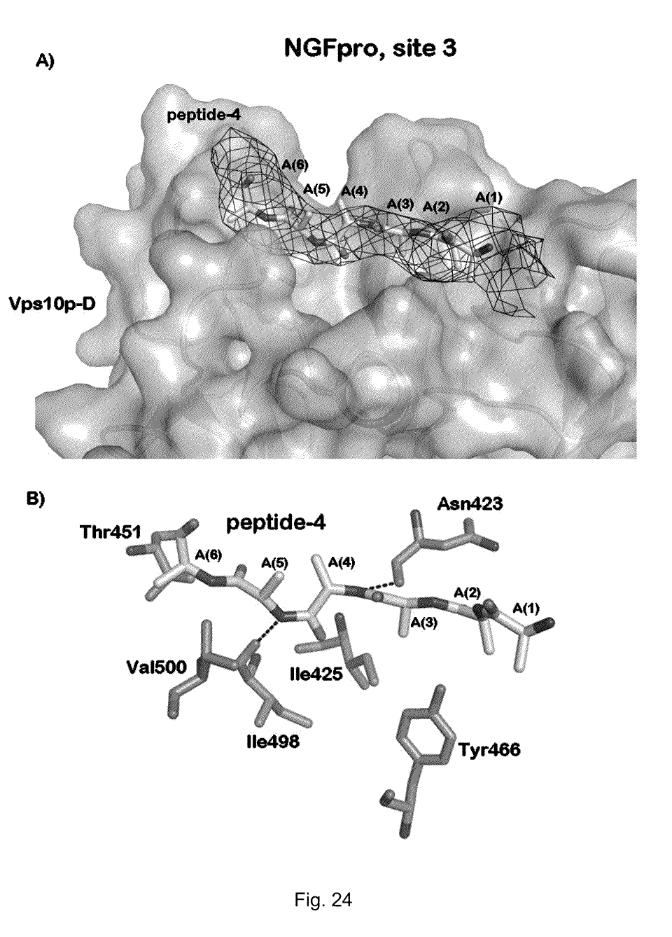

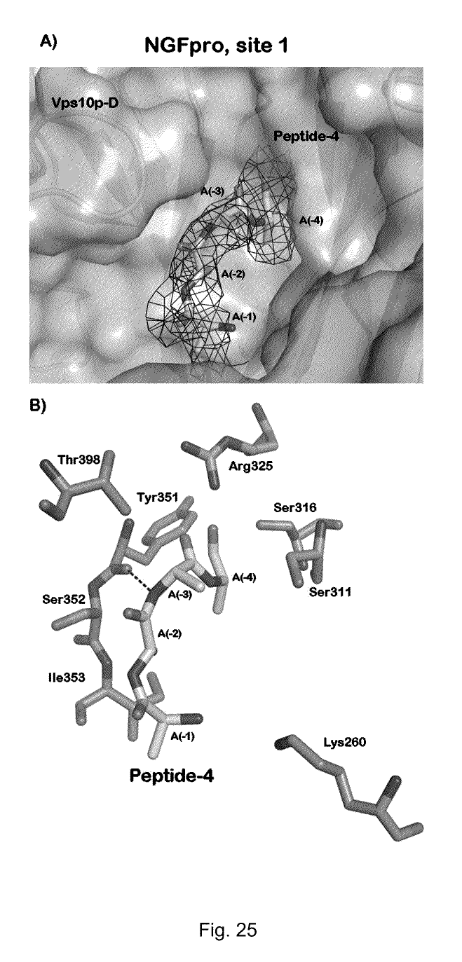

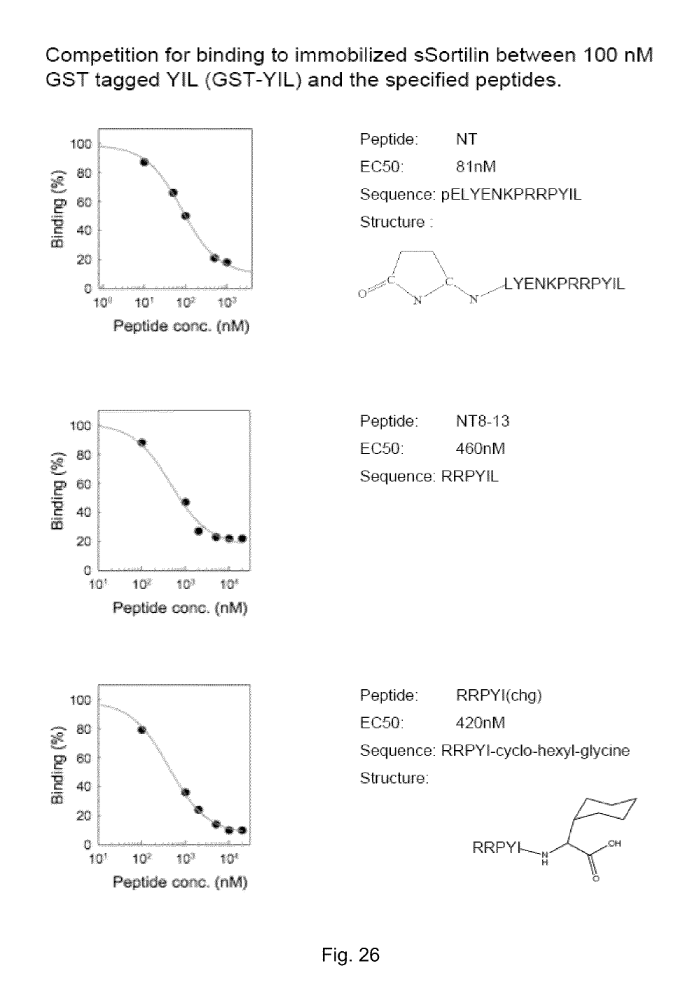

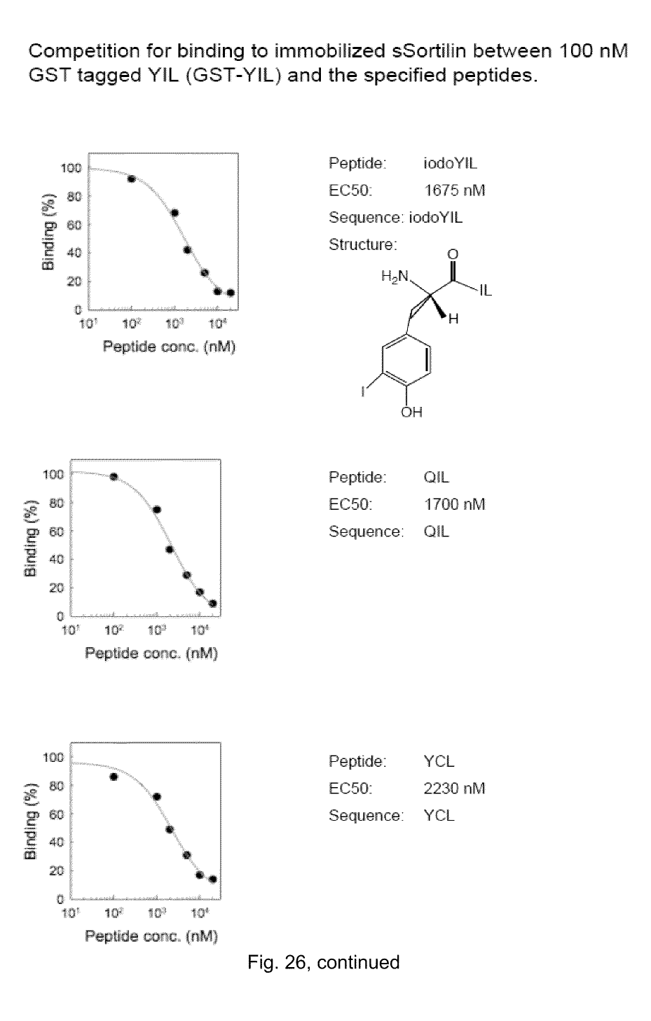

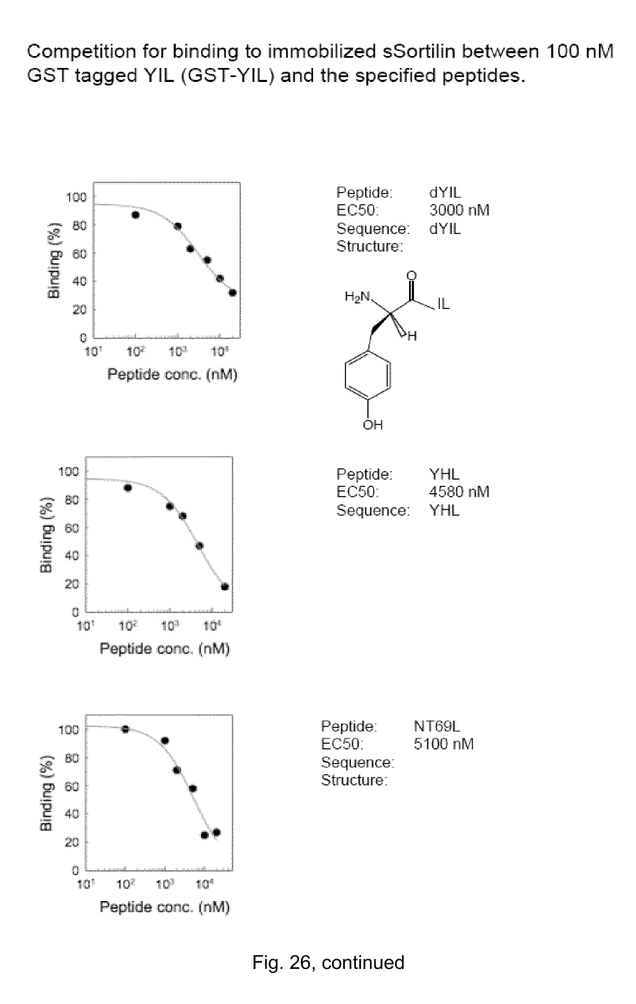

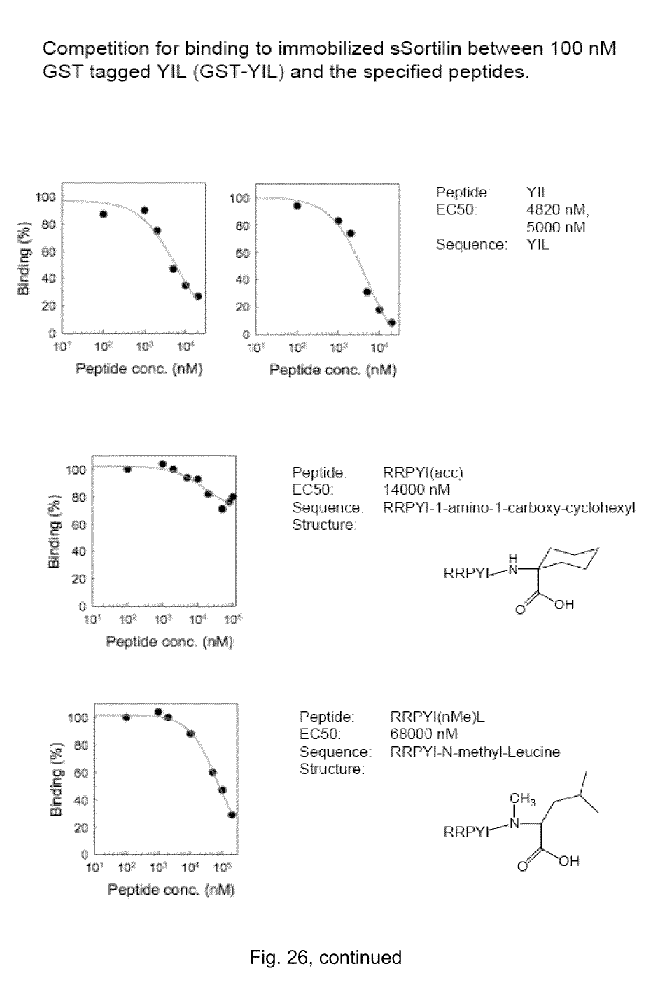

E) Propeptide binding across the tunnel. Cross section of the sSortilin:propeptide structure as in FIG. 1d. The 1σ surface of the final 3.2 Å 3Fc-2Fo electron density is shown as a net-representation.

FIG. 3: Effects of NT and derived peptides on sSortilin binding Surface plasmon resonance analysis of ligand binding to immobilized sSortilin in the absence (top filled curves) or presence of Neurotensin derived peptides (middle and lower curves). The numbering indicates which amino acids of NT (1-13) that are contained in the individual peptides. Binding in the presence of the C-terminal tripeptide 11-YIL-13 (NT 11-13) is indicated by A-B) Binding of the GSTtagged Sortilin propeptide (GST-Sort-pro); C) Binding of the GST-tagged propeptide of NGF; D) Binding of RAP.

FIG. 4: Secretion and Ligand Binding of sSortilin and sSortilin Mutant receptors

A) A pulse chase of ³⁵S-biolabelled sSortilin in CHO cells. Receptors, wt or mutant receptors with the indicated amino acid substitutions, were immunoprecipatated from cell lysates or medium at the indicated times.

B) Binding of proBDNF and the Sortilin-propeptide to wt sSortilin and to the purified S283E mutant. The receptors were immobilized at similar

concentrations (0.06 pM/mm²) and binding was analyzed by SPR. A silver stain of the purified mutant receptor is shown as an inset. C) Binding of the NGF-prodomain to wt sSortilin (upper panel) and to the S316E mutant (lower panel) in the absence or presence of a surplus of Neurotensin.

FIG. 5: Sequence alignment of Sortilin sequences. The numbering corresponds to sSortilin. To obtain the corresponding length pre-pro-Sortilin numbering (according to SEQ ID NO. 1) for a certain amino acid residue the number 77 should be added.

Sequences were identified by a BLAST search in the non-redundant protein database at NCBI: Bos_{—}taurus: ref|XP_{—}588956.3|;

Canis_{—}familiaris: ref|XP_{—}537041.2|;

Rattus_{—}norvegicus: ref|XP_{—}001076150.1|;

Mus_{—}musculus: ref|NP_{—}064356.2|;

Ornithorhynchus_{—}anatinus: ref|XP_{—}001505243.1;

Tetraodon_{—}nigroviridis: emb|CAG07500.1|;

Danio_{—}rerio: ref|NP_{—}998395.1|

and subsequently aligned to the sSortilin construct using ClustalW. Only the region corresponding to the sSortilin construct is shown with the C-terminal His-tag omitted. The alignment view was created using Jalview (34) and coloured shades of blue according to conservation at each position. Below the sequences bars indicate position of β strands and α helices as assigned by DSSP (34). Black bars labelled Blade 1 through 10 indicate the position of the individual blades of the propeller and the green and orange bar indicate the extent of the two domains of 10CC. The disulphide linkages are indicated above the sequences by thin lines either connecting the two cysteines or labelled with the residue number of the disulphide partner. The blue bars show the position of the two hydrophobic loops. Asterisks identifies glycosylated asparagine residues.

Capital N identifies residues involved in binding of the C-terminal part of Neurotensin whereas lowercase n identifies residues involved in binding of the N-terminal part of Neurotensin.

FIG. 6: Overview of expression and crystallization

FIG. 7: X-ray diffraction pattern to 2 Å resolution

FIG. 8: Refinement statistics and Ramachandran plot

FIG. 9: Statistics of β-propeller structures demonstrating that the 10-bladed Sortilin β-propeller is unique, new and unexpected.

FIG. 10: Overview of binding of PYIL ligand to Sortilin mutant structures S316E and R325A as compared to wild type (WT).

FIG. 11: Optimisation of Sortilin crystals comprising a fragment of the Sortilin propeptide.

FIG. 12: The figure represents the hydrogen bonding arrangement from the C-terminal of neurotensin, shown as Pro-Tyr-Ile-Leu, and sortilin as seen in the 2.0 Å structure of luminal sortilin complexed with neurotensin. Only the hydrogen bonds of the neurotensin leucine are invariable while that of isoleucine-353 and lysine-260 to the neurotensin tyrosine are variable.

To illustrate the hydrophobic interactions between sortilin and neurotensin, residues of sortilin with carbon atoms within 4.2 Å of neurotensin carbon atoms have been listed next to their interaction partners.

FIG. 13: Mapping of specific interactions of binding site 1 with artificial peptide NT69L (SEQ ID NO. 12) bound.

FIG. 14: Mapping of the interactions of binding site 1. X₁ represents the point of interaction between the C-terminal carboxylate group and R325, S316 and mainchain of Y351. X₂ represents the point of interaction by hydrogen bonds between mainchain amide of NT-Leu13 and mainchain carbonyl of Y351, i.e. NT-Leu13 is the hydrogen bond donor. X₃ represents the point of interaction by hydrogen bonds between mainchain carbonyl of NT-Tyr11 and mainchain amide of 1353, i.e. mainchain NT-Tyr11 is the hydrogen bond acceptor. X₄ represents the point of interaction by a hydrogen bond between the hydroxyl group of NT-Tyr11 and the amino group of K260.

In addition to the above mentioned hydrophilic bonds there are two hydrophobic interactions represented by R₁ and R₂ wherein R₁ is a genuine hydrophobic pocket for NT-Leu13 lined by residues I327, F314, Y351, I353 and M363, and wherein in R₂, which is not really a pocket, NT-Ile12 is close to F350, the flexible loop from T397 to E401 partly limits the binding site. Movement of the loop has been observed during docking studies.

In addition to the binding interactions occupied during binding of the C-terminal part of Neurotensin (PYIL), there are three additional specific interactions (arrows) represented by J1, J2 and J3 comprising interaction possibilities with S305 and mainchain carbonyl and amide of F306.

In order to create other compounds that can occupy the binding site it is important to satisfy the potential for electrostatic interactions in positions X₁, X₂ and X₃ and also filling the hydrophobic cavity at R₁, whereas position R₂ is of less importance.

The following properties are desired for a ligand to interact in the specified points of interaction:

At site X₁:—a negative charge and/or possibility to accept several hydrogen bonds such as but not limited to carboxylate-, sulfonic acid-, di-fluoro—lacking a negative charge to compensate the positive charge of the Arginine but is a good hydrogen bond acceptor, di-chloro (lacking a negative charge to compensate the positive charge of the Arginine but is a good hydrogen bond acceptor).

At site X₂:—a hydrogen bond donor such as but not limited to a hydroxyl group, amino group or amide.

At site X3: —a hydrogen bond acceptor such as but not limited to carbonyl, chloro, fluoro.

At site R₁:—a bulky hydrophobic group such as but not limited to cyclohexyl-alanine, leucine, Ile, Met, Phe.

At site R₂:—a hydrophobic residue as Ile, Leu, Cys, or partially hydrophobic group as His, Gln, Lys, Arg, Glu.

FIG. 15: Overview of the density at the two binding sites of Sortilin. The novel binding site for the pro-domain of Nerve Growth Factor is Site 3.

FIG. 16: Fo-Fc density at site 3 shown at 2.6σ. Residues involved in binding shown as sticks. The peptide of the prodomain of Nerve Growth factor is shown in yellow.

FIG. 17: Atomic coordinates of sSortilin in complex with a fragment of the NGF-prodomain. The numbering of the first built Sortilin amino acid residues of this pdb file is C9 which corresponds to C86 of SEQ ID NO: 1 which is numbered in accordance with the Expasy database entry Q99523 as of the filing date of the present application.

FIG. 18: Atomic coordinates at high resolution (2 Å) of sSortilin in complex with Neurotensin provided in a molar ration of 1:1.5 resulting in occupation of binding site 1. The numbering of the first built Sortilin amino acid residues of this pdb file is G10 which corresponds to G87 of SEQ ID NO: 1 which is numbered in accordance with the Expasy database entry Q99523 as of the filing date of the present application.

FIG. 19: Atomic coordinates of sSortilin in complex with Neurotensin provided in a molar ration of 1:15 resulting in occupation of both binding site 1 (high affinity site) and binding site 2 (low affinity site). The numbering of the first built Sortilin amino acid residues of this pdb file is G54 which corresponds to G54 of SEQ ID NO: 1 which is numbered in accordance with the Expasy database entry Q99523 as of the filing date of the present application.

FIG. 20: Atomic coordinates of sSortilin crystallised in complex with Sortilin's own propeptide. The propeptide is omitted in this model. The numbering of the first built Sortilin amino acid residues of this pdb file is D6 which corresponds to D83 of SEQ ID NO: 1 which is numbered in accordance with the Expasy database entry Q99523 as of the filing date of the present application.

FIG. 21: Overview of the six icosapeptides of the NGF propeptide synthesized to cover the whole propeptide.

FIG. 22: Surface plasmon resonance analysis of the binding affinity of NGFpro peptide and icosapeptides for immobilized sSortilin.

FIG. 23: Overview of the sSortilin-peptide4 complex displayed as surface representation. The surface of Vsp10p-D is light gray, 10CC domain is gray, peptide4 from NGFpro is black and the glycosylations is displayed using ‘ball and stick’ representation coloured by atom type.

FIG. 24: Binding of the NGF prodomain (Site 3). A) The peptide-4 from NGFpro are shown as ‘ball-and-stick’ model coloured by atom type. A Fo-Fc electron density map, calculated without the peptides and contoured at 2.66 are superimposed upon the peptide. sSortilin is displayed using surface representation. B) The bound peptide4 is modelled as a hexa-alanine fragment and displayed as a ‘ball and stick’ model together with interacting residues of sSortilin.

FIG. 25: Binding of the NGF prodomain (Site 1/NTS-site). A) The peptide-4 from NGFpro is displayed as ‘ball-and-stick’ model coloured by atom type. The electron density map displayed has been calculated as indicated in FIG. 24 and superimposed upon the peptide. sSortilin is displayed using surface representation. B) The bound peptide4 is modelled as tetra-alanine fragment and displayed with interacting residues of sSortilin.

FIG. 26: Competition of peptides with GST C-terminally tagged with Tyr-Ile-Leu (YIL). Binding to immobilized sSortilin was measured by surface plasmon resonance. 100% corresponds to the measured response units obtained for 100 nM GST-YIL in the absence of competing peptide. The EC50 values is the concentration of peptide at which the GST-YIL binding is reduced to 50%. Sequences are given for the peptides and for peptides that contain non-natural amino acids the structure is also shown.

### OVERVIEW OF SEQUENCES

### SEQ ID NO 1: Sortilin

### SEQ ID NO 2: SorLA

### SEQ ID NO 3: SorCS1

### SEQ ID NO 4: SorCS2

### SEQ ID NO 5: SorCS3

SEQ ID NO 6: pre-pro-NGF
SEQ ID NO 7: pre-pro-BDNF

### SEQ ID NO 8: Neurotrophin-3

### SEQ ID NO 9: Neurotrophin-4/5

### SEQ ID NO 10: Neurotensin (1-13)

### SEQ ID NO 11: PYIL (C-term.of Neurotensin)

### SEQ ID NO 12: NT69L

### EXAMPLES

### Example 1

### Expression and Purification of Sortilin

Soluble Sortilin (sSortilin), comprising the entire luminal domain (amino acids 1 to 758) but not the transmembrane segment or the cytoplasmic tail of Sortilin, fused C-terminally to His6 was stably expressed in CHO-K1 cells as previously described (5). The CHO-transfectants were cultured in serum-free HyQ-CCM5 CHO medium (HyClone, Logan, Utah) in 500 cm³ Nunclon™ TripleFlasks. Incorporation of seleno-methionine (SeMet) followed a procedure previously described with only minor modifications (22). Both native and SeMet substituted protein were purified by RAP affinity chromatography as previously described (1). The S316E and R325A Sortilin mutants, were stably expressed in CHO-cells and subsequently purified from the medium by His₆-tag affinity chromatography in the same way as previously described for Sortilin mutated in the furin propeptide cleavage site (5). Neurotensin was purchased from Sigma and the Sortilin propeptide fragment of residues 37-61 as well as the various Neurotensin fragments were purchased from BIOMOL International L.P. (UK). All peptides were more than 95% pure. Expression and purification has previously been described for the Sortilin propeptide fused to GST (5) and the NGF prodomain (6). Mature BDNF (SEQ ID NO. 7, amino acid residues 128) to 246 was purchased from R&D Systems, Inc. (USA)

### Example 2

### Surface Plasmon Resonance

Surface plasmon resonance (SPR) measurements were performed on a BIAcore 2000 instrument (Biacore Sweden) equipped with CM5 sensor chips maintained at 20° C. A continuous flow of HBS buffer (10 mM HEPES pH 7.4, 3.4 mM EDTA, 150 mM NaCl, 0.005% surfactant P20) passing over the sensor surface was maintained at 5 μl/min. The carboxylated dextran matrix of the sensor chip flow cells 1-3 was activated by the injection of a solution containing 0.2 M N-ethyl-N-(3 dimethylaminopropyl)carbodiimide and 0.05MN-hydroxysuccimide in water. A sortilin solution (320 μl, 5 μg/ml in 10 mM sodium acetate pH 4.0) was then injected over flow cells 1 and 2 at a flow rate of 15 μl/min. Remaining binding sites in all three flow cells were blocked by injection (5 μl/min) of 70 μl of 1 M ethanolamine pH 8.5. The surface plasmon resonance signal from immobilized sortilin generated 4419 and 6166 BIAcore response units (RU) equivalent to 49 and 69 fmol/mm2. Screening of the samples was performed by injecting aliquots of 50 μl, at concentrations of 0.1-8 μM, through all flow cells with a flow rate of 5 μl/min. Unless otherwise stated, the samples were dissolved in 10 mM HEPES pH 7.4, 150 mM NaCl, 1.5 mM CaCl2, 1 mM EGTA, 0.005% surfactant P20. Sample buffer was also used as running buffer. The BIAcore response is expressed in relative response units (RU), i.e. the difference in response between the immobilized protein flow cell and the corresponding control flow cell (activated and blocked but without protein). Regeneration of the sensor chip after each cycle of analysis was performed by injecting 20 μl of 10 mM glycine/HCl pH 4.0, 500 mM NaCl, 20 mM EDTA and 0.005% surfactant P20. For calciumfree conditions, HBS containing 20 mM EDTA was used as sample as well as running buffer. Kinetic parameters were determined by using the BIAevaluation 3.0 software. For comparison of the response measured for mutant and wt sSortilin they were immobilized in different flow-cells on the same BIAcore chip and subjected to similar concentrations of (GST)Sort-pro, BDNF, NGF-pro and NT.

### Determination of Binding Effect

Inhibition of (GST)Sort-pro, BDNF-pro, NGF-pro and NT binding by the tripeptide Tyr-Ile-Leu (YIL) was measured as a tool of evaluating affinity of the identified molecular imaging ligands, by adding increasing concentrations of YIL to the respective samples.

### Example 3

### Fluorescence Measurements

All intrinsic fluorescence measurements were conducted on a SFM-25, Kontron Instruments, at 20° C. with measurements from 280 nm to 500 nm in 1 nm increments. Data was collected on 0.55 μM sSortilin, 5 μM NT, and 0.55 μM sSortilin with 5 μM NT, all in a 50 mM Tris-HCl pH 7.6, 150 mM NaCl buffer. sSortilin with NT was prepared by addition of NT from a 0.1M stock solution to a 0.55 μM sSortilin solution, resulting in negligible dilution.

### Example 4

### Metabolic Labelling

Metabolic labelling was performed using 200 mCi of L-[³⁵S]cysteine and L-[³⁵S]methionine per ml of medium and in the presence of 10 mg/ml BFA as previously described in detail (5). Chase was performed in the absence of BFA and at given time points receptors were immunoprecipitated from the medium and from corresponding lysed cells. The precipitated proteins were analyzed by reducing PAGE and diphenyloxazole-fluorographed gels were exposed at −70° C.

### Example 5

### Crystallization, Cryoprotection and HA Derivatization

The purified protein was dialyzed into a buffer containing 50 mM Tris-HCl pH 7.9 and 150 mM NaCl and concentrated to 4.5-5.5 mg/mL, as determined by a Bradford assay, using Centricon (Millipore Corp.) or Vivaspin (Sartorius Ltd.) concentrators. Mixing with Neurotensin (sSortilin:NT ratio 1:1.5 or 1:15) or propeptide (sSortilin:propeptide ratio 1:4) was done minutes before the crystallization experiment was set up. Crystallisation drops were set up at 20° C. using 2 μL protein solution and 2 μL of reservoir solution containing: 18-21% w/v PEG 6000, Tris-Hepes pH 7.2-7.8 (40-93 mM Tris and 100 mM Hepes) or 100 mM Tris-HCl pH 7.9, 3-6% glycerol and either 600 mM NaCl or 250-400 mM C₃H₂Na₂O₄ (sodium malonate) that was adjusted to pH 6-7.5 by malonic acid. Seleno-methionine (Se-Met) labelled sSortilin:NT crystals diffracting to 3.2 Å were obtained at the same conditions. Crystals for data collection were dehydrated and cryoprotected by increasing the glycerol concentration of the reservoir to 12-15%. After over-night equilibration the crystals were flash frozen in liquid nitrogen. The crystals normally diffracted to about 3.3-3.0 Å, but for the crystals grown with slight excess of NT and with NaCl as the reservoir salt, we rarely obtained crystals, that diffracted considerably better (about 2.5-2.0 Å) and exhibited a change in unit cell parameters (Table 1). For preparation of Hg and Pt derivatives, powder of mercury salicylate and cis-Pt(NH₃)₂Cl₂ was added directly to drops where crystals had formed. Soaking time for the Hg derivative was a month and for the Pt derivative a day. The Ta derivative was prepared by adding 1 μL of 1 mM Ta6Br12 dissolved in water to the drop of a dehydrating crystal for a soak time of 2 days, after which it had turned visibly green. None of the derivatized crystals were backsoaked.

### Example 6

### Data Collection and Processing

Data collection was performed at the synchrotrons MAX-lab (Lund, Sweden), SLS (Zurich, Switzerland) and DESY/EMBL (Hamburg, Germany), and processed using XDS (23) (see Table 1). Data on the Hg, Pt and Ta derivatives was collected near absorption edges of the respective elements and the dataset for the SeMet labeled crystal was collected directly at the Se peak wavelength (0.97853 Å), as determined by a fluorescence scan. The dataset for the sSortilin in complex with Neurotensin (sSort:NT) crystal was determined with a large excess of NT was corrected for anisotropy effects using the Diffraction Anisotropy Server (24).

TABLE 1
Data collection and processing statistics

| | | Se-sSort-NT | | sSort-NT | | sSort-NT | | sSort-NT | | | |
|---|---|---|---|---|---|---|---|---|---|---|---|
| | | (slight excess, | | (slight excess, | | (slight excess, | | (slight excess, | | | |
| | | 1:1.5) | | 1:1.5) | | 1:1.5) | | 1:1.5) | | sSort-NT69L | |
| HA soak | | | | Cis-Pt(NH₃)₂Cl₂ | | Mercury | | Ta₆Br₁₂ | | Native | |
| | | | | | | Salicylate | | | | | |
| Beamline | | I911-3, | | I911-5, | | X12, DESY | | PX1, SLS | | PX1, SLS | |
| | | MAXlab | | MAXlab | | | | | | | |
| Data statistics | | | | | | | | | | | |
| Wavelength (Å) | | 0.97853 | | 0.90718 | | 0.9050 | | 1.2548 | | 1.2970 | |
| Resolution | | 3.8 | (4.1-3.8) | 4.0 | (4.3-4.0) | 6.0 | (6.6-6.0) | 5.0 | (5.3-5.0) | 2.8 | (2.9-2.8) |
| limit (Å) | | | | | | | | | | | |
| Space group | | C2 | | C2 | | C2 | | C2 | | C2 | |
| Unit-cell | a | 162.3 | Å | 162.7 | Å | 162.6 | Å | 162.5 | Å | 161.3 | Å |
| | b | 79.8 | Å | 78.5 | Å | 75.9 | Å | 76.8 | Å | 78.4 | Å |
| | c | 112.1 | Å | 111.2 | Å | 110.7 | Å | 111.1 | Å | 112.0 | Å |

| | | | | | |
|---|---|---|---|---|---|
| β | 126.67° | 126.75° | 127.75° | 127.07° | 126.92° |

| Unique reflections | 21311 | | 18332 | | 5103 | | 9159 | | 27362 | |
|---|---|---|---|---|---|---|---|---|---|---|
| Rsym(I) | 5.2 | (11.7) | 6.8 | (15.8) | 2.6 | (5.7) | 2.4 | (3.1) | 4.5 | (31.1) |
| Completeness | 95.2 | (96.6) | 97.7 | (98.2) | 96.7 | (97.3) | 98 | (99.2) | 96.3 | (93.5) |
| I/sigma | 17.4 | (10.5) | 16.5 | (8.0) | 40.3 | (22.8) | 28.5 | (23.7) | 25.5 | (6.1) |

| | | | | | |
|---|---|---|---|---|---|
| Phasing statistics | | | | | |
| High resolution | 3.8 | 4.0 | 6.0 | 5.0 | 3.8 |
| cutoff for phasing | | | | | |
| (Å) | | | | | |
| Sites | 13 Se | 4 Pt | 2 Hg | 1 Ta-cluster | |
| Phasing Power | | | | | |
| Iso_acen | 0.262 | 0.614 | 0.415 | 0.325 | |
| Iso_cen | 0.276 | 0.674 | 0.390 | 0.315 | |
| Ano_acen | 1.705 | 0.621 | 0.981 | 0.363 | |
| Rcullis | | | | | |
| Iso_acen | 0.993 | 0.908 | 0.980 | 0.964 | |
| Iso_cen | 0.946 | 0.825 | 0.873 | 0.898 | |
| Ano_acen | 0.645 | 0.640 | 0.571 | 0.638 | |
| Fom Acentric | | | | | 0.45 |
| Centric | | | | | 0.18 |

### Example 7

### Phasing and Model Building

The inventors found 13 Se sites out of the 14 methionines present in sSortilin using ShelxD (25). SeMet SAD phases calculated using CNS (26) were used for identifying heavy atom sites in Pt, Hg, and Ta derivatives. We used all four derivatives together with an isomorphous 2.8 Å native dataset of sSortilin complexed to a Neurotensin analogue as input for MIRAS phasing in SHARP (27). A partial Cα trace was made with RESOLVE (28), which were extended and corrected by manual rebuilding in O (29). This partial model was then used for molecular replacement by use of MOLREP (30) into the 2.0 Å native dataset collected on sSortilin:NT crystals grown with a slight excess of NT. The complete model was created by cycles of refinement in CNS and manual rebuilding in O. Phasing of data collected on sSort:NT crystals grown with a large excess of NT and on data collected on sSort:propeptide fragment was performed by molecular replacement using an unfinished model for the 2.0 Å structure (NT not included), as input for MOLREP. The models were then completed by subsequent cycles of model building in 0 and refinement using CNS. For the final refinement, the inventors employed REFMAC (31) using TLS B-factor correction for the 2.0 Å sSort:NT structure, PHENIX (32) refine with TLS B-factor correction for the 2.6 Å sSort:NT structure and CNS for the 3.2 Å sSort:propeptide structure (Table 2).

TABLE 2
Data collection, processing, model building and refinement statistics

| | | sSort-NT | | sSort-NT | | sSort-propeptide | |
|---|---|---|---|---|---|---|---|
| | | (slight excess, 1:1.5) | | (large excess, 1:15) | | (fragment 4-28, 1:4) | |
| Beamline | | PX1, SLS | | I911-5, MAX-lab | | I911-5, MAX-lab | |
| Data statistics | | | | | | | |
| Wavelength (Å) | | 0.95008 | | 0.90736 | | 0.90736 | |
| Resolution limit (Å) | | 2.0 | (2.1-2.0) | 2.64 | (2.74-2.64) | 3.15 | (3.3-3.15) |
| Space group | | C2 | | C2 | | C2 | |
| Unit-cell | a | 145.8 | Å | 162.1 | Å | 162.1 | Å |
| | b | 74.5 | Å | 78.7 | Å | 78.1 | Å |
| | c | 108.3 | Å | 111.1 | Å | 111.7 | Å |

| | | | |
|---|---|---|---|
| β | 131.87° | 126.61° | 127.20° |

| Rsym(I) | 7.3 | (44.0) | 4.9 | (59.9) | 7.4 | (50.4) |
|---|---|---|---|---|---|---|
| Completeness | 96.9 | (98.8) | 98.0 | (98.0) | 99.0 | (99.5) |
| I/sigma | 11.59 | (4.32) | 19.9 | (2.9) | 14.53 | (2.59) |
| Refinement statistics | | | | | | |
| Reflections (work/test) | 53737/2862 | | 30813/953 | | 18418/938 | |
| R-factor | 0.204 | | 0.169 | | 0.230 | |
| Rfree | 0.229 | | 0.225 | | 0.295 | |
| Number of atoms in model | | | | | | |
| sSortilin and NT | 5.213 | | 5293 | | 5.194 | |
| Carbohydrate | 67 | | 94 | | 122 | |
| Water | 307 | | 213 | | 0 | |
| PEG and glycerol | 16 | | 13 | | 0 | |
| Mean B-factor (Å²) | | | | | | |
| sSortilin | 30.4 | | 70.5 | | 99.7 | |
| NT in binding site 1 | 57.1 | | 68.3 | | . . . | |
| NT in binding site 2 | . . . | | 103.2 | | . . . | |
| NT in artefact binding site | . . . | | 126.7 | | . . . | |
| Glycosylations | 49.2 | | 98.0 | | 138.0 | |
| Solvent (water, PEG, glycerol) | 46.9 | | 60.7 | | . . . | |
| Geometry | | | | | | |
| Rmsd Bond-lengths | 0.021 | Å | 0.008 | Å | 0.0076 | Å |

| | | | |
|---|---|---|---|
| Rmsd Bond angles | 1.832° | 1.204° | 1.389° |
| Phi-Psi distribution | | | |
| Most favoured | 87.0% | 81.9% | 70.7% |
| Additionally allowed | 12.0% | 16.5% | 27.0% |
| Generously allowed | 0.9% | 1.2% | 2.1% |
| Dissallowed | 0.2% | 0.3% | 0.2% |

### Example 8

### Identification of the Pro-Neurotrophin Binding Site (Binding Site 3)

sSortilin Purification

Soluble Sortilin (sSortilin), comprising SEQ ID NO. 1 (amino acids 78 to 755), fused C-terminally to His₆ was stably expressed in CHO-K1 cells as previously described (5). The CHO-transfectants were cultured in serum-free HyQ-CCM5 CHO medium (HyClone, Logan, Utah) in 500 cm³ Nunclon™ TripleFlasks. sSortilin was purified by affinity chromatography with Receptor Associated Protein immobilized on CNBr-activated Sepharose beads (GE health care) as previously described (1).

### NGFpro Purification

BL21 (DE3) star RIPL cells were transformed with a pET-30 Ek/LIC vector containing a N-terminal Histidine tag (His₆), a tobacco etch virus protease protease (TEV) site and the open reading frame of the propeptide of Nerve Growth Factor (NGFpro). Cells were grown to an OD₆₀₀ₙₘ of 0.8 before induction with 1 mM IPTG over night (0/N) at 20° C. Cells were resuspended in lysis buffer: 50 mM TrisHCl pH=8.0, 1M KCl, 10 mM imidazole, 5 mM BME, 5 mM PMSF, 2 mg/ml DNase 1 and 1 protease inhibitor tablet (Complete, Roche)). Cells were disrupted on a high pressure homogenizer (HPH) and the lysate was clarified by centrifugation at 184.000 xg. A Ni²⁺-column (HisTrap 1 ml FF, GE) was equilibrated with buffer A (50 mM TrisHCl pH=8.0, 200 mM KCl and 5 mM BME). The clarified lysate was loaded and NGFpro eluted with a 40 column volume (CV) imidazole (10 mM to 500 mM) gradient with buffer B (50 mM TrisHCl pH=8.0, 200 mM KCl, 500 mM imidazole and 5 mM BME). Fractions containing NGFpro from first Ni²⁺ column was pooled and buffer was exchanged to the TEV compatible buffer C (50 mM TrisHCl pH=8.0, 200 mM KCl, 5 mM BME, 0.5 mM EDTA). TEV digest was conducted at RT O/N. The His₆ tag was removed on a Ni²⁺ column (HisTrap 1 ml FF, GE) with a 40 column volume (CV) imidazole (0 mM to 250 mM) gradient. NGFpro from second Ni²⁺ column was concentrated using the Vivaspin 6 column with a 10 kDa cutoff membrane. Preparative gelfiltration was conducted at a Superdex 75 10/300 GL column (GE) with a flow rate of 0.4 ml/min in buffer D (50 mM TrisHCl pH=7.6 and 150 mM NaCl).

### Preparation of Peptides of NGF Propeptide

As demonstrated in FIG. 21, icosapeptides (20 aa) of the propeptide of Nerve Growth Factor were synthesized by solid phase chemistry at Caslo Laboratory Aps (www.caslo.com). The peptides were amidated at the C-terminal and covered the whole NGFpro with a 3 aa overlap. The peptides (purity>95%) were dissolved in buffer E (10 mM HEPES pH=7.0 and 50 mM NaCl).

### Surface Plasmon Resonance Analysis

All measurements were performed on a BIAcore 3000 instrument (Biacore Sweden) maintained at 20° C. A continuous flow of buffer F (10 mM HEPES pH=7.4, 150 mM (NH₄)₂SO₄, 1.5 mM CaCl₂, 1.5 mM EGTA and 0.005% Tween-20) was passed over the CM5 chip sensor surface at 5 μl/min. The affinity of NGFpro and the peptides for immobilized sSortilin were determined. The dissociation constant (Kₐ) for NGFpro was ˜10 nM and for peptide-4 ˜5 μM. The ability of the peptides to compete with NGFpro for binding to sSortilin was tested as well. The results are presented in figure 22.

Crystallizallization of sSortilin with Ligands

Purified sSortilin was dialyzed into buffer G (50 mM Tris-HCl pH 8.0 and 150 mM NaCl) and concentrated in Vivaspin (Sartorius Ltd.) concentrators to 4.5-5.5 mg/mL, as determined by a Bradford assay. sSortilin and NGFpro was mixed in molar ratio of 1:2 and incubated on ice for 1 hour. The complex was crystallized in vapour diffusion experiments using sitting drops. Crystallisation drops were set up at 20° C. using 1 μL complex solution and 1 μL of reservoir solution containing 20-28% Poly Ethylene Glycol (PEG) 5000 monomethyl ether, 100 mM TrisHCl pH=7.5 and 200 mM Li₂SO₄. sSortilin and peptide-4 was mixed in various molar ratios ranging from 1:5 to 1:28 and incubated on ice for 1 h. The complexes were crystallized in vapour diffusion experiments using sitting drops.

Crystallisation drops were set up at 20° C. using 1 μL complex solution and 1 μL of reservoir solution containing 20-28% PEG 6000, 100 mM TrisHCl pH=7.5 and 200-600 mM Li₂SO₄.

Dehydration of the crystals by adding sucrose or glycerol to the reservoir (up to 20% v/v) was carried out before they were flash-frozen in liquid nitrogen.

### Data Collection and Processing

X-ray diffraction data of the sSortilin:NGFpro complex was collected at station 1D29 at ESRF Grenoble (France) and diffraction data of the sSortilin:Peptide-4 complex crystals were collected at cryo conditions using synchrotron radiation on station I911-3 at Max-lab Lund (Sweden). The data was indexed and processed with XDS (23). Crystals of sSortilin in complex with NGFpro or Peptide-4 were isomorphous belonging to the tetragonal space group P4₁2₁2 with one sSortilin molecule in the asymmetric unit (Table 3). The structures were determined by molecular replacement using Phaser (36). The structure of sSortilin and neurotensin stripped of all its ligands was used as initial model for phasing. The resulting model was subjected to simulated annealing to reduce model bias and refinement in Phenix (32). Difference fourier maps F_{obs}-F_{calc} were used to locate the bound part of the NGFpro as well as conformational changes of loops and glycosylations of sSortilin.

TABLE 3
Data collection and processing

| sSortilin:NGFpro | sSortilin:peptide-4 |
|---|---|
| (1:2) | (1:17) |

| Beamline | ID29, ESRF | | Max-lab, I911-2 | |
|---|---|---|---|---|
| Data statistics | | | | |
| Wavelength (Å) | 1.07253 | | 1.0737 | |
| Resolution (Å) | 30.0-4.1 | (4.3-4.1) | 25.0-3.2 | (3.4-3.2) |
| Space group | P4₁2₁2 | | P4₁2₁2 | |
| Unit-cell (Å) | 159.97 | | 159.37 | |
| a, b | | | | |
| c | 106.55 | | 108.72 | |
| R_{merge} (I) | 17.9 | (73.8) | 9.4 | (69.9) |
| Completeness | 99.5 | (99.6) | 99.4 | (99.9) |
| I/sigma | 9.4 | (2.2) | 17.35 | (2.29) |

### Example 9

### Docking and in Silico Screening

Two grids were calculated using Maestro version 8.0 with Exhaustive Sampling of Optimize H-bonds, one grid with Minimize structure within 0.3 Å and one without Minimize of each available, refined structure of Sortilin-ligand complex. The hydrogen of the —OH of Ser352 and the hydrogen of the NH of Ile353 were specified as possible constraints.

The bounding box was defined as the centroid of residues 325, 260, and 352 with standard value dimensions.

Ligands were built in Maestro as tripeptides with one residue substituted from Tyr-Ile-Leu, resulting in 60 natural peptides. Ligands were energy minimized in MacroModel with the OPLS_{—}2005 force field and maximum iterations set to 10000. Docking was performed into all the grids generated using the XP scoring function. The constraints were applied so that a hydrogen bond from the ligand had to be formed to one of the two hydrogens earlier specified. Peptides were chosen for synthesis and biochemical characterization based on both G-score and manual inspection of the docking pose. Additionally, consistently poorly scoring/docking ligands that were very similar to those chosen for synthesis were also synthesized as negative controls.

Generation of Docking Grid from the Structure Used for Docking

Go to the Workflows menu and choose the Protein Preparation Wizard. Import your structure, then either leave the default settings in Fix Structure or change Delete Waters to 0.1 A, if you have no structural waters in the binding site, and press Setup. Check in the workspace that any structural waters were not removed. Manually remove any non-structural waters.

Next turn on the radio button for Exhaustive Sampling and click Optimize H-bonds. If you do not have a ligand in your binding pocket, then ignore the Minimize . . . button. If you do have a ligand in the binding pocket you should make two grids, one where you run Minimize . . . with the default settings and one where you either don't minimize or where you minimize Hydrogens only.

Go to Applications menu and choose Glide, then Receptor Grid Generation. If there is a ligand in your binding pocket it must be excluded from the grid generation and this is done by clicking it in the workspace while the Receptor tab is active. Click “Pick to identify ligand” if it isn't already yellow. Selecting the ligand sets a bounding box and you could generate a grid now but if the ligands you wish to dock are much larger than the original one then you should go the tab Site, click “Dock ligands with length <=” and adjust the slider. If there was no ligand in the original structure you should click “Centroid of selected residues” and in the workspace click the residues around the binding site.

If you are running Sortilin with a peptide in the Arg248 (/325/292) site, go to Constraints tab and select the hydrogen of the hydroxyl of Ser275 (/352/319) and the polar hydrogen of Ile276 (/353/320).

Now click Start.

### Generation of Ligands and Energy-Minimization

Click the Build Panel button to open the build panel.

Deselect all entries in the project table. In the blank workspace, use the build panel to build your ligand. Make sure you have the correct charges (LigPrep will assign correct charges though and generate additional ligands for tautomers and multiple charge states as well as minimize the energy) and double click Add Hydrogens. Press the Generate Entry From Workspace button and name your ligand.

If your next ligand is similar to the first, go to the project table and duplicate, then rename, it. Edit the new entry as you built the first ligand. If it is very dissimilar simply deselect everything in the project table and do as you did for the first. If you have SMILES of your ligands, it is faster to convert them to mol2 format with OpenBabel and import them into the project table. .pdbs must have hydrogens specified for Maestro to recognize the bond order and .sdfs do not contain the chirality info.

There are two options for energy minimization: LigPrep or MacroModel.
a) Go to Applications menu and choose MacroModel, then Multiple Minimization.

Select all your ligands from the project table and set the drop-down menu to Project Table (selected entries). In the Potential tab choose Force field: OPLS_{—}2005 (it should be default). Under Mini choose Method: PRCG (default) and Maximum iterations: 10000. If you have saved your ligands to a file and want to use them directly from there, then specify the file under the Mult tab and Start.
b) Go to Applications menu and choose LigPrep.

Select all your ligands from the project table or choose a file with all your ligands and set the drop-down menu accordingly. You might want to set the target pH to 7.4 and +/−lower than 2. Retain chiralities and start. Remember to inspect your ligands after minimization to confirm that they are correct, specifically chiral centers will be present in both enantiomers if they were not unambiguously defined in the original ligand. LigPrep is preferable to MacroModel because it generates all the states of histidine automatically.

### Docking

Go to Applications menu and choose Glide, then Ligand Docking.

Select the Receptor grid file. Set Precision to XP. Dock flexibly and allow ring-flips. In the advanced settings set Maximum number of conjugate steps to 5000. Go to the Ligands tab and choose the file generated in the energy minimization step or simply choose them in the project table and set Selected entries on. In the Output tab set Write out at most 5 poses per ligand. Adjust ligands per docking run if you have very many ligands.

If you are running Sortilin with a peptide in the Arg248 (/325/292) site then go to the Constraints tab and in Group 1 add the two h-bond constraints and set Must match: At least: 1. Only poses that include a hydrogen bond to one of the two will be included. This added because Maestro reports many curled up peptides which do not appear natural and have not been observed in the structures—if this had not been observed then the correct approach would have been to dock without constraints.

Steps one and three are repeated for all the available structures. The minimized ligands from step two are re-used.

### Evaluation of Results

Go to Applications menu and choose Glide, then Poseviewer.

Manually compare the docking of the highest scoring ligands, compare the same ligands in the other structures, synthesize those that seem reasonable as well as very related compounds that score/dock poorly for negative controls.

### Example 10

### Methods for Making PET Probe Ligands

The identified ligands are radiolabeled using e.g. radioactive fluorine, as described in Bergman et al., Nucl Med. Biol. 2002 (ref. 184), and used for slice autoradiography. The developed images are compared to slice autoradiography employing radiolabeled monoclonal sortilin antibodies. Those ligands that are suitable for coupling to antibodies are tested again in slice autoradiography with slices of sortilin knock-out mice. Ligands that image sortilin satisfactorily are injected in mice and brain homogenates are tested for radioactivity or the unlabeled ligands are labeled with radioisotopes suitable for either PET or SPECT and injected in mice or swine and their brains are imaged in vivo. Endogenous stability experiments are performed on brain homogenates. Non-blood-brain barrier permeating compounds are suitable for non-CNS imaging, while BBB permeating compounds are suitable for brain scans examining the in vivo levels and distribution of sortilin.

### REFERENCES

1. C. M. Petersen et al., J Biol Chem 272, 3599 (1997).
2. L. Jacobsen et al., J Biol Chem 271, 31379 (1996).
3. W. Hampe, M. Rezgaoui, I. Hermans-Borgmeyer, H. C. Schaller, Hum Genet. 108, 529 (2001).
4. J. Mazella et al., J Biol Chem 273, 26273 (1998).
5. C. Munck Petersen et al., Embo J 18, 595 (1999).
6. A. Nykjaer et al., Nature 427, 843 (2004).
7. H. K. Teng et al., J Neurosci 25, 5455 (2005).
8. U. B. Westergaard et al., J Biol Chem 279, 50221 (2004).
9. S. Maeda et al., J Cell Physiol 193, 73 (2002).
10. M. S, Nielsen, C. Jacobsen, G. Olivecrona, J. Gliemann, C. M. Petersen, Biol Chem 274, 8832 (1999).
11. M. S, Nielsen et al., Embo J 20, 2180 (2001).
12. K. Nakamura, K. Namekata, C. Harada, T. Harada, Cell Death Differ 14, 1552 (2007).
13. P. Jansen et al., Nat Neurosci 10, 1449 (2007).
14. P. Chalon et al., FEBS Lett 386, 91 (1996).
15. L. Jacobsen et al., J Biol Chem 276, 22788 (2001).
16. K. Tanaka, M. Masu, S, Nakanishi, Neuron 4, 847 (1990).
17. J. P. Vincent, J. Mazella, P. Kitabgi, Trends Pharmacol Sci 20, 302 (1999).
18. X. L. He, K. C. Garcia, Science 304, 870 (2004).
19. O. M. Andersen et al., Proc Natl Acad Sci USA 102, 13461 (2005).
20. S. M. Clee et al., Nat Genet. 38, 688 (2006).
21. E. Rogaeva et al., Nat Genet. 39, 168 (2007).
22. J. W. Lustbader et al., Endocrinology 136, 640 (February, 1995).
23 W. Kabsch, in International Tables for Crystallography E. Arnold, Ed. (Kluwer Academic Publishers, Dordrecht, 2001).
24. M. Strong et al., Proc Natl Acad Sci USA 103, 8060 (May 23, 2006).
25 T. R. Schneider, G. M. Sheldrick, Acta Crystallogr D Biol Crystallogr 58, 1772 (October, 2002).
26 A. T. Brunger et al., Acta Crystallogr D Biol Crystallogr 54, 905 (Sep. 1, 1998).
27 G. Bricogne, C. Vonrhein, C. Flensburg, M. Schiltz, W. Paciorek, Acta Crystallogr D Biol Crystallogr 59, 2023 (November, 2003).
28 T. C. Terwilliger, Acta Crystallogr. D 59, 38 (2003).
29 T. A. Jones, J. Y. Zou, S. W. Cowan, M. Kjeldgaard, Acta Crystallogr A 47 (Pt 2), 110 (Mar. 1, 1991).
30. A. Vagin, A. Teplyakov, Acta Crystallogr D Biol Crystallogr 56, 1622 (December, 2000).
31 G. N. Murshudov, A. A. Vagin, E. J. Dodson, Acta Crystallogr D Biol Crystallogr 53, 240 (May 1, 1997).
32. P. D. Adams et al., Acta Crystallogr D Biol Crystallogr 58, 1948 (November, 2002).
33. W. L. DeLano, The PyMOL Molecular Graphics System (DeLano Scientific, Palo Alto, Calif., USA., 2002), pp.
34. M. Clamp, J. Cuff, S. M. Searle, G. J. Barton, Bioinformatics 20, 426 (Feb. 12, 2004).
35. W. Kabsch, C. Sander, Biopolymers 22, 2577 (December, 1983).
35 A. C. Wallace, R. A. Laskowski, J. M. Thornton, Protein Eng 8, 127 (February, 1995).
36. Abbondanzo, Medeiros, Cossman, “Molecular genetics and its application to the diagnosis and classification of hematopoietic neoplasms,” Am. J. Pediatr. Hematol. Oncol., 12(4):480-489, 1990.
37. Alizadeh, A. A. et al. “Distinct types of diffuse large B-cell lymphoma identified by gene expression profiling” Nature 403 (2000): 503-11.
38. Allred, Bustamante, Daniel, Gaskill, Cruz, “Immunocytochemical analysis of estrogen receptors in human breast carcinomas. Evaluation of 130 cases and review of the literature regarding concordance with biochemical assay and clinical relevance,” Arch. Surg., 125(1): 107-113, 1990.
39. Altschul S F, Amino acid substitution matrices from an information theoretic perspective. J Mol. Biol. 1991 Jun. 5; 219(3):555-65.
40. Altschul S F, Boguski M S, Gish W, Wootton J C. Issues in searching molecular sequence databases. Nat. Genet. 1994 February; 6(2): 1 19-29.
41. Altschul S F, Madden T L, Schaffer A A, Zhang J, Zhang Z, Miller W, Lipman D J. Gapped BLAST and PSI-BLAST: a new generation of protein database search programs. Curr Opin Struct Bio1.1996 June; 6(3):353-60.
42. Argos P, Rao J K, Hargrave P A. Structural prediction of membrane-bound proteins. Eur J Biochem 1982 Nov. 15; 128(2-3):565-575.
43. Artemov, D. (2003a). “Molecular magnetic resonance imaging with targeted contrast agents.” J Cell Biochem 90(3): 5 18-24.
44. Artemov, D., N. Mori, et al. (2003b). “Magnetic resonance molecular imaging of the HER-2Ineu receptor.” Cancer Res 63(11): 2723-7.
45. Artemov D, Mori N, OI<ollie B, Bhujwalla Z M. MR molecular imaging of the Her-2Ineu receptor in breast cancer cells using targeted iron oxide nanoparticles. Magn Reson Med. 2003c March; 49(3):403-8.
46. Bannai H, Tamada Y, Maruyama O, Naltai I<, Miyano S, Extensive feature detection of N-terminal protein sorting signals. Bioinformatics. 2002 February; 18(2):298-305.
47. Belhocine T Z, Tait J F, Vanderheyden J L, Li C, Blanitenberg F G. Nuclear medicine in the era of genomics and proteomics: lessons from annexin V. J Proteome Res. 2004 May-June; 3(3):345-9.
48. Bendtsen, J D, Henrik Nielsen, Gunnar von Heijne and Ssren Brunalt. Improved prediction of signal peptides: SignalP 3.0. J. Mol. Biol., 340:783-795, 2004.
49. Bhorade, R., R. Weissleder, et al. (2000). “Macrocyclic chelators with paramagnetic cations are internalized into mammalian cells via a HIV-tat derived membrane translocation peptide.” Bioconjug Chem 1 I(3): 301-5.
50.—Blantenberg F, Mari C, Strauss H W. Imaging cell death in vivo. Q J Nucl Med. 2003 December; 47(4):337-48. Review.
51. Blasberg, R. G. and J. Gelovani (2002). “Molecular-genetic imaging: a nuclear medicine-based perspective.” Mol Imaging 1(3): 280-300.
52. Bogdanov, A., Chen J, Kang, H, Weissleder R (2005). “Molecular Imaging: An Essential Tool in Preclinical Research, Diagnostic Imaging and Therapy.” Springer-Verlag.
53. Bogdanov, A., Jr., L. Matuszewski, et al. (2002). “Oligomerization of paramagnetic substrates result in signal amplification and can be used for MR imaging of molecular targets.” Mol Imaging I(1): 16-23.
54. Bogdanov A Jr, Matuszewslti L, Bremer C, Petrovslty A, Weissleder R. Oligomerization of paramagnetic substrates result in signal amplification and can be used for MR imaging of molecular targets.
   Mol. Imaging. 2002 January-March; I(1): 16-23.
55. Bogdanov, A. A., Jr., C. P. Lin, et al. (2002). “Cellular activation of the self-quenched fluorescent reporter probe in tumor microenvironment.” Neoplasia 4(3): 228-36.
56. Bremer, C., S. Bredow, et al. (2001). “Optical imaging of matrix metalloproteinase-2 activity in tumors: feasibility study in a mouse model.” Radiology 221(2): 523-9.
57. Bremer, C., C. H. Tung, et al. (2002). “Imaging of differential protease expression in breast cancers for detection of aggressive tumor phenotypes.” Radiology 222(3): 814-8.
58. Bremer, C., C. H. Tung, et al. (2001). “In vivo molecular target assessment of matrix metalloproteinase inhibition.” Nat Med 7(6): 743-8.
59. Brown et al., J. Immunol. Meth., 12; 130(1):111-121, 1990.
60. Castillo, M., L. Kwock, et al. (1996). “Clinical applications of proton MR spectroscopy.” AJNR Am J Neuroradiol 17(1): 1-1 5.
61. Chatham, J. C. and S. J. Blacltband (2001). “Nuclear magnetic resonance spectroscopy and imaging in animal research.” Ilar J 42(3): 189-208.
62. Chatziioannou, A., Y. C. Tai, et al. (2001). “Detector development for microPET 11: a 1 micro 1 resolution PET scanner for small animal imaging.” Phys Med Bio146(11): 2899-910.
63. Chatziioannou, A. F. (2002). “Molecular imaging of small animals with dedicated PET tomographs.” Eur J Nucl Med Mol Imaging 29(1): 98-114.
64. Chen, J., C. H. Tung, et al. (2002). “In vivo imaging of proteolytic activity in atherosclerosis.” Circulation 105(23): 2766-71.
65. Chen, W. S., K. E. Luker, et al. (2000). “Effects of MDRI and MDR3P-glycoproteins, MRPI, and BCRP/MXRIABCP on the transport of (99m)Tc-tetrofosmin.” Biochem Pharmacol 60(3): 413-26.
66. Chen, W. T., C. H. Tung, et al. (2004). “Imaging reactive oxygen species in arthritis.” Mol Imaging 3(3): 159-62.
67. Chen, X., M. Tohme, et al. (2004). “Micro-PET imaging of alphavbeta3-integrin expression with 18F-labeled dimeric RGD peptide.” Mol Imaging 3(2): 96-104.
68. Cherry, S. R. and S. S. Gambhir (2001). “Use of positron emission tomography in animal research.” Ilar J 42(3): 219-32.
69. Choe G, Park J K, Jouben-Steele L, Kremen T J, Liau L M, Vinters H V, Cloughesy T F, Mischel P S. Active matrix metalloproteinase 9 expression is associated with primary glioblastoma subtype. Clin Cancer Res. 2002 September; 8(9):2894-901.
70. Coenen H H, Laufer P, Stoclclin G, Wienhard K, Pawlilc G, Bocher-Schwarz H G, Heiss W D. Links 3-N-(2-(18F)-fluoroethyl)-spiperone: a novel ligand for cerebral dopamine receptor studies with pet. Life Sci. 1987 Jan. 5; 40(1):81-8.
71. Contag, P. R., I. N. Olomu, et al. (1998). ccBioluminescent indicators in living mammals.” Nat Med 4(2): 245-7.
72. Crouzel, C., Venet, My Irie, T., Sanz, G., And Boullais, C. 1988 Labeling of Serotonergic ligand with 18F: (18F)Setoperone. J. Label. Compd. Radiopharm. 25: 403.
73. Cumming, P. and A. Gjedde (1998). “Compartmental analysis of dopa decarboxylation in living brain from dynamic positron emission tomograms.” Synapse 29(1): 37-61.
74. Del Vecchio, S., A. Ciarmiello, et al. (2000). “Scintigraphic detection of multidrug resistance in cancer.” Cancer Biother Radiopharm 15(4): 327-37.
75. Dendy, P. a. H., B. (1999). “Tomographic imaging.” Physics for diagnostic radiology: 249-278.
76. Divito K A, Berger A J, Camp R L, Dolled-Filhart M, Rimm D L, Kluger I-IM. (2004) “Automated quantitative analysis of tissue microarrays reveals an association between high Bcl-2 expression and improved outcome in melanoma.” Cancer Res. 64(23): 8773-7.
77. Dodd, C. H., H. C. Hsu, et al. (2001). “Normal T-cell response and in vivo magnetic resonance imaging of T cells loaded with HIV transactivator-peptide-derived superparamagnetic nanoparticles.” J Immunol Methods 256(1-2): 89-105.
78. Eisen M B, Spellman P T, Brown P O, and D Botstein. Cluster analysis and display of genome-wide expression patterns. Proceedings National Academy of Sciences, USA, 1998. 95: p. 14863-14868.
79. Emanuelsson, Olof, Henrik Nielsen, Saren Brunalt and Gunnar von Heijne. Predicting subcellular localization of proteins based on their N-terminal amino acid sequence, J. Mol. Biol., 300: 1005-1016, 2000,
80. Feldkamp M M, Lala P, Lau N, Roncari L, Guha A. Expression of activated epidermal growth factor receptors, Ras-guanosine triphosphate, and mitogen-activated protein kinase in human glioblastoma multiforme specimens. Neurosurgery. 1999 December; 45(6): 1442-53.
81. Fischman, A. J., J. W. Babich, et al. (1993). “A ticket to ride: peptide radiopharmaceuticals.” J Nucl Med 34(12): 2253-63.
82. Flaclte, S., S. Fischer, et al. (2001). “Novel MRI contrast agent for n˜olecularim aging of fibrin: implications for detecting vulnerable plaques.” Circulation 104(11): 1280-5.
83. Franc, B. L., S. J. Mandl, et al. (2003). “Breaching biological barriers: protein translocation domains as tools for molecular imaging and therapy.” Mol Imaging 2(4): 3 13-23.
84. Gambhir, S. S. (2002). “Molecular imaging of cancer with positron emission tomography.” Nat Rev Cancer 2(9): 683-93.
85. Gambhir, S. S., J. R. Barrio, et al. (1999). “Assays for noninvasive imaging of reporter gene expression.” Nucl Med Bio126(5): 48 1-90.
86. Ghambhir, S. (in press, Springer-Verlag). “Quantitiative assay development for positron emission tomography.” Molecular imaging with positron emission tomography.Geourjon Cy Combet C, Blanchet C, Deleage G. Identification of related proteins with weak sequence identity using secondary structure information. Protein Sci 2001 April; 10(4):788-97.
87. Ghambhir, S. (in press, Springer-Verlag). “Quantitiative assay development for positron emission tomography.” Molecular imaging with positron emission tomography.
88. Godard S, Getz G, Delorenzi M, Farmer P, Kobayashi H, Desbaillets I, Nozalti My Diserens A C, Hamou M F, Dietrich P Y, Regli L, Janzer R C, Bucher P, Stupp R, de Tribolet N, Domany E, Hegi M E. Classification of human astrocytic glioinas on the basis of gene expression: a correlated group of genes with angiogenic activity emerges as a strong predictor of subtypes. Cancer Res. 2003 Oct. 15; 63(20):6613-25.
89. Goldberg, R. M., T. R. Fleming, et al. (1998). “Surgery for recurrent colon cancer: strategies for identifying resectable recurrence and success rates after resection. Eastern Cooperative Oncology Group, the North Central Cancer Treatment Group, and the Southwest Oncology Group.” Ann Intern Med 129(1): 27-35.
90. Golembieslti W A Y Rempel S A. cDNA array analysis of SPARC-modulated changes in glioma gene expression. J. Neurooncol. 2002 December; 60(3):2 13-26.
91. Golub, T. R. et al. “Molecular Classification of Cancer: Class Discovery and Class Prediction by Gene Expression Monitoring” Science 286 (1999): 53 1-7.
92. Hadjantonakis, A. K. and A. Nagy (2001). “The color of mice: in the light of GFP-variant reporters.” Histochem Cell Biol 1 15(1): 49-58.
93. Harisinghani, M. G., J. Barentsz, et al. (2003). “Noninvasive detection of clinically occult lymphnode metastases in prostate cancer.” N Engl J Med 348(25): 2491-9.
94. Harn H J, Lee H S, Ho L I, Lee Ding J H. Selective expression of CD44 messenger RNA splice variants in four high grade human brain tumour cell lines. Biochem Mol Biol Int. 1994 July; 33(4):743-9.
95. Hastie, T. et al. ‘“Gene shaving’ as a method for identifying distinct sets of genes with similar expression patterns” Genome Biol. 2000; 1 (2):RESEARCH0003. Epub 2000 Aug. 4.
96. Herschman, H. R., D. C. MacLaren, et al. (2000). “Seeing is believing: non-invasive, quantitative and repetitive imaging of reporter gene expression in living animals, using positron emission tomography.” J Neurosci Res 59(6): 699-705.
97. Hoelzinger D B, Mariani L, Weis J, Woylte T, Berens T J, McDonough W S, Sloan A, Coons S W, Berens M E. Gene expression profile of glioblastoma multiforme invasive phenotype points to new therapeutic targets. Neoplasia. 2005 January; 7(1):7-16,
98. Horton P, Nakai I. “Better prediction of protein cellular localization sites with the 1c nearest neighbors classifier.” Proc Int Conf Intell Syst Mol. Biol. 1997; 5: 147-52.
99. Huang, S. C., M. E. Phelps, et al. (1980). “Noninvasive determination of local cerebral metabolic rate of glucose in man.” Am J Physiol238(1): E69-82.
100. Iyer, M., M. Berenji, et al. (2002). ‘Woninvasive imaging of cationic lipid-mediated delivery of optical and PET reporter genes in living mice.” Mol Ther 6(4): 555-62.
101. Jackson, E. (2001). “Principles of magnetic resonance imaging and magnetic resonance spectroscopy.” Targeted molecular imaging in oncology: 30-61.
102. Jacobs, A. H., C. Dittmar, et al. (2002). “Molecular imaging of gliomas.” Mol Imaging 1(4): 309-35.
103. Jacobs, A. H., A. Winkles, et al. (2002). “Molecular and functional imaging technology for the development of efficient treatment strategies for gliomas.” Techno 1 Cancer Res Treat I(3): 187-204.
104. Jaffer, F. A. and R. Weissleder (2004). “Seeing within: molecular imaging of the cardiovascular system.” Circ Res 94(4): 433-45.
105. Jaffer, F. A. and R. Weissleder (2005). “Molecular imaging in the clinical arena.” Jama 293(7): 855-62.
106. Jonassen I. Efficient discovery of conserved patterns using a pattern graph. Comput. Appl. Biosci. 13(5):509-522 (1997)
107. Jonassen I., Collins J. F. and Higgins D.; Finding flexible patterns in unaligned protein sequences. Protein Science 4(8): 1587-1 595 (1995)
108. Josephson L, C. H. Tung, et al. (1999). “High-efficiency intracellular magnetic labeling with novel superparamagnetic-Tat peptide conjugates.” Bioconjug Chem 10(2): 186-91.
109. Jubb A M, Landon T H, Burwick J, Pham T Q, Frantz G D, Cairns B, Quirke P, Peale F V, Hillan K J. (2003) “Quantitative analysis of colorectal tissue microarrays by iminunofluorescence and in situ hybridization.” J. Pathol. 200(5): 577-88.
110. Kang H W, Josephson L, Petrovsky A, Weissleder R, Bogdanov A Jr. Magnetic resonance imaging of inducible E-selectin expression in human endothelial cell culture. Bioconjug Chem. 2002 January-February; 13(1): 122-7.
111. Kelly, K., H. Alencar, et al. (2004). “Detection of invasive colon cancer using a novel, targeted, library-derived fluorescent peptide.” Cancer Res 64(17): 6247-5 1.
112. Kim, E. (2001). “Radioimmunodetection of cancer.” Targeted molecular imaging in oncology, Springer-Verlag: 88-10 1.
113. Kneller, D. G., F. E. Cohen and R. Langridge (1990) “Improvements in Protein Secondary Structure Prediction by an Enhanced Neural Network” J. Mol. Biol. (2 14) 17 1-1 82.
114. Kobayashi, H. and M. W. Brechbiel(2003). “Dendrimer-based macromolecular MRI contrast agents: characteristics and application.” Mol Imaging 2(1): 1-10. Kung H F, Alavi A, Chang W, Kung M P, Keyes J W Jr, Velchik M G, Billings J, Pan S, Noto R, Rausch, et al. In vivo SPECT imaging of CNS D-2 dopamine receptors: initial studies with iodine-123-IBZM in humans. J Nucl Med. 1990 May; 31(5):573-9.
115. Icyte J, Doolittle R F. A simple method for displaying the hydropathic character of a protein. J Mol Biol 1982 May 5; 157(1): 105-132
116. Lamberts, S. W., W. H. Baltlter, et al. (1990). “Somatostatin-receptor imaging in the localization of endocrine tumors.” N Engl J Med 323(18): 1246-9.
117. Lanza, G. M. and S. A. Wicltline (2001). “Targeted ultrasonic contrast agents for molecular imaging and therapy.” Prog Cardiovasc Dis 44(1): 13-3 1.
118. Lardinois, D., W. Weder, et al. (2003). “Staging of non-small-cell lung cancer with integrated positron-emission tomography and computed tomography.” N Engl J Med 348(25): 2500-7.
119. Lash A E, Tolstoshev C M, Wagner L, Schuler G D, Strausberg R L, Riggins G J, Altschul S F. SAGEmap: a public gene expression resource. Genome Res. 2000 July; 10(7): 105 1-60.
120. Lewin, M., N. Carlesso, et al. (2000). “Tat peptide-derivatized magnetic nanoparticles allow in vivo traclting and recovery of progenitor cells.” Nat Biotechnol 1 S(4): 41 0-4.
121. Li, J. J., X. Fang, et al. (2002). “Molecular aptamer beacons for real-time protein recognition.” Biochem Biophys Res Commun 292(1): 3 1-40.
122. Li K C, Bednarski M D. Vascular-targeted molecular imaging using functionalized polymerized vesicles. J Magn Reson Imaging. 2002 October; 16(4):388-93.
123. Liang, Q., K. Nguyen, et al. (2002). “Monitoring adenoviral DNA delivery, using a mutant herpes simplex virus type 1 thymidine kinase gene as a PET reporter gene.” Gene Ther 9(24): 1659-66.
124. Ligon A H, Pershouse M A, Jasser S, Hong Y K, Yung W K, Steclt P A. Differentially expressed gene products in glioblastoma cells suppressed for tumorigenicity. J. Neurovirol. 1998 April; 4(2):2 17-26.
125. Ljubimova J Y, Khazenzon N M, Chen Z, Neyman Y I, Turner L, Riedinger M S, Black K L. Gene expression abnormalities in human glial tumors identified by gene array. Int J. Oncol. 2001 February; 18(2):287-95.
126. Ljubimova J Y, Lakhter A J, Loltsh A, Yong W H, Riedinger M S, Miner J H, Soroltin L M, Ljubimov A V, Black K L. Overexpression of alpha4 chain-containing laminins in human glial tumors identified by gene microarray analysis. Cancer Res. 2001 Jul. 15; 61(14):5601-10.
127. Lovqvist, A., J. L. Humm, et al. (2001). “PET imaging of (86)Y-labeled anti-Lewis Y monoclonal antibodies in a nude mouse model: comparison between (86)Y and (111) In radiolabels.” J Nucl Med 42(8): 1281-7.
128. Lucignani, G. a. F., H H. (2000). “Neurochemical imaging with emission tomography: Clinical applications.” Diagnostic nuclear medicine, Springer-Verlag: 7-35.
129. Luypaert, R., S. Boujraf, et al. (2001). “Diffusion and perfusion MRI: basic physics.” Eur J Radiol 38(1): 19-27.
130. Mahmood, U. and R. Weissleder (2002). “Some tools for molecular imaging.” Acad Radiol 9(6):629-3 1.
131. Marchler-Bauer A, Panchenko A R, Shoemalter B A Y Thiessen P A, Geer L Y, and Bryant S H CDD: a database of conserved domain alignments with links to domain three-dimensional structure. Nucleic Acids Res. 2002; 30:28 1-3.
132. Mariani L, Beaudry C, McDonough W S, Hoelzinger D B, Demuth T, Ross K R, Berens T, Coons S W, Watts G, Trent J M, Wei J S, Giese A, Berens M E. Glioma cell motility is associated with reduced transcription of proapoptotic and proliferation genes: a cDNA microarray analysis. J. Neurooncol. 2001 June; 53(2):161-76.
133. Mariani L, Beaudry C, McDonough W S, Hoelzinger D B, ICaczmarelt E, Ponce F, Coons S W, Giese A, Seiler R W, Berens M E. Death-associated protein 3 (Dap-3) is overexpressed in invasive glioblastoma cells in vivo and in glioma cell lines with induced motility phenotype in vitro. Clin Cancer Res. 2001 August; 7(8):2480-9.
134. Markert J M, Fuller C M, Gillespie G Y, Bubien J K, McLean L A, Hong R L, Lee K, Gullans S R, Mapstone T B, Benos D J. Differential gene expression profiling in human brain tumors. Physiol Genomics. 2001 Feb. 7; 5(1):21-33.
135. Massoud, T. F. and S. S. Gambhir (2003). “Molecular imaging in living subjects: seeing fundamental biological processes in a new light.” Genes Dev 17(5): 545-80.
136. McCarthy, T. J., A. U. Sheriff, et al. (2002). “Radiosynthesis, in vitro validation, and in vivo evaluation of 18F-labeled COX-I and COX-2 inhibitors.” J Nucl Med 43(1): 117-24.
137. Mischel P S, Shai R, Shi T, Horvath S, Lu K V, Choe G, Seligson D, Icremen T J, Palotie A, Liau L M, Cloughesy T F, Nelson S F. Identification of molecular subtypes of glioblastoina by gene expression profiling. Oncogene. 2003 Apr. 17; 22(15):236 1-73.
138. Mitchell, P. (2001). “Turning the spotlight on cellular imaging.” Nat Biotechnol 19(11): 1013-7.
139. Muraltami Y, Takamatsu H, Talti J, Tatsumi M, Noda A, Ichise R, Tait J F, Nishimura S. 18F labelled annexin V: a PET tracer for apoptosis imaging. Eur J Nucl Med Mol. Imaging. 2004 April; 3 1 (4):469-74. Epub 2003 Dec. 10.
140. Naghavi, M., P. Libby, et al. (2003). “From vulnerable plaque to vulnerable patient: a call for new definitions and risk assessment strategies: Part 11.” Circulation 108(15): 1772-8.
141. Nielsen, Henrik, Jacob Engelbrecht, Sarren Brunalt and Gunnar von Heijne. Identification of prokaryotic and eukaryotic signal peptides and prediction of their cleavage sites. Protein Engineering, 10:1-6, 1997.
142. Nielsen, H and Anders Krogh. Prediction of signal peptides and signal anchors by a hidden Marltov model. Proceedings of the Sixth International Conference on Intelligent Systems for Molecular Biology (ISMB 6), AAAI Press, Menlo Park, Calif., pp. 122-130, 1998.
143. Oriuchi, N. a. Y., D. J. (2001). “Antibodies for targeted imaging: properties and radiolabeling.” Targeted molecular imaging in oncology, Springer-Verlag: 83-87.
144. Paik, S., S. Shak, et al. (2004). “A multigene assay to predict recurrence of tainoxifen-treated, nodenegative breast cancer.” N Engl J Med 35 1(27): 28 17-26.
145. Perou, C. M. et al. “Molecular portraits of human breast tumours” Nature 406 (2000): 747-52.
146. Polyaltov, V., V. Sharma, et al. (2000). “Novel Tat-peptide chelates for direct transduction of technetium-99m and rhenium into human cells for imaging and radiotherapy.” Bioconjug Cheln 11(6): 762-71.
147. Raza S M, Fuller G N, Rhee C H, Huang S, Hess K, Zhang W, Sawaya R. Identification of necrosisassociated genes in glioblastoma by cDNAmicroarray analysis. Clin Cancer Res. 2004 Jan. 1; 10(1 Pt 1):212-21.
148. Remington, S. J. (2002). “Negotiating the speed bumps to fluorescence.” Nat Biotechnol20(1): 28-9.
149. Remsen, L. G., C. I. McCormick, et al. (1996). “MR of carcinoma-specific monoclonal antibody conjugated to monocrystalline iron oxide nanoparticles: the potential for noninvasive diagnosis.” AJNR Am J Neuroradiol 17(3): 41 1-8.
150. Reubi, J. C., J. C. Schar, et al. (2000). “Affinity profiles for human somatostatin receptor subtypes SSTI-SST5 of somatostatin radiotracers selected for scintigraphic and radiotherapeutic use.” Eur J Nucl Med 27(3): 273-82.
151. Rickman D S, Bobek M P, Misek D E, Kuiclt R, Blaivas My Kurnit D M, Taylor J, Hanash S M. Distinctive molecular profiles of high-grade and low-grade gliomas based on oligonucleotide microarray analysis. Cancer Res. 2001 Sep. 15; 61(18):6885-91.
152. Rosebrough, S. F. (1996). “Two-step immunological approaches for imaging and therapy.” Q J Nucl Med 40(3): 234-51.
153. Rosenthal, M. S., J. Cullom, et al. (1995). “Quantitative SPECT imaging: a review and recommendations by the Focus Committee of the Society of Nuclear Medicine Computer and Instrumentation Council.” J Nucl Med 36(8): 1489-5 13.
154. Rost B, Casadio R, Fariselli P, Sander C. “Transmembrane helices predicted at 95% accuracy”. Protein Sci 1995 March; 4(3):52 1-33.
155. Rost B, Sander C. Prediction of protein secondary structure at better than 70% accuracy. J Mol Biol 1993 Jul. 20; 232(2):584-99.
156. Sallinen S L, Sallinen P K, Haapasalo H K, Helin H J, Helen P T, Schraml P, ICallioniemi O P, Kononen J. Identification of differentially expressed genes in human gliomas by DNA microarray and tissue chip techniques. Cancer Res. 2000 Dec. 1; 60(23): δ 17-22.
157. Sambrook, J., Fritsch, E. F., Maniatis, T., 1989. Molecular Cloning: A Laboratory Manual. Cold Spring Harbor Laboratory Press, Cold Spring Harbor, N.Y.
158. Shields, A. F., J. R. Grierson, et al. (1998). “Imaging proliferation in vivo with (F-18)FLT and positron emission tomography.” Nat Med 4(11): 1334-6.
159. Sipkins D A, Cheresh D A, Kazemi M R, Nevin L M, Bednarslti M D, Li K C. Detection of tumor angiogenesis in vivo by alphaVbeta3-targeted magnetic resonance imaging. Nat. Med. 1998 May; 4(5):623-6.
160. Sipkins D A, Gijbels K, Tropper F D, Bednarski My Li K C, Steinman L. ICAM-I expression in autoimmune encephalitis visualized using magnetic resonance imaging. J. Neuroimmunol. 2000 Apr. 3; 104(1): 1-9.
161. Stolz, B., G. Weckbecker, et al. (1998). “The somatostatin receptor-targeted radiotherapeutic (90YDOTA-DPhel, Tyr3)octreotide (90Y-SMT 487) eradicates experimental rat pancreatic CA 20948 tumours.” Eur J Nucl Med 25(7): 668-74.
162. Strijckmans, K. (2001). “The isochronous cyclotron: principles and recent developments.” Comput Med Imaging Graph 25(2): 69-78.
163. Tanwar M K, Gilbert M R, Holland E C. Gene expression microarray analysis reveals YKL-40 to be a potential serum marker for malignant character in human glioma. Cancer Res. 2002 Aug. 1; 62(15):4364-8.
164. Ternpany, C. M. and B. J. McNeil (2001). “Advances in biomedical imaging.” Jama 285(5): 562-7.
165. Tibshirani R, Hastie T, Narasimhan B, and G Chu. Diagnosis of multiple cancer types by shrunken centroids of gene expression. Proc Natl Acad Sci USA, 2002. 99(10): p. 6567-72.
166. Toretsky J, Levenson A, Weinberg !A T, Tait J F, Uren A, Mease R C. Preparation of F-18 labeled annexin V: a potential PET radiopharmaceutical for imaging cell death. Nucl Med. Biol. 2004 August; 3 1(6):747-52.
167. Townsend, D. W. (2001). “A combined PETICT scanner: the choices.” J Nucl Med 42(3): 533-4.
168. Townsend, D. W. and S. R. Cherry (2001). “Combining anatomy and function: the path to true image fusion.” Eur Radiol 1 I(10): 1968-74.
169. Tran N L, McDonough W S, Donohue P J, Winkles J A, Berens T J, Ross K R, Hoelzinger D B, Beaudry C, Coons S W, Berens M E. The human Fn14 receptor gene is up-regulated in migrating glioma cells in vitro and overexpressed in advanced glial tumors. Am J. Pathol. 2003 April; 162(4):1313-21.
170. Tsiambas E, Karameris A, Dervenis C, Lazaris A C, Giannakou N, Gerontopoulos K, Patsouris E. (2006) “HER21neu expression and gene alterations in pancreatic ductal adenocarcinorna: a comparative immunohistochemistry and chromogenic in situ hybridization study based on tissue microarrays and computerized image analysis.” JOP 7(3): 283-94.
171. Tung, C. H., S. Bredow, et al. (1999). “Preparation of a cathepsin D sensitive near-infrared fluorescence probe for imaging.” Bioconjug Chem 10(5): 892-6.
172. Tusher V G, Tibshirani R, and G Chu. Significance analysis of microarrays applied to the ionizing radiation response, Proceedings National Academy of Sciences, USA, 2001.98(9): p. 5116-5121.
173. van Tinteren, H., O, S, Noeltstra, et al. (2002). “Effectiveness of positron emission tomography in the preoperative assessment of patients with suspected non-small-cell lung cancer: the PLUS multicentre randornised trial.” Lancet 359(93 15): 1388-93.
174. Virgolini, I. (2000). “Peptide imaging.” Diagnostic nuclear medicine, Springer-Verlag: 135-158.
175. Wagner H N Jr, Burns H D, Dannals R F, Wong D F, Langstrom B, Duelfer T, Frost J J, Ravert H T, Links J M, Rosenbloom S B, Lukas S E, Kramer A V, Kuhar M J. Imaging dopamine receptors in the human brain by positron tomography. Science. 1983 Sep. 23; 221(4617):1264-6
176. Weissleder R. Target-specific superparanlagnetic MR contrast agents. Magn Reson Med. 1991 December; 22(2):209-12; discussion 213-5.
177. Weissleder, R. (1999). “Molecular imaging: exploring the next frontier.” Radiology 212(3): 609-14.
178. Weissleder, R. (2002). “Scaling down imaging: molecular mapping of cancer in mice.” Nat Rev Cancer 2(1): 11-8.
179. Weissleder, R. and U. Mahmood (2001). “Molecular imaging.” Radiology 219(2): 316-33.
180. Winter, P. M., A. M. Morawslti, et al. (2003). “Molecular imaging of angiogenesis in early-stage atherosclerosis with alpha(v)beta3-integrin-targeted nanoparticles.” Circulation 108(18): 2270-4.
181. Wunderbaldinger, P., L. Josephson, et al. (2002). “Tat peptide directs enhanced clearance and hepatic permeability of magnetic nanoparticles.” Bioconjug Chem 13(2): 264-8.
182. Zerhouni, E. (2003). “Medicine. The NIH Roadmap.” Science 302(5642): 63-72. Zhang R, Tremblay T L, McDermid A, Thibault P, Stanimirovic D. Identification of differentially expressed proteins in human glioblastoma cell lines and tumors. Glia. 2003 Apr. 15; 42(2): 194-208.
183. Ziegler, S. (2000). “Instrumentation and data acquisition.” Diagnostic nuclear medicine, Springer-Verlag: 221-236.
184. Bergmann R (2002). “Biodistribution and catabolism of (18)F-labeled neurotensin(8-13) analogs.” Nucl Med. Biol. 29(1):61-72.

1-87. (canceled)

88. A computer-assisted method for identifying a target specific molecular imaging ligand of sortilin capable of binding to binding site 1 and/or binding site 2 and/or binding site 3 of SEQ ID NO. 1 (Sortilin), or a fragment or variant thereof, using a programmed computer comprising a processor, a data storage system, a data input device and a data output device, comprising the following steps:
a. inputting into the programmed computer through said input device data comprising: atomic coordinates of a subset of the atoms of said sortilin, thereby generating a criteria data set;
wherein said atomic coordinates are selected from the three-dimensional structure presented in any of FIGS. 17 to 20 or atomic coordinates selected from a three-dimensional structure that deviates from the three-dimensional structure presented in any of FIGS. 17 to 20 by a root mean square deviation over protein backbone atoms of not more than 3 Å;
b. comparing, using said processor, the criteria data set to a computer data base of low-molecular weight organic chemical structures and peptide fragments stored in the data storage system; and
c. selecting from said data base, using computer methods, a chemical structure having a portion that is structurally complementary to the criteria data set and being free of steric interference with the receptor sortilin.

89. A method for identifying a target specific molecular imaging ligand, said method comprising the steps of:
a. selecting a potential ligand using atomic coordinates in conjunction with computer modelling, wherein said atomic coordinates are the atomic coordinates presented in any of FIGS. 17 to 20 or wherein the atomic coordinates are selected from a three-dimensional structure that deviates from the three-dimensional structure presented in any of FIGS. 17 to 20 by a root mean square deviation over protein backbone atoms of not more than 3 Å, by docking potential ligands into a set of binding interaction sites in binding site 1 and/or binding site 2 and/or binding site 3 of SEQ ID NO: 1 (Sortilin), or a fragment or variant thereof, said binding interaction generated by computer modelling and selecting a potential ligand capable of binding to at least one amino acid in said set of binding interaction sites of sortilin;
b. providing said potential ligand and said receptor sortilin;
c. contacting the potential ligand with said receptor sortilin; and
d. detecting binding of said receptor sortilin by the potential ligand.

90. The method according to claim 89, wherein docking of potential target specific molecular imaging ligand molecules is performed by employing a three-dimensional structure defined by atomic coordinates of the three dimensional structure presented in any of FIGS. 17 to 20 and such that said potential ligand is capable of binding to at least three amino acids in the binding site 1 and/or binding site 2 and/or binding site 3 of SEQ ID NO: 1 (Sortilin), or a fragment or variant thereof.

91. A method of identifying a potential target specific molecular imaging ligand of binding site 1, binding site 2 or binding site 3 of sortilin, or a fragment or variant thereof, said method comprising the steps of:
a. introducing into a computer, information derived from atomic coordinates defining a conformation of binding site 1 and/or binding site 2 and/or binding site 3 of SEQ ID NO: 1 (Sortilin), or a fragment or variant thereof, based on three-dimensional structure determination, whereby a computer program utilizes or displays on the computer screen the structure of said conformation;
wherein said atomic coordinates are selected from the three-dimensional structure as presented in any of FIGS. 17 to 20 or atomic coordinates selected from a three-dimensional structure that deviates from any one of the three-dimensional structure represented by any of FIGS. 17 to 20 by a root mean square deviation over protein backbone atoms of not more than 3 Å;
b. generating a three-dimensional representation of binding site 1, binding site 2 or binding site 3 of Sortilin, or a fragment or variant thereof, by said computer program on a computer screen;
c. superimposing a model of a potential ligand on the representation of said binding site 1, binding site 2 or binding site 3;
d. assessing the possibility of bonding and the absence of steric interference of the potential ligand with binding site 1, binding site 2 or binding site 3 of Sortilin or a fragment or variant thereof;
e. incorporating said potential ligand compound in a binding assay of said receptor sortilin; and
f. determining whether said potential ligand is capable of binding to binding site 1 and/or binding site 2 and/or binding site 3 of SEQ ID NO: 1 by performing a biochemical or biophysical competitive binding assay,
wherein the competing ligand is selected from the group consisting of amino acid residues 19 to 241 of SEQ ID NO: 6 (proNGF), amino acid residues 19 to 121 of SEQ ID NO: 6 (NGF pro domain), amino acid residues 19 to 246 of SEQ ID NO: 7 (proBDNF), amino acid residues 19 to 127 of SEQ ID NO: 7 (BDNF pro domain), amino acid residues 17 to 257 of SEQ ID NO: 8 (proNT3), amino acid residues 17 to 140 of SEQ ID NO: 8 (NT3 pro domain), amino acid residues 25 to 210 of SEQ ID NO: 9 (proNT4/5), amino acid residues 25 to 80 of SEQ ID NO: 9 (NT4/5 pro domain), SEQ ID NO: 10 (Neurotensin), SEQ ID NO: 11 (PYIL), amino acid residues 11 to 13 of SEQ ID NO: 10 (YIL) and SEQ ID NO: 12 (NT69L), or a fragment or variant of said competing ligand.

92. The method according to claim 91, wherein information derived from the atomic coordinates of at least one of the following amino acid residues of binding site 1: R325, S316, Y351, I353, K260, I327, F314, F350 to M363, S305, F306, T398 to G400, I303-G309, Q349-A356, Y395 and T402 of SEQ ID NO: 1 are used, or
wherein information derived from the atomic coordinates of at least one of the following amino acid residues of binding site 2: L572, L114, V112, R109 to S111, S115 to G118, T570, G571, W586, W597, T168-I174, L572, A573 and S584 to F588 of SEQ ID NO: 1 are used, or
wherein information derived from the atomic coordinates of at least one of the following amino acid residues of binding site 3: D403, S420, D422, N423, S424, I425, Q426, T451, Y466, Q470, I498, S499 and V500 of SEQ ID NO: 1 are used.

93. The method according to claim 88, wherein the criteria data set or binding interaction set comprise at least 3 amino acid residues selected from the identified groups.

94. The method according to claim 91, wherein the atomic coordinates are determined to a resolution of at least 3 Å.

95. The method according to claim 91, wherein the atomic coordinates are determined to a resolution of at least 2 Å.

96. The method according to claim 91, wherein the atomic coordinates are determined to a resolution of at least 1.5 Å.

97. The method according to claim 91, wherein the potential ligand molecule interacts with at least amino acids in the high affinity Neurotensin binding site of SEQ ID NO: 1, or wherein the potential ligand molecule interacts with at least amino acids in the low affinity Neurotensin binding site of SEQ ID NO: 1.

98. The method according to claim 91, wherein the potential ligand molecule interacts with at least amino acids in the Sortilin propeptide binding site of SEQ ID NO: 1, or wherein the potential ligand molecule interacts with at least amino acids in the pro-neurotrophin binding site of SEQ ID NO: 1.

99. The method according to claim 91, wherein the potential ligand is selected from the group consisting of non-hydrolyzable peptides and peptide analogues, organic compounds and inorganic compounds.

100. The method according to claim 91, wherein a library of small organic molecules are screened, or
wherein a library of potential peptide ligands are screened.

101. A method for building an atomic model of a Vps10p-domain receptor protein molecule comprising the steps of:
a. identifying a Vps10p-domain receptor, or a fragment or variant thereof, having at least 20% sequence identity to SEQ ID NO: 1, and
b. utilizing the atomic coordinates as presented in any of FIGS. 17 to 20 or atomic coordinates selected from a three-dimensional structure that deviates from the three-dimensional structure presented in any of FIGS. 17 to 20 by a root mean square deviation over protein backbone atoms of not more than 3 Å,
to obtain an atomic model of the identified Vps10p-domain receptor by homology modelling.

102. The method of claim 101, wherein said Vps10p-domain receptor is selected from the group consisting of SEQ ID NO: 2 (SorLA), SEQ ID NO: 3 (SorCS1), SEQ ID NO: 4 (SorCS2) and SEQ ID NO: 5 (SorCS3), or a fragment or variant thereof.

103. A method of identifying a potential target specific molecular imaging ligand of the Vps10p-domain receptor identified by the method of claim 101, or a fragment or variant thereof, said method comprising the steps of:
a. introducing into a computer, information derived from atomic coordinates defining a conformation of a binding site having at least 20% sequence identity to 1 and/or binding site 2 and/or binding site 3 of SEQ ID NO: 1 (Sortilin), or a fragment or variant thereof, based on three-dimensional structure determination, whereby a computer program utilizes or displays on the computer screen the structure of said conformation; wherein said atomic coordinates are selected from the three-dimensional structure as presented in any of FIGS. 17 to 20 or atomic coordinates selected from a three-dimensional structure that deviates from any one of the tree-dimensional structure represented by any of FIGS. 17 to 20 by a root mean square deviation over protein backbone atoms of not more than 3 Å;
b. generating a three-dimensional representation of a binding site having at least 20% sequence identity to binding site 1, binding site 2 or binding site 3 of Sortilin, or a fragment or variant thereof, by said computer program on a computer screen;
a. superimposing a model of a potential ligand on the representation of said binding site having at least 20% sequence identity to site 1, binding site 2 or binding site 3 of Sortilin;
b. assessing the possibility of bonding and the absence of steric interference of the potential ligand with the binding site having at least 20% sequence identity to binding site 1, binding site 2 or binding site 3 of Sortilin or a fragment or variant thereof;
c. incorporating said potential ligand compound in a binding assay of said Vps10p-domain receptor; and
d. determining whether said potential ligand is capable of binding to said binding site having at least 20% sequence identity to binding site 1 and/or binding site 2 and/or binding site 3 of SEQ ID NO: 1 by performing a biochemical or biophysical competitive binding assay wherein the competing ligand is selected from the group consisting of amino acid residues 19 to 241 of SEQ ID NO: 6 (proNGF), amino acid residues 19 to 121 of SEQ ID NO: 6 (NGF pro domain), amino acid residues 19 to 246 of SEQ ID NO: 7 (proBDNF), amino acid residues 19 to 127 of SEQ ID NO: 7 (BDNF pro domain), amino acid residues 17 to 257 of SEQ ID NO: 8 (proNT3), amino acid residues 17 to 140 of SEQ ID NO: 8 (NT3 pro domain), amino acid residues 25 to 210 of SEQ ID NO: 9 (proNT4/5), amino acid residues 25 to 80 of SEQ ID NO: 9 (NT4/5 pro domain), SEQ ID NO: 10 (Neurotensin), SEQ ID NO: 11 (PYIL), amino acid residues 11 to 13 of SEQ ID NO: 10 (YIL) and SEQ ID NO: 12 (NT69L); or a fragment or variant of said competing ligand.
